(19) United States
(12) Patent Application Publication
(10) Pub. No.: US 2009/0196801 A1
(43) Pub. Date: Aug. 6, 2009

(54) Hydrogen power, plasma and reactor for lasing, and power conversion

(75) Inventor: Randell L. Mills, Cranbury, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: BlackLight Power, Inc.

(21) Appl. No.: 12/230,547

(22) Filed: Aug. 29, 2008

Related U.S. Application Data
(63) Continuation of application No. 10/494,571, filed on May 6, 2004, now abandoned.
(60) Provisional application No. 60/331,308, filed on Nov. 14, 2001.
(60) Provisional application No. 60/342,114, filed on Dec. 26, 2001.
(60) Provisional application No. 60/399,739, filed on Aug. 1, 2002.
(60) Provisional application No. 60/380,846, filed on May 17, 2002.
(60) Provisional application No. 60/385,892, filed on Jun. 6, 2002.
(60) Provisional application No. 60/398,135, filed on Jul. 25, 2002.

(51) Int. Cl. B01J 19/08

(52) U.S. Cl. 422/186

(57) ABSTRACT

Provided is an inverted population of hydrogen, formed from a novel catalytic reaction of hydrogen atoms to form lower-energy hydrogen. The inverted population of hydrogen is capable of lasing. The power may be utilized as laser light or the light due to stimulated or spontaneous emission may be converted to electricity with a pholon-to-electric converter such as a photovoltaic cell.

### I. INTRODUCTION

1. Field of the Invention

This invention relates to a power source and a laser based on the power source wherein the power may also be converted to electricity with a power converter of the present invention. The power source comprises a cell for the catalysis of atomic hydrogen to form novel hydrogen species and/or compositions of matter comprising new forms of hydrogen. The reaction may be maintained by a microwave or glow discharge plasma of hydrogen and a source of catalyst. The power from the catalysis of hydrogen may create an inverted population of a species capable of lasing such as atomic hydrogen. The power may utilized as laser light or the light due to stimulated or spontaneous emission may be converted to electricity with a photon-to-electric converter such as a photovoltaic cell. In addition or alternatively, the thermal power may used for heating or be directly converted into electricity since it forms or contributes energy to the plasma. The plasma power may be converted to electricity by a magnetohydrodynamic power converter from a directional flow of ions formed using a magnetic mirror based on the adiabatic invariant

$$\frac{{v}_{⊥}^{2}}{B} = constant .$$

Alternatively, the power converter comprises plasmadynamic converter comprising a magnetic field which permits positive ions to be separated from electrons using at least one electrode to produce a voltage with respect to at least one counter electrode connected through a load. These and other methods and means to convert plasma into electricity are described in my prior published applications and articles, which are incorporated by reference in their entirety below.

2. Background of the Invention

2.1 Hydrinos

A hydrogen atom having a binding energy given by

$$Binding Energy = \frac{13.6 eV}{{( \frac{1}{p} )}^{2}} \qquad ( 1 )$$

where p is an integer greater than 1, preferably from 2 to 200, is disclosed in R. Mills, The Grand Unified Theory of Classical Quantum Mechanics, January 2000 Edition, BlackLight Power, Inc., Cranbury, N.J., Distributed by Amazon.com (“'00 Mills GUT”), provided by BlackLight Power, Inc., 493 Old Trenton Road, Cranbury, N.J., 08512; R. Mills, The Grand Unified Theory of Classical Quantum Mechanics, September 2001 Edition, BlackLight Power, Inc., Cranbury, N.J., Distributed by Amazon.com (“'01 Mills GUT”), provided by BlackLight Power, Inc., 493 Old Trenton Road, Cranbury, N.J., 08512 (posted at www.blacklightpower.com; R. Mills, The Grand Unified Theory of Classical Quantum Mechanics, September 2002 Edition, BlackLight Power, Inc., Cranbury, N.J., (“'02 Mills GUT”), provided by BlackLight Power, Inc., 493 Old Trenton Road, Cranbury, N.J., 08512 (posted at www.blacklightpower.com; R. Mills, P. Ray, R. M. Mayo, “Comparison of Ammonia-Plasma Sources of Stationary Inverted Balmer and Lyman Populations for a CW HI Laser”, J. Appl. Spectroscopy, in preparation; R. L. Mills, P. C. Ray, B. Dhandapani, R. M. Mayo, J. He, A. Echezuria, M. Nansteel, X Chen, “Excessive Balmer α Line Broadening of Glow Discharge and Microwave Hydrogen Plasmas, Excess Power, and a Novel Vibrational Series in the EUV Region Due to a Catalytic Reaction of Atomic Hydrogen”, IJHE, in preparation; R. L. Mills, P. Ray, J. Dong, M. Nansteel, R. M. Mayo, B. Dhandapani, X. Chen, “Comparison of Balmer α Line Broadening and Power Balances of Helium-Hydrogen Plasma Sources”, IJHE, in preparation; R. Mills, P. Ray, M. Nansteel, R. M. Mayo, “Comparison of Water-Plasma Sources of Stationary Inverted Balmer and Lyman Populations for a CW HI Laser”, J. Appl. Spectroscopy, in preparation; R. Mills, J. He, B. Dhandapani, P. Ray, “Comparison of Catalysts and Microwave Plasma Sources of Vibrational Spectral Emission of Fractional-Rydberg-State Hydrogen Molecular Ion”, Canadian Journal of Physics, submitted; R. L. Mills, P. Ray, J. Dong, M. Nansteel, B. Dhandapani, J. He, “Vibrational Spectral Emission of Fractional-Principal-Quantum-Energy-Level Molecular Hydrogen”, Bulletin of the Chemical Society of Japan, submitted; J. Phillips, R. L. Mills, X. Chen, “Water Bath Calorimetric Study of Excess Heat in ‘Resonance Transfer’ Plasmas”, Journal of Applied Physics, submitted; R. L. Mills, P. Ray, B. Dhandapani, X. Chen, “Comparison of Catalysts and Microwave Plasma Sources of Spectral Emission of Fractional-Principal-Quantum-Energy-Level Atomic and Molecular Hydrogen”, Journal of Applied Spectroscopy, submitted; R. Mills, J. He, A. Echezuria, B Dhandapani, P. Ray, “Comparison of Catalysts and Microwave Plasma Sources of Vibrational Spectral Emission of Fractional-Rydberg-State Hydrogen Molecular Ion”, Vibrational Spectroscopy, submitted; R. L. Mills, P. Ray, B. Dhandapani, J. He, “Novel Liquid-Nitrogen-Condensable Molecular Hydrogen Gas”, Chemistry—A European Journal, submitted; R. L. Mills, P. C. Ray, R. M. Mayo, M. Nansteel, B. Dhandapani, J. Phillips, “Spectroscopic Study of Unique Line Broadening and Inversion in Low Pressure Microwave Generated Water Plasmas”, Physics of Plasmas, submitted; R. L. Mills, P. Ray, B. Dhandapani, J. He, “Spectroscopic Identification of Fractional Rydberg States of Atomic Hydrogen Formed by a Catalytic Helium-Hydrogen Plasma Reaction”, Applied Spectroscopy: General, submitted; R. L. Mills, M. Nansteel, P. C. Ray, “Bright Hydrogen-Light and Power Source due to a Resonant Energy Transfer with Strontium and Argon Ions”, Vacuum, submitted; R. L. Mills, P. Ray, B. Dhandapani, J. Dong, X. Chen, “Power Source Based on Helium-Plasma Catalysis of Atomic Hydrogen to Fractional Rydberg States”, J. Mol. Struct., submitted; R. Mills, J. He, A. Echezunra, B Dhandapani, P. Ray, “Comparison of Catalysts and Plasma Sources of Vibrational Spectral Emission of Fractional-Rydberg-State Hydrogen Molecular Ion”, Vibrational Spectroscopy, submitted; R. Mills, J. Sankar, P. Ray, B. Dhandapani, J. He, “Spectroscopic Characterization of the Atomic Hydrogen Energies and Densities and Carbon Species During Helium-Hydrogen-Methane Plasma CVD Synthesis of Single Crystal Diamond Films”, Chemistry of Materials, submitted; R. Mills, P. Ray, R. M. Mayo, “Stationary Inverted Balmer and Lyman Populations for a CW HI Water-Plasma Laser”, IEEE Transactions on Plasma Science, submitted; R. L. Mills, P. Ray, B. Dhandapani, J. He, “New Energy States of Atomic Hydrogen Formed in a Catalytic Helium-Hydrogen Plasma”, IEEE Transactions on Plasma Science, submitted; R. L. Mills, P. Ray, “Spectroscopic Evidence for a Water-Plasma Laser”, Europhysics Letters, submitted; R. Mills, P. Ray, R. M. Mayo, “Spectroscopic Evidence for CW H I Lasing in a Water-Plasma”, J. of Applied Physics, submitted; R. L. Mills, B. Dhandapani, J. He, J. Sankar, “CVD Synthesis of Single Crystal Diamond Films on Silicon Substrates Without Seeding”, J of Materials Chemistry, submitted; R. L. Mills, X. Chen, P. Ray, J. He, B. Dhandapani, “Plasma Power Source Based on a Catalytic Reaction of Atomic Hydrogen Measured by Water Bath Calorimetry”, Thermochimica Acta, submitted; R. L. Mills, A. Voigt, B. Dhandapani, J. He, “Synthesis and Spectroscopic Identification of Lithium Chloro Hydride”, Materials Characterization, submitted; R. L. Mills, B. Dhandapani, J. He, “Highly Stable Amorphous Silicon Hydride”, Solar Energy Materials & Solar Cells, submitted; R. L. Mills, B. Dhandapani, J. He, J. Sankar, “Synthesis of HDLC Films from Solid Carbon”, Thin Solid Films, submitted; R. Mills, P. Ray, R. M. Mayo, “The Potential for a Hydrogen Water-Plasma Laser”, Applied Physics Letters, submitted; R. L. Mills, “Classical Quantum Mechanics”, Proceedings A, submitted; R. Mills, P. Ray, “Spectra of the Bound-Free Hyperfine Levels of a Novel Hydride Ion Formed from Incandescently Heated Hydrogen Gas with Certain Group I Catalysts”, Journal of Photochemistry and Photobiology A, submitted; R. L. Mills, P. Ray, “Spectroscopic Characterization of Stationary Inverted Lyman Populations and Free-Free and Bound-Free Emission of Lower-Energy State Hydride Ion Formed by a Catalytic Reaction of Atomic Hydrogen and Certain Group I Catalysts, ChemPhysChem, submitted; R. M. Mayo, R. Mills, “Direct Plasmadynanic Conversion of Plasma Thermal Power to Electricity for Microdistributed Power Applications”, 40th Annual Power Sources Conference, Cherry Hill, N.J., June 10-13, (2002), pp. 1-4; R. Mills, P. Ray, R. M. Mayo, “Chemically-Generated Stationary Inverted Lyman Population for a CW HI Laser”, J Vac. Sci. and Tech. A, submitted; R. L. Mills, P. Ray, “Stationary Inverted Lyman Population Formed from Incandescently Heated Hydrogen Gas with Certain Catalysts”, J. Phys. D, Applied Physics, submitted; R. Mills, “A Maxwellian Approach to Quantum Mechanics Explains the Nature of Free Electrons in Superfluid Helium”, Foundations of Science, submitted; R. Mills and M. Nansteel, P. Ray, “Bright Hydrogen-Light Source due to a Resonant Energy Transfer with Strontium and Argon Ions”, New Journal of Physics, Vol. 4, (2002), pp. 70.1-70.28; R. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, in press; R. L. Mills, P. Ray, J. Dong, M. Nansteel, B. Dhandapani, J. He, “Spectral Emission of Fractional-Principal-Quantum-Energy-Level Atomic and Molecular Hydrogen”, Vibrational Spectroscopy, submitted; R. L. Mills, P. Ray, E. Dayalan, B. Dhandapani, J. He, “Comparison of Excessive Balmer α Line Broadening of Inductively and Capacitively Coupled RF, Microwave, and Glow Discharge Hydrogen Plasmas with Certain Catalysts”, IEEE Transactions on Plasma Science, in press; R. M. Mayo, R. Mills, M. Nansteel, “Direct Plasmadynamic Conversion of Plasma Thermal Power to Electricity”, IEEE Transactions on Plasma Science, in press; H. Conrads, R. Mills, Th. Wrubel, “Emission in the Deep Vacuum Ultraviolet from a Plasma Formed by Incandescently Heating Hydrogen Gas with Trace Amounts of Potassium Carbonate”, Plasma Sources Science and Technology, submitted; R. L. Mills, P. Ray, “Stationary Inverted Lyman Population and a Very Stable Novel Hydride Formed by a Catalytic Reaction of Atomic Hydrogen and Certain Catalysts”, International Journal of Engineering Science, submitted; R. L. Mills, J. He, P. Ray, B. Dhandapani, X. Chen, “Synthesis and Characterization of a Highly Stable Amorphous Silicon Hydride as the Product of a Catalytic Helium-Hydrogen Plasma Reaction”, Int. J. Hydrogen Energy, submitted; R. L. Mills, A. Voigt, B. Dhandapani, J. He, “Synthesis and Characterization of Lithium Chloro Hydride”, Int. J. Hydrogen Energy, submitted; R. L. Mills, P. Ray, “Substantial Changes in the Characteristics of a Microwave Plasma Due to Combining Argon and Hydrogen”, New Journal of Physics, www.njp.org, Vol. 4, (2002), pp. 22.1-22.17; R. L. Mills, P. Ray, “A Comprehensive Study of Spectra of the Bound-Free Hyperfine Levels of Novel Hydride Ion H⁻(½), Hydrogen, Nitrogen, and Air”, Int. J. Hydrogen Energy, in press; R. L. Mills, E. Dayalan, “Novel Alkali and Alkaline Earth Hydrides for High Voltage and High Energy Density Batteries”, Proceedings of the 17^{th} Annual Battery Conference on Applications and Advances, California State University, Long Beach, Calif., (Jan. 15-18, 2002), pp. 1-6; R. M. Mayo, R. Mills, M. Nansteel, “On the Potential of Direct and MHD Conversion of Power from a Novel Plasma Source to Electricity for Microdistributed Power Applications”, IEEE Transactions on Plasma Science, in press; R. Mills, P. C. Ray, R. M. Mayo, M. Nansteel, W. Good, P. Jansson, B. Dhandapani, J. He, “Stationary Inverted Lyman Populations and Free-Free and Bound-Free Emission of Lower-Energy State Hydride Ion Formed by an Exothermnic Catalytic Reaction of Atomic Hydrogen and Certain Group I Catalysts”, Physical Chemistry Chemical Physics, submitted; R. Mills, E. Dayalan, P. Ray, B. Dhandapani, J. He, “Highly Stable Novel Inorganic Hydrides from Aqueous Electrolysis and Plasma Electrolysis”, Electrochimica Acta, Vol. 47, No. 24, (2002), pp. 3909-3926; R. L. Mills, P. Ray, B. Dhandapani, J. He, “Comparison of Excessive Balmer at Line Broadening of Glow Discharge and Microwave Hydrogen Plasmas with Certain Catalysts”, J. of Applied Physics, January, 1, (2003); R. L. Mills, P. Ray, B. Dhandapani, J. He, “Emission Spectroscopic Identification of Fractional Rydberg States of Atomic Hydrogen Formed by a Catalytic Helium-Hydrogen Plasma Reaction”, Journal of Luminescence, submitted; R. L. Mills, P. Ray, B. Dhandapani, M. Nansteel, X. Chen, J. He, “New Power Source from Fractional Rydberg States of Atomic Hydrogen”, Canadian Journal of Chemistry, submitted; R. L. Mills, P. Ray, B. Dhandapani, M. Nansteel, X. Chen, J. He, “Spectroscopic Identification of Transitions of Fractional Rydberg States of Atomic Hydrogen”, New Journal of Chemistry, submitted; R. L. Mills, P. Ray, B. Dhandapani, M. Nansteel, X. Chen, J. He, “New Power Source from Fractional Quantum Energy Levels of Atomic Hydrogen that Surpasses Internal Combustion”, J. Mol. Struct., Vol. 643, No. 1-3, (2003), pp. 43-54; R. L. Mills, P. Ray, “Spectroscopic Identification of a Novel Catalytic Reaction of Rubidium Ion with Atomic Hydrogen and the Hydride Ion Product”, Int. J. Hydrogen Energy, Vol. 27, No. 9, (2002), pp. 927-935; R. Mills, J. Dong, W. Good, P. Ray, J. He, B. Dhandapani, “Measurement of Energy Balances of Noble Gas-Hydrogen Discharge Plasmas Using Calvet Calorimetry”, Int. J. Hydrogen Energy, Vol. 27, No. 9, (2002), pp. 967-978; R. L. Mills, A. Voigt, P. Ray, M. Nansteel, B. Dhandapani, “Measurement of Hydrogen Balmer Line Broadening and Thermal Power Balances of Noble Gas-Hydrogen Discharge Plasmas”, Int. J. Hydrogen Energy, Vol. 27, No. 6, (2002), pp. 671-685, R. Mills, P. Ray, “Vibrational Spectral Emission of Fractional-Principal-Quantum-Energy-Level Hydrogen Molecular Ion”, Int. J. Hydrogen Energy, Vol. 27, No. 5, (2002), pp. 533-564; R. Mills, P. Ray, “Spectral Emission of Fractional Quantum Energy Levels of Atomic Hydrogen from a Helium-Hydrogen Plasma and the Implications for Dark Matter”, Int. J. Hydrogen Energy, Vol. 27, No. 3, pp. 301-322; R. Mills, P. Ray, “Spectroscopic Identification of a Novel Catalytic Reaction of Potassium and Atomic Hydrogen and the Hydride Ion Product”, Int. J. Hydrogen Energy, Vol. 27, No. 2, (2002), pp. 183-192; R. Mills, “BlackLight Power Technology-A New Clean Hydrogen Energy Source with the Potential for Direct Conversion to Electricity”, Proceedings of the National Hydrogen Association, 12 th Annual U.S. Hydrogen Meeting and Exposition, Hydrogen: The Common Thread, The Washington Hilton and Towers, Washington D.C., (Mar. 6-8, 2001), pp. 671-697; R. Mills, W. Good, A. Voigt, Jinquan Dong, “Minimum Heat of Formation of Potassium Iodo Hydride”, Int. J. Hydrogen Energy, Vol. 26, No. 11, (2001), pp. 1199-1208; R. Mills, “Spectroscopic Identification of a Novel Catalytic Reaction of Atomic Hydrogen and the Hydride Ion Product”, Int. J. Hydrogen Energy, Vol. 26, No. 10, (2001), pp. 1041-1058; R. Mills, N. Greenig, S. Hicks, “Optically Measured Power Balances of Glow Discharges of Mixtures of Argon, Hydrogen, and Potassium, Rubidium, Cesium, or Strontium Vapor”, Int. J. Hydrogen Energy, Vol. 27, No. 6, (2002), pp. 651-670; R. Mills, “The Grand Unified Theory of Classical Quantum Mechanics”, Global Foundation, Inc. Orbis Scientiae entitled The Role of Attractive and Repulsive Gravitational Forces in Cosmic Acceleration of Particles The Origin of the Cosmic Gamma Ray Bursts, (29th Conference on High Energy Physics and Cosmology Since 1964) Dr. Behram N. Kursunoglu, Chairman, Dec. 14-17, 2000, Lago Mar Resort, Fort Lauderdale, Fla., Kluwer Academic/Plenum Publishers, New York, pp. 243-258; R. Mills, “The Grand Unified Theory of Classical Quantum Mechanics”, Int. J. Hydrogen Energy, Vol. 27, No. 5, (2002), pp. 565-590; R. Mills and M. Nansteel, P. Ray, “Argon-Hydrogen-Strontium Discharge Light Source”, IEEE Transactions on Plasma Science, Vol. 30, No. 2, (2002), pp. 639-653; R. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979; R. Mills, “BlackLight Power Technology-A New Clean Energy Source with the Potential for Direct Conversion to Electricity”, Global Foundation International Conference on “Global Warming and Energy Policy”, Dr. Behram N. Kursunoglu, Chairman, Fort Lauderdale, Fla., Nov. 26-28, 2000, Kluwer AcadenmicPlenum Publishers, New York, pp. 187-202; R. Mills, “The Nature of Free Electrons in Superfluid Helium—a Test of Quantum Mechanics and a Basis to Review its Foundations and Make a Comparison to Classical Theory”, Int. J. Hydrogen Energy, Vol. 26, No. 10, (2001), pp. 1059-1096; R. Mills, M. Nansteel, and Y. Lu, “Excessively Bright Hydrogen-Strontium Plasma Light Source Due to Energy Resonance of Strontium with Hydrogen”, J. of Plasma Physics, in press; R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943; R. Mills, “Observation of Extreme Ultraviolet Emission from Hydrogen-KI Plasmas Produced by a Hollow Cathode Discharge”, Int. J. Hydrogen Energy, Vol. 26, No. 6, (2001), pp. 579-592; R. Mills, “Temporal Behavior of Light-Emission in the Visible Spectral Range from a Ti—K2CO3—H-Cell”, Int. J. Hydrogen Energy, Vol. 26, No. 4, (2001), pp. 327-332; R. Mills, T. Onuma, and Y. Lu, “Formation of a Hydrogen Plasma from an Incandescently Heated Hydrogen-Catalyst Gas Mixture with an Anomalous Afterglow Duration”, Int. J. Hydrogen Energy, Vol. 26, No. 7, July, (2001), pp. 749-762; R. Mills, M. Nansteel, and Y. Lu, “Observation of Extreme Ultraviolet Hydrogen Emission from Incandescently Heated Hydrogen Gas with Strontium that Produced an Anomalous Optically Measured Power Balance”, Int. J. Hydrogen Energy, Vol. 26, No. 4, (2001), pp. 309-326; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. Mills, “Novel Inorganic Hydride”, Int. J. of Hydrogen Energy, Vol. 25, (2000), pp. 669-683; R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367; R. Mills, “Highly Stable Novel Inorganic Hydrides”, Journal of New Materials for Electrochemical Systems, in press; R. Mills, “Novel Hydrogen Compounds from a Potassium Carbonate Electrolytic Cell”, Fusion Technology, Vol. 37, No. 2, March, (2000), pp. 157-182; R. Mills, “The Hydrogen Atom Revisited”, Int. J. of Hydrogen Energy, Vol. 25, Issue 12, December, (2000), pp. 1171-1183; Mills, R., Good, W., “Fractional Quantum Energy Levels of Hydrogen”, Fusion Technology, Vol. 28, No. 4, November, (1995), pp. 1697-1719; Mills, R., Good, W., Shaubach, R., “Dihydrino Molecule Identification”, Fusion Technology, Vol. 25, 103 (1994); R. Mills and S. Kneizys, Fusion Technol. Vol. 20, 65 (1991); and in prior PCT applications PCT/US02/06945; PCT/US02/06955; PCT/IUS01/09055; PCT/US01/25954; PCT/US00/20820; PCT/US00/20819; PCT/US99/17171; PCT/US99/17129; PCT/US 98/22822; PCT/US98/14029; PCT/US96/07949; PCT/US94/02219; PCT/US91/08496; PCT/US90/01998; and prior U.S. patent application Ser. No. 09/225,687, filed on Jan. 6, 1999; Ser. No. 60/095,149, filed Aug. 3, 1998; Ser. No. 60/101,651, filed Sep. 24, 1998; Ser. No. 60/105,752, filed Oct. 26, 1998; Ser. No. 60/113,713, filed Dec. 24, 1998; Ser. No. 60/123,835, filed Mar. 11, 1999; Ser. No. 60/130,491, filed Apr. 22, 1999; Ser. No. 60/141,036, filed Jun. 29, 1999; Ser. No. 09/009,294 filed Jan. 20, 1998; Ser. No. 09/111,160 filed Jul. 7, 1998; Ser. No. 09/111,170 filed Jul. 7, 1998; Ser. No. 09/111,016 filed Jul. 7, 1998; Ser. No. 09/111,003 filed Jul. 7, 1998; Ser. No. 09/110,694 filed Jul. 7, 1998; Ser. No. 09/110,717 filed Jul. 7, 1998; Ser. No. 60/053,378 filed Jul. 22, 1997; Ser. No. 60/068,913 filed Dec. 29, 1997; Ser. No. 60/090,239 filed Jun. 22, 1998; Ser. No. 09/009,455 filed Jan. 20, 1998; Ser. No. 09/110,678 filed Jul. 7, 1998; Ser. No. 60/053,307 filed Jul. 22, 1997; Ser. No. 60/068,918 filed Dec. 29, 1997; Ser. No. 60/080,725 filed Apr. 3, 1998; Ser. No. 09/181,180 filed Oct. 28, 1998; Ser. No. 60/063,451 filed Oct. 29, 1997; Ser. No. 09/008,947 filed Jan. 20, 1998; Ser. No. 60/074,006 filed Feb. 9, 1998; Ser. No. 60/080,647 filed Apr. 3, 1998; Ser. No. 09/009,837 filed Jan. 20, 1998; Ser. No. 08/822,170 filed Mar. 27, 1997; Ser. No. 08/592,712 filed Jan. 26, 1996; Ser. No. 08/467,051 filed on Jun. 6, 1995; Ser. No. 08/416,040 filed on Apr. 3, 1995; Ser. No. 08/467,911 filed on Jun. 6, 1995; Ser. No. 08/107,357 filed on Aug. 16, 1993; Ser. No. 08/075,102 filed on Jun. 11, 1993; Ser. No. 07/626,496 filed on Dec. 12, 1990; Ser. No. 07/345,628 filed Apr. 28, 1989; Ser. No. 07/341,733 filed Apr. 21, 1989 the entire disclosures of which are all incorporated herein by reference (hereinafter “Mills Prior Publications”).

The binding energy of an atom, ion, or molecule, also known as the ionization energy, is the energy required to remove one electron from the atom, ion or molecule. A hydrogen atom having the binding energy given in Eq. (1) is hereafter referred to as a hydrino atom or hydrino. The designation for a hydrino of radius

$$\frac{{a}_{H}}{p} ,$$

where α_{H} is the radius of an ordinary hydrogen atom and p is an integer, is

$$H [ \frac{{a}_{H}}{p} ] .$$

A hydrogen atom with a radius α_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a catalyst having a net enthalpy of reaction of about

m·27.2 eV (2a)

where m is an integer. This catalyst has also been referred to as an energy hole or source of energy hole in Mills earlier filed Patent Applications. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

In another embodiment, the catalyst to form hydrinos has a net enthalpy of reaction of about

m/2·27.2 eV (2b)

where m is an integer greater that one. It is believed that the rate of catalysis is increased as the net enthalpy of reaction is more closely matched to m/2·27.2 eV. It has been found that catalysts having a net enthalpy of reaction within ±10%, preferably ±5%, of m/2·27.2 eV are suitable for most applications.

A catalyst of the present invention may provide a net enthalpy of m·27.2 eV where m is an integer or m/2·27.2 eV where in is an integer greater than one by undergoing a transition to a resonant excited state energy level with the energy transfer from hydrogen. For example, He⁺ absorbs 40.8 eV during the transition from the n=1 energy level to the n=2 energy level which corresponds to 3/2-27.2 eV (m=3 in Eq. (2b)). This energy is resonant with the difference in energy between the p=2 and the p=1 states of atomic hydrogen given by Eq. (1). Thus He⁺ may serve as a catalyst to cause the transition between these hydrogen states.

A catalyst of the present invention may provide a net enthalpy of m·27.2 eV where m is an integer or m/2·27.2 eV where m is an integer greater than one by becoming ionized during resonant energy transfer. For example, the third ionization energy of argon is 40.74 eV; thus, Ar²⁺ absorbs 40.8 eV during the ionization to Ar³⁺ which corresponds to 3/2·27.2 eV (m=3 in Eq. (2b)). This energy is resonant with the difference in energy between the p=2 and the p=1 states of atomic hydrogen given by Eq. (1). Thus Ar²⁺ may serve as a catalyst to cause the transition between these hydrogen states.

This catalysis releases energy from the hydrogen atom with a commensurate decrease in size of the hydrogen atom, rₙ=nα_{H}. For example, the catalysis of H(n=1) to H(n=½) releases 40.8 eV, and the hydrogen radius decreases from

$${a}_{H} to \frac{1}{2} {a}_{H} .$$

A catalytic system is provided by the ionization of t electrons from an atom each to a continuum energy level such that the sun of the ionization energies of the t electrons is approximately m X 27.2 eV where m is an integer. One such catalytic system involves potassium metal. The first, second, and third ionization energies of potassium are 4.34066 eV, 31.63 eV, 45.806 eV, respectively [D. R. Lide, CRC Handbook of Chemnistry and Physics, 78 th Edition, CRC Press, Boca Raton, Fla., (1997), p. 10-214 to 10-216]. The triple ionization (t=3) reaction of K to K³⁺, then, has a net enthalpy of reaction of 81.7426 eV, which is equivalent to m=3 in Eq. (2a).

$$\begin{matrix}81.7426 eV + K ( m ) + H [ \frac{{a}_{H}}{p} ] \to {K}^{3 +} + 3 {e}^{-} + H [ \frac{{a}_{H}}{( p + 3 )} ] + [ {( p + 3 )}^{2} - {p}^{2} ] X 13.6 eV & ( 3 ) \\ {K}^{3 +} + 3 {e}^{-} \to K ( m ) + 81.7426 eV & ( 4 )\end{matrix}$$

And, the overall reaction is

$$H [ \frac{{a}_{H}}{p} ] \to H [ \frac{{a}_{H}}{( p + 3 )} ] + [ {( p + 3 )}^{2} - {p}^{2} ] X 13.6 eV \qquad ( 5 )$$

Rubidium ion (Rb⁺) is also a catalyst because the second ionization energy of rubidium is 27.28 eV. In this case, the catalysis reaction is

$$\begin{matrix}27.28 eV + {Rb}^{+} + H [ \frac{{a}_{H}}{p} ] {Rb}^{2 +} + {e}^{-} + H [ \frac{{a}_{H}}{( p + 1 )} ] + [ {( p + 1 )}^{2} - {p}^{2} ] X 13.6 eV & ( 6 ) \\ {Rb}^{2 +} + {e}^{-} \to {Rb}^{+} + 27.28 eV & ( 7 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 8 )$$

Strontium ion (Sr⁺) is also a catalyst since the second and third ionization energies of strontium are 11.03013 eV and 42.89 eV, respectively. The ionization reaction of Sr⁺ to Sr³⁺, (t=2), then, has a net enthalpy of reaction of 53.92 eV, which is equivalent to n=2 in Eq. (2a).

$$\begin{matrix}53.92 eV + {Sr}^{+} + H [ \frac{{a}_{H}}{p} ] \to {Sr}^{3 +} + 2 {e}^{-} + H [ \frac{{a}_{H}}{( p + 2 )} ] + [ {( p + 2 )}^{2} - {p}^{2} ] X 13.6 eV & ( 9 ) \\ {Sr}^{3 +} + 2 {e}^{-} \to {Sr}^{+} + 53.92 eV & ( 10 )\end{matrix}$$

And, the overall reaction is

$$H [ \frac{{a}_{H}}{p} ] \to H [ \frac{{a}_{H}}{( p + 2 )} ] + [ {( p + 2 )}^{2} - {p}^{2} ] X 13.6 eV \qquad ( 11 )$$

Helium ion (He⁺) is also a catalyst because the second ionization energy of helium is 54.417 eV. In this case, the catalysis reaction is

$$\begin{matrix}54.417 eV + {He}^{+} + H [ \frac{{a}_{H}}{p} ] \to {He}^{2 +} + {e}^{-} + H [ \frac{{a}_{H}}{( p + 2 )} ] + [ {( p + 2 )}^{2} - {p}^{2} ] X 13.6 eV & ( 12 ) \\ {He}^{2 +} + {e}^{-} \to {He}^{+} + 54.417 eV & ( 13 )\end{matrix}$$

And, the overall reaction is

$$H [ \frac{{a}_{H}}{p} ] \to H [ \frac{{a}_{H}}{( p + 2 )} ] + [ {( p + 2 )}^{2} - {p}^{2} ] X 13.6 eV \qquad ( 14 )$$

Argon ion is a catalyst. The second ionization energy is 27.63 eV.

$$\begin{matrix}27.63 eV + {Ar}^{+} + H [ \frac{{a}_{H}}{p} ] \to {Ar}^{2 +} + {e}^{-} + H [ \frac{{a}_{H}}{( p + 1 )} ] + [ {( p + 1 )}^{2} - {p}^{2} ] X 13.6 eV & ( 15 ) \\ {Ar}^{2 +} + {e}^{-} \to {Ar}^{+} + 27.63 eV & ( 16 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 17 )$$

A neon ion and a proton can also provide a net enthalpy of a multiple of that of the potential energy of the hydrogen atom. The second ionization energy of neon is 40.96 eV, and H⁺ releases 13.6 eV when it is reduced to H. The combination of reactions of Ne⁺ to Ne²⁺ and H⁺ to H, then, has a net enthalpy of reaction of 27.36 eV, which is equivalent to m=1 in Eq. (2a).

$$\begin{matrix}27.36 eV + {Ne}^{+} + {H}^{+} + H [ \frac{{a}_{H}}{p} ] \to H + {Ne}^{2 +} + H [ \frac{{a}_{H}}{( p + 1 )} ] + [ {( p + 1 )}^{2} - {p}^{2} ] X 13.6 eV & ( 18 ) \\ H + {Ne}^{2 +} \to {H}^{+} + {Ne}^{+} + 27.36 eV & ( 19 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 20 )$$

A neon ion can also provide a net enthalpy of a multiple of that of the potential energy of the hydrogen atom. Net has an excited state Ne⁺ of 27.2 eV (46.5 nm) which provides a net enthalpy of reaction of 27.2 eV, which is equivalent to m=1 in Eq. (2a).

$$\begin{matrix}27.2 eV + {Ne}^{+} + H [ \frac{{a}_{H}}{p} ] \to {Ne}^{{+}^{*}} + H [ \frac{{a}_{H}}{( p + 1 )} ] + [ {( p + 1 )}^{2} - {p}^{2} ] X 13.6 eV & ( 21 ) \\ {Ne}^{{+}^{*}} \to {Ne}^{+} + 27.2 eV & ( 22 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 23 )$$

The first neon excimer continuum Ne₂* may also provide a net enthalpy of a multiple of that of the potential energy of the hydrogen atom. The first ionization energy of neon is 21.56454 eV, and the first neon excimer continuum Ne₂* has an excited state energy of 15.92 eV. The combination of reactions of Ne₂* to 2Ne⁺, then, has a net enthalpy of reaction of 27.21 eV, which is equivalent to m=1 in Eq. (2a).

$$\begin{matrix}27.21 eV + {Ne}_{2}^{*} + H [ \frac{{a}_{H}}{p} ] \to 2 {Ne}^{+} + H [ \frac{{a}_{H}}{( p + 1 )} ] + [ {( p + 1 )}^{2} - {p}^{2} ] X 13.6 eV & ( 24 ) \\ 2 {Ne}^{+} \to {Ne}_{2}^{*} + 27.21 eV & ( 25 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 26 )$$

Similarly for helium, the helium excimer continuum to shorter wavelengths He₂* may also provide a net enthalpy of a multiple of that of the potential energy of the hydrogen atom. The first ionization energy of helium is 24.58741 eV, and the helium excimer continuum He₂* has an excited state energy of 21.97 eV. The combination of reactions of He₂* to 2He⁺, then, has a net enthalpy of reaction of 27.21 eV, which is equivalent to m=1 in Eq. (2a).

$$\begin{matrix}27.21 eV + {He}_{2}^{*} + H [ \frac{{a}_{H}}{p} ] \to 2 {He}^{+} + H [ \frac{{a}_{H}}{( p + 1 )} ] + [ {( p + 1 )}^{2} - {p}^{2} ] X 13.6 eV & ( 27 ) \\ 2 {He}^{+} \to {He}_{2}^{*} + 27.21 eV & ( 28 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 29 )$$

Atomic hydrogen in sufficient concentration may serve as a catalyst since the ionization energy of hydrogen is 13.6 eV. Two atoms fulfill the catalyst criterion—a chemical or physical process with an enthalpy change equal to an integer multiple of 27.2 eV since together they ionize at 27.2 eV. Thus, the transition cascade for the pth cycle of the hydrogen-type atom,

$$H [ \frac{{a}_{H}}{p} ] ,$$

with two hydrogen atoms,

$$H [ \frac{{a}_{H}}{1} ] ,$$

as the catalyst is represented by

$$\begin{matrix}27.21 eV + 2 H [ \frac{{a}_{H}}{1} ] + H [ \frac{{a}_{H}}{p} ] -> 2 {H}^{+} + 2 {e}^{-} + H [ \frac{{a}_{H}}{( p + 1 )} ] + [ {( p + 1 )}^{2} - {p}^{2} ] \times 13.6 eV & ( 30 ) \\ 2 {H}^{+} + 2 {e}^{-} -> 2 H [ \frac{{a}_{H}}{1} ] + 27.21 eV & ( 31 )\end{matrix}$$

And, the overall reaction is

$$H [ \frac{{a}_{H}}{p} ] -> H [ \frac{{a}_{H}}{( p + 1 )} ] + [ {( p + 1 )}^{2} - p ] \times 13.6 eV \qquad ( 32 )$$

A nitrogen molecule can also provide a net enthalpy of a multiple of that of the potential energy of the hydrogen atom. The bond energy of the nitrogen molecule is 9.75 eV, and the first and second ionization energies of the nitrogen atom are 14.53414 eV and 29.6013 eV, respectively. The combination of reactions of N₂ to 2N and N to N²⁺, then, has a net enthalpy of reaction of 53.9 eV, which is equivalent to m=2 in Eq. (2a).

$$\begin{matrix}53.9 eV + {N}_{2} + H [ \frac{{a}_{H}}{p} ] -> N + {N}^{2} + H [ \frac{{a}_{H}}{( p + 2 )} ] + [ {( p + 2 )}^{2} - {p}^{2} ] \times 13.6 eV & ( 33 ) \\ N + {N}^{2 +} -> {N}_{2} + 53.9 eV & ( 34 )\end{matrix}$$

And, the overall reaction is

$$H [ \frac{{a}_{H}}{p} ] -> H [ \frac{{a}_{H}}{( p + 2 )} ] + [ {( p + 2 )}^{2} - {p}^{2} ] \times 13.6 eV \qquad ( 35 )$$

A carbon molecule can also provide a net enthalpy of a multiple of that of the potential energy of the hydrogen atom. The bond energy of the carbon molecule is 6.29 eV, and the first and through the sixth ionization energies of a carbon atom are 11.2603 eV, 24.38332 eV, 47.8878 eV, 64.4939 eV, and 392.087 eV, respectively. The combination of reactions of C₂ to 2C and C to C⁵⁺, then, has a net enthalpy of reaction of 546.40232 eV, which is equivalent to m=20 in Eq. (2a).

$$\begin{matrix}546.4 eV + {C}_{2} + H [ \frac{{a}_{H}}{p} ] -> C + {C}^{5 +} + H [ \frac{{a}_{H}}{( p + 20 )} ] + [ {( p + 20 )}^{2} - {p}^{2} ] \times 13.6 eV & ( 36 ) \\ C + {C}^{5 +} -> {C}_{2} + 546.4 eV & ( 37 )\end{matrix}$$

And, the overall reaction is

$$H [ \frac{{a}_{H}}{p} ] -> H [ \frac{{a}_{H}}{( p + 20 )} ] + [ {( p + 20 )}^{2} - {p}^{2} ] \times 13.6 eV \qquad ( 38 )$$

An oxygen molecule can also provide a net enthalpy of a multiple of that of the potential energy of the hydrogen atom. The bond energy of the oxygen molecule is 5.165 eV, and the first and second ionization energies of an oxygen atom are 13.61806 eV and 35.11730 eV, respectively. The combination of reactions of O₂ to 2O and O to O²⁺, then, has a net enthalpy of reaction of 53.9 eV, which is equivalent to m=2 in Eq. (2a).

$$\begin{matrix}53.9 eV + {O}_{2} + H [ \frac{{a}_{H}}{p} ] -> O + {O}^{2 +} + H [ \frac{{a}_{H}}{( p + 2 )} ] + [ {( p + 2 )}^{2} - {p}^{2} ] \times 13.6 eV & ( 39 ) \\ O + {O}^{2 +} -> {O}_{2} + 53.9 eV & ( 40 )\end{matrix}$$

And, the overall reaction is

$$H [ \frac{{a}_{H}}{p} ] -> H [ \frac{{a}_{H}}{( p + 2 )} ] + [ {( p + 2 )}^{2} - {p}^{2} ] \times 13.6 eV \qquad ( 41 )$$

An oxygen molecule can also provide a net enthalpy of a multiple of that of the potential energy of the hydrogen atom by an alternative reaction. The bond energy of the oxygen molecule is 5.165 eV, and the first through the third ionization energies of an oxygen atom are 13.61806 eV, 35.11730 eV, and 54.9355 eV, respectively. The combination of reactions of O₂ to 2O and O to O³⁺, then, has a net enthalpy of reaction of 108.83 eV, which is equivalent to m=4 in Eq. (2a).

$$\begin{matrix}108.83 eV + {O}_{2} + H [ \frac{{a}_{H}}{p} ] -> O + {O}^{3 +} + H [ \frac{{a}_{H}}{( p + 4 )} ] + [ {( p + 4 )}^{2} - {p}^{2} ] \times 13.6 eV & ( 42 ) \\ O + {O}^{3 +} -> {O}_{2} + 108.83 eV & ( 43 )\end{matrix}$$

And, the overall reaction is

$$H [ \frac{{a}_{H}}{p} ] -> H [ \frac{{a}_{H}}{( p + 4 )} ] + [ {( p + 4 )}^{2} - {p}^{2} ] \times 13.6 eV \qquad ( 44 )$$

An oxygen molecule can also provide a net enthalpy of a multiple of that of the potential energy of the hydrogen atom by an alternative reaction. The bond energy of the oxygen molecule is 5.165 eV, and the first through the fifth ionization energies of an oxygen atom are 13.61806 eV, 35.11730 eV, 54.9355 eV, 77.41353 eV, and 113.899 eV, respectively. The combination of reactions of O₂ to 2O and O to O⁵⁺, then, has a net enthalpy of reaction of 300.15 eV, which is equivalent to m=11 in Eq. (2a).

$$\begin{matrix}300.15 eV + {O}_{2} + H [ \frac{{a}_{H}}{p} ] -> O + {O}^{5 +} + H [ \frac{{a}_{H}}{( p + 11 )} ] + [ {( p + 11 )}^{2} - {P}^{2} ] \times 13.6 eV & ( 45 ) \\ O + {O}^{5 +} -> {O}_{2} + 300.15 eV & ( 46 )\end{matrix}$$

And, the overall reaction is

$$H [ \frac{{a}_{H}}{p} ] -> H [ \frac{{a}_{H}}{( p + 11 )} ] + [ {( p + 11 )}^{2} - {p}^{2} ] \times 13.6 eV \qquad ( 47 )$$

In addition to nitrogen, carbon, and oxygen molecules which are exemplary catalysts, other molecules may be catalysts according to the present invention wherein the energy to break the molecular bond and the ionization of t electrons from an atom from the dissociated molecule to a continuum energy level is such that the sum of the ionization energies of the t electrons is approximately m·27.2 eV where t and m are each an integer. The bond energies and the ionization energies may be found in standard sources such as D. R. Linde, CRC Handbook of Chemistry and Physics, 79 th Edition, CRC Press, Boca Raton, Fla., (1999), p. 9-51 to 9-69 and David R. Linde, CRC Handbook of Chemistry and Physics, 79 th Edition, CRC Press, Boca Raton, Fla., (1998-9), p. 10-175 to p. 10-177, respectively. Thus, further molecular catalysts which provide a positive enthalpy of m·27.2 eV to cause release of energy from atomic hydrogen may be determined by one skilled in the art.

Molecular hydrogen catalysts capable of providing a net enthalpy of reaction of approximately m×27.2 eV where in is an integer to produce hydrino whereby the molecular bond is broken and t electrons are ionized from a corresponding free atom of the molecule are given infra. The bonds of the molecules given in the first column are broken and the atom also given in the first column is ionized to provide the net enthalpy of reaction of m×27.2 eV given in the eleventh column where m is given in the twelfth column. The energy of the bond which is broken given by Linde [D. R. Lide, CRC Handbook of Chemistry and Physics, 79 th Edition, CRC Press, Boca Raton, Fla., (1999), p. 9-51 to 9-69] which is herein incorporated by reference is given in the 2nd column, and the electrons which are ionized are given with the ionization potential (also called ionization energy or binding energy). The ionization potential of the n th electron of the atom or ion is designated by IPₙ and is given by Linde [D. R. Lide, CRC Handbook of Chemistry and Physics, 79 th Edition, CRC Press, Boca Raton, Fla., (1998-9), p. 10-175 to p. 10-177] which is herein incorporated by reference. For example, the bond energy of the oxygen molecule, BE=5.165 eV, is given in the 2nd column, and the first ionization potential, IP₁=13.61806 eV, and the second ionization potential, IP₂=35.11730 eV, are given in the third and fourth columns, respectively. The combination of reactions of O₂ to 2O and O to O²⁺, then, has a net enthalpy of reaction of 53.9 eV, as given in the eleventh column, and m=2 in Eq. (2a) as given in the twelfth column.

TABLE 1
Molecular Hydrogen Catalysts

| Catalyst | BE | IP1 | IP2 | IP3 | IP4 | IP5 | IP6 | IP7 | IP8 | Enthalpy | m |
|---|---|---|---|---|---|---|---|---|---|---|---|
| C₂/C | 6.26 | 11.2603 | 24.38332 | 47.8878 | 64.4939 | 392.087 | | | | 546.4 | 20 |
| N₂/N | 9.75 | 14.53414 | 29.6013 | | | | | | | 53.9 | 2 |
| O₂/O | 5.165 | 13.61806 | 35.11730 | | | | | | | 54.26 | 2 |
| O₂/O | 5.165 | 13.61806 | 35.11730 | 54.9355 | | | | | | 108.83 | 4 |
| O₂/O | 5.165 | 13.61806 | 35.11730 | 54.9355 | 77.41353 | 113.899 | | | | 300.15 | 11 |
| CO₂/O | 5.52 | 13.61806 | 35.11730 | | | | | | | 54.26 | 2 |
| CO₂/O | 5.52 | 13.61806 | 35.11730 | 54.9355 | | | | | | 109.19 | 4 |
| CO₂/O | 5.52 | 13.61806 | 35.11730 | 54.9355 | 77.41353 | 113.8990 | | | | 300.5 | 11 |
| NO₂/O | 3.16 | 13.61806 | 35.11730 | 54.9355 | 77.41353 | 113.8990 | | | | 298.14 | 11 |
| NO₃/O | 2.16 | 13.61806 | 35.11730 | 54.9355 | 77.41353 | 113.8990 | 138.1197 | | | 435.26 | 16 |

In an embodiment, a molecular catalyst such as nitrogen is combined with another catalyst such as He⁺ (Eqs. (12-14)) or Ar⁺ (Eqs. (15-17)). In an embodiment of a catalyst combination of argon and nitrogen, the percentage of nitrogen is within the range 1-10%. In an embodiment of a catalyst combination of argon and nitrogen, the source of hydrogen atoms is a hydrogen halide such as HF.

The energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) -> {H}_{2} O ( l ) \qquad ( 48 )$$

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} -> \frac{1}{3} , \frac{1}{3} -> \frac{1}{4} , \frac{1}{4} -> \frac{1}{5} , and \qquad$$

so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

2.2 Dihydrino Molecular Ion, Dihydrino Molecule, and Hydrino Hydride Ion

The theory of lower-energy hydrogen molecular ions, molecules, and hydride ions are given in Mills '02 GUT in Chps. 12 and 7 which are incorporated by reference. H(1/p) may react with a proton to form a molecular ion H₂(1/p)⁺ that has a bond energy and vibrational levels that are p² times those of the molecular ion comprising uncatalyzed atomic hydrogen where p is an integer. E_{T}, the total energy of the hydrogen molecular H₂(1/p)⁺, is

E_{T}=13.6 eV(−4p² ln 3+p²+2p² ln 3)=−p² 16.28 eV (49)

The bond dissociation energy, E_{D}, is the difference between the total energy of the corresponding hydrogen atom or hydrino atom and E_{T}.

$$\begin{matrix}{E}_{D} = E ( H ⌊ \frac{{a}_{H}}{p} ⌋ ) - {E}_{T} \\ = - {p}^{2} 13.6 + {p}^{2} 16.28 eV \\ = {p}^{2} 2.68 eV\end{matrix} \qquad ( 50 )$$

H₂(1/p)⁺ has been observed spectroscopically [R. Mills, P. Ray, “Vibrational Spectral Emission of Fractional-Principal-Quantum-Energy-Level Hydrogen Molecular Ion”, Int. J. Hydrogen Energy, Vol. 27, No. 5, (2002), pp. 533-564; R. Mills, J. He, A. Echezuria, B Dhandapani, P. Ray, “Comparison of Catalysts and Plasma Sources of Vibrational Spectral Emission of Fractional-Rydberg-State Hydrogen Molecular Ion”, Vibrational Spectroscopy, submitted]. For example, the catalysis reaction product H(¼) was predicted to further react to form a new molecular ion H₂(¼)⁺ with the emission of a vibrational series from its transition state. The emission including both Stokes and antiStokes-like branches is given by the previously derived formula [R. Mills, J. He, A. Echezuria, B Dbandapani, P. Ray, “Comparison of Catalysts and Plasma Sources of Vibrational Spectral Emission of Fractional-Rydberg-State Hydrogen Molecular Ion”, Vibrational Spectroscopy, submitted]:

E_{D+vib}=4²E_{DH}_{₂}_{⁺}±ν2²E_{vib H}_{₂}_{⁺}_{(ν=0→ν=1)}, ν*=0, 1, 2, 3 (51)

In Eq. (51), E_{DH}_{₂}_{⁺} and E_{vibH}_{₂}_{^{*}}_{(ν=0→ν=1)} are the experimental bond and vibrational energies of H₂⁺, respectively. Extreme ultraviolet (EV) spectroscopy was recorded on microwave discharges of helium with 10% hydrogen in the range 10-65 nm. The predicted emission (Eq. (51)) was observed at the longer wavelengths for ν*=0 to ν*=20 and at the shorter wavelengths for ν*=0 to ν*=3. A peak at 28.93 nm matched the predicted bond energy of the molecular ion, 42.88 eV.

The diatomic molecule H₂(1/p) may form by reaction of the corresponding fractional Rydberg state atoms H(1/p)

2H(1/p)→H₂(1/p) (52)

where each energy level corresponds to a fractional quantum number that is the reciprocal of an integer p. The central field of fractional Rydberg state H₂(1/p) is p times that of ordinary H₂, the corresponding total, bond, and vibrational energies are p² those of H₂, and the internuclear distance is

$$2 {c}^{′} = \frac{\sqrt{2} {a}_{o}}{p} \qquad ( 53 )$$

E_{T}, the total energy of the molecule H₂(1/p), is

$$\begin{matrix}{E}_{T} = - 13.6 eV [ ( \begin{matrix}2 {p}^{2} \sqrt{2} - {p}^{2} \sqrt{2} + \\ \frac{{p}^{2} \sqrt{2}}{2}\end{matrix} ) ln \frac{\sqrt{2} + 1}{\sqrt{2} - 1} - {p}^{2} \sqrt{2} ] \\ = - {p}^{2} 31.63 eV\end{matrix} \qquad ( 54 )$$

where −31.63 eV is the total energy of H₂. The experimental bond energy of the hydrogen molecule [P. W. Atkins, Physical Chemistry, Second Edition, W. H. Freeman, San Francisco, (1982), p. 589] is

E_{D}=4.4783 eV (55)

The theoretical bond energies of hydrogen type-type molecules H₂(1/p) are

E_{D}=p²4.4783 eV (56)

Dihydrino gas has been cryogenically isolated [. L. Mills, P. Ray, B. Dhandapani, J. He, “Novel Liquid-Nitrogen-Condensable Molecular Hydrogen Gas”, Chemistry—A European Journal, submitted which is herein incorporated by reference in its entirety]. Extreme ultraviolet (EUV) spectroscopy was recorded on microwave discharges of helium with 2% hydrogen. Novel emission lines were observed with energies of q·13.6 eV where q=1, 2, 3, 4, 6, 7, 8, 9, 11 or these discrete energies less 21.2 eV corresponding to inelastic scattering of these photons by helium atoms due to excitation of He (1s²) to He (1s¹2p¹). These lines matched H(1/p), fractional Rydberg states of atomic hydrogen, formed by a resonant nonradiative energy transfer to He⁺. Corresponding emission due to the reaction 2H(½)→H₂(½) with vibronic coupling at

$${E}_{D + vib} = {p}^{2} {E}_{D {H}_{2}} \pm ( \frac{{υ}^{*}}{3} ) {E}_{vib {H}_{2} ( υ = 0 \to υ = 1 )} ,$$

ν*=1, 2, 3 . . . was observed at the longer wavelengths for ν*=2 to ν*=32 and at the shorter wavelengths for ν*=1 to ν*=16 where E_{DH}_{₂} and E_{vibH}_{₂}_{(ν=0→ν=1)} are the experimental bond and vibrational energies of H₂, respectively. Fraction-principal-quantum-level molecular hydrogen H₂ (1/p) gas was isolated by liquefaction using an ultrahigh-vacuum liquid nitrogen cryotrap and was characterized by gas chromatography (GC), mass spectroscopy (MS), optical emission spectroscopy (OES), and ¹H NMR of the condensable gas dissolved in CDC₁₋₃. The condensable gas was highly pure hydrogen by GC and MS and had a higher ionization energy than H₂. In addition to the Balmer series, a unique visible emission spectrum was observed by OES that shifted with deuterium substitution. An upfield shifted NMR peak was observed at 3.25 ppm compared to that of H₂ at 4.63 ppm.

The hydrino hydride ion of the present invention can be formed by the reaction of an electron source with a hydrino, that is, a hydrogen atom having a binding energy of about

$$\frac{13.6 eV}{{n}^{2}} , where n = \frac{1}{p}$$

and p is an integer greater than 1. The hydrino hydride ion is represented by H⁻(n=1/p) or H⁻(1/p):

$$\begin{matrix}H [ \frac{{a}_{H}}{p} ] + {e}^{-} \to {H}^{-} ( n = 1 / p ) & ( 57 a ) \\ H [ \frac{{a}_{H}}{p} ] + {e}^{-} \to {H}^{-} ( 1 / p ) & ( 57 b )\end{matrix}$$

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion” The hydrino hydride ion comprises a hydrogen nucleus including proteum, deuterium, or tritium, and two indistinguishable electrons at a binding energy according to Eq. (58).

The binding energy of a novel hydrino hydride ion can be represented by the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 58 )$$

where p is an integer greater than one, s=½, π is pi, \hat{n} is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ the mass of the proton, α_{H} is the radius of the hydrogen atom, αₒ is the Bohr radius, and e is the elementary charge. The radii are given by

$$\begin{matrix}{r}_{2} = {r}_{1} \\ = {a}_{0} ( 1 + \sqrt{s ( s + 1 )} ) s \\ = \frac{1}{2}\end{matrix} \qquad ( 59 )$$

The binding energies of the hydrino hydride ion, H⁻(n=1/p) as a function of p, where p is an integer, are shown in TABLE 2.

TABLE 2
The representative binding energy of the hydrino hydride
ion H⁻(n = 1/p) as a function of p, Eq. (58).

| | r₁ | Binding | Wavelength |
|---|---|---|---|
| Hydride Ion | (a₀)^{a} | Energy (eV)^{b} | (nm) |
| H⁻(n = 1) | 1.8660 | 0.7542 | 1644 |
| H⁻(n = 1/2) | 0.9330 | 3.047 | 406.9 |
| H⁻(n = 1/3) | 0.6220 | 6.610 | 187.6 |
| H⁻(n = 1/4) | 0.4665 | 11.23 | 110.4 |
| H⁻(n = 1/5) | 0.3732 | 16.70 | 74.23 |
| H⁻(n = 1/6) | 0.3110 | 22.81 | 54.35 |
| H⁻(n = 1/7) | 0.2666 | 29.34 | 42.25 |
| H⁻(n = 1/8) | 0.2333 | 36.09 | 34.46 |
| H⁻(n = 1/9) | 0.2073 | 42.84 | 28.94 |
| H⁻(n = 1/10) | 0.1866 | 49.38 | 25.11 |
| H⁻(n = 1/11) | 0.1696 | 55.50 | 22.34 |
| H⁻(n = 1/12) | 0.1555 | 60.98 | 20.33 |
| H⁻(n = 1/13) | 0.1435 | 65.63 | 18.89 |
| H⁻(n = 1/14) | 0.1333 | 69.22 | 17.91 |
| H⁻(n = 1/15) | 0.1244 | 71.55 | 17.33 |
| H⁻(n = 1/16) | 0.1166 | 72.40 | 17.12 |
| H⁻(n = 1/17) | 0.1098 | 71.56 | 17.33 |
| H⁻(n = 1/18) | 0.1037 | 68.83 | 18.01 |
| H⁻(n = 1/19) | 0.0982 | 63.98 | 19.38 |
| H⁻(n = 1/20) | 0.0933 | 56.81 | 21.82 |
| H⁻(n = 1/21) | 0.0889 | 47.11 | 26.32 |
| H⁻(n = 1/22) | 0.0848 | 34.66 | 35.76 |
| H⁻(n = 1/23) | 0.0811 | 19.26 | 64.36 |
| H⁻(n = 1/24) | 0.0778 | 0.6945 | 1785 |

^{a}Equation (59)
^{b}Equation (58)

The existence of novel alkaline and alkaline earth hydride and halido-hydrides were also previously identified by large distinct upfield ¹H NMR resonances compared to the NMR peaks of the corresponding ordinary hydrides [R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979.]. Using a number of analytical techniques such as XPS and time-of-flight-secondary-mass-spectroscopy (ToF-SIMS) as well as NMR, the hydrogen content was assigned to H⁻(1/p), novel high-binding-energy hydride ions in stable fractional principal quantum states [R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. L. Mills, B. Dhandapani, J. He, “Highly Stable Amorphous Silicon Hydride”, Solar Energy Materials & Solar Cells, submitted]. The synthesis reactions typically involve metal ion catalysts. For example, Rb⁺ to Rb²⁺ and 2K⁺ to K+K²⁺ each provide a reaction with a net enthalpy equal to the potential energy of atomic hydrogen. It was reported previously [R. L. Mills, P. Ray, “A Comprehensive Study of Spectra of the Bound-Free Hyperfine Levels of Novel Hydride Ion H⁻(½), Hydrogen, Nitrogen, and Air”, Int. J. Hydrogen Energy, in press] that the presence of these gaseous ions with thermally dissociated hydrogen formed a hydrogen plasma with hydrogen atom energies of 17 and 12 eV respectively, compared to 3 eV for a hydrogen microwave plasma. The energetic catalytic reaction involves a resonance energy transfer between hydrogen atoms and Rb⁺ or 2K⁺ to form a very stable novel hydride ion H⁻(½). Its predicted binding energy of 3.0468 eV was observed by high resolution visible spectroscopy as a continuum threshold at 406.82 nm, and a structured, strong emission peak was observed at 407.1 nm corresponding to the fine structure and hyperfine structure of H(½). From the electron g factor, bound-free hyperfine structure lines of H⁻(½) were predicted with energies E_{HF} given by E_{HF}=j²3.00213×10⁵+30.0563 eV (j is an integer) as an inverse Rydberg-type series from 3.0563 eV to 3.1012 eV—the hydride binding energy peak with the fine structure plus one and five times the spin-pairing energy, respectively. The high resolution visible plasma emmission spectra in the region of 399.5 to 406.0 nm matched the predicted emission lines for j=1 to j=39 with the series edge at 399.63 nm up to 1 part in 10⁵.

2.3 Hydrogen Plasma

Developed sources that provide suitable intensity hydrogen plasmas are high voltage discharges, synchrotron devices, inductively coupled plasma generators, and magnetically confined plasmas. In contrast to the high electric fields, power densities, and temperatures of prior sources, an intense hydrogen plasma is generated at low gas temperatures (e.g. ≈10³ K) with a very low field (1V/cm) from atomic hydrogen and certain atomized elements or certain gaseous ions which singly or multiply ionize at integer multiples of the potential energy of atomic hydrogen, m·27.2 eV [R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943 which is incorporated by reference]. The so-called resonant transfer or rt-plasma of one embodiment of the present invention forms by a resonant energy transfer mechanism involving the species providing a net enthalpy of a multiple of 27.2 eV and atomic hydrogen.

2.4 Blue to Infrared Laser

Inverted Lyman and Balmer populations may permit a continuous wave (cw) laser at blue wavelengths. For the last four decades, scientists from academia and industry have been searching for lasers using hydrogen plasma. However, the generation of population inversion is very difficult. Recombining expanding plasma jets formed by methods such as arcs or pulsed discharges is considered one of the most promising methods of realizing an H I laser. The continuous generation of a hydrogen inverted population in a stationary steady state plasma has not been achieved. The present invention teaches such an inverted population in water vapor, ammonia vapor, and rt-plasmas as the basis of a laser capable of providing laser wavelengths over a broad range from blue to infrared.

2.5. Photon Power to Electricity Conversion

Electricity can be generated from visible and near infrared light using photovoltaic cells. The efficiency can be increased significantly when the band gap of the material matches the wavelength, and the efficiency also increases with power to very high power levels (>500 W·cm⁻²). Photocells of the power converter of the present invention that respond to ultraviolet and extreme ultraviolet light comprise radiation hardened conventional cells. Due to the higher energy of the photons potentially higher efficiency is achievable compared to those that convert lower energy photons. The hardening may be achieved by a protective coating such as a atomic layer of platinum or other noble metal.

### II. SUMMARY OF THE INVENTION

An object of the present invention is to generate power and novel hydrogen species and compositions of matter comprising new forms of hydrogen via the catalysis of atomic hydrogen.

Another object of the present invention is to generate a plasma and a source of light such as high energy light, extreme ultraviolet light and ultraviolet light, and energetic particles such as fast hydrogen atoms (fast H) via the catalysis of atomic hydrogen.

Another object of the present invention is to create an inverted population of an energy level of a species such as an atom, molecule, or ion capable of lasing. The inverted population forms due to catalysis of atomic hydrogen to lower-energy states. The present invention further comprises a laser wherein the catalysis cell serves as the laser cavity, and an inverted population is formed due to catalysis.

Another object of the present invention is to cause the energy of the catalysis reaction to be emitted as high intensity light as well as heat, by forming excited electronic populations such as atomic hydrogen exited populations using a species which transfers or converts energy from the catalysis reaction to form the excited state populations. In one embodiment, the excited state population comprises an inverted population.

Another object of the present invention is to convert photon power to electrical power.

### 1. Catalysis of Hydrogen to Form Novel Hydrogen Species and Compositions of Matter Comprising New Forms of Hydrogen

The above object and other objectives are achieved by the present invention comprising a power source and hydrogen reactor. The power source and reactor comprises a cell for the catalysis of atomic hydrogen to form novel hydrogen species and compositions of matter comprising new forms of hydrogen. The novel hydrogen compositions of matter comprise:

(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. The compounds of the invention are hereinafter referred to as “increased binding energy hydrogen compounds”.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy
(i) greater than the total energy of the corresponding ordinary hydrogen species, or
   (ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present invention has a total energy greater than the total energy of the corresponding ordinary hydrogen species. The hydrogen species having an increased total energy according to the present invention is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (58) for p=24 has a first binding energy that is less than the first binding energy of ordinary hydride ion, while the total energy of the hydride ion of Eq. (58) for p=24 is much greater than the total energy of the corresponding ordinary hydride ion.

Also provided are novel compounds and molecular ions comprising

(a) a plurality of neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the invention are hereinafter referred to as “increased binding energy hydrogen compounds”.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the invention are hereinafter referred to as “increased binding energy hydrogen compounds”.

The total energy of the increased total energy hydrogen species is the sum of the energies to remove all of the electrons from the increased total energy hydrogen species. The total energy of the ordinary hydrogen species is the sum of the energies to remove all of the electrons from the ordinary hydrogen species. The increased total energy hydrogen species is referred to as an increased binding energy hydrogen species, even though some of the increased binding energy hydrogen species may have a first electron binding energy less than the first electron binding energy of ordinary molecular hydrogen. However, the total energy of the increased binding energy hydrogen species is much greater than the total energy of ordinary molecular hydrogen.

In one embodiment of the invention, the increased binding energy hydrogen species can be Hₙ, and Hₙ⁻ where n is a positive integer, or Hₙ⁺ where n is a positive integer greater than one. Preferably, the increased binding energy hydrogen species is Hₙ and Hₙ⁻ where n is an integer from one to about 1×10⁶, more preferably one to about 1×10⁴, even more preferably one to about 1×10², and most preferably one to about 10, and Hₙ⁺, where n is an integer from two to about 1×10⁶, more preferably two to about 1×10⁴, even more preferably two to about 1×10², and most preferably two to about 10. A specific example of Hₙ⁻ is H₁₆⁻.

In an embodiment of the invention, the increased binding energy hydrogen species can be Hₙ^{m-} where n and m are positive integers and Hₙ^{m+} where n and m are positive integers with m<n. Preferably, the increased binding energy hydrogen species is Hₙ^{m-} where n is an integer from one to about 1×10⁶, more preferably one to about 1×10⁴, even more preferably one to about 1×10², and most preferably one to about 10 and m is an integer from one to 100, one to ten, and Hₙ^{m+} where n is an integer from two to about 1×10⁶, more preferably two to about 1×10⁴, even more preferably two to about 1×10², and most preferably two to about 10 and m is one to about 100, preferably one to ten.

According to a preferred embodiment of the invention, a compound is provided, comprising at least one increased binding energy hydrogen species selected from the group consisting of (a) hydride ion having a binding energy according to Eq. (58) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”).

The compounds of the present invention are capable of exhibiting one or more unique properties which distinguishes them from the corresponding compound comprising ordinary hydrogen, if such ordinary hydrogen compound exists. The unique properties include, for example, (a) a unique stoichiometry; (b) unique chemical structure; (c) one or more extraordinary chemical properties such as conductivity, melting point, boiling point, density, and refractive index; (d) unique reactivity to other elements and compounds; (e) enhanced stability at room temperature and above; and/or (f) enhanced stability in air and/or water. Methods for distinguishing the increased binding energy hydrogen-containing compounds from compounds of ordinary hydrogen include: 1.) elemental analysis, 2.) solubility, 3.) reactivity, 4.) melting point, 5.) boiling point, 6.) vapor pressure as a function of temperature, 7.) refractive index, 8.) X-ray photoelectron spectroscopy (XPS), 9.) gas chromatography, 10.) X-ray diffraction (XRD), 11.) calorimetry, 12.) infrared spectroscopy (IR), 13.) Raman spectroscopy, 14.) Mossbauer spectroscopy, 15.) extreme ultraviolet (EUV) emission and absorption spectroscopy, 16.) ultraviolet (UV) emission and absorption spectroscopy, 17.) visible emission and absorption spectroscopy, 18.) nuclear magnetic resonance spectroscopy, 19.) gas phase mass spectroscopy of a heated sample (solids probe and direct exposure probe quadrapole and magnetic sector mass spectroscopy), 20.) time-of-flight-secondary-ion-mass-spectroscopy (TOFSIMS), 21.) electrospray-ionization-time-of-flight-mass-spectroscopy (ESITOFMS), 22.) thermogravimetric analysis (TGA), 23.) differential thermal analysis (DTA), 24.) differential scanning calorimetry (DSC), 25.) liquid chromatography/mass spectroscopy (LCMS), and/or 26.) gas chromatography/mass spectroscopy (GCMS).

According to the present invention, a hydrino hydride ion (H⁻) having a binding energy according to Eq. (58) that is greater than the binding of ordinary ha ride ion (about 0.8 eV) for p=2 up to 23, and less for p=24 (H⁻) is provided. For p=2 to p=24 of Eq. (58), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Compositions comprising the novel hydride ion are also provided.

Novel compounds are provided comprising one or more hydrino hydride ions and one or more other elements. Such a compound is referred to as a hydrino hydride compound.

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.46 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further preferred embodiment of the invention, a compound is provided comprising at least one increased binding energy hydrogen species such as (a) a hydrogen atom having a binding energy of about

$$\frac{13.6 eV}{{( \frac{1}{p} )}^{2}} ,$$

preferably within ±10%, more preferably +5%, where p is an integer, preferably an integer from 2 to 200; (b) a hydride ion (H⁻) having a binding energy of about

$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

preferably within ±10%, more preferably ±5%, where p is an integer, preferably an integer from 2 to 200; (c) H₄⁺(1/p); (d) a trihydrino molecular ion, H₃⁺(1/p), having a binding energy of about

$$\frac{22.6}{{( \frac{1}{p} )}^{2}} eV$$

preferably within ±10%, more preferably ±5%, where p is an integer, preferably an integer from 2 to 200; (e) a dihydrino having a binding energy of about

$$\frac{15.3}{{( \frac{1}{p} )}^{2}} eV$$

preferably within ±10%, more preferably ±5%, where p is an integer, preferably and integer from 2 to 200; (f) a dihydrino molecular ion with a binding energy of about

$$\frac{16.3}{{( \frac{1}{p} )}^{2}} eV$$

preferably within ±10%, more preferably ±5%, where p is an integer, preferably an integer from 2 to 200.

According to one embodiment of the invention wherein the compound comprises a negatively charged increased binding energy hydrogen species, the compound further comprises one or more cations, such as a proton, ordinary H₂⁺, or ordinary H₃⁺.

A method is provided for preparing compounds comprising at least one increased binding energy hydride ion. Such compounds are hereinafter referred to as “hydrino hydride compounds”. The method comprises reacting atomic hydrogen with a catalyst having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

### 2. Hydrogen Power and Plasma Cell and Reactor

The invention is also directed to a reactor for producing a increased binding energy hydrogen compounds of the invention, such as dihydrino molecules and hydrino hydride compounds. A further product of the catalysis is plasma, light, and power. Such a reactor is hereinafter referred to as a “hydrogen reactor” or “hydrogen cell”. The hydrogen reactor comprises a cell for making hydrinos. The cell for making hydrinos may take the form of a gas cell, a gas discharge cell, a plasma torch cell, or microwave power cell, for example. These exemplary cells which are not meant to be exhaustive are disclosed in Mills Prior Publications. Each of these cells comprises: a source of atomic hydrogen; at least one of a solid, molten, liquid, or gaseous catalyst for making hydrinos; and a vessel for reacting hydrogen and the catalyst for making hydrinos. As used herein and as contemplated by the subject invention, the term “hydrogen”, unless specified otherwise, includes not only proteum (¹H), but also deuterium (²H) and tritium (³H).

The reactors described herein as “hydrogen reactors” are capable of producing not only hydrinos, but also the other increased binding energy hydrogen species and compounds of the present invention. Hence, the designation “hydrogen reactors” should not be understood as being limiting with respect to the nature of the increased binding energy hydrogen species or compound produced.

According to one aspect of the present invention, novel compounds are formed from hydrino hydride ions and cations wherein the cell further comprises an electron source. Electrons from the electron source contact the hydrinos and react to form hydrino hydride ions. The reactor produces hydride ions having the binding energy of Eq. (58). The cation may be from an added reductant, or a cation present in the cell (such as a cation comprising the catalyst).

In an embodiment, a plasma forms in the hydrogen cell as a result of the energy released from the catalysis of hydrogen. Water vapor may be added to the plasma to increase the hydrogen concentration as shown by Kikuchi et al. [J. Kikuchi, M. Suzuki, H. Yano, and S. Fujinura, Proceedings SPIE-The International Society for Optical Engineering, (1993), 1803 (Advanced Techniques for Integrated Circuit Processing II), pp. 70-76) which is herein incorporated by reference.

### 3. Catalysts

3.1 Atom and Ion Catalysts

In an embodiment, a catalytic system is provided by the ionization of t electrons from a participating species such as an atom, an ion, a molecule, and an ionic or molecular compound to a continuum energy level such that the sum of the ionization energies of the t electrons is approximately m×27.2 eV where m is an integer. One such catalytic system involves cesium. The first and second ionization energies of cesium are 3.89390 eV and 23.15745 eV, respectively. The double ionization (t=2) reaction of Cs to Cs²⁺, then, has a net enthalpy of reaction of 27.05135 eV, which is equivalent to m=1 in Eq. (2a).

$$\begin{matrix}27.05135 eV + Cs ( m ) + H [ \frac{{a}_{H}}{p} ] \to {Cs}^{2 +} + 2 {e}^{-} + H [ \frac{{a}_{H}}{( p + 1 )} ] + [ {( p + 1 )}^{2} - p ] \times 13.6 eV & ( 60 ) \\ {Cs}^{2 +} + 2 {e}^{-} \to Cs ( m ) + 27.05135 eV & ( 61 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] \times 13.6 eV \qquad ( 62 )$$

Thermal energies may broaden the enthalpy of reaction. The relationship between kinetic energy and temperature is given by

$${E}_{kinetic} = \frac{3}{2} kT \qquad ( 63 )$$

For a temperature of 1200 K, the thermal energy is 0.16 eV, and the net enthalpy of reaction provided by cesium metal is 27.21 eV which is an exact match to the desired energy.

Hydrogen catalysts capable of providing a net enthalpy of reaction of approximately m×27.2 eV where m is an integer to produce hydrino whereby t electrons are ionized from an atom or ion are given infra. A further product of the catalysis is energy and plasma. The atoms or ions given in the first column are ionized to provide the net enthalpy of reaction of m×27.2 eV given in the tenth column where m is given in the eleventh column. The electrons which are ionized are given with the ionization potential (also called ionization energy or binding energy). The ionization potential of the n th electron of the atom or ion is designated by IPₙ and is given by Linde [D. R. Lide, CRC Handbook of Chemistry and Physics, 78 th Edition, CRC Press, Boca Raton, Fla., (1997), p. 10-214 to 10-216) which is herein incorporated by reference. That is for example, Cs+3.89390 eV→Cs⁺e⁻ and Cs⁺+23.15745 eV→Cs²⁺+e⁻. The first ionization potential, IP₁=3.89390 eV, and the second ionization potential, IP₂=23.15745 eV, are given in the second and third columns, respectively. The net enthalpy of reaction for the double ionization of Cs is 27.05135 eV as given in the tenth column, and m=1 in Eq. (2a) as given in the eleventh column.

TABLE 3
Hydrogen Ion or Atom Catalysts

| Catalyst | IP1 | IP2 | IP3 | IP4 | IP5 | IP6 | IP7 | IP8 | Enthalpy | m |
|---|---|---|---|---|---|---|---|---|---|---|
| Li | 5.39172 | 75.6402 | | | | | | | 81.032 | 3 |
| Be | 9.32263 | 18.2112 | | | | | | | 27.534 | 1 |
| Ar | 15.75962 | 27.62967 | 40.74 | | | | | | 84.12929 | 3 |
| Ar | 15.75962 | 27.62967 | 40.74 | 59.81 | 75.02 | | | | 218.95929 | 8 |
| Ar | 15.75962 | 27.62967 | 40.74 | 59.81 | 75.02 | 91.009 | 124.323 | | 434.29129 | 16 |
| K | 4.34066 | 31.63 | 45.806 | | | | | | 81.777 | 3 |
| Ca | 6.11316 | 11.8717 | 50.9131 | 67.27 | | | | | 136.17 | 5 |
| Ti | 6.8282 | 13.5755 | 27.4917 | 43.267 | 99.3 | | | | 190.46 | 7 |
| V | 6.7463 | 14.66 | 29.311 | 46.709 | 65.2817 | | | | 162.71 | 6 |
| Cr | 6.76664 | 16.4857 | 30.96 | | | | | | 54.212 | 2 |
| Mn | 7.43402 | 15.64 | 33.668 | 51.2 | | | | | 107.94 | 4 |
| Fe | 7.9024 | 16.1878 | 30.652 | | | | | | 54.742 | 2 |
| Fe | 7.9024 | 16.1878 | 30.652 | 54.8 | | | | | 109.54 | 4 |
| Co | 7.881 | 17.083 | 33.5 | 51.3 | | | | | 109.76 | 4 |
| Co | 7.881 | 17.083 | 33.5 | 51.3 | 79.5 | | | | 189.26 | 7 |
| Ni | 7.6398 | 18.1688 | 35.19 | 54.9 | 76.06 | | | | 191.96 | 7 |
| Ni | 7.6398 | 18.1688 | 35.19 | 54.9 | 76.06 | 108 | | | 299.96 | 11 |
| Cu | 7.72638 | 20.2924 | | | | | | | 28.019 | 1 |
| Zn | 9.39405 | 17.9644 | | | | | | | 27.358 | 1 |
| Zn | 9.39405 | 17.9644 | 39.723 | 59.4 | 82.6 | 108 | 134 | 174 | 625.08 | 23 |
| As | 9.8152 | 18.633 | 28.351 | 50.13 | 62.63 | 127.6 | | | 297.16 | 11 |
| Se | 9.75238 | 21.19 | 30.8204 | 42.945 | 68.3 | 81.7 | 155.4 | | 410.11 | 15 |
| Kr | 13.9996 | 24.3599 | 36.95 | 52.5 | 64.7 | 78.5 | | | 271.01 | 10 |
| Kr | 13.9996 | 24.3599 | 36.95 | 52.5 | 64.7 | 78.5 | 111 | | 382.01 | 14 |
| Rb | 4.17713 | 27.285 | 40 | 52.6 | 71 | 84.4 | 99.2 | | 378.66 | 14 |
| Rb | 4.17713 | 27.285 | 40 | 52.6 | 71 | 84.4 | 99.2 | 136 | 514.66 | 19 |
| Sr | 5.69484 | 11.0301 | 42.89 | 57 | 71.6 | | | | 188.21 | 7 |
| Nb | 6.75885 | 14.32 | 25.04 | 38.3 | 50.55 | | | | 134.97 | 5 |
| Mo | 7.09243 | 16.16 | 27.13 | 46.4 | 54.49 | 68.8276 | | | 220.10 | 8 |
| Mo | 7.09243 | 16.16 | 27.13 | 46.4 | 54.49 | 68.8276 | 125.664 | 143.6 | 489.36 | 18 |
| Pd | 8.3369 | 19.43 | | | | | | | 27.767 | 1 |
| Sn | 7.34381 | 14.6323 | 30.5026 | 40.735 | 72.28 | | | | 165.49 | 6 |
| Te | 9.0096 | 18.6 | | | | | | | 27.61 | 1 |
| Te | 9.0096 | 18.6 | 27.96 | | | | | | 55.57 | 2 |
| Cs | 3.8939 | 23.1575 | | | | | | | 27.051 | 1 |
| Ce | 5.5387 | 10.85 | 20.198 | 36.758 | 65.55 | | | | 138.89 | 5 |
| Ce | 5.5387 | 10.85 | 20.198 | 36.758 | 65.55 | 77.6 | | | 216.49 | 8 |
| Pr | 5.464 | 10.55 | 21.624 | 38.98 | 57.53 | | | | 134.15 | 5 |
| Sm | 5.6437 | 11.07 | 23.4 | 41.4 | | | | | 81.514 | 3 |
| Gd | 6.15 | 12.09 | 20.63 | 44 | | | | | 82.87 | 3 |
| Dy | 5.9389 | 11.67 | 22.8 | 41.47 | | | | | 81.879 | 3 |
| Pb | 7.41666 | 15.0322 | 31.9373 | | | | | | 54.386 | 2 |
| Pt | 8.9587 | 18.563 | | | | | | | 27.522 | 1 |
| He+ | | 54.4178 | | | | | | | 54.418 | 2 |
| Na+ | | 47.2864 | 71.6200 | 98.91 | | | | | 217.816 | 8 |
| Rb+ | | 27.285 | | | | | | | 27.285 | 1 |
| Fe3+ | | | | 54.8 | | | | | 54.8 | 2 |
| Mo2+ | | | 27.13 | | | | | | 27.13 | 1 |
| Mo4+ | | | | | 54.49 | | | | 54.49 | 2 |
| In3+ | | | | 54 | | | | | 54 | 2 |
| Ar+ | | 27.62967 | | | | | | | 27.62967 | 1 |
| Sr+ | | 11.03 | 42.89 | | | | | | 53.92 | 2 |

In an embodiment, each of the catalysts Rb⁺, K⁺/K⁺, and Sr⁺ may be formed from the corresponding metal by ionization. The source of ionization may be UV light or a plasma. At least one of a source of UV light and a plasma may be provided by the catalysis of hydrogen with a one or more hydrogen catalysts given in TABLES 1 and 3. The catalysts may also be formed from the corresponding metal by reaction with hydrogen to form the corresponding alkali hydride or by ionization at a hot filament which may also serve to dissociate molecular hydrogen to atomic hydrogen. The hot filament may be a refractory metal such as tungsten or molybdenum operated within a high temperature range such as 1000 to 2800° C.

A catalyst of the present invention can be an increased binding energy hydrogen compound having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200.

In another embodiment of the catalyst of the present invention, hydrinos are formed by reacting an ordinary hydrogen atom with a catalyst having a net enthalpy of reaction of about

$$\frac{m}{2} \cdot 27.2 eV \qquad ( 64 )$$

where m is an integer. It is believed that the rate of catalysis is increased as the net enthalpy of reaction is more closely matched to

$$\frac{m}{2} \cdot 27.2 eV .$$

It has been found that catalysts having a net enthalpy of reaction within ±10%, preferably ±5%, of

$$\frac{m}{2} \cdot 27.2 eV$$

are suitable for most applications.

In an embodiment, catalysts are identified by the formation of a rt-plasma at low voltage as described in Mills publication R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943 which is incorporated by reference. In another embodiment, a means of identifying catalysts and monitoring the catalytic rate comprises a high resolution visible spectrometer with resolution preferable in the range 1 to 0.01 Å. The identity of a catalysts and the rate of catalysis may be determined by the degree of Doppler broadening of the hydrogen Balmer lines.

3.2 Hydrino Catalysts

In a process called disproportionation, lower-energy hydrogen atoms, hydrinos, can act as catalysts because each of the metastable excitation, resonance excitation, and ionization energy of a hydrino atom is m×27.2 eV. The transition reaction mechanism of a first hydrino atom affected by a second hydrino atom involves the resonant coupling between the atoms of m degenerate multipoles each having 27.21 eV of potential energy [Mills, The Grand Unified Theory of Classical Quantum Mechanics, September 2001 Edition, Chps. 5 and 6, BlackLight Power, Inc., Cranbury, N.J., Distributed by Amazon.com; R. Mills, P. Ray, “Spectral Emission of Fractional Quantum Energy Levels of Atomic Hydrogen from a Helium-Hydrogen Plasma and the Implications for Dark Matter”, Int. J. Hydrogen Energy, Vol. 27, No. 3, pp. 301-322]. The energy transfer of m×27.2 eV from the first hydrino atom to the second hydrino atom causes the central field of the first atom to increase by m and its electron to drop m levels lower from a radius of

$$\frac{{a}_{H}}{p}$$

to a radius of

$$\frac{{a}_{H}}{p + m} .$$

The second interacting lower-energy hydrogen is either excited to a metastable state, excited to a resonance state, or ionized by the resonant energy transfer. The resonant transfer may occur in multiple stages. For example, a nonradiative transfer by multipole coupling may occur wherein the central field of the first increases by m, then the electron of the first drops m levels lower from a radius of

$$\frac{{a}_{H}}{p}$$

to a radius of

$$\frac{{a}_{H}}{p + m}$$

with further resonant energy transfer. The energy transferred by multipole coupling may occur by a mechanism that is analogous to photon absorption involving an excitation to a virtual level. Or, the energy transferred by multipole coupling during the electron transition of the first hydrino atom may occur by a mechanism that is analogous to two photon absorption involving a first excitation to a virtual level and a second excitation to a resonant or continuum level [B. J. Thompson, Handbook of Nonlinear Optics, Marcel Dekker, Inc., New York, (1996), pp. 497-548; Y. R. Shen, The Principles of Nonlinear Optics, John Wiley & Sons, New York, (1984), pp. 203-210; B. de Beauvoir, F. Nez, L. Julien, B. Cagnac, F. Biraben, D. Touahri, L. Hilico, O. Acef, A. Clairon, and J. J. Zondy, Physical Review Letters, Vol. 78, No. 3, (1997), pp. 440-443]. The transition energy greater than the energy transferred to the second hydrino atom may appear as a photon in a vacuum medium.

The transition of

$$H [ \frac{{a}_{H}}{p} ] to H [ \frac{{a}_{H}}{p + m} ]$$

induced by a multipole resonance transfer of m·27.21 eV and a transfer of [(p′)²−(p′−m′)²]×13.6 eV−m·27.2 eV with a resonance state of

$$H [ \frac{{a}_{H}}{{p}^{′} - {m}^{′}} ]$$

excited in

$$H [ \frac{{a}_{H}}{{p}^{′}} ]$$

is represented by

$$H ⌊ \frac{{a}_{H}}{{p}^{′}} ⌋ + H ⌊ \frac{{a}_{H}}{p} ⌋ -> H [ \frac{{a}_{H}}{{p}^{′} - {m}^{′}} ] + H [ \frac{{a}_{H}}{p + m} ] + [ \begin{matrix}( {( p + m )}^{2} - {p}^{2} ) - \\ ( {p}^{′2} - {( {p}^{′} - {m}^{′} )}^{2} )\end{matrix} ] \times 13.6 eV \qquad ( 65 )$$

where p, p′, m, and m′ are integers.

Hydrinos may be ionized during a disproportionation reaction by the resonant energy transfer. A hydrino atom with the initial lower-energy state quantum number p and radius

$$\frac{{a}_{H}}{p}$$

may undergo a transition to the state with lower-energy state quantum number (p+m) and radius

$$\frac{{a}_{H}}{( p + m )}$$

by reaction with a hydrino atom with the initial lower-energy state quantum number m′, initial radius

$$\frac{{a}_{H}}{{m}^{′}} ,$$

and final radius α_{H} that provides a net enthalpy of m×27.2 eV. Thus, reaction of hydrogen-type atom,

$$H [ \frac{{a}_{H}}{p} ] ,$$

with the hydrogen-type atom,

$$H [ \frac{{a}_{H}}{{m}^{′}} ] ,$$

that is ionized by the resonant energy transfer to cause a transition reaction is represented by

$$\begin{matrix}m \times 27.21 eV + H [ \frac{{a}_{H}}{{m}^{′}} ] + H ⌊ \frac{{a}_{H}}{p} ⌋ -> {H}^{+} + {e}^{-} + H [ \frac{{a}_{H}}{( p + m )} ] + [ \begin{matrix}{( p + m )}^{2} - {p}^{2} - \\ ( {m}^{′2} - 2 m )\end{matrix} ] \times 13.6 eV & ( 66 ) \\ {H}^{+} + {e}^{-} -> H [ \frac{{a}_{H}}{1} ] + 13.6 eV & ( 67 )\end{matrix}$$

And, the overall reaction is

$$H [ \frac{{a}_{H}}{{m}^{′}} ] + H ⌊ \frac{{a}_{H}}{p} ⌋ -> H [ \frac{{a}_{H}}{1} ] + H [ \frac{{a}_{H}}{( p + m )} ] + [ 2 pm + {m}^{2} - {m}^{′2} ] \times 13.6 eV + 13.6 eV \qquad ( 68 )$$

### 4. Adjustment of Catalysis Rate

It is believed that the rate of catalysis is increased as the net enthalpy of reaction is more closely matched to m·27.2 eV where in is an integer. An embodiment of the hydrogen reactor for producing increased binding energy hydrogen compounds of the invention further comprises an electric or magnetic field source. The electric or magnetic field source may be adjustable to control the rate of catalysis. Adjustment of the electric or magnetic field provided by the electric or magnetic field source may alter the continuum energy level of a catalyst whereby one or more electrons are ionized to a continuum energy level to provide a net enthalpy of reaction of approximately m×27.2 eV. The alteration of the continuum energy may cause the net enthalpy of reaction of the catalyst to more closely match m×27.2 eV. Preferably, the electric field is within the range of 0.01-10⁶ V/m, more preferably 0.1-10⁴ V/m, and most preferably 1-10³ V/m. Preferably, the magnetic flux is within the range of 0.01-50 T. A magnetic field may have a strong gradient. Preferably, the magnetic flux gradient is within the range of 10⁻⁴-10² Tcm⁻¹ and more preferably 10⁻³-1 Tcm⁻¹.

In an embodiment, the electric field E and magnetic field B are orthogonal to cause an EXB electron drift. The EXB drift may be in a direction such that energetic electrons produced by hydrogen catalysis dissipate a minimum amount of power due to current flow in the direction of the applied electric field which may be adjustable to control the rate of hydrogen catalysis.

In an embodiment of the energy cell, a magnetic field confines the electrons to a region of the cell such that interactions with the wall are reduced, and the electron energy is increased. The field may be a solenoidal field or a magnetic mirror field. The field may be adjustable to control the rate of hydrogen catalysis.

In an embodiment, the electric field such as a radio frequency field produces minimal current. In another embodiment, a gas which may be inert such as a noble gas is added to the reaction mixture to decrease the conductivity of the plasma produced by the energy released from the catalysis of hydrogen. The conductivity is adjusted by controlling the pressure of the gas to achieve an optimal voltage that controls the rate of catalysis of hydrogen. In another embodiment, a gas such as an inert gas may be added to the reaction mixture which increases the percentage of atomic hydrogen versus molecular hydrogen.

For example, the cell may comprise a hot filament that dissociates molecular hydrogen to atomic hydrogen and may further heat a hydrogen dissociator such as transition elements and inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Th, Dy, Ho, Er, Tm, Vb, Lu, Th, Pa, U, activated charcoal (carbon), and intercalated Cs carbon (graphite). The filament may further supply an electric field in the cell of the reactor. The electric field may alter the continuum energy level of a catalyst whereby one or more electrons are ionized to a continuum energy level to provide a net enthalpy of reaction of approximately m×27.2 eV. In another embodiment, an electric field is provided by electrodes charged by a variable voltage source. The rate of catalysis may be controlled by controlling the applied voltage which determines the applied field which controls the catalysis rate by altering the continuum energy level.

In another embodiment of the hydrogen reactor, the electric or magnetic field source ionizes an atom or ion to provide a catalyst having a net enthalpy of reaction of approximately m×27.2 eV For examples, potassium metal is ionized to K⁺, rubidium metal is ionized to Rb⁺, or strontium metal is ionized to Sr⁺ to provide the catalyst. The electric field source may be a hot filament whereby the hot filament may also dissociate molecular hydrogen to atomic hydrogen.

### 5. Noble Gas Catalysts and Products

In an embodiment of the hydrogen power and plasma cell, reactor, and power converter comprising an energy cell for the catalysis of atomic hydrogen to form novel hydrogen species and compositions of matter comprising new forms of hydrogen of the present invention, the catalyst comprises a mixture of a first catalyst and a source of a second catalyst. In an embodiment, the first catalyst produces the second catalyst from the source of the second catalyst. In an embodiment, the energy released by the catalysis of hydrogen by the first catalyst produces a plasma in the energy cell. The energy ionizes the source of the second catalyst to produce the second catalyst. The second catalyst may be one or more ions produced in the absence of a strong electric field as typically required in the case of a glow discharge. The weak electric field may increase the rate of catalysis of the second catalyst such that the enthalpy of reaction of the catalyst matches m×27.2 eV to cause hydrogen catalysis. In embodiments of the energy cell, the first catalyst is selected from the group of catalyst given in TABLES 1 and 3 such as potassium and strontium, the source of the second catalyst is selected from the group of helium and argon and the second catalyst is selected from the group of He⁺ and Ar⁺ wherein the catalyst ion is generated from the corresponding atom by a plasma created by catalysis of hydrogen by the first catalyst. For examples, 1.) the energy cell contains strontium and argon wherein hydrogen catalysis by strontium produces a plasma containing Ar⁺ which serves as a second catalyst (Eqs. (15-17)) and 2.) the energy cell contains potassium and helium wherein hydrogen catalysis by potassium produces a plasma containing He⁺ which serves as a second catalyst (Eqs. (12-14)). In an embodiment, the pressure of the source of the second catalyst is in the range of about 1 millitorr to about one atmosphere. The hydrogen pressure is in the range of about 1 millitorr to about one atmosphere. In a preferred embodiment, the total pressure is in the range of about 0.5 torr to about 2 torr. In an embodiment, the ratio of the pressure of the source of the second catalyst to the hydrogen pressure is greater than one. In a preferred embodiment, hydrogen is about 0.1% to about 99%, and the source of the second catalyst comprises the balance of the gas present in the cell. More preferably, the hydrogen is in the range of about 1% to about 5% and the source of the second catalyst is in the range of about 95% to about 99%. Most preferably, the hydrogen is about 5% and the source of the second catalyst is about 95%. These pressure ranges are representative examples and a skilled person will be able to practice this invention using a desired pressure to provide a desired result.

In an embodiment of the power cell and power converter the catalyst comprises at least one selected from the group of He⁺, Ne⁺, and Ar⁺ wherein the ionized catalyst ion is generated from the corresponding atom by a plasma created by methods such as a glow discharge or inductively couple microwave discharge. Preferably, the corresponding reactor such as a discharge cell or hydrogen plasma torch reactor has a region of low electric field strength such that the enthalpy of reaction of the catalyst matches m×27.2 eV to cause hydrogen catalysis. In one embodiment, the reactor is a discharge cell having a hollow anode as described by Kuraica and Konjevic [Kuraica, M., Konjevic, N., Physical Review A, Volume 46, No. 7, October (1992), pp. 4429-4432]. In another embodiment, the reactor is a discharge cell having a hollow cathode such as a central wire or rod anode and a concentric hollow cathode such as a stainless or nickel mesh. In a preferred embodiment, the cell is a microwave cell wherein the catalyst is formed by a microwave plasma.

In an embodiment of the plasma cell wherein the catalyst is a cation such as at least one selected from the group of He⁺ and Ar⁺ an increased binding energy hydrogen compound, iron hydrino hydride, is formed as hydrino atoms react with iron present in the cell. The source of iron may be from a stainless steel cell. In another embodiment, an additional catalyst such as strontium, cesium, or potassium is present.

6. Plasma and Light Source from Hydrogen Catalysis

Typically the emission of vacuum ultraviolet light from hydrogen gas is achieved using discharges at high voltage, synchrotron devices, high power inductively coupled plasma generators, or a plasma is created and heated to extreme temperatures by RF coupling (e.g. >10⁶ K) with confinement provided by a toroidal magnetic field. Observation of intense extreme ultraviolet (EUV) emission at low temperatures (e.g. ≈10³ K) from atomic hydrogen generated at a tungsten filament that heated a titanium dissociator and certain gaseous atom or ion catalysts of the present invention vaporized by filament heating has been reported previously [R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943]. Potassium, cesium, and strontium atoms and Rb⁺ ionize at integer multiples of the potential energy of atomic hydrogen formed the low temperature, extremely low voltage plasma called a resonance transfer or rt-plasma having strong EUV emission. Similarly, the ionization energy of Ar⁺ is 27.63 eV, and the emission intensity of the plasma generated by atomic strontium increased significantly with the introduction of argon gas only when Ar⁺ emission was observed [R. Mills, “Spectroscopic Identification of a Novel Catalytic Reaction of Atomic Hydrogen and the Hydride Ion Product”, Int. J. Hydrogen Energy, Vol. 26, No. 10, (2001), pp. 1041-1058]. In contrast, the chemically similar atoms, sodium, magnesium and barium, do not ionize at integer multiples of the potential energy of atomic hydrogen did not form a plasma and caused no emission.

For further characterization, the width of the 656.3 nm n Balmer α line emitted from microwave and glow discharge plasmas of hydrogen alone, strontium or magnesium with hydrogen, or helium, neon, argon, or xenon with 10% hydrogen was recorded with a high resolution visible spectrometer [R. L. Mills, P. Ray, B. Dbandapani, J. He, “Comparison of Excessive Balmer α Line Broadening of Glow Discharge and Microwave Hydrogen Plasmas with Certain Catalysts”, J. of Applied Physics, January, 1, (2003)]. It was found that the strontium-hydrogen microwave plasma showed a broadening similar to that observed in the glow discharge cell of 27-33 eV; whereas, in both sources, no broadening was observed for magnesium-hydrogen. With noble-gas hydrogen mixtures, the trend of broadening with the particular noble gas was the same for both sources, but the magnitude of broadening was dramatically different. The microwave helium-hydrogen and argon-hydrogen plasmas showed extraordinary broadening corresponding to an average hydrogen atom temperature of 110-130 eV and 180-210 eV, respectively. The corresponding results from the glow discharge plasmas were 30-35 eV and 33-38 eV, respectively. Whereas, plasmas of pure hydrogen, neon-hydrogen, krypton-hydrogen, and xenon-hydrogen maintained in either source showed no excessive broadening corresponding to an average hydrogen atom temperature of ≈3 eV. In the case of the helium-hydrogen mixture and argon-hydrogen mixture microwave plasmas, the electron temperature Tₑ was measured from the ratio of the intensity of the He 501.6 nm line to that of the He 492.2 line and the ratio of the intensity of the Ar 104.8 nm line to that of the Ar 420.06 nm line, respectively. Similarly, the average electron temperature for helium-hydrogen and argon-hydrogen plasmas were high, 28,000 K and 11,600 K, respectively; whereas, the corresponding temperatures of helium and argon alone were only 6800 K and 4800 K, respectively. Stark broadening or acceleration of charged species due to high fields (e.g. over 10 kV/cm) can not be invoked to explain the microwave results since no high field was observationally present. Rather, the results may be explained by a resonant energy transfer between atomic hydrogen and atomic strontium, Ar⁺, or He²⁺ which ionize at an integer multiple of the potential energy of atomic hydrogen.

A preferred embodiment of the power cell produces a plasma and may also comprise a light source of at least one of extreme ultraviolet, ultraviolet, visible, infrared, microwave, or radio wave radiation.

A light source of the present invention comprises a cell of the present invention that comprises a light propagation structure or window for a desired radiation of a desired wavelength or desired wavelength range. For example, a quartz window may be used to transmit ultraviolet, visible, infrared, microwave, and/or radio wave light from the cell since it is transparent to the corresponding wavelength range. Similarly, a glass window may be used to transmit visible, infrared, microwave, and/or radio wave light from the cell, and a ceramic window may be used to transmit infrared, microwave, and/or radio wave light from the cell. The cell wall may comprise the light propagation structure or window. The cell wall or window may be coated with a phosphor that converts one or more short wavelengths to desired longer wavelengths. For example, ultraviolet or extreme ultraviolet may be converted to visible light. The light source may provide short wavelength light directly, and the short wavelength line emission may be used for applications known in the art such as photolithography.

A light source of the present invention such as a visible light source may comprise a transparent cell wall that may be insulated such that an elevated temperature may be maintained in the cell. In an embodiment, the wall may be a double wall with a separating vacuum space. The dissociator may be a filament such as a tungsten filament. The filament may also heat the catalyst to form a gaseous catalyst. A first catalyst may be at least one selected from the group of potassium, rubidium, cesium, and strontium metal. A second catalyst may be generated by a first. In an embodiment, at least one of helium, neon, and argon is ionized to He⁺, Ne⁺, and Ar⁺, respectively, by the plasma formed by the catalysis of hydrogen by a first catalysts such as strontium. He⁺, Ne⁺, and/or Ar⁺ serve as second hydrogen catalysts. The hydrogen may be supplied by a hydride that decomposes over time to maintain a desired pressure which may be determined by the temperature of the cell. The cell temperature may be controlled with a heater and a heater controller. In an embodiment, the temperature may be determined by the power supplied to the filament by a power controller.

A further embodiment of the present invention of a light source comprises a tunable light source that may provide coherent or laser light. Extreme ultraviolet (EUV) spectroscopy was recorded on microwave discharges of argon or helium with 10% hydrogen. Novel extreme ultraviolet (EUV) vibrational-series emission lines with energies that empirically matched E_{D+vib}=4² E_{D H}_{₂}_{⁺}±ν*2² E_{vib H}_{₂}_{²}_{(ν=0→ν=1)}, ν*=0, 1, 2, 3 . . . were observed from thehelium-hydrogen plasma at the longer wavelengths for ν*=0 to ν*=20 and at the shorter wavelengths for ν*=0 to ν*=3 where E_{D H}_{₂}_{⁺} and E_{vib H}_{₂}_{⁺}_{(ν=0→ν=1)} are the experimental bond and vibrational energies of H₂⁺, respectively [R. Mills, P. Ray, “Vibrational Spectral Emission of Fractional-Principal-Quantum-Energy-Level Hydrogen Molecular Ion”, Int. J. Hydrogen Energy, Vol. 27, No. 5, (2002), pp. 533-564; R. Mills, J. He, A. Echezuria, B Dhandapani, P. Ray, “Comparison of Catalysts and Plasma Sources of Vibrational Spectral Emission of Fractional-Rydberg-State Hydrogen Molecular Ion”, Vibrational Spectroscopy, submitted]. These lines having energies of ν1.18 eV ν=integer may be a source of tunable laser light. The tunable light source of the present invention comprises at least one of the gas, gas discharge, plasma torch, or microwave plasma cell wherein the cell may comprise a laser cavity. A source of tunable laser light may be provided by the light emitted from a dihydrino molecular ion using systems and means which are known in the art as described in Laser Handbook, Edited by M. L. Stitch, North-Holland Publishing Company, (1979).

The light source of the present invention may comprise at least one of the gas, gas discharge, plasma torch, or microwave plasma cell wherein ions or excimers are effectively formed that serve as catalysts from a source of catalyst such as He⁺, He₂*, Ne₂*, Ne⁺, Ne⁺/H⁺ or Ar⁺ catalysts from helium, helium, neon, neon-hydrogen mixture, and argon gases, respectively. The light may be largely monochromatic light such as line emission of the Lyman series such as Lyman α or Lyman β.

A mixture of helium and neon is the basis of a He—Ne laser. Both of these atoms are also a source of catalyst. In an embodiment of the plasma power cell such as the microwave cell, the source of catalyst comprises a mixture of helium and neon with hydrogen. Population of helium-neon lasing state (20.66 eV metastable state to an excited 18.70 eV state with the laser emission at 632. 8 nm) is pumped by the catalysis of atomic hydrogen. Examples of microwave and discharge cell which use at least one of neon or helium as a source of catalyst are given in Mills Publications [R. L. Mills, P. Ray, J. Dong, M. Nansteel, B. Dhandapani, J. He, “Vibrational Spectral Emission of Fractional-Principal-Quantum-Energy-Level Atomic and Molecular Hydrogen”, Vibrational Spectroscopy, submitted, R. Mills, P. Ray, “Spectral Emission of Fractional Quantum Energy Levels of Atomic Hydrogen from a Helium-Hydrogen Plasma and the Implications for Dark Matter”, Int. J. Hydrogen Energy, Vol. 27, No. 3, pp. 301-322] which are incorporated herein by reference in their entirety.

Rb⁺ to Rb²⁺ and 2K⁺ to K+K²⁺ each provide a reaction with a net enthalpy equal to the potential energy of atomic hydrogen. The presence of these gaseous ions with thermally dissociated hydrogen formed a plasma having strong VUV emission with a stationary inverted Lyman population. We propose an energetic catalytic reaction involving a resonance energy transfer between hydrogen atoms and Rb⁺ or 2K⁺ to form a very stable novel hydride ion. Its predicted binding energy of 3.0468 eV with the fine structure was observed at 4071 Å, and its predicted bound-free hyperfine structure lines E_{HF}=j²3.00213×10⁻⁵+3.0563 eV (j is an integer) matched those observed for j=1 to j=37 to within a 1 part per 10⁵. This catalytic reaction may pump a cw HI laser. The enabling description is given in Mills publications [R. Mills, P. Ray, R. Mayo, “CW HI Laser Based on a Stationary Inverted Lyman Population Formed from Incandescently Heated Hydrogen Gas with Certain Group I Catalysts”, IEEE Transactions on Plasma Science, in press] which are herein incorporated by reference in their entirety.

As given in R. L. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, in press: Then the inverted population is explained by a resonant energy transfer between hydrogen and potassium or rubidium catalysts to yield fast H(n=1) atoms. The emission of excited state H from fast H(n=1) atoms excited by collisions with the background H₂ has been discussed by Radovanov et al. [S. B. Radovanov, K. Dzierzega, J. R. Roberts, J. K. Olthoff, “Time-resolved Balmer-alpha emission from fast hydrogen atoms in low pressure, radio-frequency discharges in hydrogen”, Appl. Phys. Lett., Vol. 66, No. 20, (1995), pp. 2637-2639]. Collisions with oxygen may also play a role in the inversion since inverted hydrogen populations are observed in the case of alkali nitrates and water vapor plasmas [R. Mills, P. Ray, R. M. Mayo, “Stationary Inverted Balmer and Lyman Populations for a CW HI Water-Plasma Laser”, IEEE Transactions on Plasma Science, submitted]. Formation of H⁺ is also predicted which is far from thermal equilibrium in terms of the hydrogen atom temperature. Akatsuka et al. [H. Akatsuka, M. Suzuki, “Stationary population inversion of hydrogen in arc-heated magnetically trapped expanding hydrogen-helium plasmajet”, Phys. Rev. E, Vol. 49, (1994), pp. 1534-1544] show that it is characteristic of cold recombining plasmas to have the high lying levels in local thermodynamic equilibrium (LTE); whereas, population inversion is obtained when Tₑ, suddenly decreases concomitant with rapid decay of the lower lying states.

As a consequence of the nonradiative energy transfer of m·27.2 eV to the catalyst, the hydrogen atom becomes unstable and emits further energy until it achieves a lower-energy nonradiative state having a principal energy level given by Eq. (1). Thus, these intermediate states also correspond to an inverted population, and the emission from these states with energies of q·13.6 eV where q=1, 2, 3, 4, 6, 7, 8, 9, 11, 12 shown in Refs. 14 and 19 may be the basis of a laser in the EUV and soft X-ray, since the excitation of the corresponding relaxed Rydberg state atoms H(1/(p+m)) requires the participation of a nonradiative process [H. Conrads, R. Mills, Th. Wrubel, “Emission in the Deep Vacuum Ultraviolet from a Plasma Formed by Incandescently Heating Hydrogen Gas with Trace Amounts of Potassium Carbonate”, Plasma Sources Science and Technology, submitted].

### 7. Energy Reactor

An energy reactor 50, in accordance with the invention, is shown in FIG. 1 and comprises a vessel 52 which contains an energy reaction mixture 54, a heat exchanger 60, and a power converter such as a steam generator 62 and turbine 70. The heat exchanger 60 absorbs heat released by the catalysis reaction, when the reaction mixture, comprised of hydrogen and a catalyst reacts to form lower-energy hydrogen. The heat exchanger exchanges heat with the steam generator 62 which absorbs heat from the exchanger 60 and produces steam. The energy reactor 50 further comprises a turbine 70 which receives steam from the steam generator 62 and supplies mechanical power to a power generator 80 which converts the steam energy into electrical energy, which can be received by a load 90 to produce work or for dissipation.

The energy reaction mixture 54 comprises an energy releasing material 56 including a source of hydrogen isotope atoms or a source of molecular hydrogen isotope, and a source of catalyst 58 which resonantly remove approximately m×27.21 eV to form lower-energy atomic hydrogen and approximately m×48.6 eV to form lower-energy molecular hydrogen where m is an integer wherein the reaction to lower energy states of hydrogen occurs by contact of the hydrogen with the catalyst. For example, He⁺ fulfills the catalyst criterion—a chemical or physical process with an enthalpy change equal to an integer multiple of 27.2 eV since it ionizes at 54.417 eV which is 2·27.2 eV. The catalysis releases energy in a form such as heat and lower-energy hydrogen isotope atoms and/or molecules.

The source of hydrogen can be hydrogen gas, dissociation of water including thermal dissociation, electrolysis of water, hydrogen from hydrides, or hydrogen from metal-hydrogen solutions. In all embodiments, the source of catalysts can be one or more of an electrochemical, chemical, photochemical, thermal, free radical, sonic, or nuclear reaction(s) or inelastic photon or particle scattering reaction(s). In the latter two cases, the present invention of an energy reactor comprises a particle source 75b and/or photon source 75a to supply the catalyst. In these cases, the net enthalpy of reaction supplied corresponds to a resonant collision by the photon or particle. In a preferred embodiment of the energy reactor shown in FIG. 1, atomic hydrogen is formed from molecular hydrogen by a photon source 75a such as a microwave source or a UV source.

The photon source may also produce photons of at least one energy of approximately

$$m \times 27.21 eV , \frac{m}{2} \times 27.21 eV , or 40.8 eV$$

causes the hydrogen atoms undergo a transition to a lower energy state. In another preferred embodiment, a photon source 75a producing photons of at least one energy of approximately m×48.6 eV, 95.7 eV, or m×31.94 eV causes the hydrogen molecules to undergo a transition to a lower energy state. In all reaction mixtures, a selected external energy device 75, such as an electrode may be used to supply an electrostatic potential or a current (magnetic field) to decrease the activation energy of the reaction. In another embodiment, the mixture 54, further comprises a surface or material to dissociate and/or absorb atoms and/or molecules of the energy releasing material 56. Such surfaces or materials to dissociate and/or absorb hydrogen, deuterium, or tritium comprise an element, compound, alloy, or mixture of transition elements and inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Th, Dy, Ho, Er, Tm, Vb, Lu, Th, Pa, U, activated charcoal (carbon), and intercalated Cs carbon (graphite).

In an embodiment, a catalyst is provided by the ionization of t electrons from an atom or ion to a continuum energy level such that the sum of the ionization energies of the t electrons is approximately m×27.2 eV where t and m are each an integer. A catalyst may also be provided by the transfer of t electrons between participating ions. The transfer of t electrons from one ion to another ion provides a net enthalpy of reaction whereby the sum of the ionization energy of the electron donating ion minus the ionization energy of the electron accepting ion equals approximately m·27.2 eV where t and m are each an integer.

In a preferred embodiment, a source of hydrogen atom catalyst comprises a catalytic material 58, that typically provide a net enthalpy of approximately m×27.21 eV plus or minus 1 eV. In a preferred embodiment, a source of hydrogen molecule catalysts comprises a catalytic material 58, that typically provide a net enthalpy of reaction of approximately m×48.6 eV plus or minus 5 eV. The catalysts include those given in TABLES 1 and 3 and the atoms, ions, molecules, and hydrinos described in Mills Prior Publications which are incorporated herein by reference.

A further embodiment is the vessel 52 containing a catalysts in the molten, liquid, gaseous, or solid state and a source of hydrogen including hydrides and gaseous hydrogen. In the case of a reactor for catalysis of hydrogen atoms, the embodiment further comprises a means to dissociate the molecular hydrogen into atomic hydrogen including an element, compound, alloy, or mixture of transition elements, inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Th, Dy, Ho, Er, Tm, Vb, Lu, Th, Pa, U, activated charcoal (carbon), and intercalated Cs carbon (graphite) or electromagnetic radiation including UV light provided by photon source 75. Alternatively, the hydrogen is dissociated in a plasma.

The present invention of an electrolytic cell energy reactor, plasma electrolysis reactor, barrier electrode reactor, RF plasma reactor, pressurized gas energy reactor, gas discharge energy reactor, microwave cell energy reactor, and a combination of a glow discharge cell and a microwave and or RF plasma reactor of the present invention comprises: a source of hydrogen; one of a solid, molten, liquid, and gaseous source of catalyst; a vessel containing hydrogen and the catalyst wherein the reaction to form lower-energy hydrogen occurs by contact of the hydrogen with the catalyst; and a means for removing the lower-energy hydrogen product. The present energy invention is further described in Mills Prior Publications which are incorporated herein by reference.

In a preferred embodiment, the catalysis of hydrogen produces a plasma. The plasma may also be at least partially maintained by a microwave generator wherein the microwaves are tuned by a tunable microwave cavity, carried by a waveguide, and are delivered to the reaction chamber though an RF transparent window or antenna. The microwave frequency may be selected to efficiently form atomic hydrogen from molecular hydrogen. It may also effectively form ions or excimers that serve as catalysts from a source of catalyst such as He⁺, He₂*, Ne₂*, Ne⁺/H⁺ or Ar⁺ catalysts from helium, helium, neon, neon-hydrogen mixture, and argon gases, respectively. In an embodiment, the cell provides a catalyst for a source of catalyst such as He⁺, Ar⁺, and Ne⁺ from helium, argon, and neon gas, respectively. In embodiments, cell types may be combined for based on specific functions. For example, a glow discharge cell which is very effective at producing catalyst for a source of catalyst such as He⁺, Ar⁺, and Ne⁺ from helium, argon, and neon gas, respectively, may be combined with a reactor such as a microwave reactor that is well suited for the production of atomic hydrogen to react with the catalyst.

### 8. Hydrogen Microwave Plasma and Power Cell and Reactor

A hydrogen microwave plasma and power cell and reactor of the present invention for the catalysis of atomic hydrogen to form increased-binding-energy-hydrogen species and increased-binding-energy-hydrogen compounds comprises a vessel having a chamber capable of containing a vacuum or pressures greater than atmospheric, a source of atomic hydrogen, a source of microwave power to form a plasma, and a catalyst capable of providing a net enthalpy of reaction of m/2·27.2±0.5 eV where m is an integer, preferably m is an integer less than 400. The source of microwave power may comprise a microwave generator, a tunable microwave cavity, waveguide, and an antenna. Alternatively, the cell may further comprise a means to at least partially convert the power for the catalysis of atomic hydrogen to microwaves to maintain the plasma

### 9. Hydrogen Capacitively and Inductively Coupled RF Plasma and Power Cell and Reactor

A hydrogen capacitively and/or inductively coupled radio frequency (RF) plasma and power cell and reactor of the present invention for the catalysis of atomic hydrogen to form increased-binding-energy-hydrogen species and increased-binding-energy-hydrogen compounds comprises a vessel having a chamber capable of containing a vacuum or pressures greater than atmospheric, a source of atomic hydrogen, a source of RF power to form a plasma, and a catalyst capable of providing a net enthalpy of reaction of m/2 27.2±0.5 eV where m is an integer, preferably m is an integer less than 400. The cell may further comprise at least two electrodes and an RF generator wherein the source of RF power may comprise the electrodes driven by the RF generator. Alternatively, the cell may further comprise a source coil which may be external to a cell wall which permits RF power to couple to the plasma formed in the cell, a conducting cell wall which may be grounded and a RF generator which drives the coil which may inductively and/or capacitively couple RF power to the cell plasma.

### 10. Hydrogen Laser

A laser of the present invention comprises a power and plasma cell and a increased-binding-energy-hydrogen species reactor wherein a water plasma is maintained. In an embodiment, a water plasma is maintained in microwave cavity such as a reentrant cavity such as an Evenson cavity. A stationary inverted H Balmer population was observed from a low pressure water-vapor microwave discharge plasma [R. Mills, P. Ray, R. M. Mayo, “Stationary Inverted Balmer and Lyman Populations for a CW HI Water-Plasma Laser”, IEEE Transactions on Plasma Science, submitted]. The ionization and population of excited atomic hydrogen levels was attributed to energy provided by a catalytic resonance energy transfer between hydrogen atoms and molecular oxygen formed in the water plasma. The catalysis by oxygen according to at least Eqs. (39-41) was supported by the observation of O²⁺ and H Balmer line broadening of 55 eV compared to 1 eV for hydrogen alone. The high hydrogen atom temperature with a relatively low electron temperature, Tₑ=2 eV, exhibited characteristics of cold recombining plasmas. These conditions in a water plasma favored an inverted population in the lower levels. Thus, the catalysis of atomic hydrogen may be used to pump a cw H I laser. From our results, laser oscillations are expected i) n=3, n=4, n=5, n=6, n=7 and n=8 to n=2, ii) n=4, n=5, n=6, and n=7 to n=3 and iii) n=5 and n=6 to n=4. High power, highly monochromatic lasers are anticipated at wavelengths, over a broad spectral range from micron to blue which are ideal for many military, industrial, communications, and microelectronics applications.

An additional laser of the present invention comprises a rt-plasma of hydrogen with an inverted population as described by Mills [R. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, in press] which is herein incorporated by reference in its entirety. Each of the ionization of Rb⁺ and cesium and an electron transfer between two K⁺ ions (K⁺/K⁺) provide a reaction with a net enthalpy of an integer multiple of the potential energy of atomic hydrogen, 27.2 eV. The corresponding Group I nitrates provide these reactants as volatilized ions directly or as atoms by undergoing decomposition or reduction to the corresponding metal. The presence of each of the reactants identified as providing an enthalpy of 27.2 eV formed a low applied temperature, extremely low voltage plasma called a resonance transfer or rt-plasma having strong vacuum ultraviolet (VUV) emission. In contrast, magnesium and aluminum atoms or ions do not ionize at integer multiples of the potential energy of atomic hydrogen. Mg(NO₃)₂ or Al(NO₃)₃ did not form a plasma and caused no emission.

For further characterization, the width of the 6563 Å Balmer α line was recorded on light emitted from rt-plasmas. Significant line broadening of 18, 12, anzd 12 eV was observed from a rt-plasma of hydrogen with KNO₃, RbNO₃, and CsNO₃, respectively, compared to 3 eV from a hydrogen microwave plasma. These results could not be explained by Stark or thermal broadening or electric field acceleration of charged species since the measured field of the incandescent heater was extremely weak, 1 V/cm, corresponding to a broadening of much less than 1 eV. Rather the source of the excessive line broadening is consistent with that of the observed VUV emission, an energetic reaction caused by a resonance energy transfer between hydrogen atoms and K⁺/K⁺, Rb⁺, and cesium, which serve as catalysts.

KNO₃ and RbNO₃ formed the most intense plasma. Remarkably, a stationary inverted Lyman population was observed in the case of an rt-plasma formed with potassium and rubidium catalysts. These catalytic reactions may pump a cw HI laser as predicted by a collisional radiative model used to determined that the observed overpopulation was above threshold.

### 11. Photon Power to Electricity Conversion

The present invention of a power and plasma cell and an increased-binding-energy-hydrogen-species reactor further comprises a power converter comprising a hydrogen catalysis cell that produces at least one of a high population of electronically excited state atoms such as hydrogen atoms and an inverted population such as an atomic hydrogen inverted population. A significant fraction of the power is emitted as photons with spontaneous emission or stimulated emission. In an embodiment, the light is converted to electricity using a photon-to-electric converter of the present invention such as a photoelectric or photovoltaic cell. The power cell comprises a hydrogen laser of the present invention.

In an embodiment of at least one of a hydrogen microwave and a hydrogen RF plasma power cell, a microwave or RF transparent cell such as a quartz tube and a microwave or RF transparent photovoltaic material such as amorphous silicon photovoltaic that is circumferential to the cell are inside of the microwave cavity. The cavity may be a reentrant cavity such as an Evenson cavity. The photovoltaic material may comprise the wall of the cell. The cell may further comprise a cell wall cooler such as an air cooler or a water cooler to maintain the photovoltaic at a desired operating temperature. The cell may also comprise mirrors or lenses to direct the light onto the photovoltaic.

In an embodiment that uses a photovoltaic for power conversion, high energy light may be converted to lower energy light by a phosphor on the transparent walls of the cell so that the photons emitted by the excited phosphor more closely match the peak wavelength efficiency of the photovoltaic.

In an embodiment, a species is added to achieve at least one of atomic hydrogen population inversion or conversion of the power of the catalysis reaction to excited state atomic hydrogen. In an embodiment, the inverting or converting species is a gas comprising at least one molecule from the list of O_{2*}H₂O, CO₂, N², NO₂, NO, CO, and halogen gas. Percentage inverting or converting species in the catalysis reaction mixture is in the range of 0.1% to 99.9%, preferably in the range of 0.1 to 50%, more preferably in the range 1% to 25%, and most preferably in the range of 1% to 5%.

### III. BRIEF DESCRIPTION OF THE DRAWINGS

FIG. 1 is a schematic drawing of a power system comprising a hydrogen power and plasma cell and reactor in accordance with the present invention;

FIG. 2 is a schematic drawing of a hydrogen plasma electrolytic power and plasma cell and reactor in accordance with the present invention;

FIG. 3 is a schematic drawing of a hydrogen gas power and plasma cell and reactor in accordance with the present invention;

FIG. 4 is a schematic drawing of a hydrogen gas discharge power and plasma cell and reactor in accordance with the present invention;

FIG. 5 is a schematic drawing of a hydrogen RF barrier electrode gas discharge power and plasma cell and reactor in accordance with the present invention;

FIG. 6 is a schematic drawing of a hydrogen plasma torch power and plasma cell and reactor in accordance with the present invention;

FIG. 7 is a schematic drawing of another hydrogen plasma torch power and plasma cell and reactor in accordance with the present invention;

FIG. 8 is a schematic drawing of a hydrogen microwave power and plasma cell and reactor in accordance with the present invention;

FIG. 9 is a schematic drawing of a hydrogen microwave power and plasma cell, reactor, and laser in accordance with the present invention;

FIG. 10 is a schematic drawing of a laser in accordance with the present invention;

FIG. 11 is a schematic drawing of a rt-plasma cell laser in accordance with the present invention.

FIG. 12 is a schematic drawing of a hydrogen power and plasma cell, reactor, and photon-to-electric converter in accordance with the present invention.

FIG. 13. The experimental set up comprising a filament gas cell to form an rt-plasma light source and an VUV spectrometer which was differentially pumped.

FIG. 14. The 6563 Å Balmer α line width recorded with a high resolution (±0.06 Å) visible spectrometer on an rt-plasma formed with K and K⁺/K⁺ catalysts. Significant broadening was observed corresponding to an average hydrogen atom temperature of 18 eV.

FIG. 15. The 6563 Å Balmer α line width recorded with a high resolution (±0.06 Å) visible spectrometer on an rt-plasma formed with Rb⁺ catalyst. Significant broadening was observed corresponding to an average hydrogen atom temperature of 12 eV.

FIG. 16. The 6563 Å Balmer α line width recorded with a high resolution (±0.06 Å) visible spectrometer on an rt-plasma formed with C catalyst. Significant broadening was observed corresponding to an average hydrogen atom temperature of 12 eV.

FIG. 17. The 4861 Å Balmer β line width recorded with a high resolution (±0.06 Å) visible spectrometer on an rt-plasma formed with Rb⁺ catalyst. Significant broadening was observed corresponding to an average hydrogen atom temperature of 12 eV.

FIG. 18. The 4340 Å Balmer γ line width recorded with a high resolution (±0.06 Å) visible spectrometer on an rt-plasma formed with Rb⁺ catalyst. Significant broadening was observed corresponding to an average hydrogen atom temperature of 14 eV.

FIG. 19. The 4102 Å Balmer 6 line width recorded with a high resolution (±0.06 Å) visible spectrometer on an rt-plasma formed with Rb⁺ catalyst. Significant broadening was observed corresponding to an average hydrogen atom temperature of 11 eV.

FIG. 20. The probe current versus voltage trace of the Langmuir probe of the RbNO₃ rt-plasma. The electron density and temperature were measured to be nₑ=2×10⁹ cm⁻³ and Tₑ=1-2 eV. The electron density was over six orders of magnitude less than that required to achieve 1 Å electron Stark; broadening.

FIG. 21. The statistical curve fit of an RbNO₃ rt-plasma. The data matched a Gaussian profile having the

$${X}^{2} = \sum \frac{{( Calculated - Measured )}^{2}}{Calculated} and {R}^{2}$$

(correlation coefficient squared) values of 0.00023 and 0.99908, respectively. Significant broadening was observed corresponding to an average hydrogen atom temperature of 12 eV.

FIG. 22. The statistical curve fit of the hydrogen microwave plasma. The data matched a Gaussian profile having the X² and R² values of 0.00092 and 0.98937, respectively.

FIG. 23. The VUV spectrum (450-800 Å) of the cell emission recorded at about the point of the maximum Lyman α emission from a gas cell at a cell temperature of 700° C. comprising a tungsten filament, a titanium dissociator, 300 mtorr hydrogen, and vaporized K and K⁺ from KNO₃ that was recorded with a CEM. Line emission corresponding to K³⁺ was observed at 650-670 Å and 740-760 Å. K²⁺ was observed at 510 Å and 550 Å, and K⁺ was observed at 620 Å.

FIG. 24. The VUV spectrum (500-900 Å) of the emission of the RbNO₃—H₂ gas cell (top curve) and the standard rubidium plasma (bottom curve). The RbNO₃—H₂ gas cell comprised a tungsten filament, a titanium dissociator, 300 mTorr hydrogen, and vaporized Rb⁺ from RbNO₃. The emission was recorded with a CEM at about the point of the maximum Lyman α at a cell temperature of 700° C. Line emission corresponding to Rb²⁺ was observed at 815.9 Å, 591 Å, 581 Å, 556 Å, and 533 Å. Rb⁺ was observed at 741.5 Å, 711 Å, 697 Å, and 643.8 Å.

FIG. 25. The UV spectrum (3400-4150 Å) the cell emission recorded at about the point of the maximum Lyman α emission from a gas cell at a cell temperature of 700° C. comprising a tungsten filament, a titanium dissociator, 300 mtorr hydrogen, and vaporized Cs from CsNO₃ that was recorded with a photomultiplier tube (PMT) and a sodium salicylate scintillator. Line emission corresponding to Cs²⁺ was observed at 3477 Å, 3618 Å, and 4001 Å. Cs⁺ was observed at 3680 Å, 3806 Å, and 4069 Å. Cs was observed at 3888.6 Å with Cs²⁺ at 3888.4 Å.

FIG. 26. The VUV spectrum (400-800 Å) of the cell emission from the gas cell at a cell temperature of 700° C. comprising a tungsten filament, vaporized cesium metal, and 300 mtorr hydrogen that was recorded with a PMT and a sodium salicylate scintillator. Emission was observed from a continuum state of Cs²⁺ at 533 Å. The single emission feature with the absence of the other corresponding Rydberg series of lines from Cs⁺ confirmed the resonant energy transfer of 27.2 eV from atomic hydrogen to atomic cesium.

FIG. 27. The VUV spectra (900-1300 Å) of the cell emission from hydrogen microwave plasma (dotted line) and the KNO₃—H₂ rt-plasma (solid line) with an inverted Lyman population.

FIG. 28. The VUV spectra (900-1300 Å) of the cell emission from hydrogen microwave plasma (dotted line) and the RbNO₃—H₂ rt-plasma (solid line) with an inverted Lyman population.

FIG. 29. The VUV spectra (900-1300 Å) of the cell emission from hydrogen microwave plasma (dotted line) and the CsNO₃—H₂ rt-plasma (solid line) with no inverted Lyman population.

FIG. 30. The visible spectrum (4000-6700 Å) recorded on a hydrogen microwave plasma showing the Balmer α, β, γ, and δ line intensities corresponding to n=3, n=4, n=5, and n=6 to n=2.

FIG. 31. The visible spectrum (4000-6700 Å) recorded on a KNO₃ rt-plasma showing the Balmer α, β, γ, and δ line intensities corresponding to n=3, n=4, n=5, and n=6 to n=2.

FIG. 32. The visible spectrum (4000-6700 Å) recorded on a RbNO₃ rt-plasma showing the Balmer α, β, γ, and δ line intensities corresponding to n=3, n=4, n=5, and n=6 to n=2.

FIG. 33. A plot of the absolute reduced population density

$$\frac{{N}_{n}}{{g}_{n}}$$

versus quantum number n recorded on a KNO₃ rt-plasma, a RbNO₃ rt-plasma, and a CsNO₃ rt-plasma. In the case of KNO₃ and RbNO₃ rt-plasmas, population inversion was observed for n=3. From laser equations and a collisional-radiative model, an overpopulation was achieved for n=3.

FIG. 34. The experimental set comprising a quartz tube cell, a source of water vapor, a flow system, and a visible spectrometer.

FIG. 35. The visible spectrum (4000-6700 Å) of the cell emission from a hydrogen microwave plasma at 90 W input power. No inversion was observed.

FIG. 36. The visible spectrum (4000-6700 Å) of the cell emission from a water microwave plasma with 50 W input power. A stationary inverted H Balmer population was observed. The population of the levels n=4, 5, and 6 of hydrogen were continuously inverted with respect to is =3.

FIG. 37. The visible spectrum (2750-7200 Å) of the cell emission from a water microwave plasma with 90 W input power. A stationary inverted H Balmer population was observed. In addition to the continuous population inversion of the H levels n=4, 5, and 6 with respect to n=3 observed at 50 W, the n=5 and 6 levels were further continuously inverted with respect to n=4 when the input power was increased to 90 W. The levels n=7, 8, and 9 of hydrogen were also continuously inverted with respect to n=3.

FIG. 38. The VUV spectra (900-1300 Å) of the cell emission from hydrogen microwave and water microwave plasmas with 90 W input power. An inverted Lyman population was observed from the water plasma emission with the inversion observed in the visible as shown in FIGS. 36 and 37 extending to the n=2 level.

FIG. 39. The visible spectrum (3000-7200 Å) of the cell emission from an inductively coupled water RF plasma with 90 W input power. No inversion was observed.

FIG. 40. The visible spectrum (3000-7200 Å) of the cell emission from a capacitively coupled water RF plasma with 90 W input power. No inversion was observed.

FIG. 41. The visible spectrum (2750-7200 Å) of the cell emission from a water high voltage glow discharge plasma with 90 W input power. Strong OH(A-X) emission, but no inversion was observed.

FIG. 42. The OH(A-X) microwave water plasma emission spectrum in the region of 2750-3300 Å with 90 W input power.

FIG. 43. The OH(A-X) (1-0) R-branch and the (1-0) Q-branch were observed in the 2800-2950 Å region of the microwave water plasma emission spectrum shown in FIG. 42.

FIG. 44. The OH(A-X) (0-0) R-branch and the (0-0), (1-1), and (2-2) Q-branches were observed in the 3000-3300 Å region of the microwave water plasma emission spectrum shown in FIG. 42.

FIG. 45. The 6562.8 Å Balmer α line width recorded with a high resolution (±0.06 Å) visible spectrometer on a hydrogen microwave discharge plasma. The statistical curve fit of the Balmer α line width profile matched a Gaussian profile having the

$${X}^{2} = \sum \frac{{( Calculated - Measured )}^{2}}{Calculated} and {R}^{2}$$

(correlation coefficient squared) values of 4.86 and 0.99, respectively. No line excessive broadening was observed corresponding to an average hydrogen atom temperature of 1 eV.

FIG. 46. The 6562.8 Å Balmer α line width recorded with a high resolution (±0.06 Å) visible spectrometer on a water vapor microwave discharge plasma. The statistical curve fit of the Balmer α line width profile matched a Gaussian profile having the X² and R² values of 7.48 and 0.996, respectively. Significant broadening was observed corresponding to an average hydrogen atom temperature of 55 eV.

FIG. 47. The visible spectrum (3700-3960 Å) of the cell emission from a water microwave plasma with 90 W input power. The catalysis mechanism was supported by the observation of O²⁺ at 3715.0 Å, 3754.8 Å, and 3791.28 Å. O⁺ was observed at 3727.2 Å, 3749.4 Å, 3771 3872 Å, and 3946.3 Å. The hydrogen Balmer lines corresponding to the transitions 10-2, 9-2, and 8-2 were also observed.

### IV. DETAILED DESCRIPTION OF THE INVENTION

The following preferred embodiments of the invention disclose numerous property ranges, including but not limited to, voltage, current, pressure, temperature, microwave power, and the like, which are merely intended as illustrative examples. Based on the detailed written description, one skilled in the art would easily be able to practice this invention within other property ranges to produce the desired result without undue experimentation.

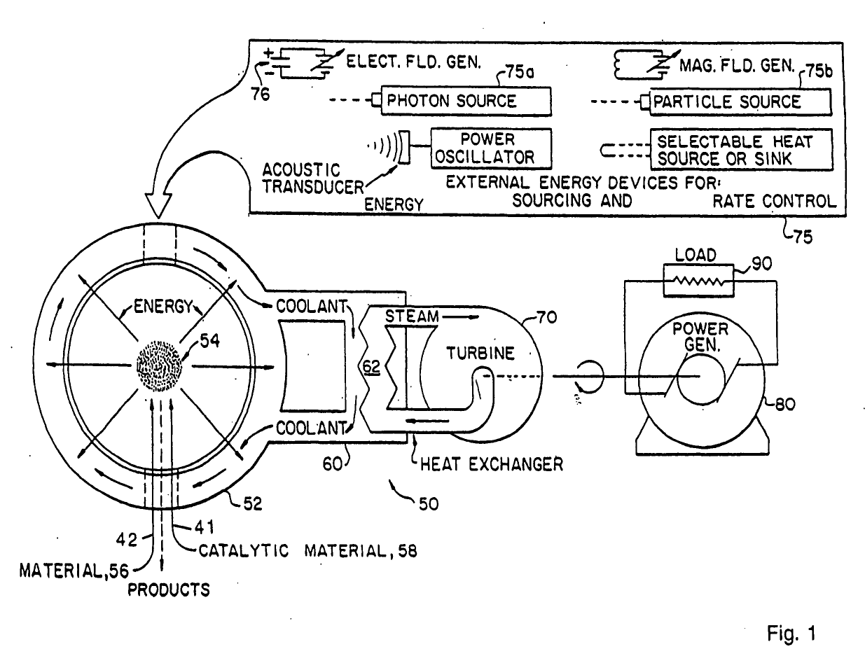

1. Hydrogen Power and Plasma Cell and Reactor One embodiment of the present invention involves a power system comprising a hydrogen power and plasma cell and reactor shown in FIG. 1. The hydrogen power and plasma cell and reactor comprises a vessel 52 containing a catalysis mixture 54. The catalysis mixture 54 comprises a source of atomic hydrogen 56 supplied through hydrogen supply passage 42 and a catalyst 58 supplied through catalyst supply passage 41. Catalyst 58 has a net enthalpy of reaction of about

$$\frac{m}{2} \cdot 27.21 \pm 0.5 eV ,$$

where m is an integer, preferably an integer less than 400. The catalysis involves reacting atomic hydrogen from the source 56 with the catalyst 58 to form lower-energy hydrogen “hydrinos” and produce power. The hydrogen reactor may further include an electron source 70 for contacting hydrinos with electrons, to reduce the hydrinos to hydrino hydride ions.

The source of hydrogen can be hydrogen gas, water, ordinary hydride, or metal-hydrogen solutions. The water may be dissociated to form hydrogen atoms by, for example, thermal dissociation or electrolysis. According to one embodiment of the invention, molecular hydrogen is dissociated into atomic hydrogen by a molecular hydrogen dissociating catalyst. Such dissociating catalysts include, for example, noble metals such as palladium and platinum, refractory metals such as molybdenum and tungsten, transition metals such as nickel and titanium, inner transition metals such as niobium and zirconium, and other such materials listed in the Prior Mills Publications.

According to another embodiment of the invention, a photon source such as a microwave or UV photon source dissociates hydrogen molecules to hydrogen atoms.

In the hydrogen power and plasma cell and reactor embodiments of the present invention, the means to form hydrinos can be one or more of an electrochemical, chemical, photochemical, thermal, free radical, sonic, or nuclear reaction(s), or inelastic photon or particle scattering reaction(s). In the latter two cases, the hydrogen reactor comprises a particle source 75b and/or photon source 75a as shown in FIG. 1, to supply the reaction as an inelastic scattering reaction. In one embodiment of the hydrogen reactor, the catalyst in the molten, liquid, gaseous, or solid state includes those given in TABLES 1 and 3 and those given in the Tables of the Prior Mills Publications (e.g. TABLE 4 of PCT/US90/01998 and pages 25-46, 80-108 of PCT/US94/02219).

When the catalysis occurs in the gas phase, the catalyst may be maintained at a pressure less than atmospheric, preferably in the range about 10 millitorr to about 100 torr. The atomic and/or molecular hydrogen reactant is also maintained at a pressure less than atmospheric, preferably in the range about 10 millitorr to about 100 torr. However, if desired, higher pressures even greater than atmospheric can be used.

The hydrogen power and plasma cell and reactor comprises the following: a source of atomic hydrogen; at least one of a solid, molten, liquid, or gaseous catalyst for generating hydrinos; and a vessel for containing the atomic hydrogen and the catalyst. Methods and apparatus for producing hydrinos, including a listing of effective catalysts and sources of hydrogen atoms, are described in the Prior Mills Publications. Methodologies for identifying hydrinos are also described. The hydrinos so produced may react with the electrons from a reductant to form hydrino hydride ions.

The power system may further comprise a source of electric field 76 which can be used to adjust the rate of hydrogen catalysis. It may further focus ions in the cell. It may further impart a drift velocity to ions in the cell. The cell may comprise a source of microwave power, which is generally known in the art, such as traveling wave tubes, klystrons, magnetrons, cyclotron resonance masers, gyrotrons, and free electron lasers. The present power cell may be an internal source of microwaves wherein the plasma generated from the hydrogen catalysis reaction may be magnetized to produce microwaves.

1.1 Hydrogen Plasma Electrolysis Power and Plasma Cell and Reactor

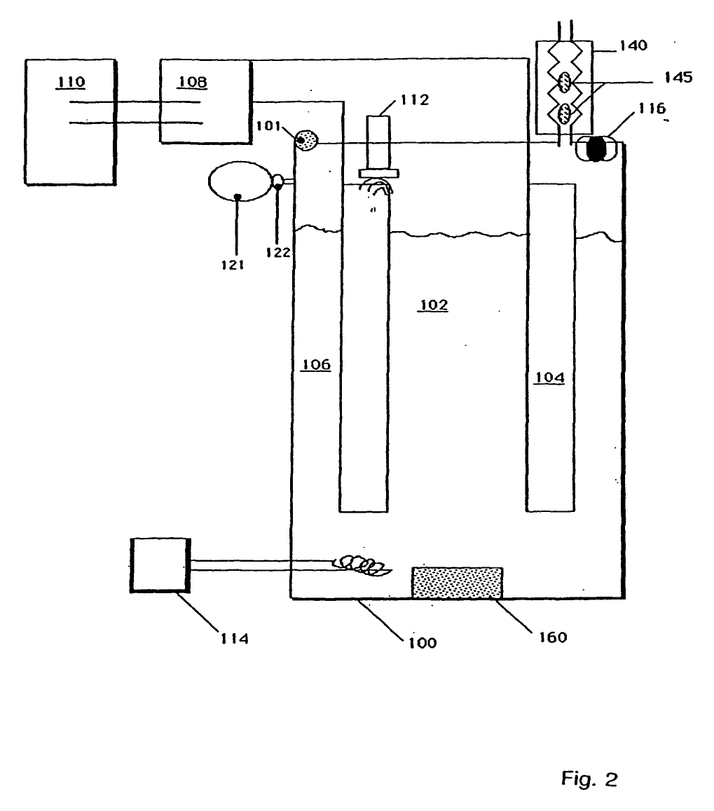

A hydrogen plasma electrolytic power cell and reactor of the present invention to make lower-energy hydrogen compounds comprises an electrolytic cell forming the reaction vessel 52 of FIG. 1, including a molten electrolytic cell. The electrolytic cell 100 is shown generally in FIG. 2. An electric current is passed through the electrolytic solution 102 having a catalyst by the application of a voltage to an anode 104 and cathode 106 by the power controller 108 powered by the power supply 110. Ultrasonic or mechanical energy may also be imparted to the cathode 106 and electrolytic solution 102 by vibrating means 112. Heat can be supplied to the electrolytic solution 102 by heater 114. The pressure of the electrolytic cell 100 can be controlled by pressure regulator means 116 where the cell can be closed. The reactor further comprises a means 101 that removes the (molecular) lower-energy hydrogen such as a selective venting valve to prevent the exothermic shrinkage reaction from coming to equilibrium.

In an embodiment, the plasma electrolytic cell is further supplied with hydrogen from hydrogen source 121 where the over pressure can be controlled by pressure control means 122 and 116. An embodiment of the electrolytic cell energy reactor, comprises a reverse fuel cell geometry which removes the lower-energy hydrogen under vacuum. The reaction vessel may be closed except for a connection to a condensor 140 on the top of the vessel 100. The cell may be operated at a boil such that the steam evolving from the boiling electrolyte 102 can be condensed in the condensor 140, and the condensed water can be returned to the vessel 100. The lower-energy state hydrogen can be vented through the top of the condensor 140. In one embodiment, the condenser contains a hydrogen/oxygen recombiner 145 that contacts the evolving electrolytic gases. The hydrogen and oxygen are recombined, and the resulting water can be returned to the vessel 100. The heat released from the catalysis of hydrogen and the heat released due to the recombination of the electrolytically generated normal hydrogen and oxygen can be removed by a heat exchanger 60 of FIG. 1 which can be connected to the condensor 140.

Hydrino atoms form at the cathode 106 via contact of the catalyst of electrolyte 102 with the hydrogen atoms generated at the cathode 106. The electrolytic cell hydrogen reactor apparatus may further comprises a source of electrons in contact with the hydrinos generated in the cell, to form hydrino hydride ions. The hydrinos are reduced (i.e. gain the electron) in the electrolytic cell to hydrino hydride ions. Reduction occurs by contacting the hydrinos with other element 160 such as a consumable reductant added to the cell from an outside source. A compound may form in the electrolytic cell between the hydrino hydride ions and cations. The cations may comprise a cation of an added reductant, or a cation of the electrolyte (such as a cation comprising the catalyst).

A hydrogen plasma forming electrolytic power cell and reactor of the present invention for the catalysis of atomic hydrogen to form increased-binding-energy-hydrogen species and increased-binding-energy-hydrogen compounds comprises a vessel, a cathode, an anode, an electrolyte, a high voltage electrolysis power supply, and a catalyst capable of providing a net enthalpy of reaction of m/2·27.2±0.5 eV where in is an integer. Preferably m is an integer less than 400. In an embodiment, the voltage is in the range of about 10 V to 50 kV and the current density may be high such as in the range of about 1 to 100 A/cm² or higher. In an embodiment, K⁺ is reduced to potassium atom which serves as the catalyst The cathode of the cell may be tungsten such as a tungsten rod, and the anode of cell of may be platinum. The catalysts of the cell may comprise at least one selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Sr⁺, Fe³⁺, Mo²⁺, Ma⁴⁺, and In³⁺. The catalyst of the cell of may be formed from a source of catalyst. The source of catalyst that forms the catalyst may comprise at least one selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Sr⁺, Fe³⁺, Mo²⁺, Mo⁴⁺, In³⁺ and K⁺/K⁺ alone or comprising compounds. The source of catalyst may comprise a compound that provides K⁺ that is reduced to the catalyst potassium atom during electrolysis.

The compound of formed comprises

(a) at least one neutral, positive, or negative increased binding energy hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions, or is negative; and

(b) at least one other element.

The increased binding energy hydrogen species may be selected from the group consisting of Hₙ, Hₙ⁻, and Hₙ⁺ where n is a positive integer, with the proviso that n is greater than 1 when H has a positive charge. The compound formed may be characterized in that the increased binding energy hydrogen species is selected from the group consisting of (a) hydride ion having a binding energy that is greater than the binding of ordinary hydride ion (about 0.8 eV) for p=2 up to 23 in which the binding energy is represented by

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer greater than one; (b) hydrogen atom having a binding energy greater than about 13.6 eV; (c) hydrogen molecule having a first binding energy greater than about 15.3 eV; and (d) molecular hydrogen ion having a binding energy greater than about 16.3 eV. The compound may be characterized in that the increased binding energy hydrogen species is a hydride ion having a binding energy of about 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. The compound may characterized in that the increased binding energy hydrogen species is a hydride ion having the binding energy:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer greater than one. The compound may characterized in that the increased binding energy hydrogen species is selected from the group consisting of

(a) a hydrogen atom having a binding energy of about

$$\frac{13.6 eV}{{( \frac{1}{p} )}^{2}}$$

where p is an integer,

(b) an increased binding energy hydride ion (H⁻) having a binding energy of about

$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ;$$

(c) an increased binding energy hydrogen species H₄⁺(1/p);

(d) an increased binding energy hydrogen species trihydrino molecular ion, H₃⁺(1/p), having a binding energy of about

$$\frac{22.6 }{{( \frac{1}{p} )}^{2}} eV$$

where p is an integer,

(e) an increased binding energy hydrogen molecule having a binding energy of about

$$\frac{15.3 }{{( \frac{1}{p} )}^{2}} eV ; and$$

(f) an increased binding energy hydrogen molecular ion with a binding energy of about

$$\frac{16.3 }{{( \frac{1}{p} )}^{2}} eV .$$

1.2 Hydrogen Gas Power and Plasma Cell and Reactor

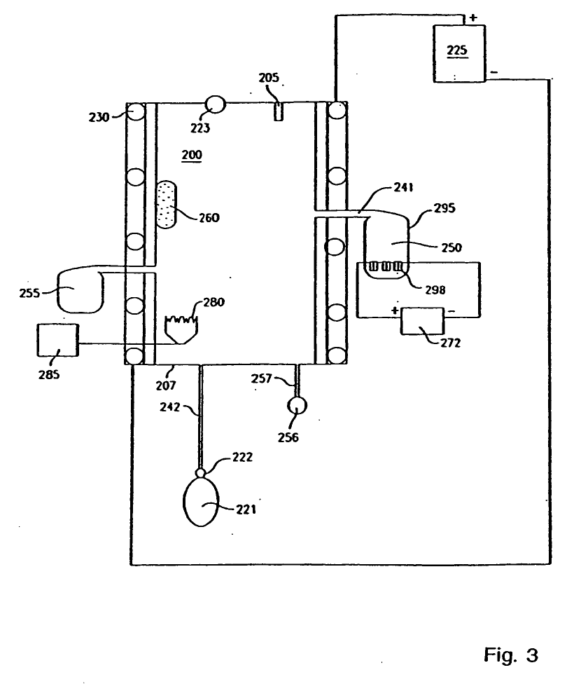

According to an embodiment of the invention, a reactor for producing hydrinos, plasma, and power may take the form of a hydrogen gas cell. A gas cell hydrogen reactor of the present invention is shown in FIG. 3. Reactant hydrinos are provided by a catalytic reaction with a catalyst such as at least one of those given in TABLES 1 and 3 and/or a by a disproportionation reaction. Catalysis may occur in the gas phase.

The reactor of FIG. 3 comprises a reaction vessel 207 having a chamber 200 capable of containing a vacuum or pressures greater than atmospheric. A source of hydrogen 221 communicating with chamber 200 delivers hydrogen to the chamber through hydrogen supply passage 242. A controller 222 is positioned to control the pressure and flow of hydrogen into the vessel through hydrogen supply passage 242. A pressure sensor 223 monitors pressure in the vessel. A vacuum pump 256 is used to evacuate the chamber through a vacuum line 257. The apparatus may further comprise a source of electrons in contact with the hydrinos to form hydrino hydride ions.

In an embodiment, the source of hydrogen 221 communicating with chamber 200 that delivers hydrogen to the chamber through hydrogen supply passage 242 is a hydrogen permeable hollow cathode of an electrolysis cell. Electrolysis of water produces hydrogen that permeates through the hollow cathode. The cathode may be a transition metal such as nickel, iron, or titanium, or a noble metal such as palladium, or platinum, or tantalum or palladium coated tantalum, or palladium coated niobium. The electrolyte may be basic and the anode may be nickel. The electrolyte may be aqueous K₂ CO₃. The flow of hydrogen into the cell may be controlled by controlling the electrolysis current with an electrolysis power controller.

A catalyst 250 for generating hydrino atoms can be placed in a catalyst reservoir 295. The catalyst in the gas phase may comprise the catalysts given in TABLES 1 and 3 and those in the Mills Prior Publications. The reaction vessel 207 has a catalyst supply passage 241 for the passage of gaseous catalyst from the catalyst reservoir 295 to the reaction chamber 200. Alternatively, the catalyst may be placed in a chemically resistant open container, such as a boat, inside the reaction vessel.

The molecular and atomic hydrogen partial pressures in the reactor vessel 207, as well as the catalyst partial pressure, is preferably maintained in the range of about 10 millitorr to about 100 torr. Most preferably, the hydrogen partial pressure in the reaction vessel 207 is maintained at about 200 millitorr.

Molecular hydrogen may be dissociated in the vessel into atomic hydrogen by a dissociating material. The dissociating material may comprise, for example, a noble metal such as platinum or palladium, a transition metal such as nickel and titanium, an inner transition metal such as niobium and zirconium, or a refractory metal such as tungsten or molybdenum. The dissociating material may be maintained at an elevated temperature by the heat liberated by the hydrogen catalysis (hydrino generation) and hydrino reduction taking place in the reactor. The dissociating material may also be maintained at elevated temperature by temperature control means 230, which may take the form of a heating coil as shown in cross section in FIG. 3. The heating coil is powered by a power supply 225.

Molecular hydrogen may be dissociated into atomic hydrogen by application of electromagnetic radiation, such as UV light provided by a photon source 205, by a hot filament or grid 280 powered by power supply 285, or by the plasma generated in the cell by the catalysis reaction.

The hydrogen dissociation occurs such that the dissociated hydrogen atoms contact a catalyst which is in a molten, liquid, gaseous, or solid form to produce hydrino atoms. The catalyst vapor pressure is maintained at the desired pressure by controlling the temperature of the catalyst reservoir 295 with a catalyst reservoir beater 298 powered by a power supply 272. When the catalyst is contained in a boat inside the reactor, the catalyst vapor pressure is maintained at the desired value by controlling the temperature of the catalyst boat, by adjusting the boat's power supply.

The rate of production of hydrinos and power by the hydrogen gas cell can be controlled by controlling the amount of catalyst in the gas phase and/or by controlling the concentration of atomic hydrogen. The concentration of gaseous catalyst in vessel chamber 200 may be controlled by controlling the initial amount of the volatile catalyst present in the chamber 200. The concentration of gaseous catalyst in chamber 200 may also be controlled by controlling the catalyst temperature, by adjusting the catalyst reservoir heater 298, or by adjusting a catalyst boat heater when the catalyst is contained in a boat inside the reactor. The vapor pressure of the volatile catalyst 250 in the chamber 200 is determined by the temperature of the catalyst reservoir 295, or the temperature of the catalyst boat, because each is colder than the reactor vessel 207. The reactor vessel 207 temperature is maintained at a higher operating temperature than catalyst reservoir 295 with heat liberated by the hydrogen catalysis (hydrino generation) and hydrino reduction. The reactor vessel temperature may also be maintained by a temperature control means, such as heating coil 230 shown in cross section in FIG. 3. Heating coil 230 is powered by power supply 225. The reactor temperature further controls the reaction rates such as hydrogen dissociation and catalysis.

In an embodiment, the catalyst comprises a mixture of a first catalyst supplied from the catalyst reservoir 295 and a source of a second catalyst supplied from gas supply 221 regulated by flow controller 222. Hydrogen may also be supplied to the cell from gas supply 221 regulated by flow controller 222. The flow controller 222 may achieve a desired mixture of the source of a second catalyst and hydrogen, or the gases may be premixed in a desired ratio. In an embodiment, the first catalyst produces the second catalyst from the source of the second catalyst. In an embodiment, the energy released by the catalysis of hydrogen by the first catalyst produces a plasma in the energy cell. The energy ionizes the source of the second catalyst to produce the second catalyst. The first catalyst may be selected from the group of catalysts given in TABLES 1 and 3 such as potassium and strontium, the source of the second catalyst may be selected from the group of helium and argon and the second catalyst may be selected from the group of He⁺ and Ar⁺ wherein the catalyst ion is generated from the corresponding atom by a plasma created by catalysis of hydrogen by the first catalyst. For examples, 1.) the energy cell contains strontium and argon wherein hydrogen catalysis by strontium produces a plasma containing Ar⁺ which serves as a second catalyst (Eqs. (15-17)) and 2.) the energy cell contains potassium and helium wherein hydrogen catalysis by potassium produces a plasma containing He⁺ which serves as a second catalyst (Eqs. (12-14)). In an embodiment, the pressure of the source of the second catalyst is in the range of about 1 millitorr to about one atmosphere. The hydrogen pressure is in the range of about 1 millitorr to about one atmosphere. In a preferred embodiment, the total pressure is in the range of about 0.5 torr to about 2 torr. In an embodiment, the ratio of the pressure of the source of the second catalyst to the hydrogen pressure is greater than one. In a preferred embodiment, hydrogen is about 0.1% to about 99%, and the source of the second catalyst comprises the balance of the gas present in the cell. More preferably, the hydrogen is in the range of about 1% to about 5% and the source of the second catalyst is in the range of about 95% to about 99%. Most preferably, the hydrogen is about 5% and the source of the second catalyst is about 95%. These pressure ranges are representative examples and a skilled person will be able to practice this invention using a desired pressure to provide a desired result.

The preferred operating temperature depends, in part, on the nature of the material comprising the reactor vessel 207. The temperature of a stainless steel alloy reactor vessel 207 is preferably maintained at about 200-1200° C. The temperature of a molybdenum reactor vessel 207 is preferably maintained at about 200-1800° C. The temperature of a tungsten reactor vessel 207 is preferably maintained at about 200-3000° C. The temperature of a quartz or ceramic reactor vessel 207 is preferably maintained at about 200-1800° C.

The concentration of atomic hydrogen in vessel chamber 200 can be controlled by the amount of atomic hydrogen generated by the hydrogen dissociation material. The rate of molecular hydrogen dissociation can be controlled by controlling the surface area, the temperature, and/or the selection of the dissociation material. The concentration of atomic hydrogen may also be controlled by the amount of atomic hydrogen provided by the atomic hydrogen source 221. The concentration of atomic hydrogen can be further controlled by the amount of molecular hydrogen supplied from the hydrogen source 221 controlled by a flow controller 222 and a pressure sensor 223. The reaction rate may be monitored by windowless ultraviolet (UV) emission spectroscopy to detect the intensity of the UV emission due to the catalysis and the hydrino, dihydrino molecular ion, dihydrino molecule, hydride ion, and compound emissions.

The gas cell hydrogen reactor further comprises other element as an electron source 260 such a reductant in contact with the generated hydrinos to form hydrino hydride ions. Compounds comprising a hydrino hydride anion and a cation may be formed in the gas cell. The cation which forms the hydrino hydride compound may comprise a cation from an added reductant, or a cation present in the cell (such as the cation of the catalyst). The cell may further comprise a getter or cryotrap 255 to selectively collect the lower-energy-hydrogen species and/or the increased-binding-energy hydrogen compounds.

1.3 Hydrogen Gas Discharge Power and Plasma Cell and Reactor

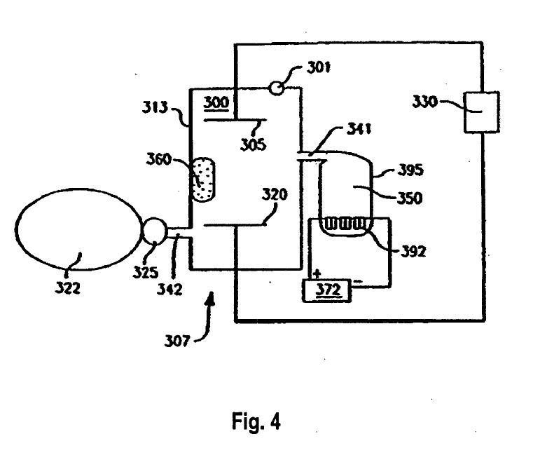

A hydrogen gas discharge power and plasma cell and reactor of the present invention is shown in FIG. 4. The hydrogen gas discharge power and plasma cell and reactor of FIG. 4, includes a gas discharge cell 307 comprising a hydrogen isotope gas-filled glow discharge vacuum vessel 313 having a chamber 300. A hydrogen source 322 supplies hydrogen to the chamber 300 through control valve 325 via a hydrogen supply passage 342. A catalyst is contained in catalyst reservoir 395. A voltage and current source 330 causes current to pass between a cathode 305 and an anode 320. The current may be reversible. In another embodiment, the plasma is generated with a microwave source such as a microwave generator.

In one embodiment of the hydrogen gas discharge power and plasma cell and reactor, the wall of vessel 313 is conducting and serves as the anode. In another embodiment, the cathode 305 is hollow such as a hollow, nickel, aluminum, copper, tungsten, molybdenum, or stainless steel hollow cathode. In an embodiment, the cathode material may be a source of catalyst such as iron or samarium.

The cathode 305 may be coated with the catalyst for generating hydrinos and energy. The catalysis to form hydrinos and energy occurs on the cathode surface. To form hydrogen atoms for generation of hydrinos and energy, molecular hydrogen is dissociated on the cathode. To this end, the cathode is formed of a hydrogen dissociative material. Alternatively, the molecular hydrogen is dissociated by the discharge.

According to another embodiment of the invention, the catalyst for generating hydrinos and energy is in gaseous form. For example, the discharge may be utilized to vaporize the catalyst to provide a gaseous catalyst. Alternatively, the gaseous catalyst is produced by the discharge current. For example, the gaseous catalyst may be provided by a discharge in rubidium metal to form Rb⁺, strontium metal to form Sr⁺, or titanium metal to form Ti²⁺, or potassium to volatilize the metal. The gaseous hydrogen atoms for reaction with the gaseous catalyst are provided by a discharge of molecular hydrogen gas such that the catalysis occurs in the gas phase.

Another embodiment of the hydrogen gas discharge power and plasma cell and reactor where catalysis occurs in the gas phase utilizes a controllable gaseous catalyst. The gaseous hydrogen atoms for conversion to hydrinos are provided by a discharge of molecular hydrogen gas. The gas discharge cell 307 has a catalyst supply passage 341 for the passage of the gaseous catalyst 350 from catalyst reservoir 395 to the reaction chamber 300. The catalyst reservoir 395 is heated by a catalyst reservoir heater 392 having a power supply 372 to provide the gaseous catalyst to the reaction chamber 300. The catalyst vapor pressure is controlled by controlling the temperature of the catalyst reservoir 395, by adjusting the heater 392 by means of its power supply 372. The reactor further comprises a selective venting valve 301.

In another embodiment of the hydrogen gas discharge power and plasma cell and reactor where catalysis occurs in the gas phase utilizes a controllable gaseous catalyst. Gaseous hydrogen atoms provided by a discharge of molecular hydrogen gas. A chemically resistant (does not react or degrade during the operation of the reactor) open container, such as a tungsten or ceramic boat, positioned inside the gas discharge cell contains the catalyst. The catalyst in the catalyst boat is heated with a boat heater using by means of an associated power supply to provide the gaseous catalyst to the reaction chamber. Alternatively, the glow gas discharge cell is operated at an elevated temperature such that the catalyst in the boat is sublimed, boiled, or volatilized into the gas phase. The catalyst vapor pressure is controlled by controlling the temperature of the boat or the discharge cell by adjusting the heater with its power supply.

The gas discharge cell may be operated at room temperature by continuously supplying catalyst. Alternatively, to prevent the catalyst from condensing in the cell, the temperature is maintained above the temperature of the catalyst source, catalyst reservoir 395 or catalyst boat. For example, the temperature of a stainless steel alloy cell is about 0-1200° C.; the temperature of a molybdenum cell is about 0-1800° C.; the temperature of a tungsten cell is about 0-3000° C.; and the temperature of a glass, quartz, or ceramic cell is about 0-1800° C. The discharge voltage may be in the range of about 1000 to about 50,000 volts. The current may be in the range of about 1 μA to about 1 A, preferably about 1 mA.

The discharge current may be intermittent or pulsed. Pulsing may be used to reduce the input power, and it may also provide a time period wherein the field is set to a desired strength by an offset voltage which may be below the discharge voltage. One application of controlling the field during the nondischarge period is to optimize the energy match between the catalyst and the atomic hydrogen. In an embodiment, the offset voltage is between, about 0.5 to about 500 V. In another embodiment, the offset voltage is set to provide a field of about 0.1 V/cm to about 50 V/cm. Preferably, the offset voltage is set to provide a field between about 1 V/cm to about 10 V/cm. The peak voltage may be in the range of about 1 V to 10 MV. More preferably, the peak voltage is in the range of about 10 V to 100 kV. Most preferably, the voltage is in the range of about 100 V to 500 V. The pulse frequency and duty cycle may also be adjusted. An application of controlling the pulse frequency and duty cycle is to optimize the power balance. In an embodiment, this is achieved by optimizing the reaction rate versus the input power. The amount of catalyst and atomic hydrogen generated by the discharge decay during the nondischarge period. The reaction rate may be controlled by controlling the amount of catalyst generated by the discharge such as Ar⁺ and the amount of atomic hydrogen wherein the concentration is dependent on the pulse frequency, duty cycle, and the rate of decay. In an embodiment, the pulse frequency is of about 0.1 Hz to about 100 MHz. In another embodiment, the pulse frequency is faster than the time for substantial atomic hydrogen recombination to molecular hydrogen. Based on anomalous plasma afterglow duration studies [R. Mills, T. Onuma, and Y. Lu, “Formation of a Hydrogen Plasma from an Incandescently Heated Hydrogen-Catalyst Gas Mixture with an Anomalous Afterglow Duration”, Int. 1. Hydrogen Energy, Vol. 26, No. 7, July, (2001), pp. 749-762; R. Mills, “Temporal Behavior of Light-Emission in the Visible Spectral Range from a Ti—K2CO3—H-Cell”, Int. J. Hydrogen Energy, Vol. 26, No. 4, (2001), pp. 327-332], preferably the frequency is within the range of about 1 to about 200 Hz. In an embodiment, the duty cycle is about 0.1% to about 95%. Preferably, the duty cycle is about 1% to about 50%.

In another embodiment, the power may be applied as an alternating current (AC). The frequency may be in the range of about 0.001 Hz to 1 GHz. More preferably the frequency is in the range of about 60 Hz to 100 MHz. Most preferably, the frequency is in the range of about 10 to 100 MHz. The system may comprises two electrodes wherein one or more electrodes are in direct contact with the plasma; otherwise, the electrodes may be separated from the plasma by a dielectric barrier. The peak voltage may be in the range of about 1 V to 10 MV. More preferably, the peak voltage is in the range of about 10 V to 100 kV. Most preferably, the voltage is in the range of about 100 V to 500 V.

The gas discharge cell apparatus further comprises other element as an electron source 360 such a reductant in contact with the generated hydrinos to form hydrino hydride ions. Compounds comprising a hydrino hydride anion and a cation may be formed in the gas cell. The cation which forms the hydrino hydride compound may comprise a cation from an added reductant, or a cation present in the cell (such as the cation of the catalyst).

In one embodiment of the gas discharge cell apparatus, alkali and alkaline earth hydrino hydrides and energy are produced in the gas discharge cell 307. In an embodiment, the catalyst reservoir 395 contains potassium, rubidium, or strontium metal which may be is ionized to K⁺, Rb⁺ or Sr⁺ catalyst, respectively. The catalyst vapor pressure in the gas discharge cell is controlled by heater 392. The catalyst reservoir 395 is heated with the heater 392 to maintain the catalyst vapor pressure proximal to the cathode 305 preferably in the pressure range 10 millitorr to 100 torr, more preferably at about 200 mtorr. In another embodiment, the cathode 305 and the anode 320 of the gas discharge cell 307 are coated with potassium, rubidium, or strontium. The catalyst is vaporized during the operation of the cell. The hydrogen supply from source 322 is adjusted with control 325 to supply hydrogen and maintain the hydrogen pressure in the 10 millitorr to 100 torr range.

In an embodiment, the electrode to provide the electric field is a compound electrode comprising multiple electrodes in series or parallel that may occupy a substantial portion of the volume of the reactor. In one embodiment, the electrode comprises multiple hollow cathodes in parallel so that the desired electric field is produced in a large volume to generate a substantial power level. One design of the multiple hollow cathodes comprises an anode and multiple concentric hollow cathodes each electrically isolated from the common anode. Another compound electrode comprises multiple parallel plate electrodes connected in series.

A preferable hollow cathode is comprised of refractory materials such as molybdenum or tungsten. A preferably hollow cathode comprises a compound hollow cathode. A preferable catalyst of a compound hollow cathode discharge cell is neon as described in R. L. Mills, P. Ray, J. Dong, M. Nansteel, B. Dhandapani, J. He, “Vibrational Spectral Emission of Fractional-Principal-Quantum-Energy-Level Atomic and Molecular Hydrogen”, Vibrational Spectroscopy, submitted which is herein incorporated by reference in its entirety. In an embodiment of the cell comprising a compound hollow cathode and neon as the source of catalyst with hydrogen, the partial pressure of neon is in the range 99.99%-90% and hydrogen is in the range 0.01-10%. Preferably the partial pressure of neon is in the range 99.9-99% and hydrogen is in the range 0.1-1%.

In an embodiment, metal hydride films such as FeH form with a helium, argon, or neon-hydrogen mixture plasma such as (99/1%) with a reactor such as a stainless steel reactor and a stainless steel cathode. Preferably the cathode is made of a metal M, and MH is synthesized wherein H is an increased binding energy hydrogen species. In an embodiment, the cathode is iron in the case of the synthesis of FeH. In another embodiment, the cell is operated at an elevated temperature. The cell may be operated in the temperature range of about 25-100° C. Preferably the cell is operated in the range of about 100-3500° C. More preferably the cell is operated in the range of about 200-1500° C. Most preferably the cell is operated in the range of about 400-800° C. The higher operating temperature may also cause hydrino hydride compounds to volatilize from the cathode to increase the power of the hydrogen catalysis reaction.

In an embodiment, the synthesis of the metal hydride films is enhanced by lining the reactor with a dielectric such as quartz and maintaining a plasma with a catalyst gas such as neon, argon, or helium with hydrogen. The hydrino metal hydride can be peeled from the liner such as a quartz liner. The reaction must be run at high temperature in order to achieve a sufficient metal reactant vapor pressure such as in the range of about 300° C. to 1000° C. and preferably in the range of about 400° C. to 600° C. in order to achieve a sufficient iron vapor pressure to form iron hydrino hydride.

1.4 Hydrogen Radio Frequency (RF) Barrier Electrode Discharge Power and Plasma Cell and Reactor

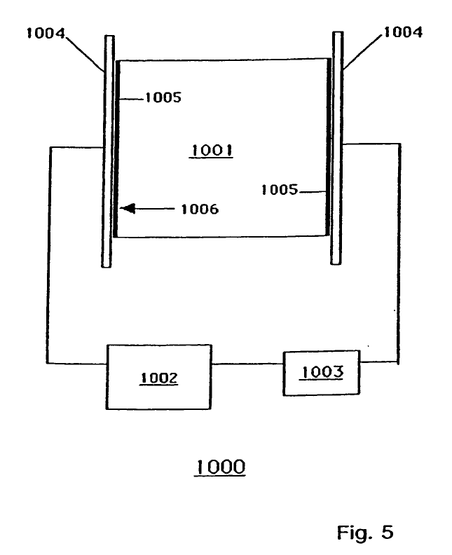

In an embodiment of the hydrogen discharge power and plasma cell and reactor, at least one of the discharge electrodes is shielded by a dielectric barrier such as glass, quartz, Alumina, or ceramic in order to provide an electric field with minimum power dissipation. A radio frequency (RF) barrier electrode discharge cell system 1000 of the present invention is shown in FIG. 5. The RF power may be capacitively coupled. In an embodiment, the electrodes 1004 may be external to the cell 1001. A dielectric layer 1005 separates the electrodes from the cell wall 1006. The high driving voltage may be AC and may be high frequency. The driving circuit comprises a high voltage power source 1002 which is capable of providing RF and an impedance matching circuit 1003. The frequency is preferably in the range of about 100 Hz to about 10 GHz, more preferably, about 1 kHz to about 1 MHz, most preferably about 5-10 kHz. The voltage is preferably in the range of about 100 V to about 1 MV, more preferably about 1 kV to about 100 kV, and most preferably about 5 to about 10 kV.

1.5 Hydrogen Plasma Torch Power and Plasma Cell and Reactor

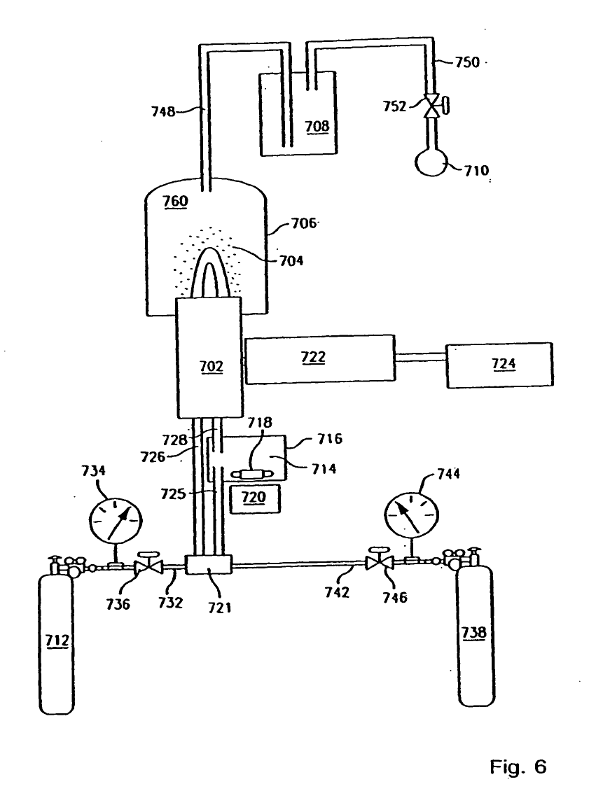

A hydrogen plasma torch power and plasma cell and reactor of the present invention is shown in FIG. 6. A plasma torch 702 provides a hydrogen isotope plasma 704 enclosed by a manifold 706 and contained in plasma chamber 760. Hydrogen from hydrogen supply 738 and plasma gas from plasma gas supply 712, along with a catalyst 714 for forming hydrinos and energy, is supplied to torch 702. The plasma may comprise argon, for example. The catalyst may comprise at least one of those given in TABLES 1 and 3 or a hydrino atom to provide a disproportionation reaction. The catalyst is contained in a catalyst reservoir 716. The reservoir is equipped with a mechanical agitator, such as a magnetic stirring bar 718 driven by magnetic stirring bar motor 720. The catalyst is supplied to plasma torch 702 through passage 728. The catalyst may be generated by a microwave discharge. Preferred catalysts are He⁺ or Ar⁺ from a source such as helium gas or argon gas.

Hydrogen is supplied to the torch 702 by a hydrogen passage 726. Alternatively, both hydrogen and catalyst may be supplied through passage 728. The plasma gas is supplied to the torch by a plasma gas passage 726. Alternatively, both plasma gas and catalyst may be supplied through passage 728.

Hydrogen flows from hydrogen supply 738 to a catalyst reservoir 716 via passage 742. The flow of hydrogen is controlled by hydrogen flow controller 744 and valve 746. Plasma gas flows from the plasma gas supply 712 via passage 732. The flow of plasma gas is controlled by plasma gas flow controller 734 and valve 736. A mixture of plasma gas and hydrogen is supplied to the torch via passage 726 and to the catalyst reservoir 716 via passage 725. The mixture is controlled by hydrogen-plasma-gas mixer and mixture flow regulator 721. The hydrogen and plasma gas mixture serves as a carrier gas for catalyst particles which are dispersed into the gas stream as fine particles by mechanical agitation. The aerosolized catalyst and hydrogen gas of the mixture flow into the plasma torch 702 and become gaseous hydrogen atoms and vaporized catalyst ions (such as Rb⁺ ions from a salt of rubidium) in the plasma 704. The plasma is powered by a microwave generator 724 wherein the microwaves are tuned by a tunable microwave cavity 722. Catalysis may occur in the gas phase.

The amount of gaseous catalyst in the plasma torch can be controlled by controlling the rate at which the catalyst is aerosolized with a mechanical agitator. The amount of gaseous catalyst can also be controlled by controlling the carrier gas flow rate where the carrier gas includes a hydrogen and plasma gas mixture (e.g., hydrogen and argon). The amount of gaseous hydrogen atoms to the plasma torch can be controlled by controlling the hydrogen flow rate and the ratio of hydrogen to plasma gas in the mixture. The hydrogen flow rate and the plasma gas flow rate to the hydrogen-plasma-gas mixer and mixture flow regulator 721 can be controlled by flow rate controllers 734 and 744, and by valves 736 and 746. Mixer regulator 721 controls the hydrogen-plasma mixture to the torch and the catalyst reservoir. The catalysis rate can also be controlled by controlling the temperature of the plasma with microwave generator 724.

Hydrino atoms, dihydrino molecular ions, dihydrino molecules, and hydrino hydride ions are produced in the plasma 704. Dihydrino molecules and hydrino hydride compounds may be cryopumped onto the manifold 706, or they may flow into a trap 708 such as a cryotrap through passage 748. Trap 708 communicates with vacuum pump 710 through vacuum line 750 and valve 752. A flow to the trap 708 is effected by a pressure gradient controlled by the vacuum pump 710, vacuum line 750, and vacuum valve 752.

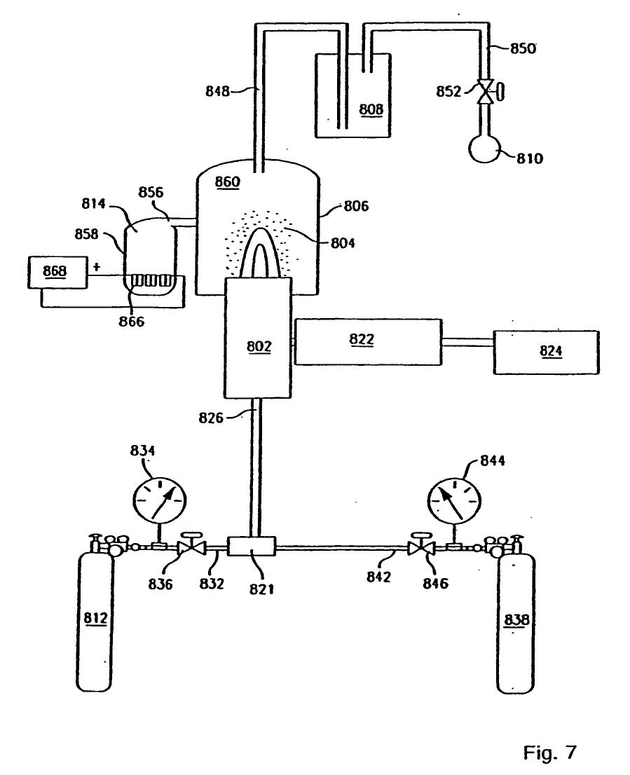

In another embodiment of the plasma torch hydrogen reactor shown in FIG. 7, at least one of plasma torch 802 or manifold 806 has a catalyst supply passage 856 for passage of the gaseous catalyst from a catalyst reservoir 858 to the plasma 804. The catalyst 814 in the catalyst reservoir 858 is heated by a catalyst reservoir heater 866 having a power supply 868 to provide the gaseous catalyst to the plasma 804. The catalyst vapor pressure can be controlled by controlling the temperature of the catalyst reservoir 858 by adjusting the heater 866 with its power supply 868. The remaining elements of FIG. 7 have the same structure and function of the corresponding elements of FIG. 6. In other words, element 812 of FIG. 7 is a plasma gas supply corresponding to the plasma gas supply 712 of FIG. 6, element 838 of FIG. 7 is a hydrogen supply corresponding to hydrogen supply 738 of FIG. 6, and so forth.

In another embodiment of the plasma torch hydrogen reactor, a chemically resistant open container such as a ceramic boat located inside the manifold contains the catalyst. The plasma torch manifold forms a cell which can be operated at an elevated temperature such that, the catalyst in the boat is sublimed, boiled, or volatilized into the gas phase. Alternatively, the catalyst in the catalyst boat can be heated with a boat beater having a power supply to provide the gaseous catalyst to the plasma. The catalyst vapor pressure can be controlled by controlling the temperature of the cell with a cell heater, or by controlling the temperature of the boat by adjusting the boat heater with an associated power supply.

The plasma temperature in the plasma torch hydrogen reactor is advantageously maintained in the range of about 5,000-30,000° C. The cell may be operated at room temperature by continuously supplying catalyst. Alternatively, to prevent the catalyst from condensing in the cell, the cell temperature can be maintained above that of the catalyst source, catalyst reservoir 855 or catalyst boat. The operating temperature depends, in part, on the nature of the material comprising the cell. The temperature for a stainless steel alloy cell is preferably about 0-1200° C. The temperature for a molybdenum cell is preferably about 0-1800° C. The temperature for a tungsten cell is preferably about 0-3000° C. The temperature for a glass, quartz, or ceramic cell is preferably about 0-1800° C. Where the manifold 706 is open to the atmosphere, the cell pressure is atmospheric.

An exemplary plasma gas for the plasma torch hydrogen reactor is argon which may also serve as a source of catalyst. Exemplary aerosol flow rates are about 0.8 standard liters per minute (slm) hydrogen and about 0.15 slm argon. An exemplary argon plasma flow rate is about 5 slm. An exemplary forward input power is about 1000 W, and an exemplary reflected power is about 10-20 W.

In other embodiments of the plasma torch hydrogen reactor, the mechanical catalyst agitator (magnetic stirring bar 718 and magnetic stirring bar motor 720) is replaced with an aspirator, atomizer, or nebulizer to form an aerosol of the catalyst 714 dissolved or suspended in a liquid medium such as water. The medium is contained in the catalyst reservoir 716. Or, the aspirator, atomizer, ultrasonic dispersion means, or nebulizer injects the catalyst directly into the plasma 704. The nebulized or atomized catalyst can be carried into the plasma 704 by a carrier gas, such as hydrogen.

The hydrogen plasma torch cell further includes an electron source in contact with the hydrinos, for generating hydrino hydride ions. In the plasma torch cell, the hydrinos can be reduced to hydrino hydride ions by contacting a reductant extraneous to the operation of the cell (e.g. a consumable reductant added to the cell from an outside source). Compounds comprising a hydrino hydride anion and a cation may be formed in the cell. The cation which forms the hydrino hydride compound may comprise a cation of other element, an oxidized species such as a reductant, or a cation present in the plasma (such as a cation of the catalyst).

### 2. Hydrogen RF and Microwave Power and Plasma Cell and Reactor

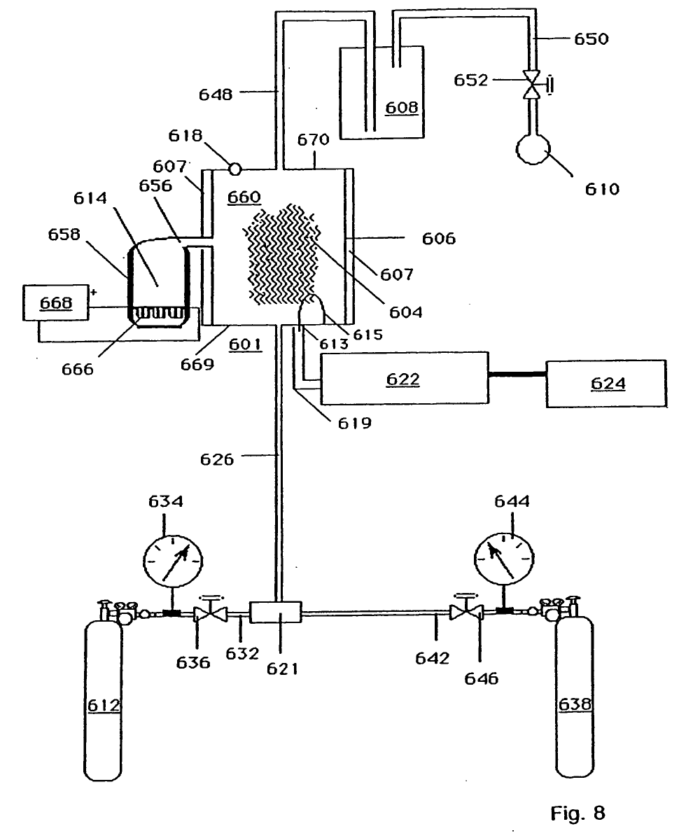

According to an embodiment of the invention, a reactor for producing power, plasma, and at least one of hydrinos, hydrino hydride ions, dihydrino molecular ions, and dihydrino molecules may take the form of a hydrogen microwave reactor. A hydrogen microwave gas cell reactor of the present invention is shown in FIG. 8. Hydrinos are provided by a reaction with a catalyst capable of providing a net enthalpy of reaction of m/2 27.2±0.5 eV where iii is an integer, preferably an integer less than 400 such as those given in TABLES 1 and 3 and/or by a disproportionation reaction wherein lower-energy hydrogen, hydrinos, serve to cause transitions of hydrogen atoms and hydrinos to lower-energy levels with the release of power. Catalysis may occur in the gas phase. The catalyst may be generated by a microwave discharge. Preferred catalysts are He⁺ or Ar⁺ from a source such as helium gas or argon gas. The catalysis reaction may provide power to form and maintain a plasma that comprises energetic ions. Microwaves that may or may not be phase bunched may be generated by ionized electrons in a magnetic field; thus, the magnetized plasma of the cell comprises an internal microwave generator. The generated microwaves may then be the source of microwaves to at least partially maintain the microwave discharge plasma.

The reactor system of FIG. 8 comprises a reaction vessel 601 having a chamber 660 capable of containing a vacuum or pressures greater than atmospheric. A source of hydrogen 638 delivers hydrogen to supply tube 642, and hydrogen flows to the chamber through hydrogen supply passage 626. The flow of hydrogen can be controlled by hydrogen flow controller 644 and valve 646. In an embodiment, a source of hydrogen communicating with chamber 660 that delivers hydrogen to the chamber through hydrogen supply passage 626 is a hydrogen permeable hollow cathode of an electrolysis cell of the reactor system. Electrolysis of water produces hydrogen that permeates through the hollow cathode. The cathode may be a transition metal such as nickel, iron, or titanium, or a noble metal such as palladium, or platinum, or tantalum or palladium coated tantalum, or palladium coated niobium. The electrolyte may be basic and the anode may be nickel, platinum, or a dimensionally stable anode. The electrolyte may be aqueous K₂CO₃. The flow of hydrogen into the cell may be controlled by controlling the electrolysis current with an electrolysis power controller.

Plasma gas flows from the plasma gas supply 612 via passage 632. The flow of plasma gas can be controlled by plasma gas flow controller 634 and valve 636. A mixture of plasma gas and hydrogen can be supplied to the cell via passage 626. The mixture is controlled by hydrogen-plasma-gas mixer and mixture flow regulator 621. The plasma gas such as helium may be a source of catalyst such as He⁺ or He₂*, argon may be a source of catalyst such as Ar⁺, neon may serve as a source of catalyst such as Ne₂* or Ne⁺, and neon-hydrogen mixture may serve as a source of catalyst such as Ne⁺/H⁺. The source of catalyst and hydrogen of the mixture flow into the plasma and become catalyst and atomic hydrogen in the chamber 660.

The plasma may be powered by a microwave generator 624 wherein the microwaves are tuned by a tunable microwave cavity 622, carried by waveguide 619, and can be delivered to the chamber 660 though an RF transparent window 613 or antenna 615. Sources of microwaves known in the art are traveling wave tubes, klystrons, magnetrons, cyclotron resonance masers, gyrotrons, and free electron lasers. The waveguide or antenna may be inside or outside of the cell. In the latter case, the microwaves may penetrate the cell from the source through a window of the cell 613. The microwave window may comprise Alumina or quartz.

In another embodiment, the cell 601 is a microwave resonator cavity. In an embodiment, the source of microwave supplies sufficient microwave power density to the cell to ionize a source of catalyst such as at least one of helium, neon-hydrogen mixture, and argon gases to form a catalyst such as He⁺, Ne⁺, and Ar⁺, respectively. In such an embodiment, the microwave power source or applicator such as an antenna, waveguide, or cavity forms a nonthermal plasma wherein the species corresponding to the source of catalyst such as helium or argon atoms and ions have a higher temperature than that at thermal equilibrium. Thus, higher energy states such as ionized states of the source of catalyst are predominant over that of hydrogen compared to a corresponding thermal plasma wherein excited states of hydrogen are predominant. In an embodiment, the source of catalyst is in excess compared to the source of hydrogen atoms such that the formation of a nonthermal plasma is favored. The power supplied by the source of microwave power may be delivered to the cell such that it is dissipated in the formation of energetic electrons within about the electron mean free path. In an embodiment, the total pressure is about 0.5 to about 5 Torr and the mean electron free path is about 0.1 cm to 1 cm. In an embodiment, the dimensions of the cell are greater than the electron mean free path. In an embodiment, the cavity is at least one of the group of a reentrant cavity such as an Evenson cavity, Beenakker, McCarrol, and cylindrical cavity. In an embodiment, the cavity provides a strong electromagnetic field which may form a nonthermal plasma. The strong electromagnetic field may be due to a TM₀₁₀ mode of a cavity such as a Beenakker cavity. In a preferred embodiment, the cavity provides an E mode rather than an M mode. In a preferred embodiment, the cavity is a reentrant cavity such as an Evenson cavity that forms a plasma with an E mode. Multiple sources of microwave power may be used simultaneously. For example, the microwave plasma such as a nonthermal plasma may be maintained by multiple Evenson cavities operated in parallel to form the plasma in the microwave cell 601. The cell may be cylindrical and may comprise a quartz cell with Evenson cavities spaced along the longitudinal axis. In another embodiment, a multi slotted antenna such as a planar antenna serves as the equivalent of multiple sources of microwaves such as dipole-antenna-equivalent sources. One such embodiment is given in Y. Yasaka, D. Nozaki, M. Ando, T. Yamamoto, N. Goto, N. Ishii, T. Morimoto, “Production of large-diameter plasma using multi-slotted planar antenna,” Plasma Sources Sci. Technol., Vol. 8, (1999), pp. 530-533 which is incorporated herein by reference in its entirety.

In an embodiment, of the hydrogen microwave power and plasma cell and reactor, the output power is optimized by using a cavity such as a reentrant cavity such as an Evenson cavity and tuning the cell to an optimal voltage staging wave. In an embodiment, the reflected versus input power is tuned such that a desired voltage standing wave is obtained which optimizes or controls the output power. Typically, the ratio of the maximum voltage to the minimum voltage on the transmission line determines the voltage standing wave. In another embodiment, the cell comprises a tunable microwave cavity having a desired voltage standing wave to optimize and control the output power.

The cell may further comprise a magnet such a solenoidal magnet 607 to provide an axial magnetic field. The ions such as electrons formed by the hydrogen catalysis reaction produce microwaves to at least partially maintain the microwave discharge plasma. The microwave frequency may be selected to efficiently form atomic hydrogen from molecular hydrogen. It may also effectively form ions that serve as catalysts from a source of catalyst such as He⁺, Ne⁺, Ne⁺/H⁺, or Ar⁺ catalysts from helium, neon, neon-hydrogen mixtures, and argon gases, respectively.

The microwave frequency is preferably in the range of about 1 MHz to about 100 GHz, more preferably in the range about 50 MHz to about 10 GHz, most preferably in the range of about 75 MHz±50 MHz or about 2.4 GHz±1 GHz.

A hydrogen dissociator may be located at the wall of the reactor to increase the atomic hydrogen concentrate in the cell. The reactor may further comprise a magnetic field wherein the magnetic field may be used to provide magnetic confinement to increase the electron and ion energy to be converted into power by means such as a magnetohydrodynamic or plasmadynamic power converter.

A vacuum pump 610 may be used to evacuate the chamber 660 through vacuum lines 648 and 650. The cell may be operated under flow conditions with the hydrogen and the catalyst supplied continuously from catalyst source 612 and hydrogen source 638. The amount of gaseous catalyst may be controlled by controlling the plasma gas flow rate where the plasma gas includes a hydrogen and a source of catalyst (e.g., hydrogen and argon or helium). The amount of gaseous hydrogen atoms to the plasma may be controlled by controlling the hydrogen flow rate and the ratio of hydrogen to plasma gas in the mixture. The hydrogen flow rate and the plasma gas flow rate to the hydrogen-plasma-gas mixer and mixture flow regulator 621 are controlled by flow rate controllers 634 and 644, and by valves 636 and 646. Mixer regulator 621 controls the hydrogen-plasma mixture to the chamber 660. The catalysis rate is also controlled by controlling the temperature of the plasma with microwave generator 624.

Catalysis may occur in the gas phase. Hydrino atoms, dihydrino molecular ions, dihydrino molecules, and hydrino hydride ions are produced in the plasma 604. Dihydrino molecules and hydrino hydride compounds may be cryopumped onto the wall 606, or they may flow into a 608 such as a cryotrap through passage 648. Trap 608 communicates with vacuum pump 610 through vacuum line 650 and valve 652. A flow to the trap 608 can be effected by a pressure gradient controlled by the vacuum pump 610, vacuum line 650, and vacuum valve 652.

In another embodiment of the hydrogen microwave reactor shown in FIG. 8, the wall 606 has a catalyst supply passage 656 for passage of the gaseous catalyst from a catalyst reservoir 658 to the plasma 604. The catalyst in the catalyst reservoir 658 can be heated by a catalyst reservoir heater 666 having a power supply 668 to provide the gaseous catalyst to the plasma 604. The catalyst vapor pressure can be controlled by controlling the temperature of the catalyst reservoir 658 by adjusting the heater 666 with its power supply 668. The catalyst in the gas phase may comprise those given in TABLES 1 and 3, hydrinos, and those described in the Mills Prior Publication.

In another embodiment of the hydrogen microwave reactor, a chemically resistant open container such as a ceramic boat located inside the chamber 660 contains the catalyst. The reactor further comprises a heater that may maintain an elevated temperature. The cell can be operated at an elevated temperature such that the catalyst in the boat is sublimed, boiled, or volatilized into the gas phase. Alternatively, the catalyst in the catalyst boat can be heated with a boat heater having a power supply to provide the gaseous catalyst to the plasma. The catalyst vapor pressure can be controlled by controlling the temperature of the cell with a cell heater, or by controlling the temperature of the boat by adjusting the boat heater with an associated power supply.

In an embodiment, the hydrogen microwave reactor further comprises a structure interact with the microwaves to cause localized regions of high electric and/or magnetic field strength. A high magnetic field may cause electrical breakdown of the gases in the plasma chamber 660. The electric field may form a nonthermal plasma that increases the rate of catalysis by methods such as the formation of the catalyst from a source of catalyst. The source of catalyst may be argon, neon-hydrogen mixture, helium to form He⁺, Ne⁺, and Ar⁺ respectively. The structures and methods are simialar to those given in the Plasma Torch Cell Hydride Reactor section of my previous published PCT/US02/06945.

The nonthermal plasma temperature corresponding to the energetic ion and/or electron temperature as opposed to the relatively low energy thermal neutral gas temperature in the microwave cell reactor is advantageously maintained in the range of about 5,000-5,000,000° C. The cell may be operated without heating or insulation. Alternatively, in the case that the catalyst has a low volatility, the cell temperature is maintained above that of the catalyst source, catalyst reservoir 658 or catalyst boat to prevent the catalyst from condensing in the cell. The operating temperature depends, in part, on the nature of the material comprising the cell. The temperature for a stainless steel alloy cell is preferably about 0-1200° C. The temperature for a molybdenum cell is preferably about 0-1800° C. The temperature for a tungsten cell is preferably about 0-3000° C. The temperature for a glass, quartz, or ceramic cell is preferably about 0-1800° C.

The molecular and atomic hydrogen partial pressures in the chamber 660, as well as the catalyst partial pressure, is preferably maintained in the range of about 1 mtorr to about 100 atm. Preferably the pressure is in the range of about 100 mtorr to about 1 atm, more preferably the pressure is about 100 mtorr to about 20 torr.

An exemplary plasma gas for the hydrogen microwave reactor is argon. Exemplary flow rates are about 0.1 standard liters per minute (slm) hydrogen and about 1 slm argon. An exemplary forward microwave input power is about 1000 W. The flow rate of the plasma gas or hydrogen-plasma gas mixture such as at least one gas selected for the group of hydrogen, argon, helium, argon-hydrogen mixture, helium-hydrogen mixture, water vapor, ammonia is preferably about 0-1 standard liters per minute per cm³ of vessel volume and more preferably about 0.001-10 sccm per cm³ of vessel volume. In the case of an helium-hydrogen, neon-hydrogen, or argon-hydrogen mixture, preferably helium, neon, or argon is in the range of about 99 to about 1%, more preferably about 99 to about 95%. The power density of the source of plasma power is preferably in the range of about 0.01 W to about 100 W/cm³ vessel volume.

In other embodiments of the microwave reactor, the catalyst may be agitated and supplied through a flowing gas stream such as the hydrogen gas or plasma gas which may be an additional source of catalyst such as helium or argon gas. The source of catalyst may also be provided by an aspirator, atomizer, or nebulizer to form an aerosol of the source of catalyst. The catalyst which may become an aerosol may be dissolved or suspended in a liquid medium such as water. The medium may be contained in the catalyst reservoir 614. Alternatively, the aspirator, atomizer, or nebulizer may inject the source of catalyst or catalyst directly into the plasma 604. In another embodiment, the nebulized or atomized catalyst may be carried into the plasma 604 by a carrier gas, such as hydrogen, helium, neon, or argon where the helium, neon-hydrogen, or argon may be ionized to He⁺, Ne⁺, or Ar⁺, respectively, and serve as hydrogen catalysts.

Hydrogen may serve as the catalyst according to Eqs. (30-32). In an embodiment the catalysis of atomic hydrogen to form increased-binding-energy-hydrogen species is achieved with a hydrogen plasma. The cavity may be reentrant cavity such as an Evenson cavity. The hydrogen pressure may be in the range of about 1 mtorr to about 100 atm. Preferably the pressure is in the range of about 100 mtorr to about 1 atm, more preferably the pressure is about 100 mtorr to about 10 torr. The microwave power density may be in the range of about 0.01 W to about 100 W/cm³ vessel volume. The hydrogen flow rate may be in the range of about 0-1 standard liters per minute per cm³ of vessel volume and more preferably about 0.001-10 sccm per cm³ of vessel volume.

The microwave cell may be interfaced with any of the converters of plasma or thermal energy to mechanical or electrical power described herein such as the magnetic mirror magnetohydrodynamic power converter, plasmadynamic power converter, or heat engine, such as a steam or gas turbine system, sterling engine, or thermionic or thermoelectric converter given in Mills Prior Publications. In addition it may be interfaced with the gyrotron, photon bunching microwave power converter, charge drift power, or photoelectric converter as disclosed in Mills Prior Publications.

The hydrogen microwave reactor further includes an electron source in contact with the hydrinos, for generating hydrino hydride ions. In the cell, the hydrinos may be reduced to hydrino hydride ions by contacting a reductant extraneous to the operation of the cell (e.g. a consumable reductant added to the cell from an outside source). In an embodiment, the microwave cell reactor further comprise a selective valve 618 for removal of lower-energy hydrogen products such as dihydrino molecules. Compounds comprising a hydrino hydride anion and a cation may be formed in the gas cell. The cation which forms the hydrino hydride compound may comprise a cation of other element, a cation of an oxidized added reductant, or a cation present in the plasma (such as a cation of the catalyst).

Metal hydrino hydrides may be formed in the microwave plasma reactor having a hydrogen plasma and a source of metal such as a source of the metals given in TABLE 3 that serve as both the catalyst and the reactant. The metal atoms may be provided by vaporization through heating. In one embodiment, the metal is vaporized from a hot filament containing the metal. The vapor pressure of the metal is maintained in the range 0.001 Torr to 100 Torr and the hydrogen plasma is maintained in the range 0.001 Torr to 100 Torr. Preferably the range for both metal and hydrogen is 0.1 Torr to 10 Torr.

### 3. Hydrogen Capacitively and Inductively Coupled RF Plasma and Power Cell and Reactor

According to an embodiment of the invention, a reactor for producing power and at least one of hydrinos, hydrino hydride ions, dihydrino molecular ions, and dihydrino molecules may take the form of a hydrogen capacitively or inductively coupled RF power and plasma cell and reactor. A hydrogen RF plasma reactor of the present invention is also shown in FIG. 8. The cell structures, systems, catalysts, and methods may be the same as those given for the microwave plasma cell reactor except that the microwave source may be replaced by a RF source 624 with an impedance matching network 622 that may drive at least one electrode and/or a coil. The RF plasma cell may further comprise two electrodes 669 and 670. The coaxial cable 619 may connect to the electrode 669 by coaxial center conductor 615. Alternatively, the coaxial center conductor 615 may connect to an external source coil which is wrapped around the cell 601 which may terminate without a connection to ground or it may connect to ground. The electrode 670 may be connected to ground in the case of the parallel plate or external coil embodiments. The parallel electrode cell may be according to the industry standard, the Gaseous Electronics Conference (GEC) Reference Cell or modification thereof by those skilled in the art as described in G A. Hebner, K. E. Greenberg, “Optical diagnostics in the Gaseous electronics Conference Reference Cell, J. Res. Natl. Inst. Stand. Technol., Vol. 100, (1995), pp. 373-383; V. S. Gathen, J. Ropcke, T. Gans, M. Kaning, C. Lukas, H. F. Dobele, “Diagnostic studies of species concentrations in a capacitively coupled RF plasma containing CH₄—H₂— Ar,” Plasma Sources Sci. Technol., Vol. 10, (2001), pp. 530-539; P. J. Hargis, et al., Rev. Sci. Instrum., Vol. 65, (1994), p. 140; Ph. Belenguer, L. C. Pitchford, J. C. Hubinois, “Electrical characteristics of a RF-GD-OES cell,” J. Anal. At. Spectrom., Vol. 16, (2001), pp. 1-3 which are herein incorporated by reference in their entirety.

The cell which comprises an external source coil such as a 13.56 MHz external source coil microwave plasma source is as given in D. Barton, J. W. Bradley, D. A. Steele, and R. D. Short, “investigating radio frequency plasmas used for the modification of polymer surfaces,” J. Phys. Chem. B, Vol. 103, (1999), pp. 4423-4430; D. T. Clark, A. J. Dilks, J. Polym. Sci. Polym. Chem. Ed., Vol. 15, (1977), p. 2321; B. D. Beake, J. S. G. Ling, G. J. Leggett, J. Mater. Chem., Vol. 8, (1998), p. 1735; R. M. France, R. D. Short, Faraday Trans. Vol. 93, No. 3, (1997), p. 3173, and R. M. France, R. D. Short, Langmuir, Vol. 14, No. 17, (1998), p. 4827 which are herein incorporated by reference in their entirety. At least one wall of the cell 601 wrapped with the external coil is at least partially transparent to the RF excitation. The RF frequency is preferably in the range of about 100 Hz to about 100 GHz, more preferably in the range about 1 kHz to about 100 MHz, most preferably in the range of about 13.56 MHz±50 MHz or about 2.4 GHz±1 GHz.

In another embodiment, an inductively coupled plasma source is a toroidal plasma system such as the Astron system of Astex Corporation described in U.S. Pat. No. 6,150,628 which is herein incorporated by reference in its entirety. In an embodiment, the field strength is high to cause a nonthermal plasma. The toroidal plasma system may comprise a primary of a transformer circuit. The primary may be driven by a radio frequency power supply. The plasma may be a closed loop which acts at as a secondary of the transformer circuit. The RF frequency is preferably in the range of about 100 Hz to about 100 GHz, more preferably in the range about 1 kHz to about 100 MHz, most preferably in the range of about 13.56 MHz±50 MHz or about 2.4 GHz±1 GHz.

In an embodiment, the plasma cell is driven by at least one of a traveling and a standing wave plasma generators such as given in Fossa [A. C. Fossa, M. Moisan, M. R. Wertheimer, “vacuum ultraviolet to visible emission from hydrogen plasma: effect of excitation frequency”, Journal of Applied Physics, Vol. 88, No. 1, (2000), pp. 20-33 which is herein incorporated by reference in its entirety].

In another embodiment, the frequency of the cell is 50 kHz and is driven by a radio frequency generator such as that given by Bzenic et. al. [S. A. Bzenic, S. B. Radovanov, S. B. Vrhovac, Z. B. Velikic, and B. M. Jelenkovic, “On the mechanism of Doppler broadening of H_{β} after dissociative excitation in hydrogen glow discharges”, Chem. Phys. Lett., Vol. 184, (1991), pp. 108-112 which is herein incorporate by reference in its entirety].

In another embodiment of the plasma cell for the production of power and lower-energy-hydrogen compounds, the cell comprises a helicon as described in Asian Particle Accelerator Conference (APAC98), March 26th—Poster Presentation 6D-061, Development of DC Accelerator Ion Sources using Helicon Plasmas p. 825, G. S. Eom, I. S. Hong, Y. S. Hwang, KAIST, Taejon, <http://accelconf.web.cern.ch/AccelConf/a98/APAC98/6D061.PDF>http://accelconf.web.cern. ch/AccelConf/a98/APAC98/6D061.PDFG which is herein incorporated by reference in its entirety.

### 4. Plasma Confinement by Spatially Controlling Catalysis

The plasma formed by the catalysis of hydrogen may be confined to a desired region of the reactor by structures and methods such as those that control the source of catalyst, the source of atomic hydrogen, or the source of an electric or magnetic field which alters the catalysis rate as given in the Adjustment of Catalysis Rate section. In an embodiment, the reactor comprises two electrodes, which provide an electric field to control the catalysis rate of atomic hydrogen. The electrodes may produce an electric field parallel to the z-axis. The electrodes may be grids oriented in a plane perpendicular to the z-axis such as grid electrodes 305 and 320 shown in FIG. 4. The space between the electrodes may define the desired region of the reactor. The electrodes may be used in any or the other reactor of the present invention to catalyze atomic hydrogen to lower-energy states such as a plasma electrolysis reactor, barrier electrode reactor, RF plasma reactor, pressurized gas energy reactor, gas discharge energy reactor, microwave cell energy reactor, and a combination of a glow discharge cell and a microwave and or RF plasma reactor.

In another embodiment, a magnetic field may confine a charged catalyst such as Ar⁺ to a desired region to selectively form a plasma as described in the Noble Gas Catalysts and Products section. In an embodiment of the cell, the reaction is maintained in a magnetic field such as a solenoidal or minimum magnetic (minimum B) field such that a second catalyst such as Ar⁺ is trapped and acquires a longer half-life. The second catalyst may be generated by a plasma formed by hydrogen catalysis using a first catalyst. By confining the plasma, the ions such as the electrons become more energetic, which increases the amount of second catalyst such as Ar⁺. The confinement also increases the energy of the plasma to create more atomic hydrogen.

In another embodiment, a hot filament which dissociates molecular hydrogen to atomic hydrogen and which may also provide an electric field that controls the rate of catalysis may be used to define the desired region in the cell. The plasma may form substantially in the region surrounding the filament wherein at least one of the atomic hydrogen concentration, the catalyst concentration, and the electric field provides a much faster rate of catalysis there than in any undesired region of the reactor.

In another embodiment, the source of atomic hydrogen such as the source of molecular hydrogen or a hydrogen dissociator may be used to determine the desired region of the reactor by providing atomic hydrogen selectively in the desired region.

In an another embodiment, the source of catalyst may determine the desired region of the reactor by providing catalyst selectively in the desired region.

In an embodiment of a microwave power cell, the plasma may be maintained in a desire region by selectively providing microwave energy to that region with at least one antenna 615 or waveguide 619 and RF window 613 shown in FIG. 8. The cell may comprise a microwave cavity which causes the plasma to be localized to the desired region.

### 5. Hydrogen Multicusp Power and Plasma Cell and Reactor

In an embodiment, the power and plasma cell and reactor comprises a filament, a vacuum vessel capable of pressures above and below atmospheric, a source of atomic hydrogen, a source of catalyst to catalyze atomic hydrogen to a lower-energy state given by Eq. (1), a means to negatively bias the walls of the cell relative to the filament, and magnets to confine a plasma generated in the cell which is formed or enhanced by the catalysis reaction (rt-plasma). In an embodiment, the reactor is described in M. Pealat, J. P. E. Taran, M. Bacal, F. Hillion, J. Chem. Phys., Vol. 82, (1985), p. 45943-4953 and J. Perrin, J. P. M. Schmnitt, Chem. Phys. Letts., Vol. 112, (1984), pp. 69-74 which are herein incorporated by reference in their entirety. In this case, in addition, the cell further comprises a source of catalyst to catalyze atomic hydrogen to a lower-energy state given by Eq. (1). An embodiment of the multicusp cell is shown in FIG. 3 wherein the walls are negative biased by a power supply, and magnets such as permanent magnets that enclose the cell to confine the plasma generated inside the cell 200.

### 6. Hydrogen Laser

Another objective of the present invention is to create an inverted population of an energy level of a species such as an atom, molecule, or ion capable of lasing. The inverted population forms due to catalysis of atomic hydrogen to lower-energy states. The present invention further comprises a laser wherein the catalysis cell serves as the laser cavity, and an inverted population is formed due to hydrogen catalysis to lower energy states given by Eq. (1).

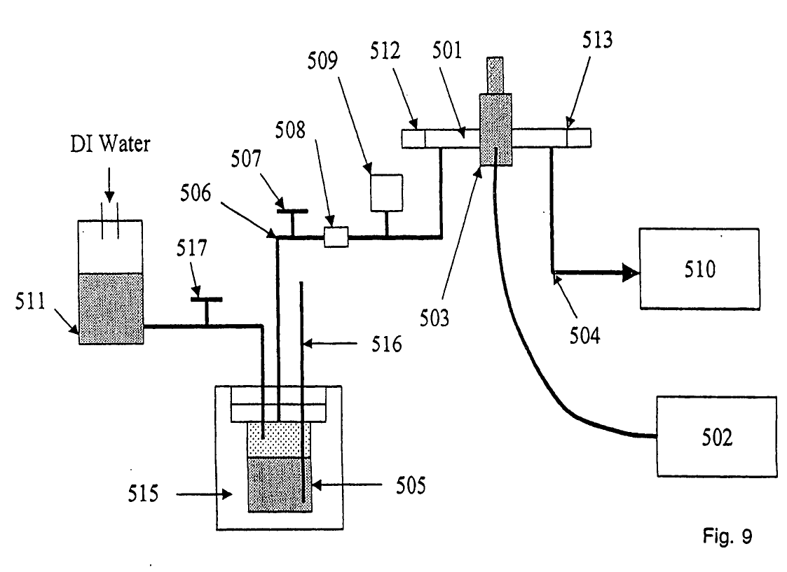

An embodiment of the hydrogen laser of the present invention comprises a reactor of the present invention to catalyze atomic hydrogen to lower-energy states such as an rt-plasma cell and a plasma electrolysis reactor, a barrier electrode reactor, an RF plasma reactor, a pressurized gas energy reactor, a gas discharge energy reactor, a microwave cell energy reactor, and a combination of a glow discharge cell and a microwave and or RF plasma reactor. An embodiment of a water plasma laser shown in FIG. 9 comprises a cavity that is a reactor such as a quartz tube 501 and means to maintain a water vapor plasma in the cavity such a microwave generator 502, and a microwave cavity 503. The microwave cavity preferably maintains an E mode such as an Evenson cavity which is a reentrant cavity. The source of water vapor may be water from a supply of deionized water such as a water reservoir 511 with a valved connection 517 to a water vapor generator 505 which may comprise a vessel with thermal insulation and a heater 515 and a temperature measurement device such as a thermocouple 516 with a supply line 506 to the cell 501. The flow may be controlled by a valve 507 and a mass flow controller 508. The pressure may be read with a pressure gauge 509. The water vapor may be flowed through the cell to a vacuum pump 510 through vacuum line 504 which also maintains the pressure in the cell with the valve 507 and mass flow controller 508.

In an embodiment, the water vapor pressure is maintained in the range of about of 0.1 mTorr to 10,000 Torr, preferably the water vapor pressure of the water vapor plasma is in the range of 10 mTorr to 100 Torr; more preferably, the water vapor pressure of the water vapor plasma is in the range of 10 mTorr to 10 Torr, and most preferably, the water vapor pressure of the water vapor plasma is in the range of 10 mTorr to 1 Torr. The water vapor flow rate is preferably about 0-1 standard liters per minute per cm³ of vessel volume and more preferably about 0.001-10 sccm per cm³ of vessel volume. The power density of the source of plasma power is preferably in the range of about 0.01 W to about 100 W/cm³ vessel volume; more preferably it is in the range of about 1 to 10 W/cm³ vessel volume.

In an embodiment, the water vapor may also be supplied by flowing hydrogen and oxygen into the cell which forms water vapor. The mole fraction of hydrogen and oxygen may be stiochiometric for water. Alternatively, an excess of hydrogen or oxygen may be maintained. Preferably the mole fraction of H₂ or O₂ does not vary from that which is stiochiometric for water by more than about ±99%, preferably it differs by less than ±50%, more preferably it differs by less than ±10%, most preferably it differs by less than ±2%.

An further embodiment of the hydrogen laser of the present invention comprises a reactor of the present invention to catalyze atomic hydrogen to lower-energy states such as an rt-plasma cell and a plasma electrolysis reactor, a barrier electrode reactor, an RF plasma reactor, a pressurized gas energy reactor, a gas discharge energy reactor, a microwave cell energy reactor, and a combination of a glow discharge cell and a microwave and or RF plasma reactor. Nitrogen may serve as a catalysis, and the energy of the catalysis reaction may form an inverted hydrogen population. An embodiment of an ammonia plasma laser shown in FIG. 9 comprises a cavity that is a reactor such as a quartz tube 501 and means to maintain an ammonia plasma in the cavity such a microwave generator 502, and a microwave cavity 503. The microwave cavity preferably maintains a reentrant cavity such as one with an E mode such as an Evenson cavity. The source of ammonia may be ammonia from a supply such as gaseous source 515 with a supply line 506 to the cell 501. The flow may be controlled by a valve 507 and a mass flow controller 508. The pressure may be read with a pressure gauge 509. The ammonia may be flowed through the cell to a vacuum pump 510 through vacuum line 504 which also maintains the pressure in the cell with the valve 507 and mass flow controller 508.

In an embodiment, the ammonia pressure is maintained in the range of about of 0.1 mTorr to 10,000 Torr, preferably the ammonia pressure of the ammonia plasma is in the range of 10 mTorr to 100 Torr; more preferably, the ammonia pressure of the ammonia plasma is in the range of 10 mTorr to 10 Torr, and most preferably, the ammonia pressure of the ammonia plasma is in the range of 10 mTorr to 1 Torr. The ammonia flow rate is preferably about 0-1 standard liters per minute per cm³ of vessel volume and more preferably about 0.001-10 sccm per cm³ of vessel volume. The power density of the source of plasma power is preferably in the range of about 0.01 W to about 100 W/cm³ vessel volume; more preferably it is in the range of about 1 to 10 W/cm³ vessel volume.

In an embodiment, the ammonia may also be supplied by flowing hydrogen and nitrogen into the cell which forms ammonia. The mole fraction of hydrogen and nitrogen may be stiochiometric for ammonia. Alternatively, an excess of hydrogen or nitrogen may be maintained. Preferably the mole fraction of H₂ or N₂ does not vary from that which is stiochiometric for ammonia by more than about ±99%, preferably it differs by less than ±50%, more preferably it differs by less than ±10%, most preferably it differs by less than ±2%.

An inverted population is formed by the catalysis of atomic hydrogen. In one embodiment, the hydrogen nonradiatively transfers energy to the catalyst, and the remaining energy may be emitted until the next stable electronic state is achieved with energy given by Eq. (1). The energy transfer may yield H(n>2) atoms directly by multipole coupling [R. L. Mills, P. Ray, B. Dhandapani, J. He, “Spectroscopic Identification of Fractional Rydberg States of Atomic Hydrogen Formed by a Catalytic Helium-Hydrogen Plasma Reaction”, Applied Spectroscopy: General, submitted which is herein incorporated by reference in its entirety] and fast H(n=1) atoms. The energy transfer may occur to a third body such as atomic hydrogen or molecular hydrogen to form fast H as reported previously [R. L. Mills, P. Ray, B. Dhandapani, J. He, “Comparison of Excessive Balmer α Line Broadening of Glow Discharge and Microwave Hydrogen Plasmas with Certain Catalysts”, J. of Applied Physics, January, 1, (2003) which is herein incorporated by reference in its entirety]. Then, excited state H may be formed from fast H(n=1) atoms by collisions with the background gas such as H₂. Inversion may be achieved by collisions with heavier gases or gases which provide a resonant excitation by the collision with fast H such as at least one molecule from the list of O₂, H₂O, CO₂) N₂, NO₂, NO, CO, and a halogen gas.

Laser oscillators occur in the cavity 501 which has the appropriate dimensions and mirrors for lasing that is known to those skilled in the art as described in J. J. Ewing. “Excimer Lasers”, Laser Handbook, Edited by M. L. Stitch, North-Holland Publishing Company, Vol. A4, (1979); Laser Handbook, Edited by F. T. Arecchi and E. O. Schulz-Dubois, North-Holland Publishing Company, Amsterdam, 1972-, Vol. 1-6 which are herein incorporated by reference in their entirety. The laser light is contained in the cavity 501 between the mirrors 512 and 513. The mirror 513 may be semitransparent, and the light may exit the cavity through this mirror.

In an embodiment, the laser medium comprises an excimer comprising at least one hydrino atom that is undergoing a transition to a lower-energy state. Hydrogen transitions from continuum excited states may couple to fractional Rydberg transitions of the same multipolarity as broad excimer emission. In an embodiment, the excimer is formed by a helium-hydrogen microwave discharge. For example, the novel emission lines observed at 44.2 nm and 40.5 nm described in R. L. Mills, P. Ray, B. Dhandapani, J. He, “Spectroscopic Identification of Fractional Rydberg States of Atomic Hydrogen Formed by a Catalytic Helium-Hydrogen Plasma Reaction”, Applied Spectroscopy: General, submitted which incorporated by reference in its entirety correspond to energies of

$$q \cdot 13.6 + ( \frac{1}{{n}_{f}^{2}} - \frac{1}{{n}_{i}^{2}} ) X 13.6 eV$$

where q=2 and n_{f}=2, 4 nᵢ=∞ and can be explained by multipole coupling of the transitions to n=¼ and n=½ with the transition from continuum states to n=4 and n=2, respectively, to give two photon emission. This excimer emission is the basis of a laser of the present invention using techniques well known to those skilled in the art as given in J. J. Ewing. “Excimer Lasers”, Laser Handbook, Edited by M. L. Stitch, North-Holland Publishing Company, Vol. A4, (1979); Laser Handbook, Edited by F. T. Arecchi and E. O. Schulz-Dubois, North-Holland Publishing Company, Amsterdam, 1972-, Vol. 1-6 which are herein incorporated by reference in their entirety.

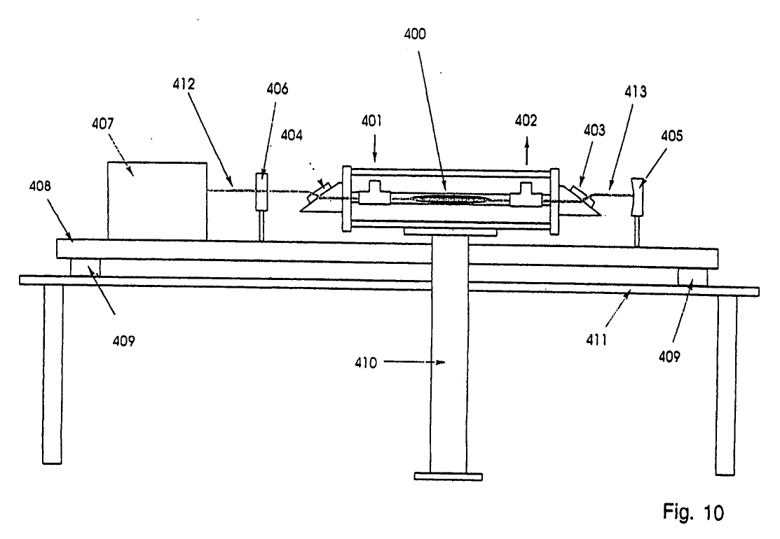

A laser according to the preset invention is shown in FIG. 10. It comprises a plasma of a catalyst and hydrogen and laser optics. The plasma may be maintained in an rt-plasma reactor, a plasma electrolysis reactor, a barrier electrode reactor, an RF plasma reactor, a pressurized gas energy reactor, a gas discharge energy reactor, a microwave cell energy reactor, and a combination of a glow discharge cell and a microwave and or RF plasma reactor. The plasma 400 may be a microwave water vapor plasma (microwave generator and cavity are shown in FIG. 9). The plasma gas containing hydrogen and catalyst such as water vapor may flow through the plasma cell via inlet 401 and outlet 402. The laser beam 412 and 413 is directed to a high reflectivity mirror 405 such as a 95 to 99.9999% reflective spherical cavity mirror and to the output coupler 406 by windows 403 and 404 such as Brewster angle windows. The output coupler may have a transmission in the range 0.1 to 50%, and preferably in the range 1 to 10%. The beam power may be measured by a power meter 407. The laser may mounted on an optical rail 408 on an optical table 411 which allows for adjustments of the cavity length to achieve lasing at a desired wavelength. Vibrations may ameliorated by vibration isolation feet 409. The plasma tube may be supported by a plasma tube support structure 410.

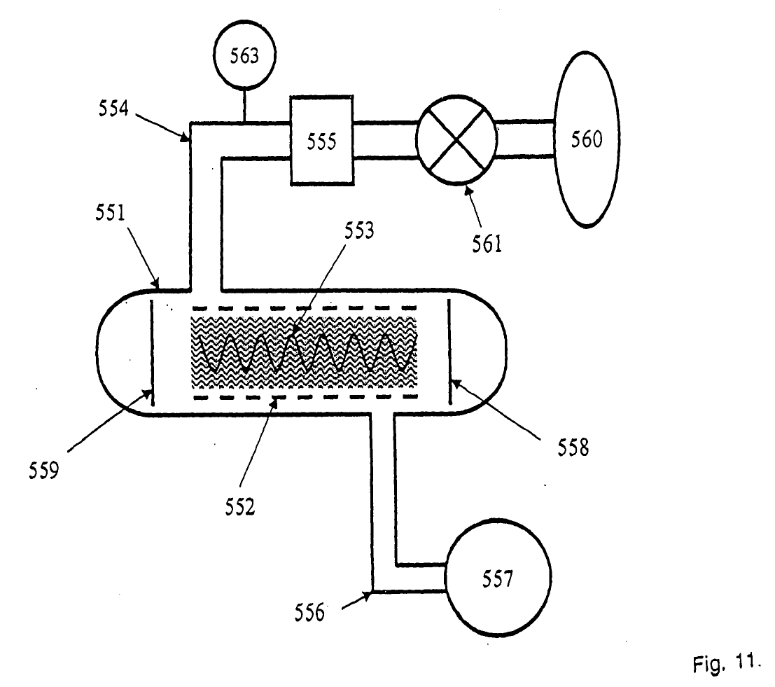

An embodiment of a hydrogen rt-plasma laser shown in FIG. 11 comprises a cavity that is a reactor such as a quartz tube 551 and a source of catalyst such as those given in Tables and 3 that produce a plasma when heated with atomic hydrogen as described in R. Mills, 3. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943 which is herein incorporated by reference in its entirety. A source of catalyst such as at least one of KNO₃ and RbNO₃ may be coated on to a hydrogen dissociator 552 such as a titanium screen. The hydrogen may be dissociated by a hot filament such as a tungsten filament 553 which may heat the hydrogen dissociator 552 as well as heat the catalyst. In an embodiment, the catalyst is vaporized by the heating and reacts with atomic hydrogen to form the resonance transfer or rt-plasma due to hydrogen catalysis. The hydrogen may be flowed through the cell from a source 560 through the inlet 554 controlled by valve 561 and mass flow controller 555. In addition, the gas flow and pressure may be maintained and controlled with pump 557 through cell outlet 556 together with valve 561 and flow controller 555. The pressure may be read with pressure gauge 563. Embodiments of conditions for operation of the rt-plasma laser cell are given in the Gas Power, Plasma, and Hydride Reactor section.

The catalysis of atomic hydrogen forms an rt-plasma with an inverted hydrogen population. Laser oscillators occur in the cavity 551 which has the appropriate dimensions and mirrors for lasing that is known to those skilled in the art as described in Laser Handbook, Edited by F. T. Arecchi and E. O, Schulz-Dubois, North-Holland Publishing Company, Amsterdam, 1972-, Vol. 1-6 which is herein incorporated by reference in its entirety. The laser light is contained in the cavity 551 between the mirrors 558 and 559. The mirror 558 may be semitransparent, and the light may exit the cavity through this mirror.

### 6.1 Exemplary Water-Plasma Laser

The laser set up shown in FIG. 9 comprised a quartz tube cell, a source of water vapor or ultrapure hydrogen, a flow system, and a pump. Water vapor was formed in a heated insulated reservoir and flowed through the half inch diameter quartz tube at a flow rate of 10 standard cm³·s⁻¹ (sccm) at a corresponding pressure of 50-100 milliTorr. At this pressure, room temperature was sufficient for maintaining the water vapor. The tube was fitted with an Evenson coaxial microwave cavity (Opthos) having an E-mode [F. C. Fehsenfeld, K. M. Evenson, H. P. Broida, “Microwave discharges operating at 2450 MHz”, Review of scientific Instruments, Vol. 35, No. 3, (1965), pp. 294-298; B. McCarroll, “An improved microwave discharge cavity for 2450 MHz”, Review of Scientific Instruments, Vol. 41, (1970), p. 279 which are herein incorporated by reference in their entirety]. The input power to the plasma at 2.45 GHz by an Opthos model MPG-4M generator was set at 50 W and 90 W as described previously [R. Mills, P. Ray, “Spectral Emission of Fractional Quantum Energy Levels of Atomic Hydrogen from a Helium-Hydrogen Plasma and the Implications for Darks Matter”, Int. J. Hydrogen Energy, Vol. 27, No. 3, pp. 301-322 which is herein incorporated by reference in its entirety). The water vapor gas flow was controlled by a 0-20 sccm range mass flow controller (MKS1179A21CS1BB) with a readout (MKS type 246). The cell pressure was monitored by a 0-10 Torr MKS Baratron absolute pressure gauge.

Inverted Balmer and Lyman populations were achieved as shown in R. Mills, P. Ray, R. M. Mayo, “Stationary Inverted Balmer and Lyman Populations for a CW HI Water-Plasma Laser”, IEEE Transactions on Plasma Science, submitted and R. Mills, P. Ray, R. M. Mayo, “Spectroscopic Evidence for CW HI Lasing in a Water-Plasma”, J. of Applied Physics, submitted which are herein incorporated by reference in their entirety. Laser oscillations occur between mirrors at opposite ends of the cavity shown in FIG. 9. One of the mirrors is semi transparent to allow the laser light to exit. Appropriate mirrors and cavity dimensions are used as known by those skilled in the art.

6.2 Exemplary rt-plasmna Laser

The laser set up shown in FIG. 11 and described previously [R. Mills and M. Nansteel, P. Ray, “Argon-Hydrogen-Strontium Discharge Light Source”, IEEE Transactions on Plasma Science, Vol. 30, No. 2, (2002), pp. 639-653] was used to maintain rt-plasmas of hydrogen with KNO₃ and RbNO₃. It comprised a thermally insulated quartz cell with a cap that incorporated polls for gas inlet, outlet, and photon detection. A tungsten filament heater and hydrogen dissociator were in the quartz tube as well as a cylindrical titanium screen that served as a second hydrogen dissociator that was coated with catalysts KNO₃, RbNO₃. The cell was maintained at 50° C. for four hours with helium flowing at 30 sccm at a pressure of 0.1 Torr. The cell was then operated with and without an ultrapure hydrogen flow rate of 5.5 sccm maintained at 300 mTorr. The titanium screen was electrically floated with 250 W of power applied to the filament. The temperature of the tungsten filament was estimated to be in the range 1100 to 1500° C. The external cell wall temperature was about 700° C.

Inverted Balmer and Lyman populations were achieved as shown in R. Mills, P. Ray, R. Mayo, “Chemically-Generated Stationary Inverted Lyman Population for a CW HI Laser”, J Vac. Sci. and Tech. A, submitted and R. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, in press which are herein incorporated by reference in their entirety. Laser oscillations occur between mirrors at opposite ends of the cavity shown in FIG. 11. One of the mirrors is semi transparent to allow the laser light to exit. Appropriate mirrors and cavity dimensions are used as known by those skilled in the art.

### 6.3 Photon Power to Electricity Conversion

The present invention of a hydrogen power and plasma cell and reactor further comprises a power converter comprising a hydrogen catalysis cell that produces atoms having binding energies given by Eq. (1) and at least one of a high population of electronically excited state atoms such as hydrogen atoms and an inverted population such as an atomic hydrogen inverted population. The power is emitted as photons with spontaneous emission or stimulated emission. The light is converted to electricity using a photon-to-electric converter of the present invention such as a photoelectric or photovoltaic cell. In an embodiment, the power cell further comprises a hydrogen laser of the present invention.

In an embodiment, the photons exit the semitransparent mirror of the laser cavity and irradiate a photovoltaic cell. The laser power may be converted to electricity using photovoltaic cells as described in the following references of photovoltaic cells to convert laser power to electric power which are incorporated by reference in their entirety: L. C. Olsen, D. A. Huber, G. Dunham, F. W. Addis, “High efficiency monochromatic GaAs solar cells”, in Conf. Rec. 22nd IEEE Photovoltaic Specialists Conf., Las Vegas, Nev., Vol. I, October (1991), pp. 419-424; R. A. Lowe, G. A. Landis, P. Jenkins, “Response of photovoltaic cells to pulsed laser illumination”, IEEE Transactions on Electron Devices, Vol. 42, No. 4, (1995), pp. 744-751; R. K. Jain, G. A. Landis, “Transient response of gallium arsenide and silicon solar cells under laser pulse”, Solid-State Electronics, Vol. 4, No. 11, (1998), pp. 1981-1983; P. A. Iles, “Non-solar photovoltaic cells”, in Conf., Rec. 21st IEEE Pholovoltaic Specialists Conf., Kissimmee, Fla., Vol. I, May, (1990), pp. 420-423.

In an embodiment of the laser power converter, using bean forming optics, the laser beam is reduced spread over a larger area as described in L. C. Olsen, D. A. Huber, G. Dunham, F. W. Addis, “High efficiency monochromatic GaAs solar cells”, in Conf. Rec. 22nd IEEE Photovoltaic Specialists Conf., Las Vegas, Nev., Vol. I, October (1991), pp. 419-424 which is herein incorporated by reference in its entirety. The beam forming optics may be a lens or a diffuser.

In another embodiment, the spontaneous or stimulated emission is converted to electrical power using a photovoltaic. Conversion of monochromatic spontaneous and/or stimulated emission from the water plasma cell [R. Mills, P. Ray, R. M. Mayo, “Stationary Inverted Balmer and Lyman Populations for a CW HI Water-Plasma Laser”, IEEE Transactions on Plasma Science, submitted which is herein incorporated by reference in its entirety] to electricity using a photovoltaic with a band gap that is matched to the wavelength can be achieved at significant power densities and efficiencies using existing photovoltaic (PV) cells. Photocells of the power converter of the present invention that respond to ultraviolet and extreme ultraviolet light comprise radiation hardened conventional cells. Due to the higher energy of the photons potentially higher efficiency is achievable compared to those that convert lower energy photons. The hardening may be achieved by a protective coating such as a atomic layer of platinum or other noble metal.

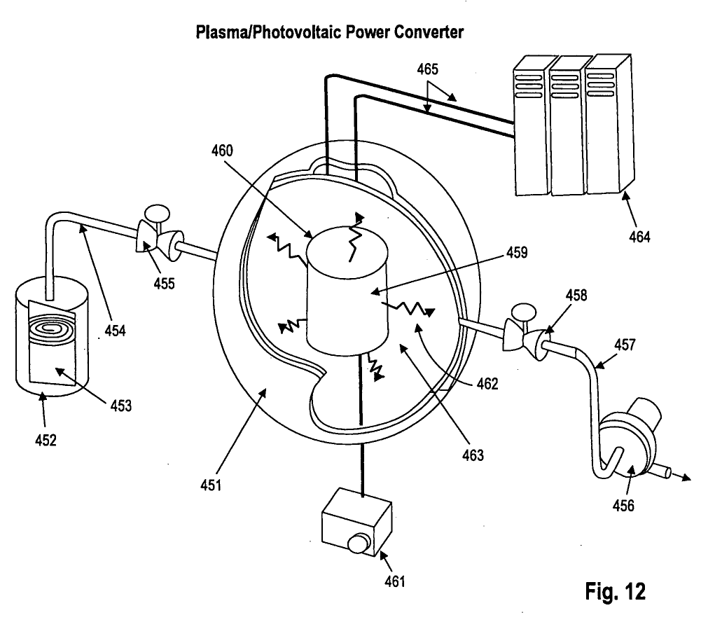

An embodiment of the power cell and photon-to-electric converter is shown in FIG. 12. It comprises a vacuum vessel 451, a source of catalyst and hydrogen such as a water vapor generator 452 containing water 453. The catalyst and hydrogen flow to the reaction vessel 451 by a line 454 controlled by a valve 455. The flow through the cell may be maintained by a pump 456, a vacuum line 457, and a vacuum valve 458. A hydrogen and catalyst plasma 459 is maintained in the reaction cell 451 by a plasma generator such as an open mesh microwave cavity 460 powered by a microwave power supply 461. The photons 462 generated by the catalysis and microwave input power are received by a photon-to-electric converter 463 such as photovoltaic tiling of the inside of the vacuum vessel 451. The electrical power is delivered to an electrical load 464 by electrical lines 465.

In an embodiment of at least one of a hydrogen microwave and a hydrogen RF plasma cell, a microwave or RF transparent cell such as a quartz tube and a microwave or RF transparent photovoltaic material such as amorphous silicon photovoltaic that is circumferential to the cell are inside of the microwave cavity. The cavity may be a reentrant cavity such as an Evenson cavity. The photovoltaic material may comprise the wall of the cell. The cell may further comprise a cell wall cooler such as an air cooler or a water cooler to maintain the photovoltaic at a desired operating temperature. In an embodiment, the photocell is cooled with a heat pipe. The cell may also comprise mirrors or lenses to direct the light onto the photovoltaic. Mirrors may also be present at the cell wall to increase the path length of light such as hydrogen Lyman series emission to maintain excited states which may be further excited by collisions or photons.

In an embodiment that uses a photovoltaic for power conversion, high energy light may be converted to lower energy light by a phosphor on the transparent walls of the cell so that the photons emitted by the excited phosphor more closely match the peak wavelength efficiency of the photovoltaic. In an embodiment, the phosphor is a gas which efficiently converts short wavelength light of the cell to long wavelength light to which the photovoltaic cell is more responsive.

In an embodiment of the power converter, photons are incident on a photoelectric material that is responsive to the wavelength of the spontaneous emission or laser light such that electrons are ejected and collected at a grid or electrode. The photoelectric material such as barium, tungsten, pure metals (e.g. Cu, Sm), Ba, Cs₂ Te, K₂CsSb, LaB₆, Sb—alkali, GaAs serves as a photocathode (positive electrode) as given in the following references which are incorporated by reference in their entirety: M. D. Van Loy, “Measurements of barium photocathode quantum yields at four excimer wavelengths”, Appl. Phys. Letts., Vol. 63, No. 4, (1993), pp. 476-478; S. D. Moustaizis, C. Fotakis, J. P. Girardeau-Montaut, “Laser photocathode development for high-current electron source”, Proc. SPIE, Vol. 1552, pp. 50-56, Short-wavelength radiation sources, Phillip Sprangle, Ed.; D. H. Dowell, S. Z. Bethel, K. D. Friddell, “Results from the average power laser experiment photocathode injector test”, Nuclear Instruments and Methods in Physics Research A, Vol. 356, (1995), pp. 167-176; A. T. Young, B. D'Etat, G. C. Stutzin, K. N. Leung, W. B. Kunkel, “Nanosecond-length electron pulses from a laser-excited photocathode”, Rev. Sci. Instrum., Vol. 61, No. 1, (1990), pp. 650-652; Q. Minquan, et al., “Investigation of photocathode driven by a laser”, Qiangjiguang Yu Lizishu/High Power Laser and Particle Beams”, Nucl. Soc. China, Vol. 9, No. 2, May (1997), pp. 185-191. And, the electron collector serves as an anode (negative electrode). The electrical circuit completed between these electrodes through a load such that the voltage developed between the electrodes drives a current. Thus, electrical power is delivered to and dissipated in the load.

In an embodiment of the hydrogen laser, the inverted population is due to the catalysis of atomic hydrogen to lower energy states wherein m·27.2 eV of energy is nonradiatively transferred from the hydrogen to the catalyst. The remaining energy due to the transition to the corresponding stable state corresponding to a fractional Rydberg state may be transferred to atomic hydrogen which serves as a third body. The resulting fast H may undergo collisions to form excited state hydrogen which comprises an inverted population capable of lasing. In an embodiment, the catalysis mixture contains oxygen in addition to the catalyst and hydrogen. The oxygen may be form a source such as gaseous oxygen or it may be from a source such as a carbonate or a nitrate as given in Mills publication [R. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, in press] which is herein incorporated by reference in its entirety. The fast atomic hydrogen formed by catalysis may collide with the oxygen to form the excited state hydrogen which comprises an inverted population. The laser power may be converted to electricity using a photovoltaic cell.

In an embodiment, a species is added to achieve at least one of atomic hydrogen population inversion or conversion of the power of the catalysis reaction to excited state atomic hydrogen. In an embodiment, the inverting or converting species is a gas comprising at least one molecule from the list of O₂, H₂O, CO₂, N₂, NO₂, NO, CO, and a halogen gas. Percentage inverting or converting species in the catalysis reaction mixture is in the range of 0.1% to 99.9%, preferably in the range of 0.1 to 50%, more preferably in the range 1% to 25%, and most preferably in the range of 1% to 5%.

In an embodiment of the power cell, the walls cool the plasma electrons to maintain a low electron temperature while the hydrogen atom temperature is very high so that the condition to achieve an inverted hydrogen atom population are maintained.

In an embodiment of the laser power converter, species which form an excimer are added to the catalytic plasma to absorb the power of the pumping mechanism which forms at least one of a large population of excited states and an inverted population. In an embodiment, the lasing species is at least one of OH*, CO₂, and H₂O. In an embodiment, at least one halogen gas is added to the plasma of hydrogen mixed with at least one noble gas such as helium, neon, and argon such that excimers form. The power is extracted by the excimer laser emission. In another embodiment, a species is added which is excited by at least one of the pumping mechanism and an energy transfer from the excited state species such as excited atomic hydrogen. The power is extracted by at least one of spontaneous and stimulated emission of the excited species. The light from the cell may be converted to a different frequency by a phosphor so that the photovoltaic conversion is more efficient.

In an embodiment, the hydrogen reactor and power converter comprises a microwave cavity such as a reentrant cavity such as an Evenson cavity wherein the cavity is comprised of a conductor with open spaces for the propagation of the light generated in the cavity. In an embodiment, the cavity comprises walls of a conducting wire mesh or a grid of wires. In an embodiment, the conductor with open spaces is coated with a dielectric material that is nonconducting to the plasma, but is transparent to microwaves such as quartz or Alumina. The light generated in the cavity may travel though the open areas in the wall with the microwave generated plasma contained substantially in the microwave cavity. The power converter may further comprises a vacuum chamber which is larger that the microwave cavity and contains the cavity and at least one photon-to-electric converter such as at least one of a photovoltaic cell and a photocathode. The photon-to-electric converter may be at the walls of the vacuum chamber and receive the photons and convert them to electricity. An advantage of the present embodiment, is the conversion of extreme ultraviolet and ultraviolet photons to electricity without the need of a window from the cell to the photon-to-electric converter. An additional advantage is to separate the plasma from the photon-to-electric converter in order to minimize plasma damage to the converter. In another embodiment, the plasma is confined by magnetic or electric field confinement to minimize the contact of the plasma with the photon-to-electric converter. In a further embodiment, the converter converts kinetic energy from charged or neutral species in the plasma such as energetic electrons, ions, and hydrogen atoms into electricity. This converter may be in contact with the plasma to receive the energetic species.

In an embodiment, the photovoltaic has a high band-gap such as a photovoltaic comprised of gallium nitride.

### 7. EXPERIMENTAL

### 7.1 Chemically-Generated Stationary Inverted Lyman Population for a CW HI Laser

Each of the ionization of Rb⁺ and cesium and an electron transfer between two K⁺ ions (K⁺/K⁺) provide a reaction with a net enthalpy of an integer multiple of the potential energy of atomic hydrogen, 27.2 eV. The corresponding Group I nitrates provide these reactants as volatilized ions directly or as atoms by undergoing decomposition or reduction to the corresponding metal. The presence of each of the reactants identified as providing an enthalpy of 27.2 eV formed a low applied temperature, extremely low voltage plasma in atomic hydrogen called a resonant transfer or rt-plasma having strong vacuum ultraviolet (VUV) emission. In contrast, magnesium and aluminum atoms or ions do not ionize at integer multiples of the potential energy of atomic hydrogen. Mg(NO₃)₂ or Al(NO₃)₃ did not form a plasma and caused no emission.

For further characterization, we recorded the width of the 6563 Å Balmer α line on light emitted from rt-plasmas. Significant line broadening of 18, 12, and 12 eV was observed from a rt-plasma of hydrogen with KNO₃, RbNO₃, and CsNO₃, respectively, compared to 3 eV from a hydrogen microwave plasma. These results could not be explained by Stark or thermal broadening or electric field acceleration of charged species since the measured field of the incandescent heater was extremely weak, 1 V/cm, corresponding to a broadening of much less than 1 eV. Rather the source of the excessive line broadening is consistent with that of the observed VUV emission, an energetic reaction caused by a resonant energy transfer between hydrogen atoms and K⁺/K⁺, Rb⁺, and cesium, which serve as catalysts.

KNO₃ and RbNO₃ formed the most intense plasma. Remarkably, a stationary inverted Lyman population was observed in the case of an rt-plasma formed with potassium and rubidium catalysts. These catalytic reactions may pump a cw HI laser as predicted by a collisional radiative model used to determined that the observed overpopulation was above threshold.

### 1. Introduction

The Lyman α, β, and γ lines of atomic hydrogen at 121.6 nm, 102.6 nm, and 97.3 nm in the vacuum ultraviolet (VUV) region are due to the transitions from n=2, n=3, and n=4 to n=1, respectively. These lines are of great importance in many applications ranging from photochemistry, to laboratory simulations of planetary atmospheres, to astrophysics and plasma physics. In plasma physics, the Lyman series line intensities and their ratios are frequently used in the determination of plasma parameters such as hydrogen number densities and other quantities such as particle fluxes or ion recombination processes [1-2, Numbers in brackets represent a specific reference listed by number following section 4 Conclusion] For the last four decades, scientists from academia and industry have been searching for lasers using a hydrogen plasma [3-6]. Developed sources that provide a usefully intense hydrogen plasma are high powered lasers, arcs and high voltage DC and RF discharges, synchrotron devices, inductively coupled plasma generators, and magnetically confined plasmas. However, the generation of population inversion in these sources is very difficult. Recombining expanding plasmas jets formed by methods such as arcs or pulsed discharges is considered one of the most promising methods of realizing an HI laser.

It was reported previously that a new plasma source has been developed that operates by incandescently heating a hydrogen dissociator to provide atomic hydrogen. Simultaneously a catalyst is heated such that it becomes gaseous and reacts with the atomic hydrogen to produce a plasma by a resonant transfer process. Such a plasma is referred to as an rt-plasma. It was extraordinary, that intense VUV emission was observed at low temperatures (e.g. ≈10³ K) and the extraordinary low field strength of about 1-2 V/cm from atomic hydrogen and certain atomized elements or selected gaseous ions which singly or multiply ionize at integer multiples of the potential energy of atomic hydrogen, 27.2 eV [7-8]. A proposed theory of this unique process was given previously [9-11].

The Group I and Group VIII elements are unique in that atoms and or ions from these groups, with the exception of xenon, provide a reaction with a net enthalpy that is a close match to an integer multiple of the potential energy of atomic hydrogen, m·27.2 eV where m is an integer. The corresponding reactions of Group I elements with a net enthalpy of m·27.2 eV which are proposed to form an rt-plasma follow:

The first and second ionization energies of lithium are 5.39172 eV and 75.6402 eV, respectively [12]. The double ionization reaction of Li to Li²⁺, then, has a net enthalpy of reaction of 81.032 eV, which is equivalent to m=3.

The second, third, and fourth ionization energies of sodium are 47.2864 eV, 71.6200 eV, and 98.91 eV, respectively [12]. The triple ionization reaction of Na⁺ to Na⁴⁺, then, has a net enthalpy of reaction of 217.8164 eV, which is equivalent to m=8.

The second ionization energy of potassium is 31.63 eV, and K⁺ releases 4.34 eV when it is reduced to K [12]. The combination of reactions K⁺ to K²⁺ and K⁺ to K, then, has a net enthalpy of reaction of 27.28 eV, which is equivalent to m=1. Also, the first, second, and third ionization energies of potassium are 4.34066 eV, 31.63 eV, and 45.806 eV, respectively [12]. The triple ionization reaction of K to K³⁺, then, has a net enthalpy of reaction of 81.7766 eV, which is equivalent to m=3.

The second ionization energy of rubidium is 27.28 eV [12]; thus, the reaction Rb⁺ to Rb²⁺ has a net enthalpy of reaction of 27.28 eV, which is equivalent to m=1.

The first and second ionization energies of cesium are 3.89390 eV and 23.15745 eV, respectively [12]. The double ionization reaction of Cs to Cs²⁺, then, has a net enthalpy of reaction of 27.05135 eV, which is equivalent to m=1.

Rt-plasmas with Group I catalysts were reported previously [7]. In this paper, we report on further characterization of rt-plasmas with Group I catalysts wherein m=1. Group I nitrates were used since they are volatile at relatively low temperatures and also undergo hydrogen reduction and gradual thermal decomposition. Thus, they provide gaseous Group I ions M⁺ or atoms M.

The energetic atomic hydrogen densities and energies were calculated from the width of the 6563 Å Balmer α line emitted from a control hydrogen microwave plasma and rt-plasmas. The characteristic emission from the catalyst was also measured. KNO₃ and RbNO₃ formed the most intense plasmas. Remarkably, the population of the levels n=3 and n=4 of hydrogen were continuously inverted with respect to the n=2 levels in an rt-plasma formed with the K⁺ and Rb⁺ catalysts. To our knowledge, this is the first report of population inversion in a chemically generated plasma. This plasma was further characterized by measuring the electron temperature Tₑ from the intensity ratios of alkali lines.

### 2. Experimental

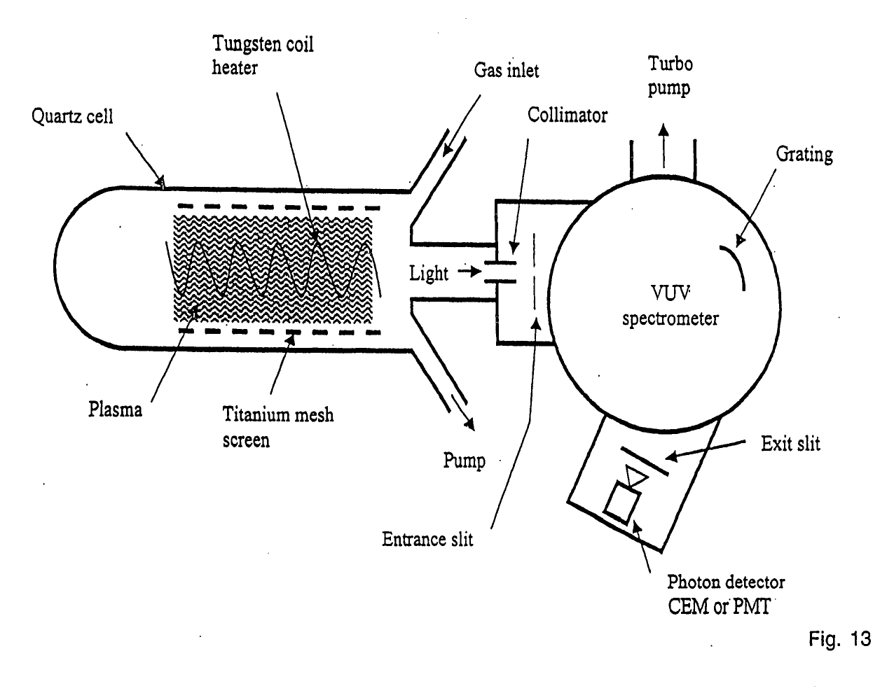

The VUV spectrum (900-1300 Å), the width of the 6563 Å Balmer α line, and the high resolution visible spectrum were recorded on light emitted from a hydrogen microwave discharge performed according to methods reported previously [13-14] that served as a control for measurements recorded on light emitted from rt-plasmas of hydrogen with KNO₃, RbNO₃, or CsNO₃. The experimental set up described previously [7-8] and shown in FIG. 13 comprised a thermally insulated quartz cell with a cap that incorporated ports for gas inlet, outlet, and photon detection. A tungsten filament heater and hydrogen dissociator were in the quartz tube as well as a cylindrical titanium screen that served as a second hydrogen dissociator that was coated with catalysts KNO₃, RbNO₃, or CsNO₃ and control materials Mg(NO₃)₂ or Al(NO₃)₃. The cell was maintained at 50° C. for four hours with helium flowing at 30 sccm at a pressure of 0.1 Torr. The cell was then operated with and without an ultrapure hydrogen flow rate of 5.5 sccm maintained at 300 mTorr. The titanium screen was electrically floated with 250 W of power applied to the filament. The temperature of the tungsten filament was estimated to be in the range 1100 to 1500° C. The external cell wall temperature was about 700° C.

The rt-plasma phenomena was also studied for cesium metal with hydrogen compared to additional controls. The quartz cell was operated under the same conditions as for the Group I nitrates with 1.) hydrogen, argon, neon, and helium alone; 2.) sodium, magnesium, barium, and cesium metals alone, and 3.) sodium, magnesium, barium, and cesium with hydrogen. The pure elements of sodium, magnesium, barium, and cesium were placed in the bottom of the cell and vaporized by filament heating.

The VUV spectrometer was a normal incidence McPherson 0.2 meter monochromator (Model 302, Seya-Namioka type) equipped with a 1200 lines/mm holographic grating with a platinum coating that covered the region 20-5600 Å. The VUV spectrum was recorded with a CEM at 2500-3000 V. The wavelength resolution was about 0.2 Å (FWHM) with slit widths of 50 μm. The increment was 2 Å and the dwell time was 500 ms. The VUV spectrum (900-1300 Å) of the rt-plasma cell emission was recorded at about the point of the maximum Lyman α emission to confirm the rt-plasma before the line broadening and high resolution visible spectra were recorded.

In addition, regions of the VUV, ultraviolet (UV) and visible (VIS) spectra (400-5600 Å) were recorded with the normal incidence VUV spectrometer using a PMT and a sodium salicylate scintillator to record emission from the atoms and ions of rt-plasma catalysts. The emission was compared with a standard VUV emission spectrum that was obtained with a gas discharge cell comprised a five-way stainless steel cross that served as the anode with a hollow stainless steel cathode that was coated with KNO₃, RbNO₃, or CsNO₃ by the same procedure used to coat the titanium dissociator. The five-way cross was pressurized with 1 torr of hydrogen to initiate the discharge. The hydrogen was then evacuated so that only catalyst lines were observed. The DC voltage at the time the spectra were recorded was 300 V.

The electron temperatures Tₑ of the RbNO₃ and KNO₃ cells were measured from the ratio of the intensity of the Rb⁺ 741.4 Å line to that of the Rb²⁺ 815.3 Å line and the ratio of the K⁺ 612.6 Å line to that of the K²⁺ 546.1 Å line, respectively, as described by Griem [15].

The spectrometer was calibrated between 400-2000 Å with a standard discharge light source using He, Ne, Ar, Kr, and Xe lines: He I (584 Å), He II (304 Å), Ne I (735 Å), Ne II (460.7 Å), Ar I (1048 Å), Ar II (932 Å), Kr II (964 Å), Xe I (1295.6 Å), Xe II (1041.3 Å), Xe II (1100.43 Å). The wavelength and intensity ratios matched those given by NIST [16]. The spectrometer response was determined to be approximately flat in the 1000-1300 Å region. The calculation of the number density of the n=2, 3, and 4 states was corrected for the minor variation of the sensitivity with wavelength in this region. To improve background identification, 10-15 spectra were recorded at each condition before data reduction. Variations in peak line intensities between spectra run under identical conditions were less than 5%.

The plasma emission from a hydrogen microwave discharge [14] control and each rt-plasma maintained in the filament heated cell was fiber-optically coupled through a 220F matching fiber adapter positioned 2 cm from the cell wall to a high resolution visible spectrometer with a resolution of ±0.06 Å over the spectral range 1900-8600 Å. The spectrometer was a Jobin Yvon Horiba 1250 M with 2400 groves/mm ion-etched holographic diffraction grating. The entrance and exit slits were set to 20 μm. The spectrometer was scanned between 4100.5-4103.5 Å, 4338.5-4343.5 Å, 4859.0-4864.0 Å, and 6560-6570 Å using a 0.1 Å step size. The signal was recorded by a PMT with a stand alone high voltage power supply (950 V) and an acquisition controller. The data was obtained in a single accumulation with a 1 second integration time.

To measure the absolute intensity, the high resolution visible spectrometer and detection system were calibrated [17] with 5460.8 Å, 5799.6 Å, and 6965.4 Å light from a Hg—Ar lamp (Ocean Optics, model HG-1) that was calibrated with a NIST certified silicon photodiode. The population density of the n=3 hydrogen excited state N₃ was determined from the absolute intensity of the Balmer α (6562.8 Å) line measured using the calibrated spectrometer. The absolute intensities of Balmer β, γ, and δ were determined from the absolute intensity of Balmer α and the relative intensity ratios.

### 3. Results and Discussion

A. Measurement of Hydrogen Atom Temperature and Number Density from Balmer line Broadening

The method of Videnovic et al. [18] was used to calculate the energetic hydrogen atom densities and energies from the width of the 6563 Å Balmer α line emitted from microwave and rt-plasmas. The full half-width Δλ_{G} of each Gaussian results from the Doppler (Δλ_{D}) and instrumental (Δλ₁) half-widths:

Δλ_{G}=\sqrt{Δλ_{D}²+Δλ_{I}²} (69)

Δλ₁ in our experiments was 0.06 Δ. The temperature was calculated from the Doppler half-width using the formula:

$${Δλ}_{D} = 7.16 X {10}^{- 6} {{λ}_{0} ( \frac{T}{μ} )}^{1 / 2} ( Å ) \qquad ( 70 )$$

where λ₀ is the line wavelength in Å, T is the temperature in K (1 e V=11,605 K), and μ is the molecular weight (=1 for hydrogen). In each case, the average Doppler half-width that was not appreciably changed with pressure varied by ±5% corresponding to an error in the energy of ±5%. The corresponding number densities varied by ±20% depending on the pressure.

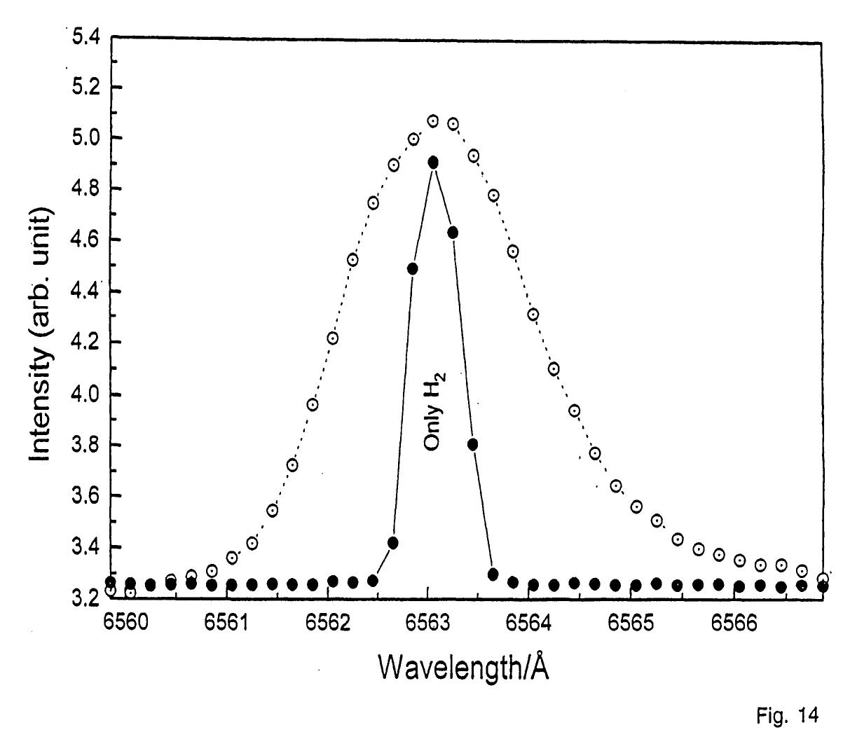

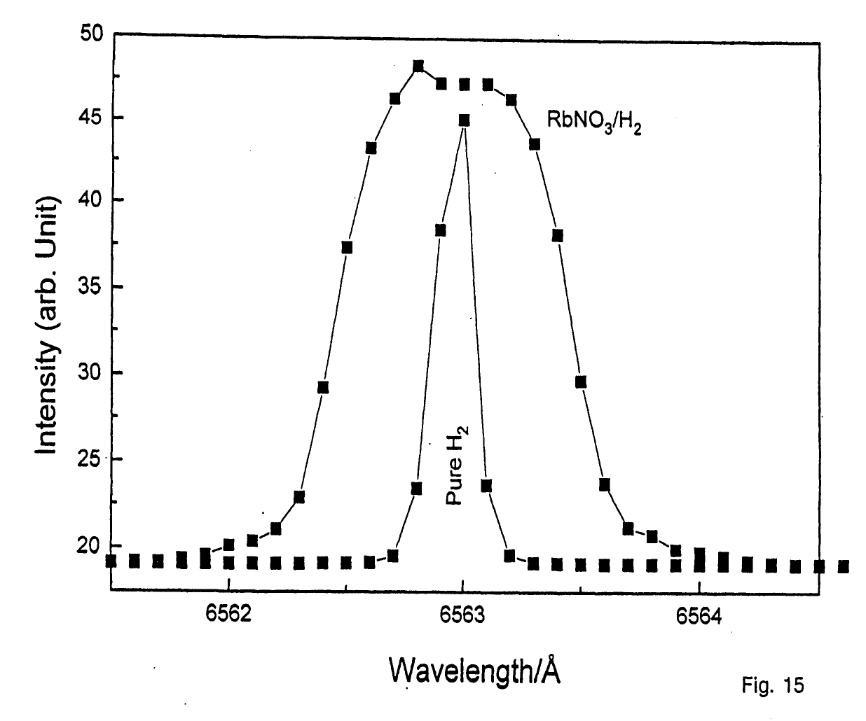

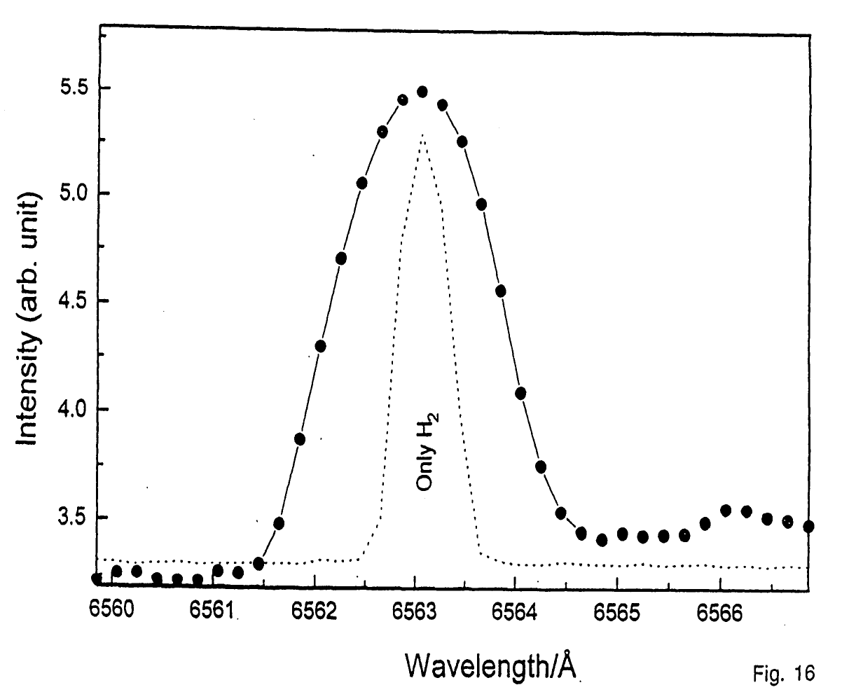

The results of the 6563 Å Balmer α line width measured with the high resolution (±0.06 Å) visible spectrometer on light emitted from rt-plasmas of hydrogen with KNO₃, RbNO₃, and CsNO₃ are shown in FIGS. 14-16, respectively. Significant line broadening of 18, 12, and 12 eV and atom densities of 4×10¹¹, 6×10¹¹, and 4×10¹¹ atoms/cm³ were observed from a rt-plasma of hydrogen with KNO₃, RbNO₃, and CSNO₃, respectively, as shown in TABLE 4. A hydrogen microwave plasma maintained at the same total pressure showed no excessive broadening corresponding to an average hydrogen atom temperature of ≈3 eV and a density of 2×10¹¹ atoms/cm³.

TABLE 4
Energetic hydrogen atom densities and energies for rt-plasmas
determined from the 6563 Å Balmer α line width.

| | Hydrogen Atom | Hydrogen Atom |
|---|---|---|
| Plasma | Density^{a} | Energy^{b} |
| Gas | (10¹¹ atoms/cm³) | (eV) |
| H₂ | 2 | 2-3^{c} |
| K; K⁺/K⁺/H₂ | 4 | 15-18 |
| Rb⁺/H₂ | 6 | 9-12 |
| Cs/H₂ | 4 | 10-12 |

^{a}Approximate Calculated after [18].
^{b}Calculated after [18].
^{c}Measured on a microwave discharge after [14].

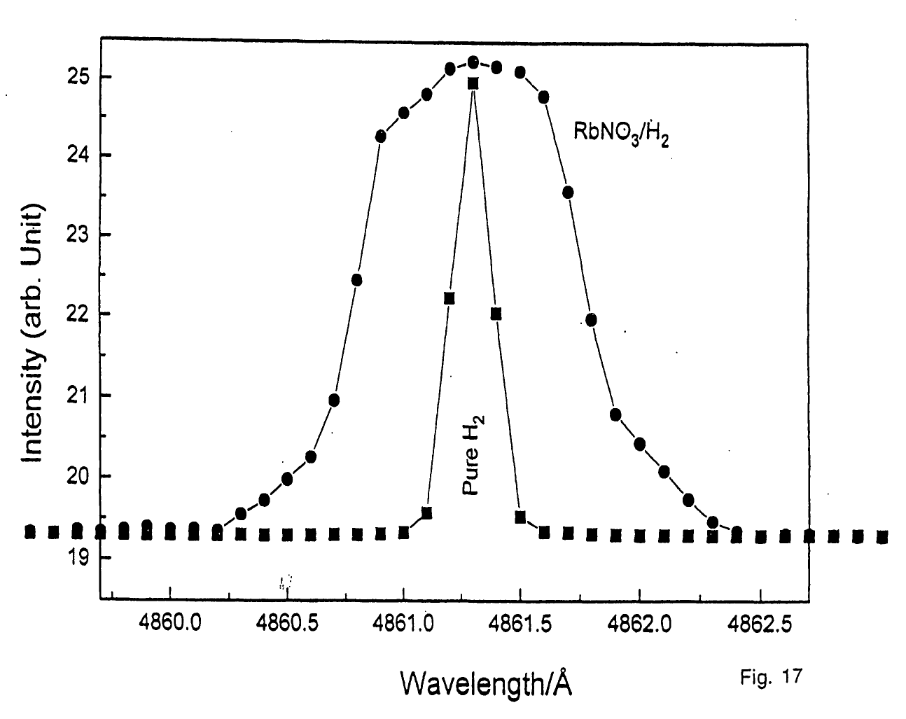

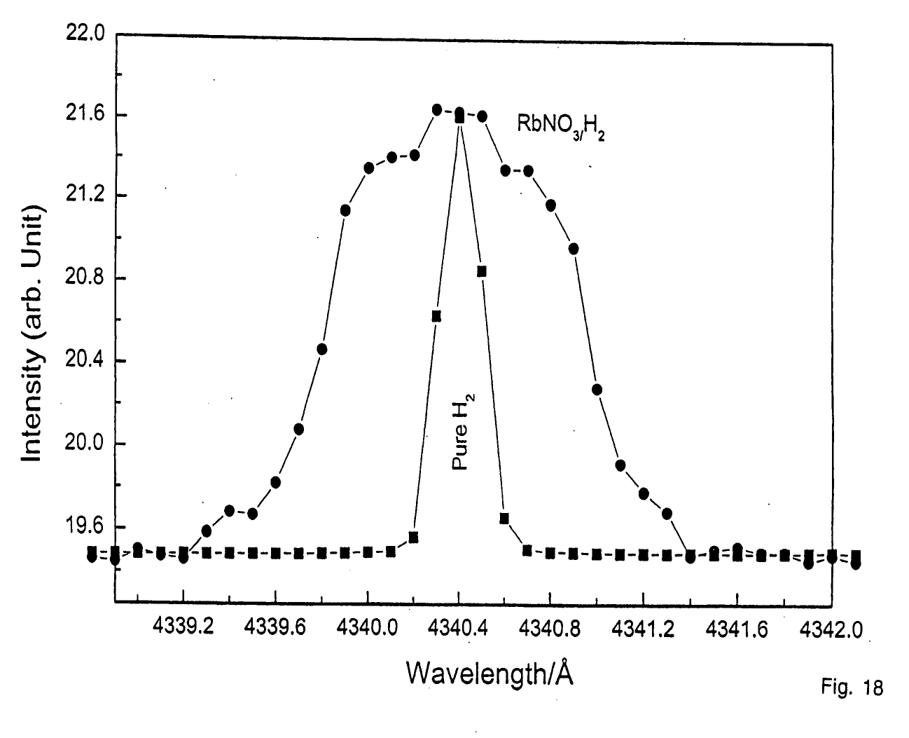

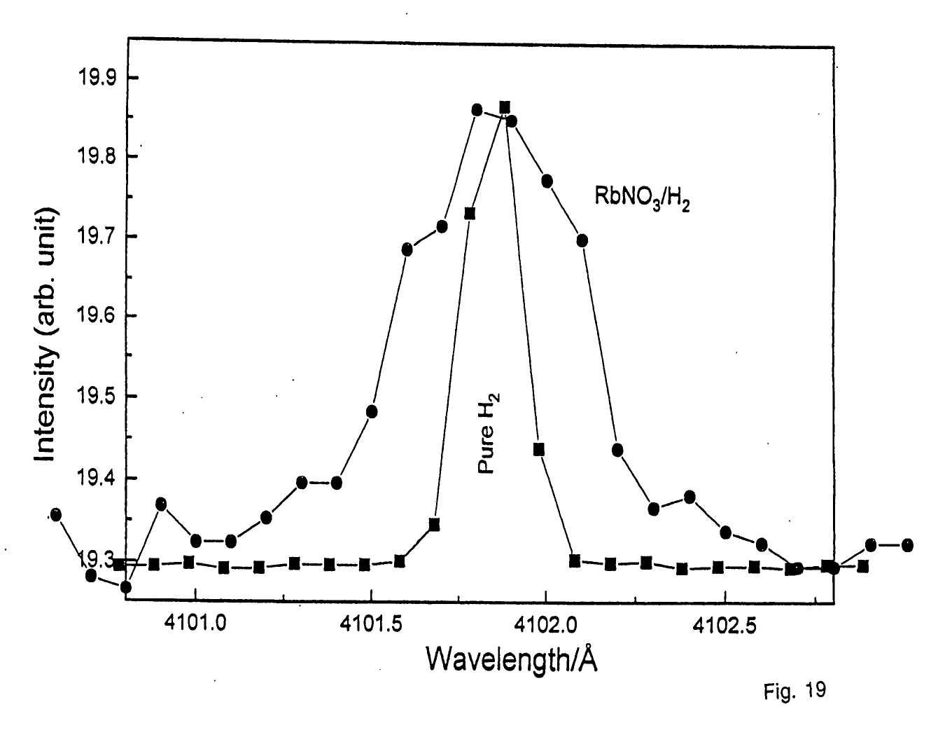

In addition to the Balmer α line, the Balmer β, γ, and δ lines corresponding to n=3, n=4, and n=5 were also broadened as shown for the case of the RbNO₃ rt-plasma emission in FIGS. 17-19, respectively. The line broadening results could not be explained by Stark or thermal broadening or electric field acceleration of charged species since the measured field of the incandescent heater was extremely weak, 1 V/cm, corresponding to a broadening of much less than 1 eV. We propose that the Doppler broadening was caused by the novel energetic reaction of atomic hydrogen with Group I catalysts which forms the rt-plasma.

Prior studies that reported fast H attributed the observation to acceleration of ions in a high electric fields at the cathode fall region and an external field Stark effect [18-21]. The authors have reported observations with a microwave plasma having no high field present [14, 22]. Microwave helium-hydrogen and argon-hydrogen plasmas showed extraordinary broadening corresponding to an average hydrogen atom temperature of 180-210 eV and 110-130 eV, respectively. Whereas, pure hydrogen and xenon-hydrogen microwave plasmas showed no excessive broadening corresponding to an average hydrogen atom temperature of <4 eV [14].

None of the hydrogen species, H⁺, H₂⁺, H₃⁺, H⁻, H, or H₂, responds to the microwave field; rather, only the electrons respond. But, the measured electron temperature in the argon-hydrogen microwave plasmas was about 1 eV; whereas, the measured neutral hydrogen temperature was 110-130 eV [14, 22]. This requires that Tᵢ>>>Tₑ. This result can not be explained by electric field acceleration of charged species. In microwave driven plasmas, there is no high electric field in a cathode fall region (>1 kV/cm) to accelerate positive ions as proposed previously [18-21] to explain significant broadening in hydrogen containing plasmas driven at a high voltage electrodes. It is impossible for H or any H-containing ion which may give rise to H to have a higher temperature than the electrons in a microwave plasma. The microwave field couples to electrons, not ions. And, the H atom temperature can not be attributed to the mechanisms proposed previously [18-21]. In fact, in the argon microwave case, the argon atoms and ions would have the highest energies since they have the largest cross section for electron collisions. No broadening of argon lines is observed. Only the hydrogen lines are broadened. The observation of excessive Balmer line broadening in a microwave driven plasma requires a source of free energy. Sources other than that provided by the electric field or known chemical reactions must be considered. We propose that the source is the energy released by the reaction which formed the rt-plasma.

We have assumed that Doppler broadening due to thermal motion was the dominant source in rt-plasmas to the extent that other sources may be neglected. To confirm this assumption, each source is now considered. In general, the experimental profile is a convolution of two Doppler profiles, an instrumental profile, the natural (lifetime) profile, Stark profiles, van der Waals profiles, a resonance profile, and fine structure. The instrumental half-width is measured to be ±0.06 Å. The natural half-width of the Balmer α line given by Djurovic and Roberts [21] is 1.4×10⁻³ Å which is negligible. The fine structure splitting is also negligible.

Stark broadening of hydrogen lines in plasmas can not be measured at low electron densities using conventional emission or absorption spectroscopy because it is hidden by Doppler broadening. In the case of the Lyman α line, the Stark width exceeds the Doppler width only at nₑ>10¹⁷ cm⁻³ for temperatures of about 10⁴ K [23].

The relationship between the Stark broadening Δλₛ of the Balmer β line in nm, the electron density nₑ in m⁻³, and the electron temperature Tₑ in K is

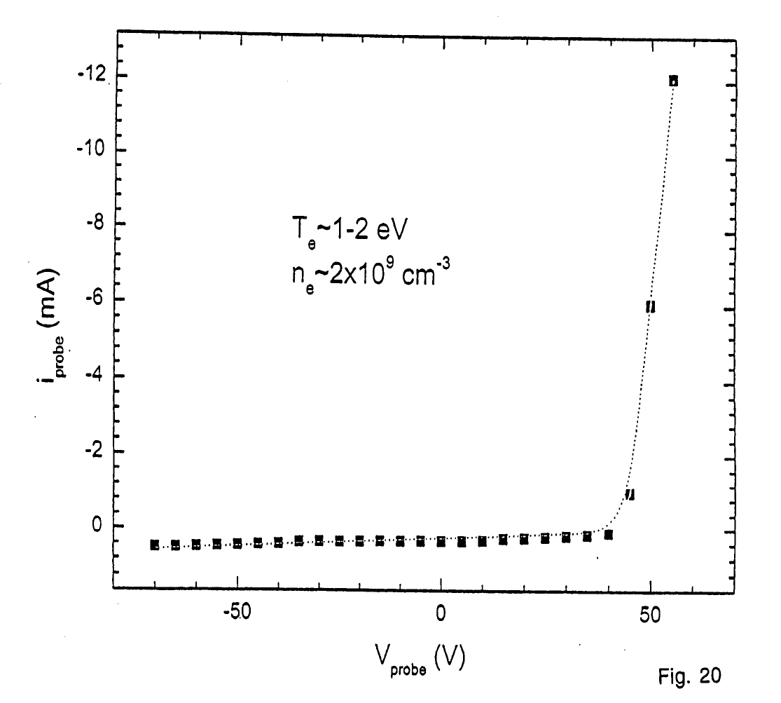

log nₑ=C₀+C₁ log(Δλ_{S})+C₂[log(Δλ_{S})]²+C₃ log(Tₑ) (71)

where C₀=22.578, C₁=1.478, C₂=−0.144, and C₃=0.1265 [24]. From Eq. (71), to get a Stark broadening of only 1 Å with Tₑ=9000 K, an electron density of about nₑ˜3×10¹⁵ cm⁻³ is required compared to that of the rt-plasma of nₑ=2×10⁹ cm⁻³ determined using a Langmuir probe as shown in FIG. 20, over six orders of magnitude less. Gigosos and Cardenoso [25] give the observed Balmer α Stark broadening for plasmas of hydrogen with helium or argon as a function of the electron temperature and density. For example, the Stark broadening of the Balmer α line recorded on a H+He⁺ plasma is only 0.33 Å with Tₑ=20,000 K and nₑ=1.4×10¹⁴ cm⁻³. Thus, the Stark broadening was also insignificant.

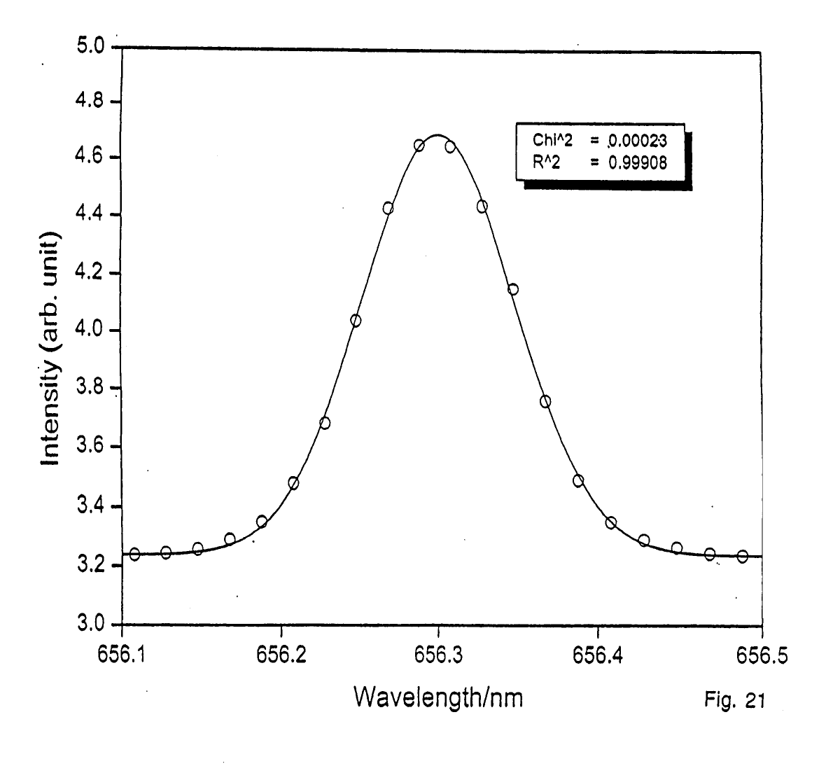

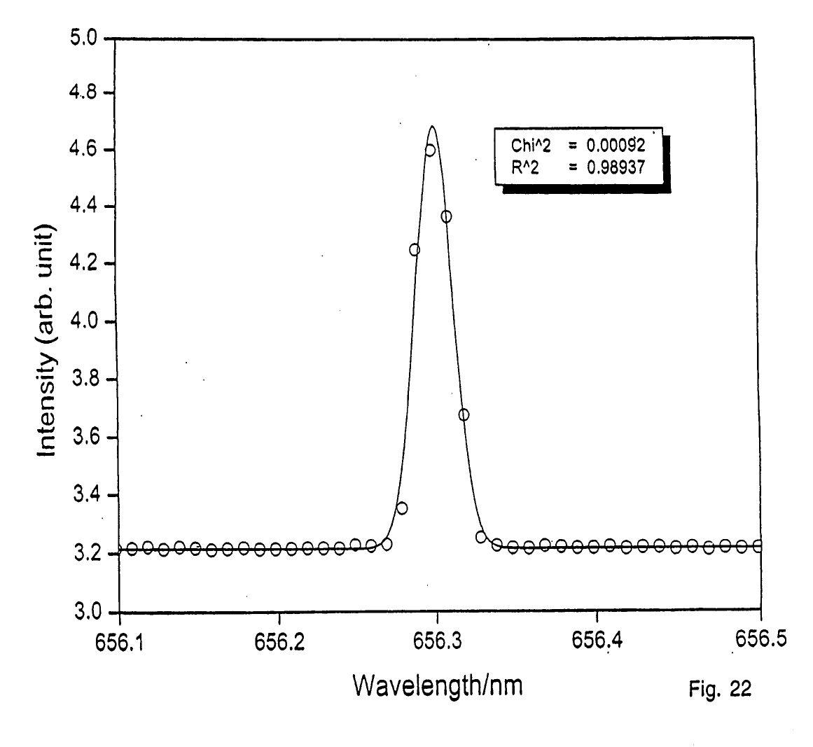

The statistical curve fit of the RbNO₃ rt-plasma and hydrogen microwave plasma emission are shown in FIGS. 21 and 22, respectively. In each case, the data matched a Gaussian profile having the X² and R² values given in FIGS. 21 and 22. The absence of Stark broadening in the RbNO₃ rt-plasma is also evident by the good fit to a Gaussian profile rather than a Voigt profile as shown in FIG. 21.

A linear Stark effect arises from an applied electric field that splits the energy level with principal quantum number n into (2n−1) equidistant sublevels. The magnitude of this effect given by Videnovic et al. [18] is about 2×10⁻¹ Å/kV·cm⁻¹. The applied electric field was present in our study was extremely weak, 1 V/cm; thus, the linear Stark effect should be negligible.

To investigate whether the rt-plasmas of this study were optically thin or thick at a given frequency ω, the effective path length τ_{ω}(L) was calculated from

τ_{ω}(L)=κ_{ω}L (72)

where L is the path length and κ_{ω} is the absorption coefficient given by

κ_{ω}=σ_{ω}N_{H} (73)

where σ_{ω} is the absorption cross section and N_{H} is the number density of the absorber. For optically thin plasmas τ_{ω}(L)<1, and for optically thick plasmas τ_{ω}(L)>1. The absorption cross section for Balmer α emission is σ=1×10⁻¹⁶ cm² [26]. As discussed infra., an estimate of the n=2H atom density based on Lyman line intensity is ˜1×10⁸ cm⁻³. Thus, for a plasma length of 50 cm, τ_{ω}(50 cm) for Balmer α is

τ_{ω}(50 cm)=κ_{ω}L=(1∴10⁻¹⁶ cm²)(1×10⁸ cm⁻³)(50 cm)=5×10⁻⁷ (74)

Since τ_{ω}(50)<<1, the rt-plasmas were optically thin; so, the self absorption of 6563 Å emission by n=2 state atomic hydrogen may be neglected as a source of the observed broadening.

As discussed above, an estimate based on emission line profiles places the total H atom density of the rt-hydrogen plasma at ˜5×10¹¹ cm⁻³. Since this is overwhelmingly dominated by the ground state, N_{H}=5×10¹¹ cm⁻³ will be used. Usually, the atomic hydrogen collisional cross section in plasmas is on the order of 10⁻¹⁸ cm² [27]. Thus, for N_{H}=5×10¹¹ cm⁻³, collisional or pressure broadening is negligible.

Since the line broadening was measured with sufficient resolution (±0.06 Å) to clearly separate the RbII and KII peaks at 6555 Å and 6595 Å, respectively, from the 6563 Å Balmer a line, the possibility of a contribution of the alkali ion lines to the hydrogen line broadening was eliminated.

B. rt-plasma Catalyst Emission

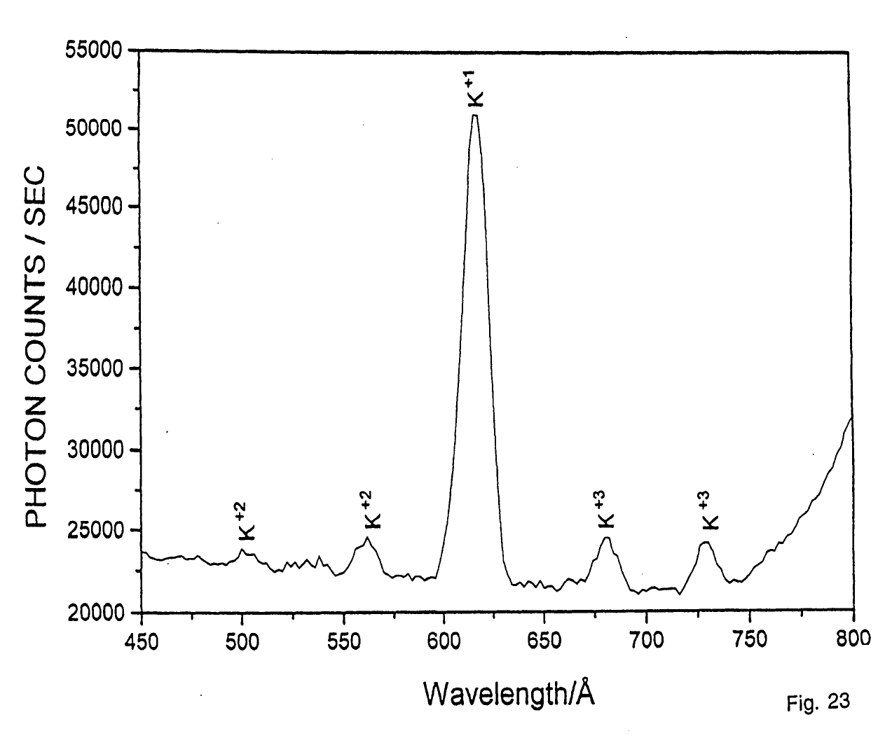

The VUV spectrum (450-800 Å) of the emission of the KNO₃—H₂ gas cell is shown in FIG. 23. The lines of K⁺, K²⁺, and K³⁺ corresponding to the two possible catalytic reactions were observed as reported previously (28) with the assignments confirmed by a standard potassium plasma spectrum and NIST tables [16, 29]. Line emission corresponding to K³⁺ was observed at 650-670 Å and 740-760 Å. K²⁺ was observed at 510 Å and 550 Å, and K⁺ was observed at 620 Å. A large K³⁺ peak was also observed at 892 Å. K was observed at 3447 Å, 4965 Å, and 5084 Å.

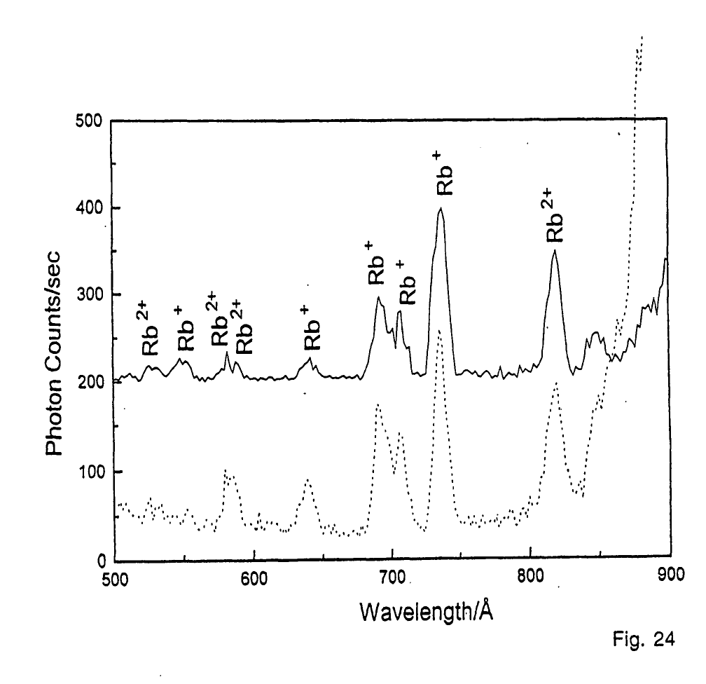

The VUV spectrum (500-900 Å) of the emission of the RbNO₃—H₂ gas cell (top curve) and the standard rubidium discharge plasma (bottom curve) are shown in FIG. 24. The standard rubidium discharge spectrum according to Sec. 2 is exemplary of the light source used to confirm the line assignments of each of the Group I nitrates studied. Line emission corresponding to Rb², was observed at 815.9 Å, 591 Å, 581 Å, 556 Å, and 533 Å. Rb⁺ was observed at 741.5 Å, 711 Å, 697 Å, and 643.8 Å. The assignments of the Rb²⁺ and Rb⁺ lines were confirmed by the NIST tables [16].

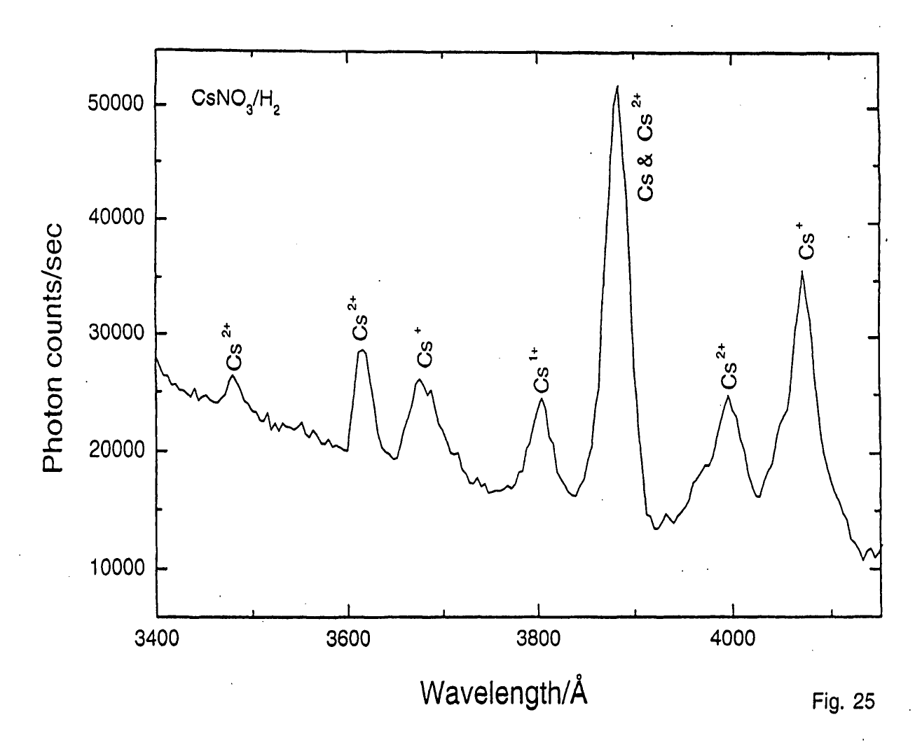

The UV spectrum (3400-4150 Å) of the emission of the CSNO₃—H₂ gas cell is shown in FIG. 25. Line emission corresponding to Cs²⁺ was observed at 3477 Å, 3618 Å, and 4001 Å. Cs⁺ was observed at 3680 Å, 3806 Å, and 4069 Å. Cs was observed at 3888.6 Å with Cs²⁺ at 3888.4 Å. The assignments of the Cs²⁺, C⁺, and Cs lines were confirmed by a standard cesium plasma spectrum and the NIST tables [16].

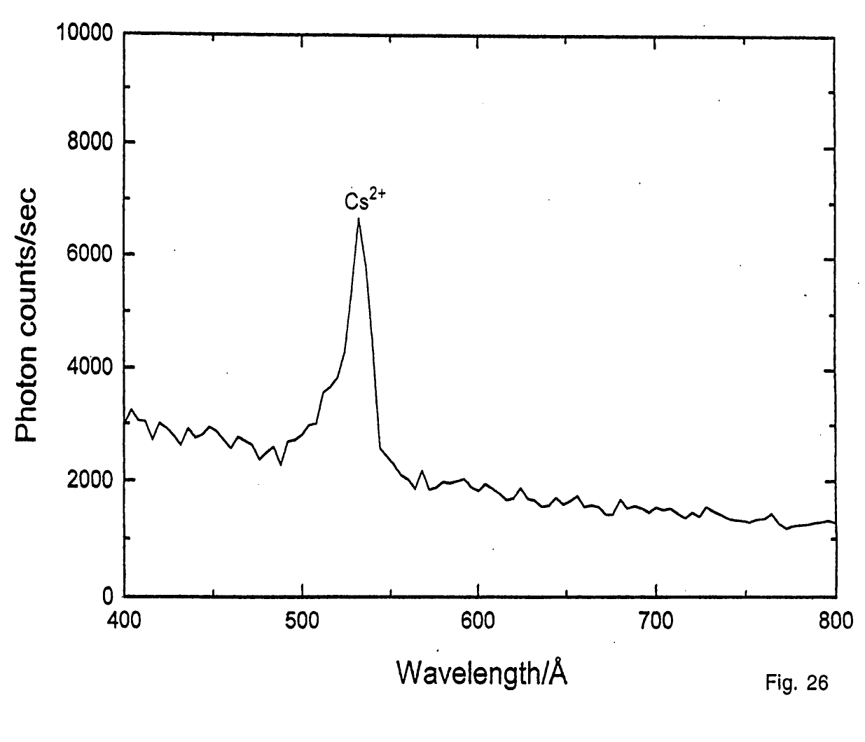

No plasma and no emission except blackbody radiation at long wavelengths was observed for 1.) hydrogen, argon, neon, and helium alone; 2.) sodium, magnesium, barium, and cesium metals alone, and 3.) sodium, magnesium, and barium, with hydrogen; whereas, a bright plasma with strong VUV emission was observed in the case of cesium metal with flowing hydrogen. The VUV spectrum (400-800 Å) of the emission of the CsNO₃—H₂ gas cell is shown in FIG. 26. Line emission corresponding to the second ionization. energy of cesium, 23.15745 eV [12], for the decay transition Cs²⁺ to Cs⁺ was observed at 533 Å. (The 533 Å emission shown in FIG. 26 is actually significantly larger than shown due to the low grating efficiency at the short wavelengths.) The only cesium lines observed for the standard cesium microwave plasma were in the visible region, and no lines were observed at wavelengths shorter than 800 Å in the case of the standard hydrogen microwave plasma.

The resonance lines of Cs II were observed with a sliding spark on the 10.7 m normal incidence vacuum spectrometer at the National Bureau of Standards (NBS) [30] as given in TABLE 5. The 533 Å emission of the hydrogen catalysis reaction with cesium shown in FIG. 26 is dramatically different from the NBS standard cesium spectrum wherein a series of lines of Cs⁺ was observed that vanished at the limit of the ionization energy of Cs⁺ to Cs²⁺. In fact, the ionization limit was not observed; rather, it was derived by NBS to be 23.17(4) eV [30]. Furthermore, I. S. Aleksakhin et al. recorded the emission of cesium in the 450-750 Å region during electron-atom collisions [31]. The ionization energy limit at 533 Å was not observed by I. S. Aleksakhin et al. either.

TABLE 5
Resonance lines of Cs II observed with a sliding spark on the 10.7 m
normal incidence vacuum spectrometer at NBS [30]. The uncertainty
of the wavelengths is ±0.005 Å.

| λ (Å) | Intensity | σ (cm⁻¹) | Upper Level |
|---|---|---|---|
| 926.657 | 40000 | 107914.8 | 6p⁶ 5d³ P₁ |
| 901.270 | 35000 | 110954.5 | 6s3/2[3/2]₁ |
| 813.837 | 15000 | 122874.7 | 6s1/2[1/2]₁ |
| 808.761 | 15000 | 123645.9 | 5d ³D₁ |
| 718.138 | 15000 | 139249.0 | 5d ¹P₁ |
| 668.386 | 500 | 149614 | 7s3/2[3/2]₁ |
| 657.112 | 100 | 152181 | 6d ³P₁ |
| 639.356 | 2000 | 156407 | 6d ³D₁ |
| 612.756 | 35 | 163189 | 7s1/2[1/2]₁ |
| 591.044 | 250 | 169192 | 6d ¹P₁ |
| 607.291 | 50 | 164666 | 8s3/2[3/2]₁ |
| 575.320 | 10 | 173816 | 6d ³D₁ |
| 564.158 | 1 | 177256 | 7d ¹P₁ |

Atomic hydrogen may resonantly transfer energy to cesium to cause its double ionization to Cs²⁺. Considering broadening by the thermal energies, the net enthalpy may be 27.2 eV, a match with the potential energy of atomic hydrogen; thus, it meets the conditions for producing an rt-plasma. Cs²⁺ may then decay and emit the radiation. The vacuum reaction is

Cs²⁺+e⁻→Cs⁺23.2 eV (75)

Following the resonant transfer, the decay energy for the transition Cs²⁺ to Cs⁺ is predicted to give 23.2 eV (533 Å) line emission corresponding to the second ionization energy of cesium, 23.15745 eV. This line emission was observed as shown in FIG. 26 without the Rydberg series of lines of Cs⁺ as observed by NBS with a sliding spark method [30] as shown in TABLE 5. The observed Cs²⁺ single line emission at 533 Å supports the resonant energy transfer of 27.2 eV from atomic hydrogen to atomic cesium to form an rt-plasma.

### C. Hydrogen Lyman and Balmer Series Emission

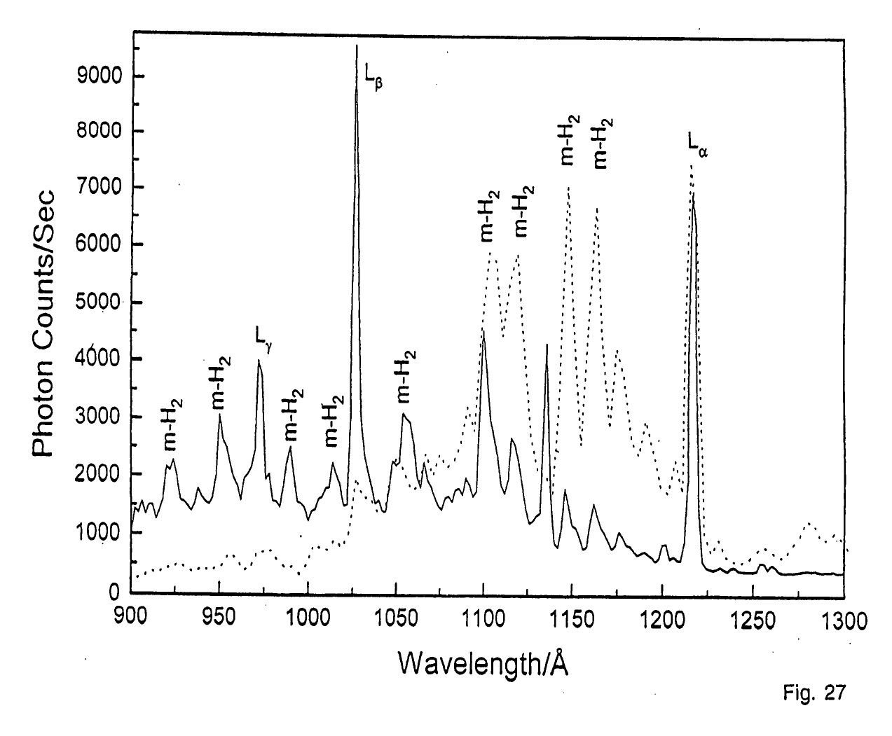

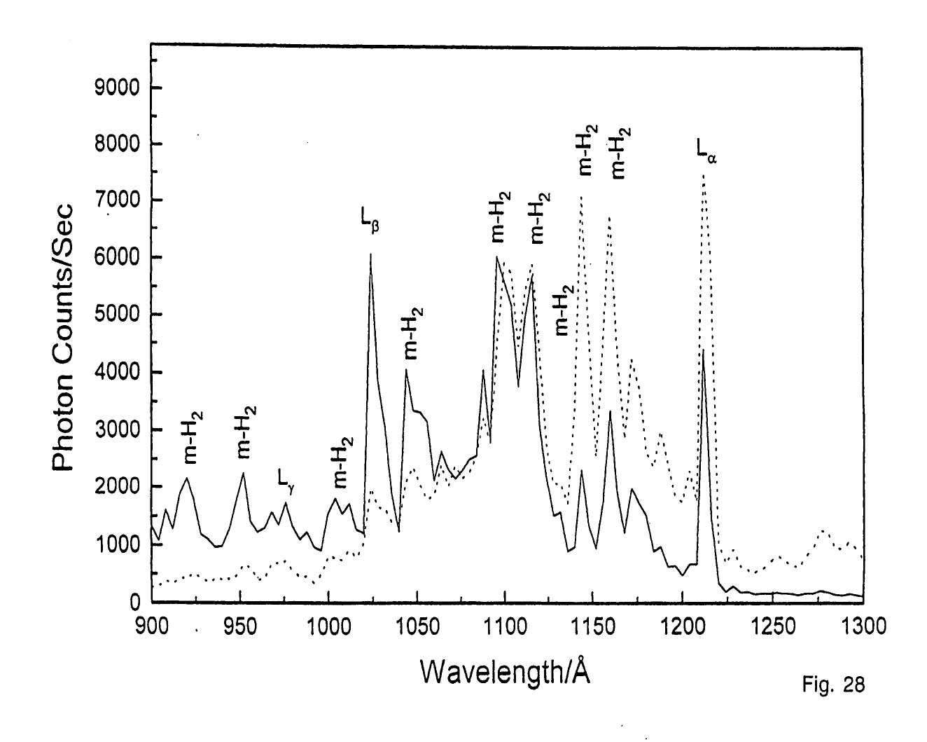

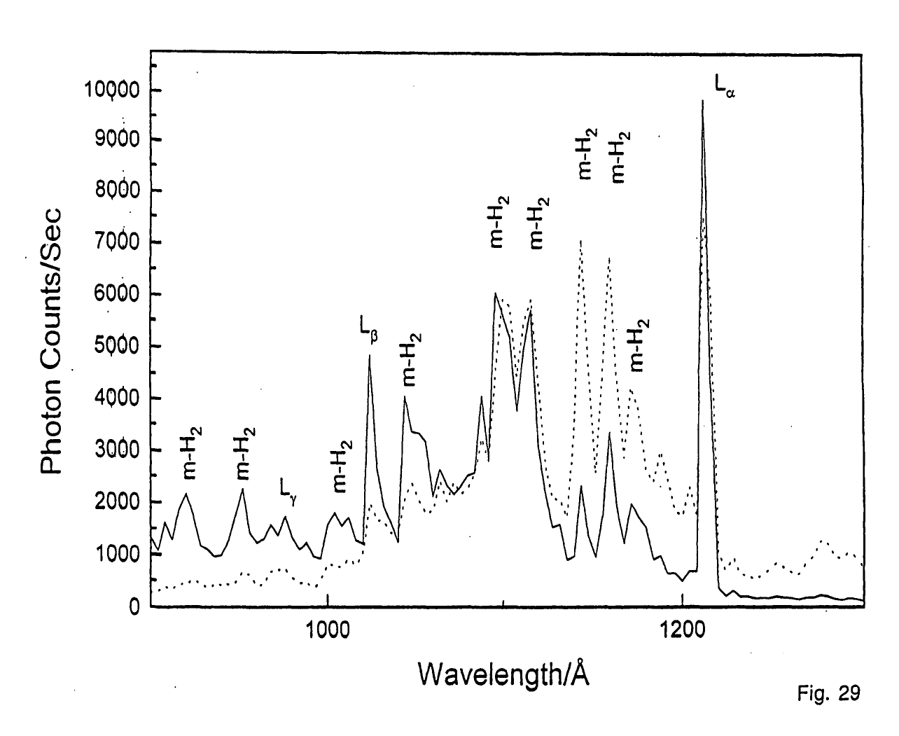

The VUV spectra (900-1300 Å) of the cell emission recorded at about the point of the maximum Lyman α emission from the KNO₃, RbNO₃, and CsNO₃ gas cells are shown in FIGS. 27-29, respectively, with the superimposed spectrum from the hydrogen microwave plasma. Strong Lyman series VUV emission was observed only with KNO₃, RbNO₃, or CsNO₃ (or cesium metal) and hydrogen. The CsNO₃ emission was similar to that of the hydrogen microwave plasma; whereas, the Lyman series lines of the KNO₃ and RbNO₃ rt-plasmas showed population inversion with much greater intensity of atomic hydrogen versus molecular hydrogen compared to the microwave plasma emission.

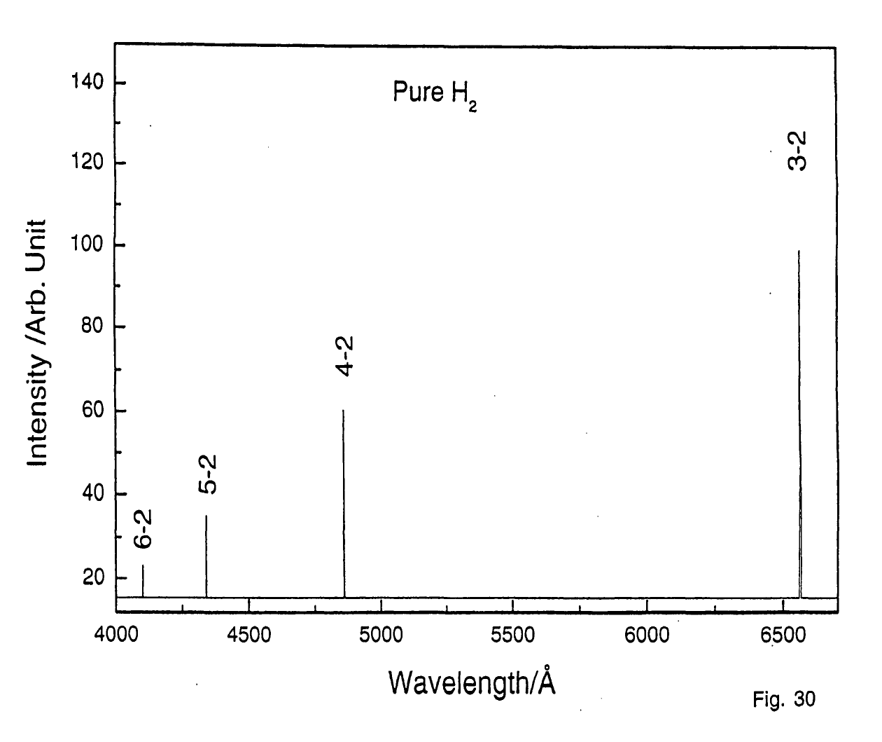

The Balmer spectra corresponding to the emission from the n=3, n=4, n=5, and n=6 states to the n=2 state recorded on a hydrogen microwave plasma, a KNO₃ rt-plasma, and a RbNO₃ rt-plasma are shown in FIGS. 30, 31, and 32, respectively. No population inversion was observed in the Balmer lines, but the Balmer α to Balmer β ratios of the KNO₃ rt-plasma and the RbNO₃ rt-plasma were higher relative to that of the control microwave plasma. This result indicates that the n=3 level was the most populated state and was consistent with the observed population inversion of the Lyman emission.

The Lyman population density of the excited hydrogen atoms N_{α}, N_{β}, and N_{γ} with principal quantum numbers n=2, 3, and 4, respectively, were obtained from their intensity integrated over the spectral peaks corrected by their Einstein coefficients. The population ratios,

$$\frac{{N}_{β}}{{N}_{α}} and \frac{{N}_{γ}}{{N}_{α}} ,$$

for pure H₂ and H₂ with KNO₃, RbNO₃, or CsNO₃ are given in TABLE 6.

TABLE 6
$The population density ratios \frac{{N}_{β}}{{N}_{α}} and \frac{{N}_{γ}}{{N}_{α}}$
for pure H₂, KNO₃, and RbNO₃.

| Plasma Gas | $\frac{{N}_{β}}{{N}_{α}}$ | $\frac{{N}_{γ}}{{N}_{α}}$ |
|---|---|---|
| Pure H₂^{a} | 0.664 | 0.521 |
| KNO₃ | 4.72 | 3.48 |
| RbNO₃ | 4.30 | 1.26 |
| CsNO₃ | 1.194 | 0.33 |

^{a}Measured on microwave discharge maintained after [13-14].

The important parameter for a lasing medium is the reduced population density N/g given by the population density N divided by the statistical weight g as discussed by Akatsuka et al. [6]. The ratio of N/g for L_{β} to L_{α} and L_{γ} to L_{α} given in TABLE 7 demonstrate that with appropriate cavity length and mirror reflection coefficient cw laser oscillations may be obtained between in =3 and n=2 since the corresponding

$$\frac{{N}_{β}}{{N}_{α}} \frac{{g}_{α}}{{g}_{β}} > 1 [ 6 ] .$$

Lasing further requires an overpopulation which may be determined from the absolute intensity of the Balmer α line.

TABLE 7
The reduced population density ratios N/g for pure H₂,
KNO₃, and RbNO₃.

| Plasma Gas | $\frac{{N}_{β}}{{N}_{α}} {\frac{{g}_{α}}{{g}_{β}} }^{a}$ | $\frac{{N}_{γ}}{{N}_{α}} {\frac{{g}_{α}}{{g}_{γ}} }^{b}$ |
|---|---|---|
| Pure H₂^{c} | 0.292 | 0.130^{c} |
| KNO₃ | 2.07 | 0.870 |
| RbNO₃ | 1.89 | 0.314 |
| CsNO₃ | 0.531 | 0.080 |

${ }^{a} \frac{{g}_{α}}{{g}_{β}} = 0.444 where g = 2 {n}^{2} and n is the principal quantum number$
${ }^{b} \frac{{g}_{α}}{{g}_{γ}} = 0.250$
^{c}Measured on microwave discharge after [14].

From the population ratios,

$$\frac{{N}_{β}}{{N}_{α}} ( \frac{{N}_{3`}}{{N}_{2}} ) and \frac{{N}_{γ}}{{N}_{α}} ( \frac{{N}_{4}}{{N}_{2}} ) ,$$

shown in TABLE 6, the corresponding

$$\frac{{N}_{4}}{{N}_{3}}$$

was determined to be 0.78, 0.74, and 0.29 for the hydrogen microwave plasma, KNO₃ rt-plasma, and RbNO₃ rt-plasma, respectively. Whereas, from the Balmer line intensities,

$$\frac{{N}_{4}}{{N}_{3}}$$

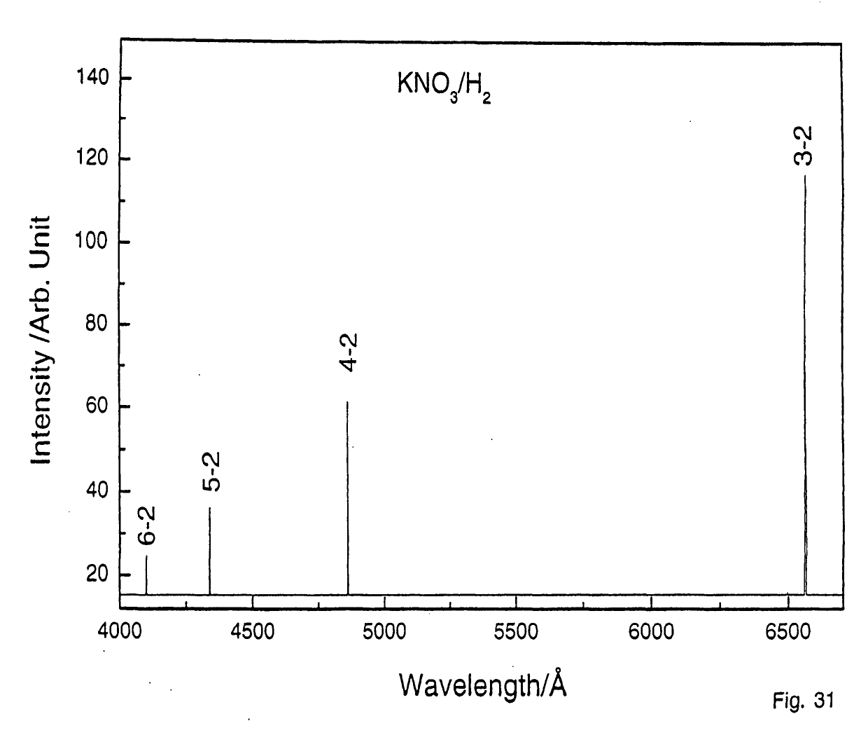

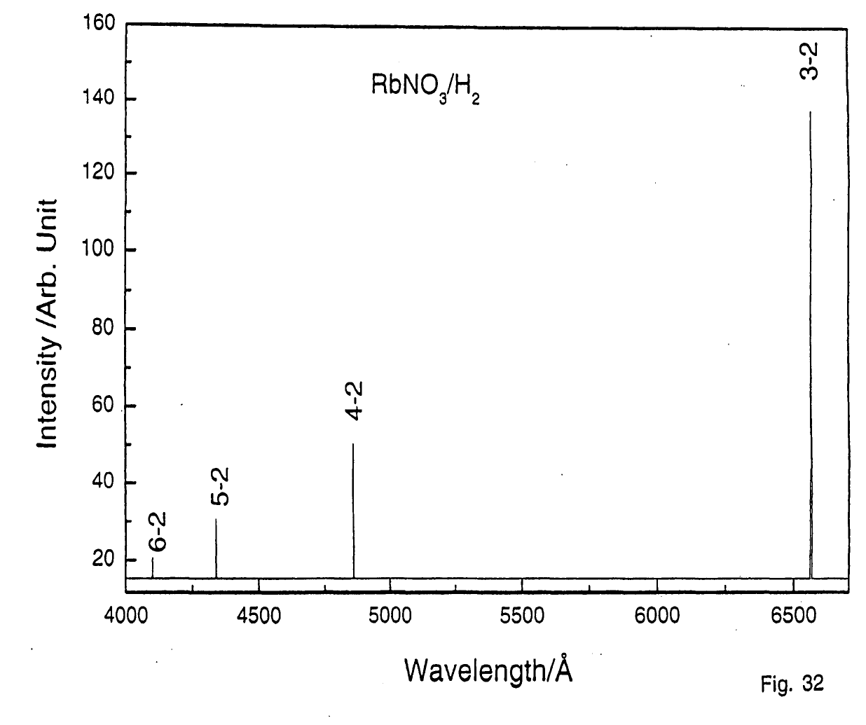

was determined to be 0.78, 0.76, and 0.29 for the hydrogen microwave plasma, KNO₃ rt-plasma, and RBNO₃ rt-plasma, respectively (cf. FIGS. 31 and 32). Since

$$\frac{{N}_{4}}{{N}_{3}}$$

determined from the Lyman series and the Balmer series was the same, and the Balmer α line was absolutely measured, the absolute reduced number densities for n=2 to n=6 were determined from the absolute Balmer α line intensity (i.e. using the experimental N₃˜1.25×10⁸ cm⁻³) and the relative ratio of the Lyman and Balmer series lines). A plot of the absolute reduced population density

$$\frac{{N}_{n}}{{g}_{n}}$$

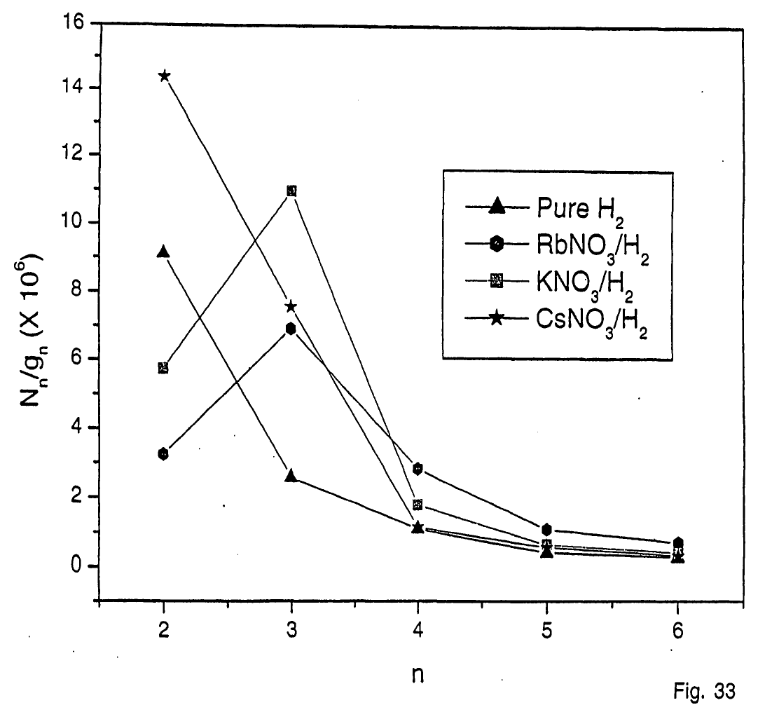

versus quantum number n recorded on recorded on a RbNO₃ rt-plasma, a KNO₃ rt-plasma, and a CsNO₃ rt-plasma is shown in FIG. 33. An inverted population was only observed for n=3 in the case of KNO₃ and RbNO₃ rt-plasmas.

For the plasma conditions of this experiment (Tₑ≈0.7−0.8 eV, nₑ≈10⁹ cm⁻³), a threshold reduced overpopulation of 4.4×10⁶ cm⁻³ is required for lasing assuming a cavity length of 100 cm and a combined mirror reflection coefficient of 0.99. Modeling results based on the collisional-radiative model [6] given in Sec. 3D show that the threshold condition is achievable for these plasmas.

Other explanations of the over population were ruled out. The spectrometer response was determined to be approximately flat in the 1000-1300 Å region. To investigate whether the rt-plasmas of this study were optically thin or thick at 1216 Å, the effective path length τ_{ω}(50 cm) was calculated from Eq. (74) using the absorption cross section for Lyman α emission, σ=4×10⁻¹⁶ cm² [26], and N_{H}=5×10¹¹ cm⁻³.

τ_{ω}(50 cm)=κ_{ω}L=(4×10⁻¹⁶ cm²)(5×10¹¹ cm⁻³)(50 cm)=1×10⁻² (76)

Since τ_{ω}(50)<<<1, the rt-plasmas were optically thin; so, the self absorption of 1216 Å emission by n=1 state atomic hydrogen may be neglected as the cause of the inverted ratio. Furthermore, the L_{α}/L_{β} intensity ratios of the control hydrogen plasmas closely matched the NIST intensity ratio using the NIST Einstein A coefficients [16]. Since the hydrogen pressure was the same in the rt-plasmas and the control hydrogen plasma, the same Einstein A coefficients were used to calculate the number density ratio in both cases.

In a non-recombining plasma [6], thermal electron collisional mechanisms can not produce the conditions necessary for population inversion. The highly ionized alkali ions observed in the plasma may ionize atomic hydrogen which may recombine in an excited state; yet, no such reaction has ever been observed which gives rise to an inverted Lyman population. Neither electrical ionization nor chemical ionization is known to form an inverted Lyman population. All known sources of excitation were exhausted [32].

Not only the observation of a stationary inverted Lyman population, but also the observed emission of VUV radiation, and in particular, Lyman series and Werner band emission from a low density plasma of quite moderate temperature was extraordinary. The incandescently heated cell should not emit VUV radiation. The spectra showed that the plasma was far from thermal equilibrium. It was unlikely that the cell components, such as the heater and titanium mesh contributed to a non Maxwellian free-electron velocity distribution. And, if the velocity distribution of free electrons determined the population of the electronic levels, it must have been an unusual one because of the preference for emission from a few specific electronic states of low quantum number. A corona equilibrium was also an inappropriate model for the plasma. Given the observations, free electrons could not excite these states. In the case that the free electrons should have been thermalized, their temperature was too low to contribute to excitation or ionization even from the tail of the velocity distribution. Longer range fields (of the order of mm) were only about a 1 V/cm. In addition to electron collisional excitation, known chemical reactions, resonant photon transfer, and multiphoton absorption, and the lowering of the ionization and excitation energies by the state of “non ideality” in dense plasmas were also rejected as the source of ionization or excitation to form the hydrogen plasma. The observation lead to the conclusion that a novel chemical power source was present.

Without the combination of KNO₃, RbNO₃, or CsNO₃ and hydrogen, only blackbody radiation from the tungsten heater was observed at lower wavelengths unless the low-voltage and temperature dependent plasma formed [7, 32-34]. Based on the VUV emission, the plasma was predominately a hydrogen plasma. The ionization of atomic hydrogen requires 13.6 eV. In the cases where plasma was observed, no possible chemical reaction of the tungsten filament, the titanium screen, KNO₃, RbNO₃, or CsNO₃, and low pressure hydrogen at a cell temperature of 750° C. could be found which accounted for the generation and sustaining of the plasma and observed spectra. In fact, no known chemical reaction releases enough energy to form an atomic hydrogen plasma of sufficient free electron and excitation temperature. Only the Lyman series of atomic hydrogen and molecular hydrogen emission and alkali emission was observed in the VUV. Only alkali metal and ion lines and atomic and molecular hydrogen emission was observed in the visible. Thus, we considered energetic chemistry of the observed emitting species.

The enthalpy of formation ΔHₚ of potassium, rubidium and cesium hydride is −14.13, −13.00, and −13.50 kcal/mole [35]. Thus, the formation of potassium, rubidium, and cesium hydride releases 0.59, 0.54, and 0.56 eV per atom, respectively. In addition, these hydrides decompose in this temperature range (288 to 415° C.). Thus, hydride formation can not account for any emission of the hydrogen plasma.

The enthalpy for the decomposition of KNO₃ [36] is

$$K N {O}_{3} -> K + \frac{1}{2} {N}_{2} + \frac{3}{2} {O}_{2} \\ ΔH = \frac{+ 118.2 kcal}{mole K N {O}_{3}} \qquad ( 77 )$$

The enthalpy for combustion of the released oxygen to form H₂O(g) is

$${H}_{2} ( g ) + \frac{1}{1} {O}_{2} ( g ) -> {H}_{2} O ( g ) \\ Δ {H}_{f} = \frac{- 57.8 kcal}{mole {H}_{2}} \qquad ( 78 )$$

or 1.25 eV per hydrogen atom. The reduction of KNO₃ to water, potassium metal, and NH₃ calculated from the heats of formation [37] only releases 0.3 eV per hydrogen atom.

9/2H₂+KNO₃→K+3H₂O+NH₃ ΔH=−14.7 kcal/mole H₂ (79)

Combining Eqs. (77-78) gives the enthalpy for the reduction of KNO₃ to water and nitrogen gas

$$K N {O}_{3} + 3 {H}_{2} -> K + \frac{1}{2} {N}_{2} + 3 {H}_{2} O \\ ΔH = \frac{- 55.2 kcal}{mole K N {O}_{3}} \qquad ( 80 )$$

or 0.399 eV per hydrogen atom. Whereas, the energy of Lyman emission is greater than 10.2 eV per atom.

The electrical input power required to maintain a glow discharge plasma in the one liter cell used to form the rt-plasmas was determined to be over 100 W. The complete combustion of the 5.5 sccm of hydrogen flow in the rt-plasmas would produce less than one watt based on the enthalpy of combustion of −241.8 kJ/mole H₂. However, nitrate was the only source of oxygen gas. The titanium screen was coated with about 0.1 g of KNO₃ or RbNO₃. From Eq. (80), the reduction of 0.1 g of KNO₃ is ΔH=−55.17 kcal/mole KNO₃. Given, that the rt-plasma was continuous for over 6 hours, the corresponding power is less about 10 mW of heat which is negligible. The corresponding power density is 10 μW/cm³; whereas, according to the Stefan-Boltzmann equation the thermal power required to maintain a hydrogen plasma (20,000 K) is about 4 MW/cm³.

The most energetic reaction is given by Eq. (79) with ΔH=−66.1 kcal/mole KNO₃. The corresponding power is also about 10 mW of heat. And, no rt-plasma formed with Al(NO₃)₃ and Mg(NO₃)₂.

Since K⁺ was present initially as KNO₃, we considered an electron transfer between K⁺ and H. K⁺ releases 4.34 eV when it is reduced to K, and H requires 13.6 eV to be ionized to H⁺. The combination of reactions K⁺ to K and H to H⁺, then, has a net enthalpy of reaction of 9.26 eV—the opposite of the required release of energy of this magnitude or higher. The same conclusion is arrived at for Rb⁺ and Cs⁺.

K²⁺ may ionize atomic hydrogen, but an energy significantly greater than 13.6 eV is required since this is not a known chemically stable state and at least 31.63 eV is required for its formation since the second ionization energy of potassium is 31.63 eV. In the case of Rb²⁺ and Cs²⁺, sources of 27.28 eV and 23.16 eV, respectively, are required.

The dissociation of atomic hydrogen on the filament produces atomic hydrogen which may recombine to release 4.45 eV. Since atomic hydrogen is neutral, no contribution from the electric field of the filament was possible. Thus, excitation with energies of 4.45 eV or less was possible by the transport of thermal energy from the filament due to hydrogen dissociation followed by recombination. But, this reaction is not sufficiently energetic to support the observed VUV emission.

Chemical energy may have been transported from regions outside of the annular region where most of the emission was observed. Dense and cold plasmas may have been created close to surfaces such as the titanium mesh due to chemical reactions. In such non ideal plasmas with electron densities close to solid density and temperatures below 0.5 eV, the potential energy of the electrons becomes comparable to their kinetic energy, and energy levels of bound electrons in atoms such as hydrogen are altered such that excitation and ionization energies are lowered [38]. This also applies to other elements of the plasma such as potassium. The electronic energy levels of the different species are further distorted when interacting with each other. The dissociation of molecules and ionization of both the molecules and atoms may become more probable with more species. However, the lowering of the ionization and excitation energies by the state of “non ideality” in dense plasmas is only about 1 eV even for potassium. Thus, the most energetic chemical source possible, dissociated atomic hydrogen, could not have provided more energy than the Frank-Condon energy of 4.45 eV during recombination. Thus, a state of “non ideality” of the plasma can not explain the energetic processes of at least 10 eV. Furthermore, the electron density measured using a Langmuir probe was nₑ=2×10⁹ cm⁻³ [39], 15 orders of magnitude less than solid density which eliminates any possibility of non ideality in these plasmas.

The measured electron temperature, Tₑ<1 eV, was over an order of magnitude too low to account for the hydrogen plasma. The filament electric field as the energy source of the excitation was also eliminated. It was reported previously that the emission occurred even when the electric field was set and measured to be zero [32-34]. The results could not be explained by electric field acceleration of charged species since the measured field of the incandescent heater was extremely weak, about 1 V/cm. The electron mean free path at the operating pressure range of 0.1 to 1 mbar was about 0.1 cm corresponding to a mean energy from the acceleration of electrons in the field of about 1 V/cm of under 1 eV. Thus, electron collisional excitation of Lyman emission or hydrogen ionization by a so called ‘run-way-situation’ of the velocities of free electrons is not probable. In addition, the correspond broadening of the Balmer line a would be much less than 1 eV compared that actually observed of over an order of a magnitude higher as shown in TABLE 4.

The field was negligible relative to that which causes an electrical discharge. At the same hydrogen pressure as that of the present studies, breakdown did not occur for an applied voltage of less than 3000 V or about 1000 V/cm across the leads with the filament disconnected. In this case, only an arc formed versus a plasma which filled the entire cell when incandescently heated KNO₃, RbNO₃, or CsNO₃ and hydrogen were present.

Temperature dependent electric fields also arise do to the greater mobility of electrons compared to ions. The generated voltage U for a plasma with a similar ion and electron temperature T is given by

$$U = \frac{kT}{2 e} ln \frac{{m}_{x}}{{m}_{e}} \qquad ( 81 )$$

where mₓ is the mass of the ion such as the potassium ion or a proton, mₑ is the electron mass, and e is the electron charge. From Eq. (81), the maximum voltage corresponding to the potassium ion was of the order of 1 V.

Excitation of hydrogen in one region of the cell with transport to produce excited state emission from the center of the cell was eliminated as a possibility. The emission was observed from the gas in the annular space between the central filament and the outer titanium mesh. Since the lifetimes of H (n=2) and H (n=3) are each approximately 10⁻⁸ s and the average velocity of the fastest hydrogen atoms was <10⁵ m/s, the excitation must have been local [21].

Multi-collisional processes may be possible [40], but very dense, high-pressure plasmas are required, and given an electron energy of Tₑ<1 eV, about 30 concerted electron collisions would be required within 10⁻⁸ s—a definite impossibility.

Multiphoton absorption with excitation to intermediate virtual levels may be possible [41-43], but extraordinary power of the order of GW are required from pulsed lasers [44].

Resonant energy transfer from excited species to hydrogen atoms in the ground state is possible to give predominantly Lyman α and Lyman β emission. Kurunczi, Shah, and Becker [40, 45-46] observed intense emission of Lyman α and Lyman β radiation at 121.6 nm and 102.5 nm, respectively, from microhollow cathode discharges in high-pressure Ne (740 Torr) with the addition of a small amount of hydrogen (up to 3 Torr). With essentially no molecular emission observed, Kurunczi et al. attributed the anomalous Lyman α emission to the near-resonant energy transfer between the Ne₂⁺ excimer and H₂ which leads to formation of H(n=2) atoms, and attributed the Lyman β emission to the near-resonant energy transfer between excited Ne⁺ atoms (or vibrationally excited neon excimer molecules) and H₂ which leads to formation of H(n=3) atoms. However, the formation of this plasma resulting in Ne₂⁺ excimers and excited Ne⁺ atoms required a field of over 10⁴ V/cm and a power density of several hundred kilowatts per cm³. Whereas, the field in the heated cells was on the order of 1 V/cm, and power was only applied to the filament. Thus, this mechanism does not provide a source of energetic excited states that may resonantly transfer energy to atomic hydrogen.

The titanium-mesh hydrogen dissociator was present in all experiments. It was previously reported [32-33] that the emission was not observed with the cell alone, with hydrogen alone, or under identical conditions wherein Na₂CO₃ replaced K₂CO₃. When the power was interrupted, the emission decayed in about two seconds. Decay was recorded over a time greater than 10,000 times the typical duration of a discharge plasma afterglow [47]. This experiment showed, that plasma emission was occurring even though the voltage between the heater wires was set to and measured to be zero for a time duration which was surprisingly extended. Since the thermal decay time of the filament for dissociation of molecular hydrogen to atomic hydrogen was similar to the plasma afterglow duration which required the presence of K₂CO₃ the emission was determined to be due to a reaction of K₂CO₃ with atomic hydrogen. The minimum temperature requirement of the tungsten wire for emission also demonstrated the emission reaction's dependence on atomic hydrogen [32]. These results also could not be explained by a conventional chemical reaction since the reduction of K₂CO₃ by hydrogen calculated from the heats of formation is very endothermic [48].

H₂+K₂CO₃→2K+H₂O+CO₂ ΔH=+122.08 kcal/mole H₂ (82)

The reaction absorbs 2.5 eV per hydrogen atom. A source of energy other than that provided by the electric field or known chemical reactions is required.

The observation, then, of population inversion also indicates the presence of free energy in the system. This is further evidence that a new chemical source of energy, greater than 12 eV/atom was present as is the observation of ions such as K³⁺ which requires an energy source of at least 81.7766 eV. The only possibility known to the authors is the proposed rt-plasma reaction [7]. We propose that the plasma formed chemically rather than electrically and that the product of the energetic chemical reaction of atomic hydrogen with potassium or rubidium ions which serve as catalysts as well as reactants are compounds having novel hydride ions reported previously [39]. Prior related studies that support the possibility of a novel reaction of atomic hydrogen which produces a chemically generated or assisted plasma (rt-plasma) and produces novel hydride compounds include VUV spectroscopy [7-8, 13-14, 22, 28, 32-34, 39, 49-55], characteristic emission from catalysts and the hydride ion products [28, 32, 39, 52-53], lower-energy hydrogen emission [13, 49-51, 54], chemically formed plasmas [7-8, 28, 32-34, 39, 52-53], Balmer α line broadening [8, 14, 22, 39, 49-50, 54-55], elevated electron temperature [14, 22, 49, 54], anomalous plasma afterglow duration [32-34], power generation [22, 49-50, 54], and analysis of novel chemical compounds [56-57].

The predicted catalyst ion emission was observed from rt-plasmas as presented in Sec. 3B. For example, characteristic emission was observed from K²⁺ as well as K³⁺ which confirmed the resonant energy transfer of 27.2 eV and 3·27.2 eV, respectively, from atomic hydrogen to the catalyst K⁺/K⁺ and K, respectively. With a highly conductive plasma, the voltage of the cell was about 20 V, and the field strength was about 1-2 V/cm which was too low to ionize potassium to K³⁺ which requires at least 81.7766 eV. Similarly, the ionization of K⁺ to K²⁺ requires 31.63 eV which could not have been due to the weak electric field. Known chemical reactions are also of too low an energy by at least an order of magnitude to form K²⁺ and K³⁺. The K³⁺ lines generated in the incandescently heated cell and due to the catalyst reaction of atomic hydrogen were confirmed by a high voltage discharge and NIST tables [16, 29].

Then the inverted population is explained by a resonant energy transfer between hydrogen and potassium or rubidium catalysts to yield fast H(n=1) atoms. The emission of excited state H from fast H(n=1) atoms excited by collisions with the background H₂ has been discussed by Radovanov et al. [20]. Collisions with oxygen may also play a role in the inversion since inverted hydrogen populations are observed in the case of alkali nitrates and water vapor plasmas [55]. Formation of H⁺ is also predicted which is far from thermal equilibrium in terms of the hydrogen atom temperature as discussed in Sec. 3A and modeled in Sec. 3D. Akatsuka et al. [6] show that it is characteristic of cold recombining plasmas to have the high lying levels in local thermodynamic equilibrium (LTE); whereas, population inversion is obtained when Tₑ suddenly decreases concomitant with rapid decay of the lower lying states.

### D. Level Population Model and Lasing Ability

In order to estimate hydrogen excited state level populations and assess lasing ability, the collisional radiative model [6, 58] is applied to the plasma conditions obtained herein (Tₑ˜0.8 eV, nₑ˜10⁹ cm⁻³). The collisional radiative model explicitly includes all level population and de-population mechanisms for each excited level from every other excited level in the hydrogen atom. Excited level n is, then, populated by collisional excitation from all lower excited states, and collisional and radiative de-excitation from all higher excited states. De-population explicitly includes collisional and radiative de-excitation to all lower states, and collisional excitation to all higher levels. Independent ionization loss, radiative recombination, and dielectronic recombination are included for all levels as well. A separate balance equation is prescribed for each individual level and is coupled to all other level equations through the population and de-population terms described above.

In order to close the set of equations, truncation was chosen at n=5. This is justified by both the experimental observation of very low measurable emission from higher lying states and a posteriori via the model results indicating a progression of negligibly smaller level densities beyond n=3. The ground state (n=1) level population cannot be determined by this method since the important affects of dissociation, molecular recombination, and transport are not included. As discussed earlier (Sec. 3A), however, an estimate based on emission line profiles places the total H atom density ˜5×10¹¹ cm⁻³. Since this is overwhelmingly dominated by the ground state, the assignment N₁=5×10¹¹ cm⁻³ will be made throughout.

Solution to the n=2-5 level equations under these conditions shows no inversion in any of the level populations. This is an expected result for a steady, thermal plasma. Also, as expected, the dominant mechanisms are found to be population by collisional excitation and de-population by radiative decay.

The results of this calculation (N₂₋₅<10⁴ cm⁻³) are inconsistent with the spectroscopic observations. Absolutely calibrating the monochromator near H_{α}, however, yields N₃˜1.25×10⁸ cm⁻³. There is, then, a heretofore undetermined mechanism providing direct excited state population, i.e. pumping. To help quantify the affects of this mechanism, the level equations are once again evaluated with N₃ fixed to 1.25×10⁸ cm⁻³ and the inclusion of an independent pumping rate. Since spectroscopic results indicate n=3−2 inversion, pumping is prescribed to the n=3 state from the ground state, n=1. The results from this calculation for n=1-5 are summarized in TABLE 8.

TABLE 8
Level densities Nₙ for excited states n = 1-5 with
an n = 3 pumping mechanism.

| n | Nₙ (10⁸ cm⁻³) |
|---|---|
| 1 | 5000 |
| 2 | 0.18 |
| 3 | 1.25 |
| 4 | 0.000229 |
| 5 | 0.000138 |

Now collisional mechanisms from the n=3 state as well as ground state collisional excitation and radiative decay significantly contribute to population and de-population rates. In addition, a demonstrated inversion in the population between the n=3 and 2 states is predicted. The reduced overpopulation density for this case is Δ(N/g)˜4.7×10⁶ cm⁻³, slightly above the threshold of 4.4×10⁶ cm⁻³. The pumping rate is also determined in this analysis yielding a rate of ˜6.44×10¹⁶ cm⁻³s⁻¹. Since the n=3 state has a excitation energy of 12.08 eV, the pumping mechanism consumes energy at a rate of ˜0.124 W˜cm⁻³, which is returned as H_{α} and H_{β} radiation.

### 4. Conclusion

The generation of the Lyman and Balmer series and the Lyman Werner bands of molecular hydrogen requires energies significantly greater than 10 eV. The formation of a hydrogen plasma by the cell loaded with KNO₃, RbNO₃, or CsNO₃ on titanium and operated in hydrogen required a minimum temperature. The heat from the filament and possibly the weak dipole field from the filament may sustain the hydrogen plasma; but, the latter is not be essential because hydrogen lines are emitted during times when this voltage is set to zero [32-34]. Furthermore, given the observations, free electrons could not excite these states. Tₑ was determined to be 0.84 eV and 0.76 eV for the KF and Rb⁺ rt-plasma respectively. Similarly, k_{B}Tₑ=(0.30−0.43) eV was determined for a K⁺ rt-plasma as reported by Conrads et al. [32] with the assumption of a Maxwell Boltzmann distribution of the level population, and a slightly higher temperature of k_{B}Tₑ=(0.32−0.48) eV was found lien a corona model was applied. The data indicated that the electron temperature was not higher than k_{B}Tₑ=0.5 eV. On this basis, it was astonishing that a strong Lyman beta transition appeared in the spectra since an excitation energy of 12.1 eV is required. This energy is a factor of about 25 above the measured thermal energy. The amount of electrons in the Maxwell tail that had enough energy to enhance the Lyman transition was 11 orders of magnitude lower than the total number of electrons. Longer range fields (of the order of nun) were only about a 1 V/cm. In addition to electron collisional excitation, known chemical reactions, resonant photon transfer, and multiphoton absorption, and the lowering of the ionization and excitation energies by the state of “non ideality” in dense plasmas were also rejected as the source of ionization or excitation to form the hydrogen plasma.

2K⁺ to K+K²⁺, Rb⁺ to Rb²⁺, and Cs to Cs²⁺ each provide a reaction with a net enthalpy equal to the potential energy of atomic hydrogen, 27.2 eV, and K to K³⁺ provides a reaction with a net enthalpy equal to 3·27.2 eV. The presence of these gaseous atoms and ions with thermally dissociated hydrogen formed a plasma having strong VUV emission. Emission was observed from Rb⁺, Rb²⁺, K, K⁺, K²⁺, K³⁺, Cs, Cs⁺, and CS²⁺ that confirmed the resonant energy transfer with the formation of the corresponding rt-plasma. Emission was also observed from a continuum state of Cs²⁺ at 533 Å. The single emission feature with the absence of the other corresponding Rydberg series of lines from species confirmed the resonant energy transfer of 27.2 eV from atomic hydrogen to atomic cesium.

A stationary inverted Lyman population was observed with potassium and rubidium catalysts. The ionization and population of excited atomic hydrogen levels was attributed to energy provided by the rt-plasma reactions. The high hydrogen atom temperature with a relatively low electron temperature, Tₑ<1 eV, were characteristic of cold recombining plasmas [6]. These conditions of the rt-plasmas favored an inverted population in the lower levels. Thus, the catalysis of atomic hydrogen may pump a cw HI laser. From our results, laser oscillations are expected between n=3 and n=2.

### REFERENCES

1. C. Zimmermann, R. Kallenbach, T. W. Hansch, Phys. Rev. Lett., Vol. 65, (1990), p. 571.
2. T. Tbuki, Chem. Phys. Lett., Vol. 94, (1990), p. 169.
3. L. I. Gudzenko, L. A. Shelepin, Sov. Phys. JEPT, Vol. 18, (1963), p. 998.
4. S. Suckewer, H. Fishman, J. Appl. Phys., Vol. 51, (1980), p. 1922.
5. W. T. Silfvast, O. R. Wood, J. Opt. Soc. Am. B, Vol. 4, (1987), p. 609.
6. H. Akatsuka, M. Suzuki, “Stationary population inversion of hydrogen in arc-heated magnetically trapped expanding hydrogen-helium plasma jet”, Phys. Rev. E, Vol. 49, (1994), pp. 1534-1544.
7. R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943.
8. R. Mills and M. Nansteel, P. Ray, “Argon-Hydrogen-Strontium Discharge Light Source”, IEEE Transactions on Plasma Science, Vol. 30, No. 2, (2002), pp. 639-653.
9. R. Mills, The Grand Unified Theory of Classical Quantum Mechanics, September 2001 Edition, BlackLight Power, Inc., Cranbury, N.J., Distributed by Amazon.com; posted at www blacklightpower.com.
10. R. Mills, “The Grand Unified Theory of Classical Quantum Mechanics”, Int. J. Hydrogen Energy, Vol. 27, No. 5, (2002), pp. 565-590.
11. R. Mills, “The Nature of Free Electrons in Superfluid Helium—a Test of Quantum Mechanics and a Basis to Review its Foundations and Make a Comparison to Classical Theory”, Int. J. Hydrogen Energy, Vol. 26, No. 10, (2001), pp. 1059-1096.
12. David R. Lide, CRC Handbook of Chemistry and Physics, 79th Edition, CRC Press, Boca Raton, Fla., (1998-9), p. 10-175 to p. 10-177.
13. R. Mills, P. Ray, “Spectral Emission of Fractional Quantum Energy Levels of Atomic Hydrogen from a Helium-Hydrogen Plasma and the Implications for Dark Matter”, Int. J. Hydrogen Energy, Vol. 27, No. 3, pp. 301-322.
14. R. L. Mills, P. Ray, B. Dhandapani, J. He, “Comparison of Excessive Balmer α Line Broadening of Glow Discharge and Microwave Hydrogen Plasmas with Certain Catalysts”, J. of Applied Physics, in press.
15. H. R. Griem, Principles of Plasma Spectroscopy, Cambridge University Press, (1987).
16. NIST Atomic Spectra Database, www.physics.nist.gov/cgi-bin/AtData/display.ksh.
17. J. Tadic, I. Juranic, G. K. Moortgat, “Pressure dependence of the photooxidation of selected carbonyl compounds in air: n-butanal and n-pentanal”, J. Photochemistry and Photobiology A: Chemistry, Vol. 143, (2000), 169-179.
18. I. R. Videnovic, N. Konjevic, M. M. Kuraica, “Spectroscopic investigations of a cathode fall region of the Grimm-type glow discharge”, Spectrochimica Acta, Part B, Vol. 51, (1996), pp. 1707-1731.
19. M. Kuraica, N. Konjevic, “Line shapes of atomic hydrogen in a plane-cathode abnormal glow discharge”, Physical Review A, Volume 46, No. 7, October (1992), pp. 4429-4432.
20. S. B. Radovanov, K. Dzierzega, J. R. Roberts, J. K. Olthoff, “Time-resolved Balmer-alpha emission from fast hydrogen atoms in low pressure, radio-frequency discharges in hydrogen”, Appl. Phys. Letts., Vol. 66, No. 20, (1995), pp. 2637-2639.
21. S. Djurovic, J. R. Roberts, “Hydrogen Balmer alpha line shapes for hydrogen-argon mixtures in a low-pressure rf discharge”, J. Appl. Phys., Vol. 74, No. 11, (1993), pp. 6558-6565.
22. R. L. Mills, P. Ray, “Substantial Changes in the Characteristics of a Microwave Plasma Due to Combining Argon and Hydrogen”, New Journal of Physics, www.njp.org, Vol. 4, (2002), pp. 22.1-22.17.
23. J. Seidel, “Theory of two-photon polarization spectroscopy of plasma-broadened hydrogen L., line”, Phys. Rev. Letts., Vol. 57, No. 17, (1986), p. 2154.
24. A. Czernikowski, J. Chapelle, Acta Phys. Pol. A., Vol. 63, (1983), p. 67.
25. M. A. Gigosos, V. Cardenoso, “New plasma diagnosis tables of hydrogen Stark broadening including ion dynamics”, J. Phys. B: At. Mol. Opt. Phys., Vol. 29, (1996), pp. 4795-4838.
26. H. Okabe, Photochemistry of Small Molecules, John Wiley & Sons, New York, (1978).
27. A. Corney, Atomic and Laser Spectroscopy, Clarendon Press, Oxford, (1977).
28. R. Mills, P. Ray, “Spectroscopic Identification of a Novel Catalytic Reaction of Potassium and Atomic Hydrogen and the Hydride Ion Product”, Int. J. Hydrogen Energy, Vol. 27, No. 2, (2002), pp. 183-192.
29. R. Kelly, Journal of Physical and Chemical Reference Data, “Atomic and Ionic Spectrum Lines below 2000 Angstroms: Hydrogen through Krypton”, Part I (H—Cr), Volume 16, (1987), Supplement No. 1, Published by the American Chemical Society and the American Institute of Physics for the National Bureau of Standards, pp. 418-422.
30. J. Reader, G. L. Epstein, “Resonance lines of Cs II, Ba III, and La IV”, Journal of the Optical Society of America, Vol. 65, No. 6, June, (1975), pp. 638-641.
31. I. S. Aleksalchin, G. G. Bogachev, A. I. Zapesochnyi, “Study of the emission of potassium, rubidium, and cesium in the 45-75 nm region during electron-atom collisions”, J. Applied Spectroscopy, Vol. 23, No. 6, December, (1975), pp. 1666-1668. Translated from Zh. Prikl. Spektrosk. (USSR), Vol. 23, No. 6, December (1975), pp. 1103-1105.
32. H. Conrads, R. Mills, Th. Wrubel, “Emission in the Deep Vacuum Ultraviolet from an Incandescently Driven Plasma in a Potassium Carbonate Cell”, Plasma Sources Science and Technology, submitted.
33. R. Mills, “Temporal Behavior of Light-Emission in the Visible Spectral Range from a Ti—K₂CO₃—H-Cell”, Int. J. Hydrogen Energy, Vol. 26, No. 4, (2001), pp. 327-332.
34. R. Mills, T. Onuma, and Y. Lu, “Formation of a Hydrogen Plasma from an Incandescently Heated Hydrogen-Catalyst Gas Mixture with an Anomalous Afterglow Duration”, Int. J. Hydrogen Energy, Vol. 26, No. 7, July, (2001), pp. 749-762.
35. W. M. Muller, J. P. Blackledge, G. G. Libowitz, Metal Hydrides, Academic Press, New York, (1968), p 201.
36. David R. Lide. CRC Handbook of Chemistry and Physics, 79 th Edition, CRC Press, Boca Raton, Fla., (1998-9), p. 5-20.
37. David R. Lide, CRC Handbook of Chemistry and Physics, 79 th Edition, CRC Press, Boca Raton, Fla., (1998-9), p. 5-18.
38. H. W. Darwin and P. Felenbok, “Data for Plasmas in Local Thermodynamic Equilibrium”, Gauthier-Villars ed., Paris, (1965).
39. R. L. Mills, P. Ray, “A Comprehensive Study of Spectra of the Bound-Free Hyperfine Levels of Novel Hydride Ion H⁻(½), Hydrogen, Nitrogen, and Air”, Int. J. Hydrogen Energy, in press.
40. P. Kurunczi, H. Shah, and K. Becker, “Excimer formation in high-pressure microhollow cathode discharge plasmas in helium initiated by low-energy electron collisions”, International Journal of Mass Spectroscopy, Vol. 205, (2001), pp. 277-283.
41. 4. B. J. Thompson, Handbook of Nonlinear Optics, Marcel Dekker, Inc., New York, (1996), pp. 497-548.
42. Y. R. Shen, The Principles of Nonlinear Optics, John Wiley & Sons, New York, (1984), pp. 203-210.
43. B. de Beauvoir, F. Nez, L. Julien, B. Cagnac, F. Biraben, D. Touahri, L. Hilico, O. Acef, A. Clairon, and J. J. Zondy, Physical Review Letters, Vol. 78, No. 3, (1997), pp. 440-443.
44. E. Parra, I. Alexeev, J. Fan, K. Y. Kim, S. J. McNaught, and H. M. Milchberg, “X-ray and extreme ultraviolet emission induced by variable pulse-width irradiation of Ar and Kr clusters and droplets, Physical Review E, Vol. 62, No. 5, November (2000), pp. RS931-RS934.
45. P. F. Kurunczi, K. H. Becker, “Microhollow Cathode Discharge Plasma: Novel Source of Monochromatic Vacuum Ultraviolet Radiation”, Proc. Hakone VII, Int. Symp. High Pressure, Low Temperature Plasma Chemistry, Greifswald, Germany, Sep. 10-13, (2000), Vol. 2, p. 491.
46. P. Kurunczi, H. Shah, and K. Becker, “Hydrogen Lyman-α and Lyman-β emissions from high-pressure microhollow cathode discharges in Ne—H₂ mixtures”, J. Phys. B: At. Mol. Opt. Phys., Vol. 32, (1999), L651-L658.
47. A. Surmeian, C. Diplasu, C. B. Collins, G. Musa, I-lovittz Popescu, J. Phys. D: Appl. Phys. Vol. 30, (1997), pp. 1755-1758.
48. R. C. Weast, CRC Handbook of Chemistry and Physics, 58 th Edition, CRC Press, West Palm Beach, Fla., (1977-78), pp. D-67-77.
49. R. L. Mills, P. Ray, B. Dhandapani, M. Nansteel, X. Chen, J. He, “Spectroscopic Identification of Transitions of Fractional Rydberg States of Atomic Hydrogen”, J. of Quantitative Spectroscopy and Radiative Transfer, Vol. 76, No. 1, (2003), pp. 117-130.
50. R. L. Mills, P. Ray, B. Dhandapani, M. Nansteel, X. Chen, J. He, “New Power Source from Fractional Quantum Energy Levels of Atomic Hydrogen that Surpasses Internal Combustion”, J. Mol. Struct., in press.
51. R. Mills, P. Ray, “Vibrational Spectral Emission of Fractional-Principal-Quantum-Energy-Level Hydrogen Molecular Ion”, Int. J. Hydrogen Energy, Vol. 27, No. 5, (2002), pp. 533-564.
52. R. Mills, “Spectroscopic Identification of a Novel Catalytic Reaction of Atomic Hydrogen and the Hydride Ion Product”, Int. J. Hydrogen Energy, Vol. 26, No. 10, (2001), pp. 1041-1058.
53. R. L. Mills, P. Ray, “Spectroscopic Identification of a Novel Catalytic Reaction of Rubidium Ion with Atomic Hydrogen and the Hydride Ion Product”, Int. J. Hydrogen Energy, Vol. 27, No. 9, (2002), pp. 927-935.
54. R. L. Mills, X. Chen, P. Ray, J. He, B. Dhandapani, “Plasma Power Source Based on a Catalytic Reaction of Atomic Hydrogen Measured by Water Bath Calorimetry”, Thermochimica Acta, submitted.
55. R. Mills, P. Ray, R. M. Mayo, “Stationary Inverted Balmer and Lyman Populations for a CW HI Water-Plasma Laser”, IEEE Transactions on Plasma Science, submitted.
56. R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367.
57. R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203.
58. T. Fujimoto, J. Phys. Soc. Jpn., Vol. 47, (1979). p. 265.

### 7.2 Stationary Inverted Balmer and Lyman Populations for a CW HI Water-Plasma Laser

### Abstract

Stationary inverted H Balmer and Lyman populations were observed from a low pressure water-vapor microwave discharge plasma. The ionization and population of excited atomic hydrogen levels was attributed to energy provided by a catalytic resonant energy transfer between hydrogen atoms and molecular oxygen formed in the water plasma. The catalysis mechanism was supported by the observation of O²⁺ and H Balmer line broadening of 55 eV compared to 1 eV for hydrogen alone. The high hydrogen atom temperature with a relatively low electron temperature, Tₑ=2 eV, exhibited characteristics of cold recombining plasmas. These conditions of a water plasma favored an inverted population in the lower levels. Thus, the catalysis of atomic hydrogen may pump a cw HI laser. From our results, laser oscillations are may be possible from i) n=3, n=4, n=5, n=6, n=7 and n=8 to n=2, ii) n=4, n=5, n=6, and n=7 to n=3 and iii) n=5 and n=6 to n=4. Lines of the Balmer series of n=5, and n=6 to n=2 and the Paschen series of n=5 to n=3 were of particular importance because of the potential to design blue and 1.3 micron infrared lasers, respectively, which are ideal for many communications and microelectronics applications. At a microwave input power of 9 W·cm⁻³, a collisional radiative model showed that the hydrogen excited state population distribution was consistent with an n=1→5,6 pumping power of an unprecedented 200 W·cm⁻³. High power hydrogen gas lasers are anticipated at wavelengths, over a broad spectral range from far infrared to violet which may be miniaturized to micron dimensions. Such a hydrogen laser represents the first new atomic gas laser in over a decade, and it may prove to be the most efficient, versatile, and useful of all. A further application is the direct generation of electrical power using photovoltaic conversion of the spontaneous or stimulated water vapor plasma emission.

### 1. Introduction

For the last fifteen years there has been an aggressive search for a blue laser. A blue laser would significantly improve the performance of many applications and open new venues. Blue lasers that are durable and bright have significant applications such as superior displays, optical sensors, laser printers and scanners, fiber optical and undersea optical communications, satellite and undersea detection and targeting of submarines, undersea mine detection, undersea salvage, medical devices, and higher density compact disk (CD) players. The shorter (blue) wavelength could be more sharply focused such that the capacity of magnetic and optical storage may be increased. Digital versatile disks (DVDs) which rely on red aluminum indium gallium phosphide (AlInGaP) semiconductor lasers have a data capacity of about 4.7 gigabytes (Gbytes) compared to 0.65 for compact discs. The capacity could be increased to 15 Gbytes with a suitable violet laser. Despite the tremendous value of a blue laser, advancements have been limited due to a lack of materials which emit blue light or blue-emitting plasmas capable of lasing.

Recombination of injected electrons and holes in InGaN has been extensively pursued as a suitable blue laser [1, the numbers in brackets represent the reference number in the list disclosed herein below]. Unfortunately, after over a decade of effort with an estimated expenditure of $1 B, blue diode lasers are still plagued by inadequate substrates, crystal layer dislocations, and defects that increase over time with the requisite high drive currents. Frustration over these and other impediments to commercialization of this important device has given rise to the view that commercial success may depend on the discovery of something completely new [2].

Inverted Lyman and Balmer populations may permit a continuous wave (cw) laser at blue wavelengths. For the last four decades, scientists from academia and industry have been searching for lasers using hydrogen plasma [3-6]. Developed sources that provide a usefully intense hydrogen plasma are high powered lasers, arcs and high voltage DC and RF discharges, synchrotron devices, inductively coupled plasma generators, and magnetically confined plasmas. However, the generation of population inversion is very difficult. Recombining expanding plasma jets formed by methods such as arcs or pulsed discharges is considered one of the most promising methods of realizing an H I laser.

Because the population of hydrogen states is overwhelmingly dominated by the ground state even in the most intense plasmas, the realization of an H I laser requires an overpopulation in a state with nᵢ>2 which decays to a state with 1≦i≦nᵢ. Thus, an H I laser based on a Balmer transition is feasible for a mechanism which produces an overpopulation in a corresponding state. The Balmer α, β, γ, and δ lines of atomic hydrogen at 6562.8 Å, 4861.3 Å, 4340.5 Å, 4101.7 Å in the visible region are due to the transitions from n=3, n=4, n=5, and n=6 to n=2, respectively. An H overpopulation of n>3 that is above threshold could be the basis of a blue laser. But, lasing of a blue Balmer line has been difficult to achieve even with cold recombining plasmas. Akatsuka and Suzuki [6], for example, were able to achieve an overpopulation for level pairs 4-3 and 5-4 only for a recombining plasma generated in a arc-heated magnetically trapped expanding plasma jet [6].

Rather than using recombining arcs or recombining electron-hole pairs in semiconductors to achieve lasing at blue wavelengths, a chemical approach was pursued. It was previously reported that a new chemically generated plasma source has been developed that operates by incandescently heating a hydrogen dissociator and a catalyst to provide atomic hydrogen and gaseous catalyst, respectively, which react to produce an energetic plasma called a resonant transfer (rt)-plasma [7-8]. Intense VUV emission was observed at low temperatures (e.g. ≈10³ K) and an extraordinary low field strength of about 1-2 V/cm from atomic hydrogen and certain atomized elements or certain gaseous ions which singly or multiply ionize at integer multiples of the potential energy of atomic hydrogen, Eₕ=27.2 eV where Eₕ is one hartree. The theory has been given previously [9-10].

The ionization of Rb⁺ and an electron transfer between two K⁺ ions (K⁺/K⁺) provide a reaction with a net enthalpy of Eₕ. The presence of each of these gaseous reactants formed an rt-plasma with atomic hydrogen having strong vacuum ultraviolet (VUV) emission. Remarkably, a stationary inverted Lyman population was also observed, and a collisional radiative model was used to determine that the observed overpopulation was above threshold for i=3 demonstrating that these catalytic reactions may pump a red cw HI laser [11].

For oxygen, there are several chemical reactions that fulfill the catalyst criterion—a chemical or physical process with an enthalpy change equal to an integer multiple of Eₕ. The bond energy of the oxygen molecule is 5.165 eV, and the first, second, and third ionization energies of an oxygen atom are 13.61806 eV, 35.11730 eV, and 54.9355 eV, respectively [12]. The reactions O₂→O+O²⁺, O₂→O+O³⁺, and 2O→2O⁺ provide a net enthalpy of about 2, 4, and 1 times Eₕ, respectively [12]. Lasing directly from oxygen is unknown, but lasing from inverted water vibration-rotational levels in water plasmas which may be from hydrogen-oxygen mixtures has been achieved several decades earlier [13]. In addition, helium-water plasmas as well as water plasma lasers were explored for a source of submillimeter wavelengths [14]. More recently, emission from OH⁺ radicals in water and helium-hydrogen water plasmas has been investigated as an efficient source of radiation in the region λ<2000 Å for the replacement of expensive working media based on krypton and xenon in microelectronics, photochemistry, and medical applications [15]. These prior water-plasma light sources were based on high-voltage glow discharges.

In our experiments, microwave water plasmas were used as sources of O₂ and atomic hydrogen. The energetic hydrogen atom densities and energies were calculated from the width of the 6563 Å Balmer α line emitted from control hydrogen and water microwave plasmas. The characteristic emission from the oxygen catalyst was measured. The absolute hydrogen excited state level densities, reduced population densities, and overpopulation densities for lasing were determined from intensity-calibrated high resolution visible spectra in the region 4000 to 7000 Å and VUV spectra in the region 900-1300 Å. Remarkably, stationary inverted Balmer and Lyman populations were observed, and to our knowledge, this is the first report of population inversion in a water plasma. The parameters of a water-plasma laser of Balmer, Paschen, and Brackett series line emission were determined using the spectrally determined reduced population densities. The plasma was further characterized by measuring the electron temperature Tₑ and density using a Langmuir probe.

The oxygen catalytic reactions may pump a cw HI laser as predicted by a collisional radiative model used to determine that the observed overpopulation was above threshold. Characteristics of the pumping mechanism and laser power that were consistent with the measured electron temperature, electron density, and reduced population densities were determined from the model.

### 2. Experimental

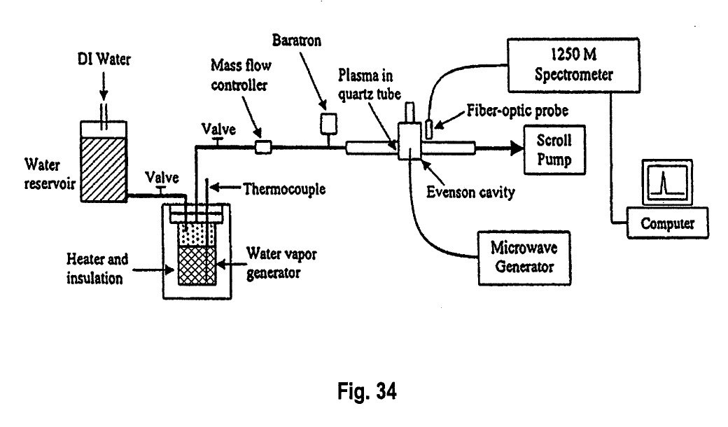

The VUV spectrum (900-1300 Å), the width of the 6562.8 Å Balmer α line, and the high resolution visible spectra (4000-7000 Å) were recorded on light emitted from microwave, capacitively coupled RF, inductively coupled RF, and glow discharge water plasmas performed according to methods and setups reported previously [8-10, 16-18]. Hydrogen and hydrogen (10%) mixed with xenon, krypton, or nitrogen control plasmas were run under the same conditions. The microwave experimental set up shown in FIG. 34 comprised a quartz tube cell, a source of water vapor or ultrapure hydrogen, a flow system, and a visible spectrometer or a VUV spectrometer that was differentially pumped. Water vapor was formed in a heated insulated reservoir and flowed through the half inch diameter quartz tube at a flow rate of 10 standard cm³·min⁻¹ (sccm) at a corresponding pressure of 50-100 milliTorr. At this pressure, room temperature was sufficient for maintaining the water vapor. The tube was fitted with an Evenson coaxial microwave cavity (Opthos Model #B1) having an E-mode [19-20]. The input power to the plasma at 2.45 GHz by an Opthos model MPG4M generator was set at 50 W and 90 W as described previously [9-10, 16-18]. The plasma volume was about 3 cm³. Hydrogen control plasma were run under the same conditions. Each gas flow was controlled by a 0-20 sccm range mass flow controller (MKS1179A21CS1BB) with a readout (MKS type 246). The cell pressure was monitored by a 0-10 Torr MKS Baratron absolute pressure gauge.

In addition, the effect of addition of oxygen or hydrogen to the intensities of the Balmer lines recorded on the water plasma was determined. Using the mass flow controller, 0, 2, 5, 10, and 20 volume % ultrapure gas was mixed with the water vapor while maintaining a constant flow rate and pressure, and each corresponding high resolution visible spectrum (4000-7000 Å) was recorded.

High resolution visible spectra (4000-7000 Å) were recorded on light emitted from hydrogen and water hollow cathode glow discharge plasmas performed according to methods reported previously [16, 18]. The glow discharge cell that comprised a five-way stainless steel cross that served as the anode with a hollow stainless steel cathode. The plasma was generated at the hollow cathode inside the discharge cell. The hollow cathode was constructed of a stainless steel rod inserted into a steel tube, and this assembly was inserted into an Alumina tube. A flange opposite the end of the hollow cathode connected the spectrometer with the cell. It had a small hole that permitted radiation to pass to the spectrometer. An DC power supply (U=0-1 kV, I=0-100 mA) was connected to the hollow cathode to generate a discharge. The DC voltage and current were 300 V and 300 mA, respectively, corresponding to an input power of 90 W. A Swagelok adapter at the very end of the steel cross provided a gas inlet and a connection with the pumping system, and the cell was pumped with a mechanical pump. Valves were between the cell and the mechanical pump, the cell and the monochromator, and the monochromator and its turbo pump. The five-way cross was pressurized with 50-100 milliTorr of gas which was maintained with a gas flow rate of 10 sccm.

High resolution visible spectra (4000-7000 Å) were recorded on light emitted from hydrogen and water capacitively coupled RF discharge plasmas performed according to methods reported previously [16]. The experimental set up comprised a Pyrex cell reactor (38 cm in length and 13 cm ID) with a diode configuration in which the plasma was confined between two parallel circular stainless steel electrodes (0.1 mm thick×7.6 cm diameter with a 2 cm separation). For spectroscopic measurements on the plasma emission, a 1 cm diameter quartz window was located in the Pyrex cell wall at the center of the gap between the electrodes. At each end of the cell, a Pyrex cap was sealed to the cell with a Viton O ring and a C-clamp. One cap incorporated ports for gas inlet and cathode feedthrough. The other cap incorporated ports for gas outlet and anode feedthrough. The cathode was connected to an 13.56 MHz RF generator (RF VII, Inc., Model MN 500) with a matching network (RF Power Products, Inc., Model RF 5S, 300 W). The forward RF power was 90 W, and the reflected power was less than 1 W. The gas flow rate and pressure were 10 sccm and 50-100 milliTorr, respectively.

High resolution visible spectra (4000-7000 Å) were recorded on light emitted from hydrogen and water inductively coupled RF discharge plasmas performed according to methods reported previously [16]. A quartz cell which was 500 mm in length and 50 mm in diameter served as the plasma reactor. A Pyrex cap was sealed to the quartz cell with a Viton O ring and a C-clamp incorporated ports for gas inlet, outlet, and photon detection. An unterminated, nine-turn, 17 cm long helical coil (18 gauge magnet wire) wrapped around the outside of the cell was connected to an 13.56 MHz RF generator (RF VII, Inc., Model MN 500) with a matching network (RF Power Products, Inc., Model RF 5S, 300 W). The coil inductance and resistance were 4.7 μH and 0.106Ω, respectively. The coil impedance was 400Ω at 13.56 MHz. The forward RF power was 90 W, and the reflected power was less than 1W. The gas flow rate and pressure were 10 sccm and 50-100 milliTorr, respectively.

The plasma emission was fiber-optically coupled through a 220F matching fiber adapter positioned 2 cm from the cell wall to a high resolution visible spectrometer with a resolution of ±0.06 Å over the spectral range 1900-8600 Å. The spectrometer was a Jobin Yvon Horiba 1250 M with 2400 groves/mm ion-etched holographic diffraction grating. The entrance and exit slits were set to 20 μm. The spectrometer was scanned between 6555-6570 Å and 4000-7000 Å using a 0.05 Å step size. The signal was recorded by a PMT with a stand alone high voltage power supply (950 V) and an acquisition controller. The data was obtained in a single accumulation with a 1 second integration time.

The method of Videnovic et al. [21] was used to calculate the energetic hydrogen atom densities and energies from the width of the 6562.8 Å Balmer α line emitted from hydrogen and water microwave plasmas. The full half-width Δλ_{G} of each Gaussian results from the Doppler (λΔ_{D}) and instrumental (Δλ₁) half-widths:

Δλ_{G}=\sqrt{Δλ_{D}²+Δλ₁²} (83)

Δλ₁ for these experiments was 0.06 Å. The temperature was calculated from the Doppler half-width using the formula:

$${Δλ}_{D} = 7.16 \times {10}^{- 6} {{λ}_{O} ( \frac{T}{μ} )}^{1 / 2} ( Å ) \qquad ( 84 )$$

where λ₀ is the line wavelength in Å, T is the temperature in K (1 eV=11,605 K), and μ is the molecular weight (=1 for hydrogen). In each case, the average Doppler half-width that was not appreciably changed with pressure varied by ±5% corresponding to an error in the energy of ±10%. The corresponding number densities for noble gas-hydrogen mixtures varied by ±20%.

To measure the absolute intensity, the high resolution visible spectrometer and detection system were calibrated [22] with 5460.8 Å, 5799.6 Å, and 6965.4 Å light from a Hg—Ar lanmp (Ocean Optics, model HG-1) that was calibrated with a NIST certified silicon photodiode. The population density of the n=3 hydrogen excited state N₃ was determined from the absolute intensity of the Balmer α (6562.8 Å) line measured using the calibrated spectrometer. The spectrometer response was determined to be approximately flat in the 4000-7000 Å region by ion etching and with a tungsten intensity calibrated lamp. The absolute intensities of n=4 to 9 were determined from the absolute intensity of Balmer α (n=3) and the relative intensity ratios.

The VUV spectrometer was a normal incidence 0.2 meter monochromator equipped with a 1200 lines/mm holographic grating with a platinum coating that covered the region 20-5600 Å. The V spectrum was recorded with a CEM. The wavelength resolution was about 0.2 Å (FWHM) with slit widths of 50 μm. The increment was 2 Å and the dwell time was 500 ms. The VUV spectra (900-1300 Å) of the water and control hydrogen plasmas were recorded at 90 W input power.

The spectrometer was calibrated between 400-2000 Å with a standard discharge light source using He, Ne, Ar, Kr, and Xe lines: He I (584 Å), He II (304 Å), Ne I (735 Å), Ne II (460.7 Å), Ar I (1048 Å), Ar I (932 Å), Kr II (964 Å), Xe I (1295.6 Å), Xe II (1041.3 Å), Xe II (1100.43 Å). The wavelength and intensity ratios matched those given by NIST [23]. The spectrometer response was determined to be approximately flat in the 1000-1300 Å region. The calculation of the number density of the n=3 to 9 states was corrected for the minor variation of the sensitivity with wavelength in this region.

The electron density and temperature of the water plasma was determined using a compensated Langmuir probe according to the method given previously [24].

3. Results and discussion

### A. Hydrogen Balmer and Lyman Series Emission

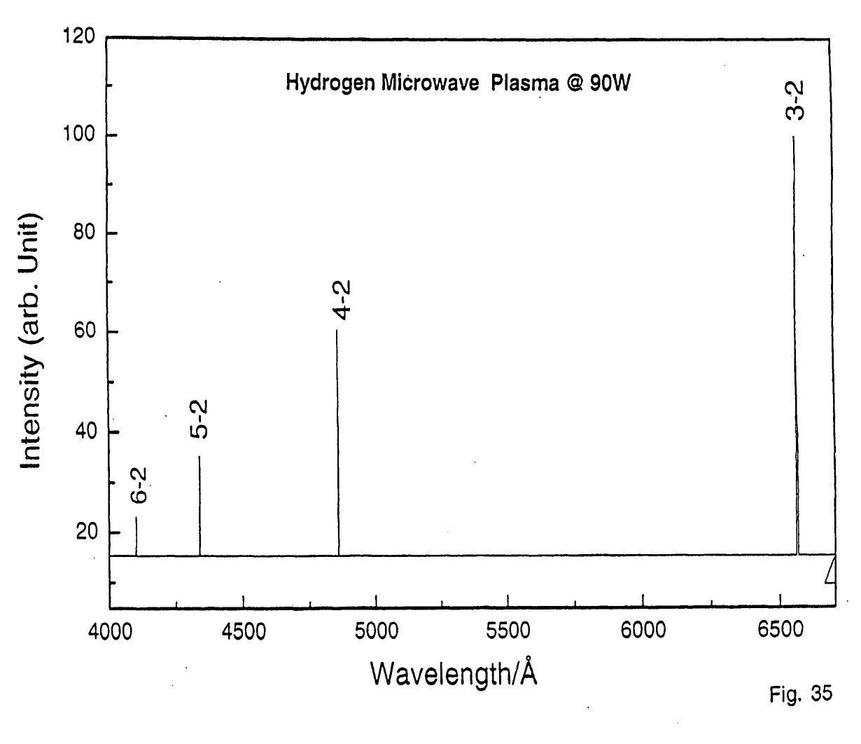

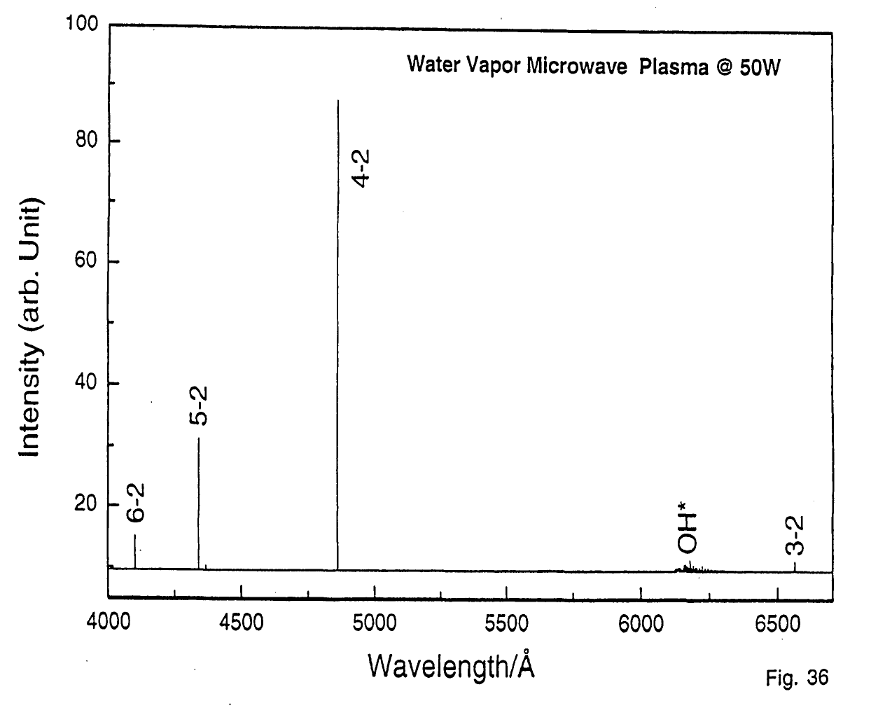

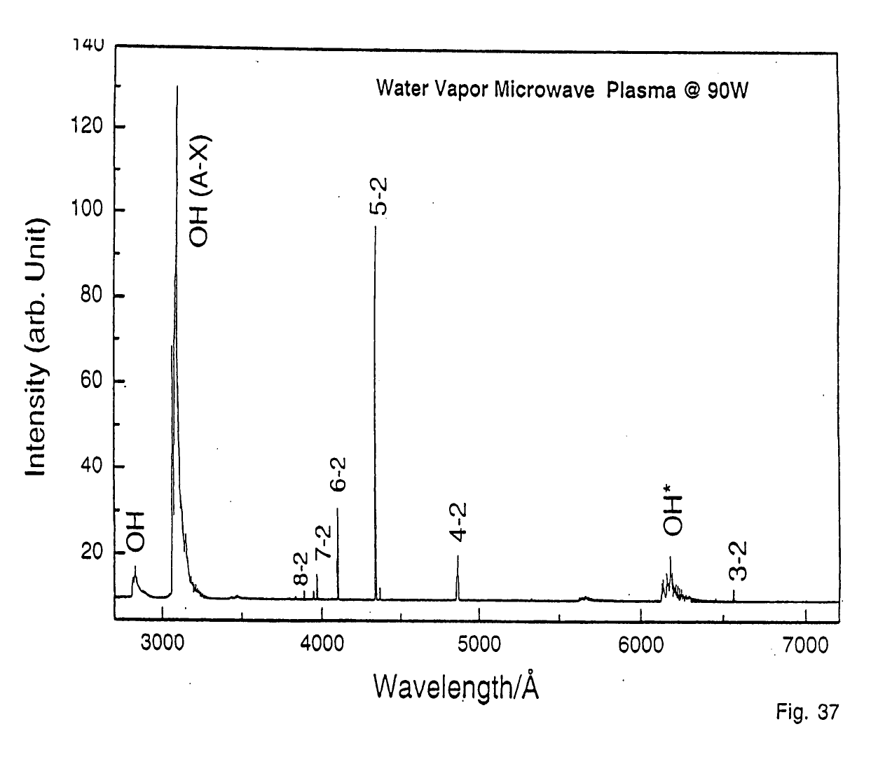

The high resolution visible spectra (4000-6700 Å) of the cell emission from a hydrogen microwave plasma with 90 W input power, a water microwave plasma with 50 W input power, and a water microwave plasma with 90 W input power are shown in FIGS. 35-37, respectively. As shown by the absolute intensity measurements of the Balmer lines of the hydrogen microwave plasma, we observed the known ratios of the Balmer lines. In contrast, the population of the levels n=4, n=5, and n=6 of hydrogen were continuously inverted with respect to n=3 in the water plasma spectrum shown in FIG. 36. The relative intensities of the Balmer lines of microwave plasmas of hydrogen (90-2%) mixed with xenon, krypton, or nitrogen at 50 W were equivalent to those of hydrogen alone; thus, the inversion is not inherent to a hydrogen plasma generated by microwaves. As shown in FIG. 37, when the input power was increased to 90 W, the n=5 and n=6 levels were further continuously inverted with respect to n=4. The levels n=7, n=8, and n=9 of hydrogen were also continuously inverted with respect to n=3. Thus, wavelength tunebility may be achieved by varying the microwave power with lasing between the corresponding power-dependent inverted levels. The requirement for a stoichiometric mixture was fairly exacting since it was observed that additions of increasing partial pressures of pure hydrogen or oxygen progressively reversed the inversion at a mole fraction over the stoichiometric ratio of greater than 2%.

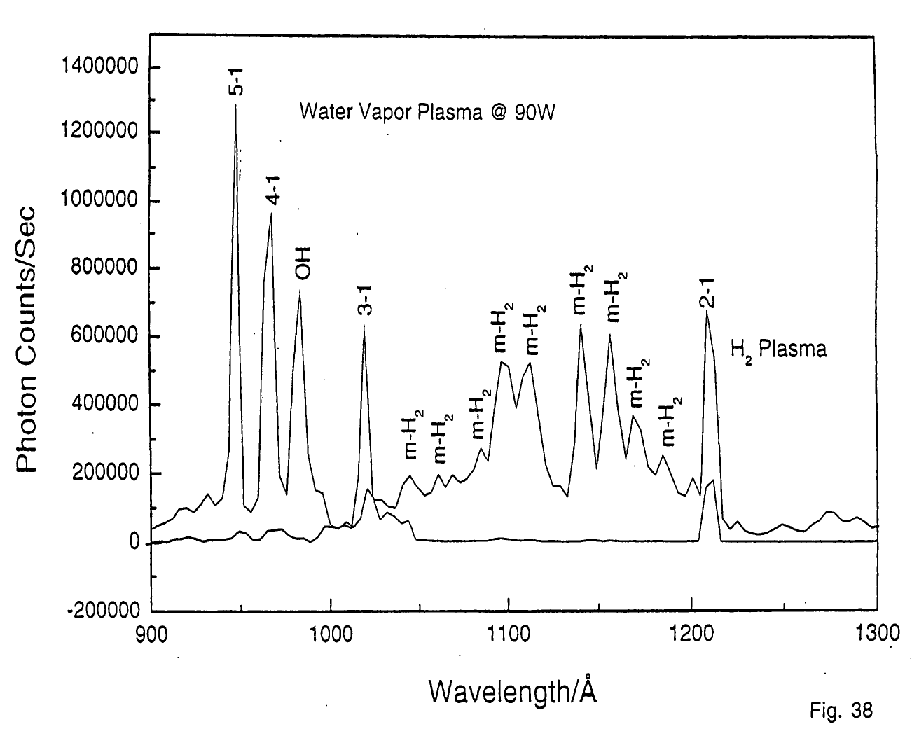

The VUV spectra (900-11300 Å) of the cell emission from hydrogen microwave and the water microwave plasmas with 90 W input power are shown in FIG. 38. An inverted Lyman population was also observed from the water plasma emission with the inversion observed in the visible as shown in FIG. 35 extending to the n=2 level. No inversion was observed for the hydrogen microwave plasma.

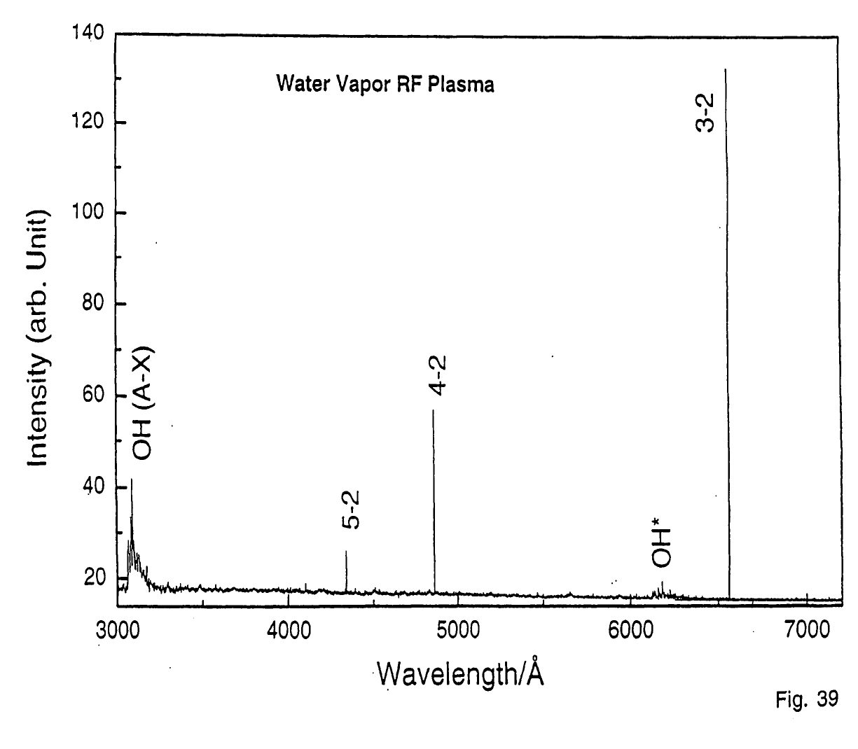

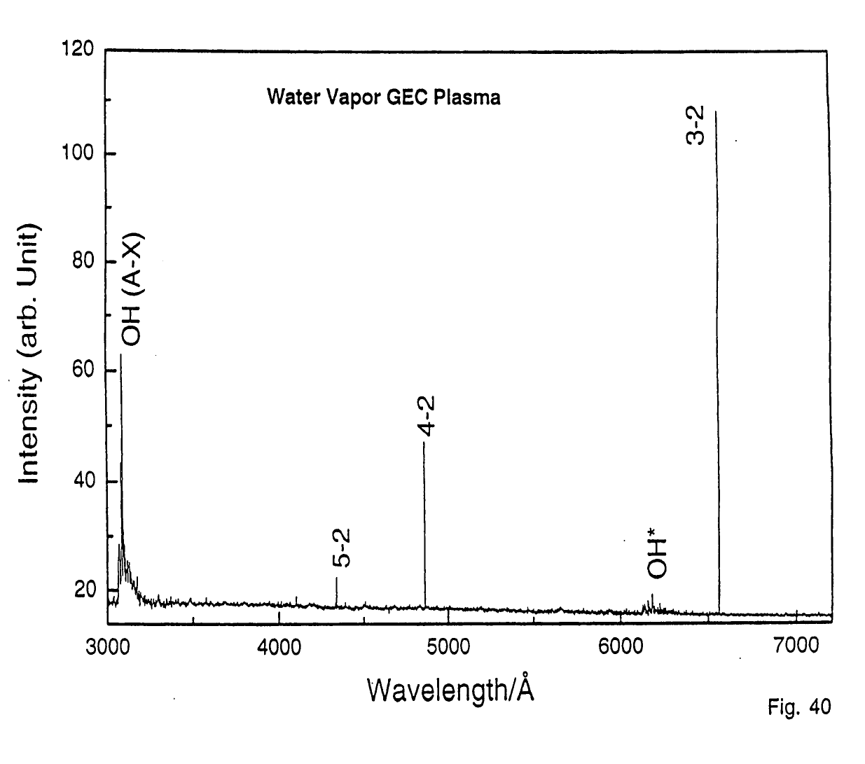

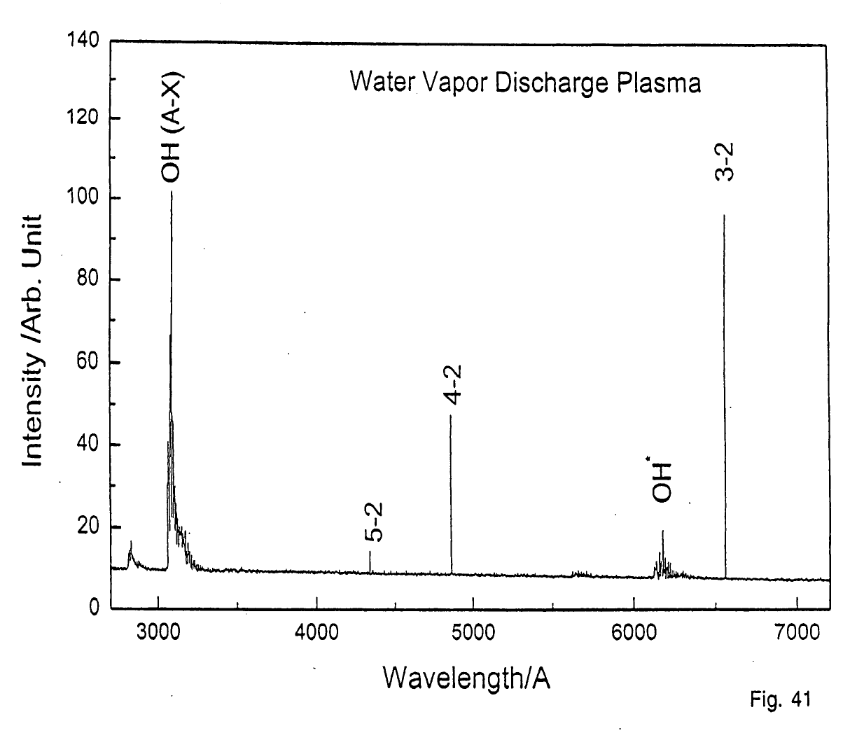

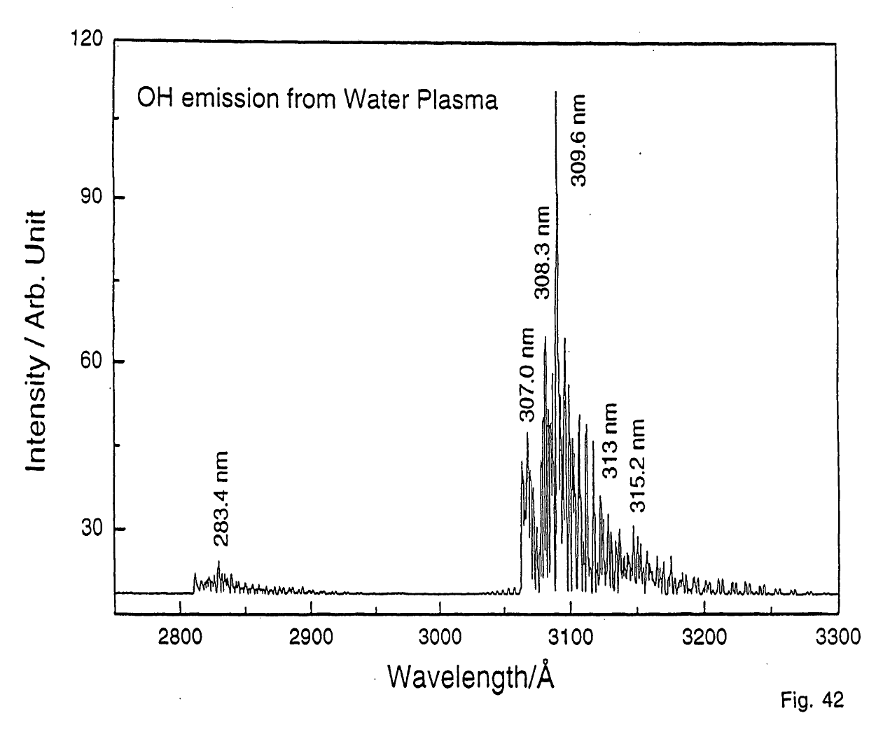

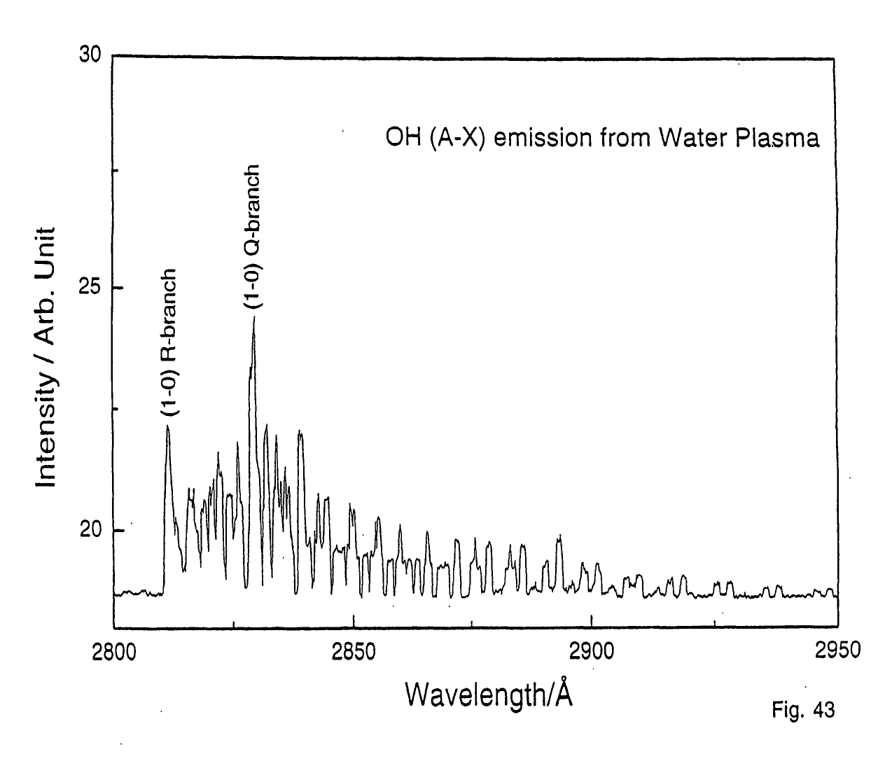

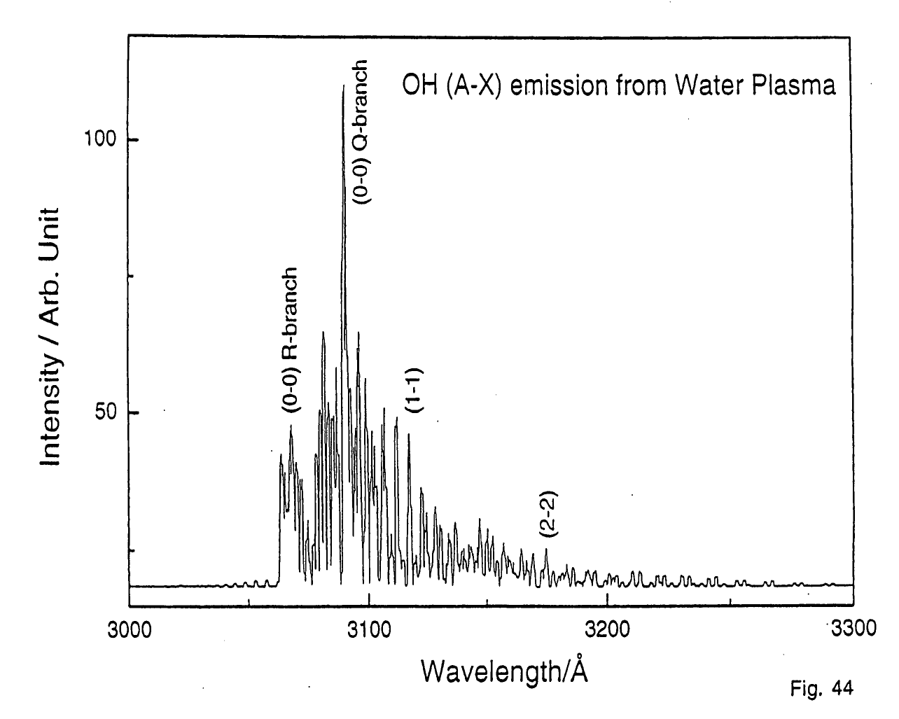

No inversion was observed with inductively or capacitively RF driven or high voltage glow discharge water plasmas as shown in FIGS. 39-41, respectively. However, intense emission of OH* radicals in water plasmas was observed from glow discharge as well as microwave sources as shown in FIGS. 41 and 37, respectively. As discussed previously, the glow discharge plasma has been extensively studied as a light source based on the emission of OH* radicals [15]. Shuaibov et al. [25] give the spectrum of a glow discharge of a He/H₂O mixture and assign the OH(A-X) emission. As a comparison, the OH(A-X) microwave water plasma emission spectrum in the region of 2800-3300 Å is given in FIG. 42. The (1-0) R-branch and the (1-0) Q-branch are observed in the 2800-2950 Å region as shown in FIG. 43. The (0-0) R-branch and the (0-0), (1-1), and (2-2) Q-branches are observed in the 3000-3300 Å region as shown in FIG. 44.

We had shown previously that the conditions of the particular discharge may be a major parameter in the observation of excessive Doppler Balmer line broadening with plasmas of hydrogen and a noble ion having an ionization potential of an integer multiple of Eₕ [8-11, 16-18]. We proposed that the corresponding energetic hydrogen formed with an Evenson microwave cavity may be a means to achieve population inversion.

Other explanations of the population inversion were ruled out. The spectrometer response was determined to be approximately flat in the 4000-7000 Å region by ion etching and with an intensity calibrated lamp. Furthermore, the Balmer and Lyman line intensity ratios of the control hydrogen plasmas closely matched those obtained using the NIST Einstein A coefficients [23]. Since these ratios did not change as the pressure was lowered, and the hydrogen pressure was lower in the water plasma than the control, the NIST Einstein A coefficients were used to calculate the number density ratios from the water plasma emission.

To determine the optical thickness of the water plasmas of this study, τ_{ω}(L), the effective path length at a given frequency ω, was calculated using

τ_{ω}(L)=κ_{ω}L (85)

where L is the path length and κ_{ω} is the absorption coefficient given by

κ_{ω}=σ_{ω}N_{H} (86)

where σ_{ω} is the absorption cross section and N_{H} is the number density of the absorber. For optically thin plasmas τ_{ω}(L)<1, and for optically thick plasmas τ_{ω}(L)>1. By orders of magnitude, self absorption of Lyman emission by n=1 state hydrogen dominates since n=1H dominates the H population distribution. At 1215.67 Å, the effective path length τ_{ω}(5 cm) was calculated from Eq. (85) using the absorption cross section for Lyman α emission, σ=4×10⁻¹⁶ cm² [26], and N_{H}=6×10¹³ cm⁻³.

τ_{ω}(5 cm)=κ_{ω}L=(4×10⁻¹⁶ cm²)(6×10¹³ cm⁻³)(5 cm)=1×10⁻ (87)

Since τ_{ω}(5)<<1, the water plasmas were optically thin. Furthermore, the water plasmas were determined to be optically thin for hydrogen absorption of the Balmer and as well as the additional Lyman lines. Thus, absorption of 6562.8 Å and 4861.3 Å and 1215.67 Å emission by n=2 and n=1 state atomic hydrogen, respectively, may be neglected as the cause of the inverted ratios.

The absorption cross section of Balmer emission by water is insignificant—nine orders of magnitude less than in the Lyman region [27]. Thus, the Balmer lines were used to determine the over populations in TABLE 9, except for the n=2 level which was determined from the intensities of the Lyman lines. The effective path length τ_{ω}(5 cm) was calculated from Eq. (85) using the absorption cross section of water for Lyman α emission, σ=1.6×10¹⁷ cm² [28], and the water number density, N_{H}_{₂}_{O}=2.5×10¹⁵ cm⁻³, calculated from the measured pressure. Thus, τ_{ω}(5 cm) is given by

τ_{ω}(5 cm)=κ_{ω}L=(1.6×10⁻¹⁷ cm²)(2.5×10¹⁵ cm⁻³)(5 cm)=0.2 (88)

Since τ_{ω}(5)<1, the water plasmas were optically thin for Lyman α emission.

TABLE 9
$Level densities {N}_{n} , reduced population densities {\frac{{N}_{n}}{{g}_{n}} }^{a} ,$
$and overpopulation ratios \frac{{N}_{n}}{{N}_{2}} \frac{{g}_{2}}{{g}_{n}} , \frac{{N}_{n}}{{N}_{3}} \frac{{g}_{3}}{{g}_{n}} , and \frac{{N}_{n}}{{N}_{4}} \frac{{g}_{4}}{{g}_{n}}$
for excited states n = 1 to 9 with an n > 2 pumping mechanism
recorded on a water microwave plasma at 90 W input power.

| Principal Quantum Number n | ${N}_{n} ( {10}^{9} {cm}^{- 3} \frac{{N}_{n}}{{g}_{n}} ( {10}^{8} {cm}^{-} \frac{{N}_{n}}{{N}_{2}} \frac{{g}_{2}}{{g}_{n}}$ | | | $\frac{{N}_{n}}{{N}_{3}} \frac{{g}_{3}}{{g}_{n}}$ | $\frac{{N}_{n}}{{N}_{4}} \frac{{g}_{4}}{{g}_{n}}$ |
|---|---|---|---|---|---|
| 1 | 60,000^{b} | 30,000 | — | — | — |
| 2 | 1.39 | 1.74 | — | — | — |
| 3 | 6.20 | 3.44 | 1.98 | — | — |
| 4 | 28.9 | 9.02 | 5.18 | 2.62 | — |
| 5 | 1930 | 385 | 221 | 112 | 42.7 |
| 6 | 838 | 116 | 66.7 | 33.7 | 12.9 |
| 7 | 47.4 | 4.83 | 2.78 | 1.40 | 0.535 |
| 8 | 26.1 | 2.04 | 1.17 | 0.593 | 0.226 |
| 9 | 15.3 | 0.955 | 0.549 | 0.278 | 0.106 |

^{a}gₙ = 2n² and n is the principal quantum number
^{b}calculated after ref. [21]

B. Measurement of Hydrogen Atom Temperature and Number Density from Balmer Line Broadening

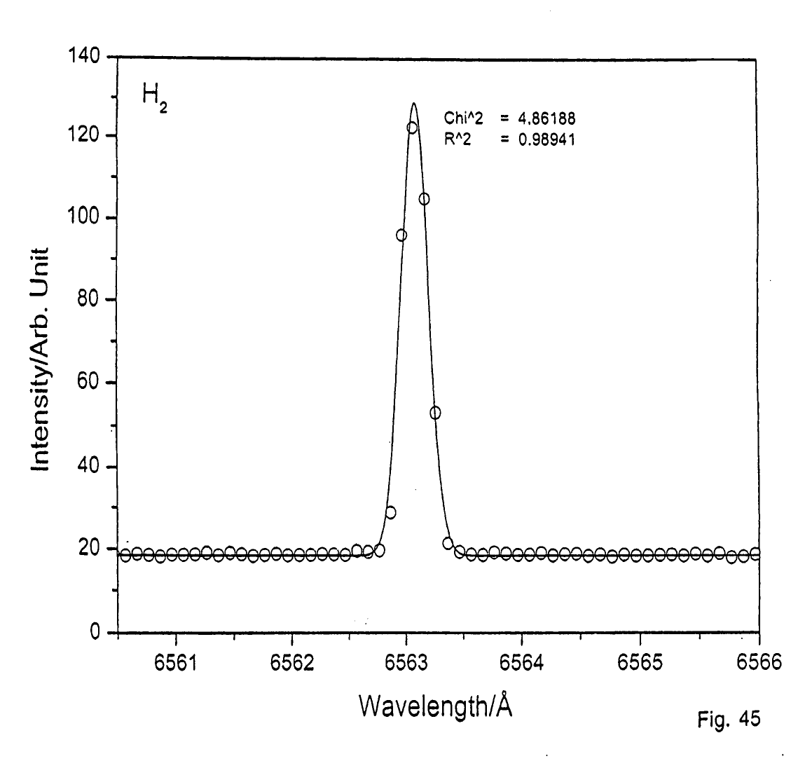

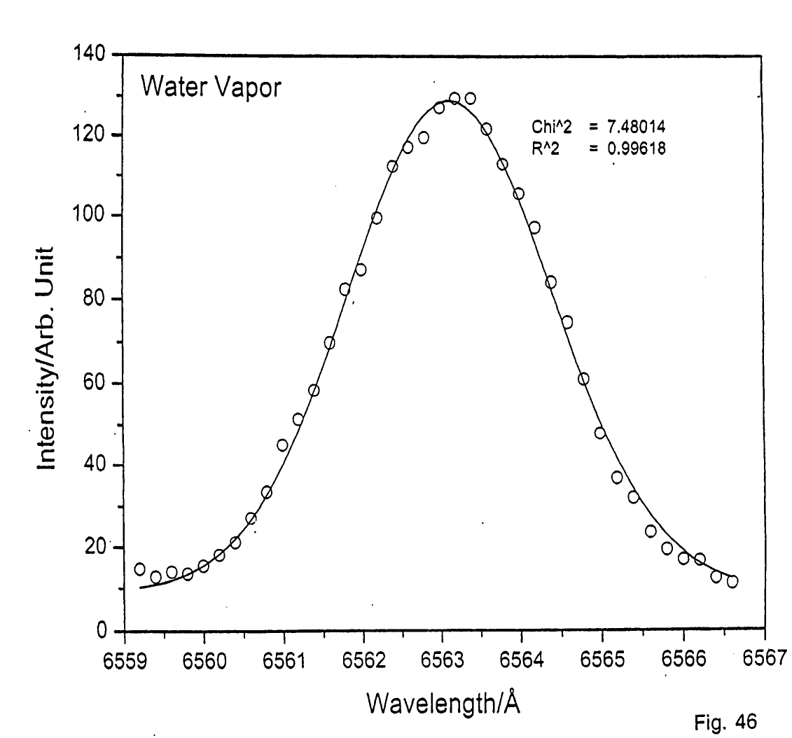

To further characterize the water plasma, the width of the 6562.8 Å Balmer α line (n=3 to n=2) was measured on light emitted from the microwave discharges of pure hydrogen alone and water vapor maintained under equivalent conditions using the high resolution visible spectrometer as shown in FIGS. 45 and 46, respectively. The method of Videnovic et al. [21] was used to calculate the hydrogen atom energies and densities from the line width. Significant line broadening of 55 eV and an atom density of 6×10¹³ atoms/cm³ was observed from the water plasma compared to an average hydrogen atom temperature of 1 eV and a density of 6×10¹¹ atoms/cm³ for hydrogen alone. Similarly, using a Langmuir probe as described previously [24], the electron temperature Tₑ measured on the microwave water plasmas was higher, 2.0 eV, compared to the Tₑ≦1 eV measured on the hydrogen plasma at the same 50 W input power.

We have assumed that Doppler broadening due to thermal motion was the dominant source in the water plasmas to the extent that other sources may be neglected. To confirm this assumption, each source is now considered. In general, the experimental profile is a convolution of a Doppler profile, an instrumental profile, the natural (lifetime) profile, Stark profiles, van der Waal's profiles, a resonance profile, and fine structure. The instrumental half-width is measured to be ±0.06 Å. The natural half-width of the Balmer α line given by Djurovic and Roberts [29] is 1.4×10⁻³ Å which is negligible. The fine structure splitting is also negligible.

Stark broadening of hydrogen lines in plasmas can not be measured at low electron densities using conventional emission or absorption spectroscopy because it is hidden by Doppler broadening. In the case of the Lyman α line, the Stark width exceeds the Doppler width only at nₑ>10¹⁷ cm⁻³ for temperatures of about 10⁴ K [30].

The relationship between the Stark broadening Δλ_{S} of the Balmer β line in run, the electron density nₑ in m⁻³, and the electron temperature Tₑ in K is

log nₑ=C₀+C₁ log(Δλ_{S})+C₂[log(Δλ_{S})]²+C₃ log(Tₑ) (89)

where C₀=22.578, C₁=1.478, C₂=−0.144, and C₃=0.1265 [31]. From Eq. (89), to get a Stark broadening of only 1 Å with Tₑ=9000 K, an electron density of about nₑ˜3×10¹⁵ cm⁻³ is required compared to that of the water plasma of nₑ=0.2×10⁸ cm⁻³ determined using a Langmuir probe, over seven orders of magnitude less. Gigosos and Cardenoso [32] give the observed Balmer α Stark broadening for plasmas of hydrogen with helium or argon as a function of the electron temperature and density. For example, the Stark broadening of the Balmer α line recorded on a H+He⁺ plasma is only 0.33 Å with Tₑ=20,000 K and nₑ=1.4×10¹⁴ cm⁻³. Thus, the Stark broadening was also insignificant.

The statistical curve fit of the hydrogen and water microwave plasma emission are shown in FIGS. 45 and 46, respectively. In each case, the data matched a Gaussian profile having the X² and R² values given in FIGS. 45 and 46. The absence of Stark broadening in the water plasma is also evident by the good fit to a Gaussian profile rather than a Voigt profile as shown in FIG. 46.

A linear Stark effect arises from an applied electric field that splits the energy level with principal quantum number n into (2n−1) equidistant sublevels. The magnitude of this effect given by Videnovic et al. [21] is about 2×10⁻² nm/kV·cm⁻¹. No applied electric field was present in our study; thus, the linear Stark effect should be negligible.

The plasma was evaluated for optical thickness. The absorption cross section for Balmer α emission is σ=1×10⁻¹⁶ cm² [26]. As discussed infra., an estimate based on Lyman line intensity, the n=2H atom density is ˜1.39×10⁹ cm⁻³. Thus, for a plasma length of 5 cm, the effective path length, τ_{ω}(5 cm), calculated from Eq. (85) for Balmer α is

τ_{ω}(5 cm)=κ_{ω}L=(1×10⁻¹⁶ cm²)(1.39×10⁹ cm⁻³⁾⁽5 cm)=6.95×10⁻⁷ (90)

Since τ_{ω}(5)<<<1, the water plasmas were optically thin; thus, the self absorption of 6562.8 Å emission by n=2 state atomic hydrogen may be neglected as a source of the observed broadening.

As discussed above, an estimate based on emission line profiles places the total H atom density of the water plasma at −6×10¹³ cm⁻³. Since this is overwhelmingly dominated by the ground state, N_{H}=6×10¹³ cm⁻³ will be used. Usually, the atomic hydrogen collisional cross section in plasmas is on the order of 10⁻¹⁸ cm² [33]. Thus, for N_{H}=6×10¹³ cm⁻³, collisional or pressure broadening is negligible.

Prior studies that reported fast H, attributed the observation to acceleration of ions in a high electric fields at the cathode fall region and an external field Stark effect [21, 34-35]. Observations with a microwave plasma having no high DC field present was reported previously [16-18]. Microwave helium-hydrogen and argon-hydrogen plasmas showed extraordinary broadening corresponding to an average hydrogen atom temperature of 180-210 eV and 110-130 eV, respectively. Whereas, pure hydrogen and xenon-hydrogen microwave plasmas showed no excessive broadening corresponding to an average hydrogen atom temperature of <2 eV [16-18]. The formation of fast H was explained by a resonant energy transfer between hydrogen atoms and Ar⁺ or He⁺ of an integer multiple of the potential energy of atomic hydrogen, 27.2 eV.

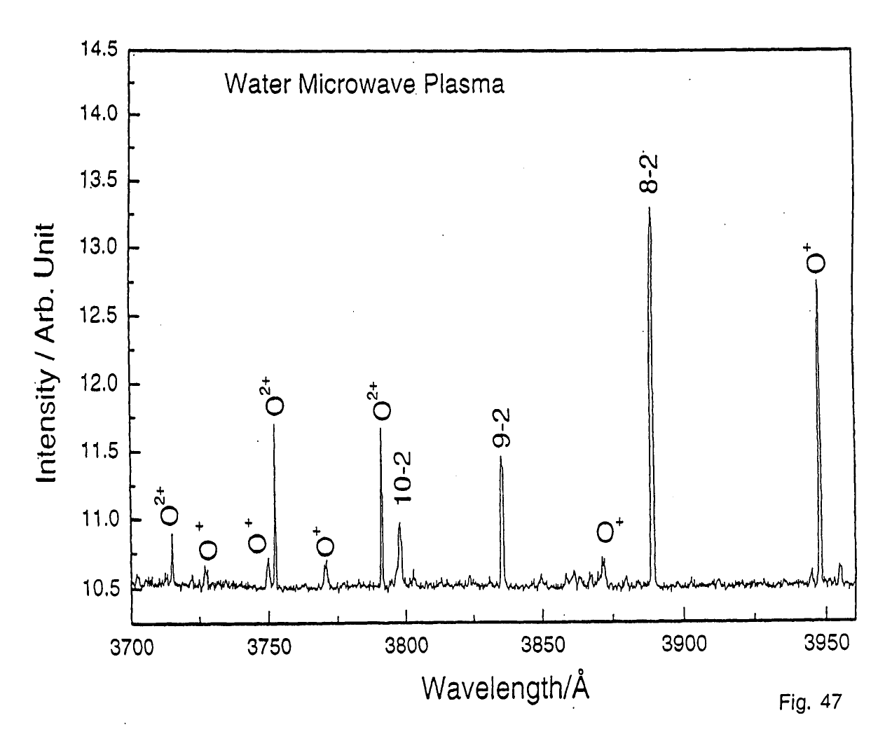

As in the case of the argon-hydrogen or helium-hydrogen plasmas, no hydrogen species, H⁺, H⁺₂, H⁺₃, H⁻, H, or H₂, of the water plasmas responds to the microwave field; rather, only the electrons respond. However, the measured electron temperature in these microwave plasmas was about 1-2 eV; whereas, the measured neutral hydrogen temperature was much higher, 55 eV. This requires that Tᵢ>>Tₑ which can not be due to direct ion coupling to the microwave power or electron-collisional heating. Nor, can this result be explained by electric field acceleration of charged species as proposed for glow discharges [21, 34-35] since in microwave driven plasmas, there is no high electric field in a cathode fall region (>1 kV/cm) to accelerate positive ions. The observation of excessive Balmer line broadening in a microwave driven plasma requires a source of energy. In the case of the water plasma, we propose that the source is the energy is due to a resonant energy transfer between hydrogen atoms and oxygen. The catalysis mechanism was supported by the observation of O²⁺ at 3715.0 Å, 3754.8 Å, and 3791.28 Å as shown in FIG. 47 as well as the extraordinary Balmer line broadening of 55 eV compared to 1 eV for hydrogen alone. This energy may further be the basis of the pumping source for the observed population inversions.

Then the inverted population is explained by a resonant energy transfer between hydrogen and oxygen to yield fast H(n=1) atoms. The emission of excited state H from fast H(n=1) atoms excited by collisions with the background H₂ has been discussed by Radovanov et al. [35]. Collisions with oxygen may also play a role in the inversion since inverted hydrogen populations are observed in the case of alkali nitrates [1] and water vapor plasmas. Formation of H⁺ is also predicted by a collisional radiative model [11] which is far from thermal equilibrium in terms of the hydrogen atom temperature. Akatsuka et al. [6] show that it is characteristic of cold recombining plasmas to have the high lying levels in local thermodynamic equilibrium (LTE); whereas, population inversion is obtained when Tₑ suddenly decreases concomitant with rapid decay of the lower lying states.

### C. Observed Level Population and Lasing Ability

To determine the potential of the water-plasma as a laser medium, the absolute reduced Balmer population density of the excited hydrogen atoms

$$\frac{{N}_{n}}{{g}_{n}}$$

with principal quantum numbers n=1 to 9 were obtained from N, their absolute intensity integrated over the visible spectral peaks shown in FIGS. 36 and 37 corrected by their Einstein coefficients, divided by g, the statistical weight (g=2n²), as discussed by Akatsuka et al. [6]. As shown in TABLE 9,

$$\frac{{N}_{n}}{{g}_{n}}$$

for quantum number n=3, 4, 5, 6 recorded on a water microwave plasma at 90 W input was determined to be 3.44×10⁸ cm⁻³, 3.44×10⁸ cm⁻³, 9.02×10⁸ cm⁻³, and 385×10⁸ cm⁻³, respectively.

The population of the n=2 level was determined from the VUV spectrum (900-1300 Å) of the microwave water plasma shown in FIG. 38. From the number densities of the levels determined from the absolute Balmer line intensities given in TABLE 9 and the Lyman lines intensities shown in FIG. 38, it was found that

$$\frac{{N}_{4}}{{N}_{3}} Balmer = 4.66 ; \\ \frac{{N}_{4}}{{N}_{3}} Lyman = 4.46 \qquad ( 91 )$$

### Since

$$\frac{{N}_{4}}{{N}_{3}}$$

determined from the Lyman series and the Balmer series was about the same, and the Balmer α line was absolutely measured, the absolute number density for n=2 given in TABLE 9 was determined from the absolute Balmer α line intensity.

$$( {N}_{2} ) Balmer = ( {N}_{3} ) Balmer \times ( \frac{( {N}_{2} ) Lyman}{( {N}_{3} ) Lyman} ) \qquad ( 92 )$$

Using N₃=6.20×10⁹ cm⁻³ and g₂=8,

$$\frac{{N}_{2}}{{g}_{2}}$$

was determined to be 1.74×10⁸ cm⁻³.

TABLE 10
Potential laser transitions of atomic hydrogen in a
microwave water-vapor plasma.

| | spectral | electronic transition |
|---|---|---|
| wavelength/Å | region | ⁿinitial-ⁿfinal |
| 74,578 | IR | . . . |
| 40,512 | IR | . . . |
| 26,252 | IR | . . . |
| 18,751 | IR | . . . |
| 12,818 | IR | . . . |
| 10,938 | IR | . . . |
| 10,049 | IR | . . . |
| 6,563 | red | . . . |
| 4,861 | blue | . . . |
| 4,340 | violet | . . . |
| 4,102 | violet | . . . |
| 3,970 | violet | . . . |
| 3,889 | violet | . . . |

With appropriate cavity length and mirror reflection coefficient, cw laser oscillations may be obtained between states having an overpopulation ratio determined by

$$\frac{{N}_{i}}{{N}_{f}} \frac{{g}_{f}}{{g}_{i}} > 1$$

as shown in TABLE 9 where i represents the quantum number of the initial state and f represents that of the final state [6]. On this basis, it was determined that lasing is possible over a wide range from far infrared to violet wavelengths. Representative transitions and wavelengths are shown in TABLE 10. The important parameter for lasing is that the reduced overpopulation density is above threshold. Using standard laser cavity equations [6], it was determined that the threshold condition is achievable with micron to submillimeter laser cavities for several commercially important wavelengths emitted from these plasmas. For plasma properties of this experiment determined using a Langmuir probe (Tₑ=2.0 eV, electron density nₑ=0.2×10⁸ cm⁻³), conditions for lasing at 12,818.1 Å, 4340.5 Å, and 4101.7 Å corresponding to the transitions 5→3, 5→2, and 6→2, respectively, were determined assuming a cavity length of 100 cm and a combined mirror reflection coefficient of 0.99, as given in TABLE 11. The overpopulation ratios

$$\frac{{N}_{5}}{{N}_{3}} \frac{{g}_{3}}{{g}_{5}} , \frac{{N}_{5}}{{N}_{2}} \frac{{g}_{2}}{{g}_{5}} , and \frac{{N}_{6}}{{N}_{2}} \frac{{g}_{2}}{{g}_{6}}$$

given in TABLE 9 were 112, 221, and 67, respectively. Threshold reduced n=5 overpopulation densities of about 0.49×10⁷ cm⁻³ and 4.6×10⁷ cm⁻³ are required for lasing to n=3 and n=2, respectively, and, a corresponding threshold reduced n=6 overpopulation density of 6.9×10⁷ cm⁻³ is required for lasing to n=2. The actual reduced overpopulation densities were much greater, 3.8×10¹⁰ cm⁻³, 3.8×10¹⁰ cm⁻³, and 1.2×10^{10 cm}⁻³, respectively. Thus, lasing may be possible with cavity lengths as small as 0.01 cm, 0.2 cm, and 0.6 cm, respectively.

TABLE 11
Observed reduced overpopulation densities recorded on a water microwave
plasma at 90 W input power, threshold overpopulation densities for lasing
with a 100 cm length cavity, and the minimum laser cavity length to
achieve lasing for the observed reduced overpopulation densities for the
transitions 5-2, 5-3, and 6-2.

| | | | | | Threshold | |
|---|---|---|---|---|---|---|
| | | | | Reduced | Reduced | |
| | | | | Overpopulation | Overpopulation | Minimum |
| Laser | ΔE | Wavelength | Aₖᵢ^{a} | Density | Density^{b} | Length |
| Transition | (eV) | (Å) | 10⁸ s⁻¹ | (10¹⁰ cm⁻³) | (10⁷ cm⁻³) | (cm) |
| 5-2 | 2.86 | 4340.5 | 0.0943 | 3.83 | 4.61 | 0.212 |
| 5-3 | 0.966 | 12,818.1 | 0.0339 | 3.82 | 0.494 | 0.013 |
| 6-2 | 3.02 | 4101.7 | 0.0515 | 1.15 | 6.92 | 0.605 |

^{a}Einstein A coefficient for the transition from level k to level i
^{b}for a laser cavity length of 100 cm and R = 0.99

### D. Level Population Model and Inversion Pumping

In order to estimate hydrogen excited state level populations and inversion pumping, the collisional radiative model [6, 36] is applied to the plasma conditions obtained herein (Tₑ˜0.8 eV, nₑ˜10⁹ cm⁻³). The collisional radiative model explicitly includes all level population and de-population mechanisms for each excited level from every other excited level in the hydrogen atom. Excited level n is, then, populated by collisional excitation from all lower excited states, and collisional and radiative de-excitation from all higher excited states. De-population explicitly includes collisional and radiative de-excitation to all lower states, and collisional excitation to all higher levels. Independent ionization loss, radiative recombination, and dielectronic recombination are included for all levels as well. A separate balance equation is prescribed for each individual level and is coupled to all other level equations through the population and de-population terms described above.

In order to close the set of equations, truncation was chosen at n=9. This is justified by both the experimental observation of no measurable emission from higher lying states and a posteriori via the model results indicating a progression of negligibly small level densities beyond n=6. The ground state (n=1) level population cannot be determined by this method since the important affects of dissociation, molecular recombination, and transport are not included. As discussed earlier (Sec. 3A), however, an estimate based on emission line profiles places the total H atom density ˜6×10¹³ cm⁻³. Since this is overwhelmingly dominated by the ground state, the assignment N₁=6×10¹³ cm⁻³ will be made throughout.

Solution to the n=2 to 9 level equations under these conditions shows no inversion in any of the level populations. This is an expected result for a steady, thermal plasma. Also, as expected, the dominant mechanisms are found to be population by collisional excitation and de-population by radiative decay.

The results of this calculation are inconsistent with the spectroscopic observations. Absolutely calibrating the monochromator for the Balmer lines however yields, N₃₋₈>10⁹ cm⁻³ as shown in TABLE 9. There is, then, a heretofore undetermined mechanism providing direct excited state population, i.e. pumping. To help quantify the affects of this mechanism, the level equations are once again evaluated with N_{5,6} fixed to the values given in TABLE 9 and the inclusion of independent pumping rates for n=5 and 6. Since spectroscopic results indicate n=3 to 8 inversion, pumping is prescribed to the n=5 and 6 states from the ground state, n=1. The results from this calculation for n=1 to 9 are summarized in TABLE 12.

TABLE 12
Model calculated level densities Nₙ for excited states
n = 1 to 9 with an n = 3 to 8 pumping mechanisms.

| Principal Quantum | |
|---|---|
| Number n | Nₙ (10⁹ cm⁻³) |
| 1^{a} | 60,000 |
| 2 | 24.4 |
| 3 | 11.7 |
| 4 | 78.4 |
| 5^{a} | 1930 |
| 6^{a} | 838 |
| 7 | 2.3 |
| 8 | 2.5 |
| 9 | 2.6 |

^{a}held fixed at the measured values

Now collisional mechanisms from the n=5 and 6 states as well as ground state collisional excitation and radiative decay significantly contribute to population and de-population rates. In addition, demonstrated inversion in the populations with the possibility of laser transitions from i) n=3, n=4, n=5, n=6, and n=7 to n=2, ii) n=4, n=5, and n=6 to n=3 and iii) n=5 and n=6 to n=4 are predicted.

The pumping rates and corresponding powers were also determined in this analysis yielding the rates given in TABLE 13. For example, in order for the n=5 state to be pumped to the desired level, the pumping mechanism must represent a transition rate density of 8.4×10¹⁹ cm⁻³·s⁻¹ from n=1 to n=5. Since the n=5 state has a excitation energy of 13.05 eV, this pumping mechanism consumes energy at a rate of ˜175.3 W·cm⁻³. Since this plasma is in the steady state, energy consumption at this rate implies an equivalent production at the same rate which is returned as H radiation corresponding to transitions to n<5. No other source of power was evident except the that proposed due to the catalytic reaction of oxygen with hydrogen.

TABLE 13
The pumping rate and pumping power calculated from the
collisional-radiative model for laser transitions 5-2, 5-3, and 6-2.

| | Calculated Pumping | Calculated Pumping |
|---|---|---|
| Laser | Rate of Upper Level | Power |
| Transition | (10¹⁹ cm⁻³s⁻¹) | (W · cm⁻³) |
| 5-2 | 8.4^{a} | 175.3^{a} |
| 5-3 | | |
| 6-2 | 2.12 | 44.8 |

^{a}for 5-2 and 5-3 transitions

### E. Blue and Infrared Laser and Power Applications

A micro-water laser may possible using proven approaches. As an advancement to the liquid based predecessor, micro-organic dye lasers have been developed by suspending each dye molecule in a cavity of a zeolite rather than in solution [37]. If they can be electrically pumped, such devices may eventually be competitive with semiconductor diode lasers; however, currently they require optical pumping. Microwaves are transparent to materials comprised of silicon or aluminum oxides. Thus, microcavities containing water vapor could potentially provide more competitive alternative microlasers for microelectronics applications that do not suffer from lattice constant and thermal expansion coefficient incompatibilities or require sophisticated materials or structures such as multiple quantum wells [1, 38].

Lasing is possible at blue wavelengths which are ideal for many communications and microelectronics applications as well as at a wavelength of 1.3 μm which is ideal for transmission through glass optical fibers. The emission wavelength of the potential water laser is about 400 nm which is suitable for the next generation 15-Gbyte DVDs [1]. Currently, the ideal laser diode for telecommunications applications is the InₓGa₁₋ₓAs_{y}P_{1-y} diode laser wherein a lattice constant mismatch requires that the laser be separate from the silicon circuits. An integrated laser would revolutionize telecommunications, electronics, and computing [39]. Conceptually, we see no obvious impediment to integration of a water-plasma laser. In addition, many more laser wavelengths corresponding to Balmer, Paschen, and Brackett lines are possible.

The observed 175 W·cm⁻³ pumping power of the n=5 state is unprecedented given the microwave input power of ˜9 W·cm⁻³. Using the model, the corresponding lasing power and efficiency of the 5-2 transition are high, 5 W·cm⁻³ and 56%, respectively, compared to the highest power commercially available for a He/Ne laser of about 50 mW at 0.01% efficiency. Our results indicate that with a microwave input power of 9 kW, 1000 cm⁻³ of water vapor plasma medium is capable of 5 kW cw laser power, comparable to the most powerful industrial cutting and welding lasers at about 50 times the efficiency. This obviously changes the prospects for many laser applications that have been limited by size or power requirements such as space-based lasers [40] and the National Ignition Facility (NIF) [41].

An even more significant opportunity exists for electric power generation. Compact magnetron-tube microwave power sources that are ubiquitous in applications such as microwave ovens are about 70-85% efficient and are extremely inexpensive and light-weight (unit cost for heating applications is about $10/kW with mass <1 kg/kW [42-44]). In addition, conversion of monochromatic spontaneous and/or stimulated emission from the water plasma cell to electricity using a photovoltaic (PV) with a band gap that is matched to the wavelength can be achieved with greater than 80% efficiency at a photovoltaic cell irradiation up to 1000 W·cm⁻² (7300 suns equivalent) requiring less than 1/7300 the PV active area of solar conversion [45-48]. Given that ultra-light, thin film photovoltaics are mass-produced at about ˜2¢ cm^{-2 [}49], we propose a competitive direct electric power generation system comprising an open cavity microwave driven water plasma surrounded by a photovoltaic converter where the cavity and converter reside inside the plasma vacuum vessel. This design eliminates the need for a window since the results of the model indicate that over 90% of the 200 W·cm⁻³ of optical power (total n=1→5,6 pumping power given in TABLE 13) due to catalysis involves Lyman emission. For short wavelength radiation, the quantum efficiency may be significantly greater than one which compensates for the photon-band-gap energy mismatch [50]. Using current technology, plasma cell power densities comparable to those of an internal combustion engine (ICE) and the efficient direct conversion of the power into electricity may be realizable with a system having reduced weight, capital cost, infrastructure requirements, and environmental impact than the ICE. Furthermore, this technology is sustainable; whereas, the ICE is not.

### 4. Conclusion

The reactions O₂, to O and O²⁺, O₂ to O and O³⁺, and 2O to 2O⁺ provide a net enthalpy of an integer multiple of the potential energy of atomic hydrogen of 2, 4, and 1 times 27.2 eV, respectively. Stationary inverted H Balmer and Lyman populations were observed from a low pressure water-vapor microwave discharge plasmas. The ionization and population of excited atomic hydrogen levels was attributed to energy provided by the catalytic resonant energy transfer between hydrogen atoms and molecular oxygen formed in the water plasma. The catalysis mechanism was supported by the observation of O²⁺ and H Balmer line broadening of 55 eV compared to 1 eV for hydrogen alone. The catalysis reaction, and consequently the inversion, depended on specific plasma conditions provided by the Evenson microwave cavity. In contrast, no inversion was observed using RF or glow discharge cells. In addition, the requirement for the natural hydrogen-oxygen stoichiometry of the water plasma was stringent in that a deviation by over 2% excess of either gas caused a reversal of the inversion.

The high hydrogen atom temperature with a relatively low electron temperature, Tₑ=2 eV, due to the catalysis reaction were characteristic of cold recombining plasmas. These conditions of a water plasma favored an inverted population in the lower levels. Thus, the catalysis of atomic hydrogen may pump a cw HI laser with expected laser oscillations from i) n=3, n=4, n=5, n=6, n=7 and n=8 to n=2, ii) n=4, n=5, n=6, and n=7 to n=3 and iii) n=5 and n=6 to n=4. A micro-water laser capable of integration may possible using proven approaches. Many more laser wavelengths corresponding to Balmer, Paschen, and Brackett lines are possible. With the capability of lasing over the widest range of atomic wavelengths of any known atomic laser, far infrared to violet, the hydrogen laser based on water-plasma may prove to be the most versatile laser yet discovered.

With the development of a pumping power of over 200 W·cm⁻³ for a microwave input power of ˜9 W·cm⁻³, new opportunities are possible for laser applications that are limited by power and/or size considerations. In addition, a potential revolutionary application is the direct generation of electrical power using photovoltaic conversion of the spontaneous or stimulated water vapor plasma emission. Energy balances of 100 times that of hydrogen combustion have been reported previously [51] which has implications for a sustainable energy technology that surpasses internal combustion.

### REFERENCES

1. S. Nakamura, “The roles of structural imperfections in InGaN-based blue light-emitting diodes and laser diodes, Science, Vol. 281, (1998), pp. 956-962.
2. R. W. Hardin, “Challenges remain for blue diode lasers”, OE Reports, SPIE, No. 192, December (1999), http://www.spie.org/web/oer/december/dec99/cover1.html.
3. L. I. Gudzenko, L. A. Shelepin, Sov. Phys. JETP, Vol. 18, (1963), p. 99⁸.
4. S. Suckewer, H. Fishman, J. Appl. Phys., Vol. 51, (1980), p. 1922.
5. W. T. Silfvast, O. R. Wood, J. Opt. Soc. Am. B, Vol. 4, (1987), p. 609.
6. H. Akatsuka, M. Suzuki, “Stationary population inversion of hydrogen in arc-heated magnetically trapped expanding hydrogen-helium plasma jet”, Phys. Rev. E, Vol. 49, (1994), pp. 1534-1544.
7. R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943.
8. R. Mills and M. Nansteel, P. Ray, “Argon-Hydrogen-Strontium Discharge Light Source”, IEEE Transactions on Plasma Science, Vol. 30, No. 2, (2002), pp. 639-653.
9. R. L. Mills, P. Ray, B. Dhandapani, M. Nansteel, X. Chen, J. He, “Spectroscopic Identification of Transitions of Fractional Rydberg States of Atomic Hydrogen”, J. of Quantitative Spectroscopy and Radiative Transfer, Vol. 76, No. 1, (2003), pp. 117-130.
10. R. L. Mills, P. Ray, B. Dhandapani, M. Nansteel, X. Chen, J. He, “New Power Source from Fractional Quantum Energy Levels of Atomic Hydrogen that Surpasses Internal Combustion”, J. Mol. Struct., in press.
11. R. Mills, P. Ray, R. M. Mayo, “Chemically-Generated Stationary Inverted Lyman Population for a CW HE Laser”, J Vac. Sci. and Tech. A, subrmitted.
12. D. R. Lide, CRC Handbook of Chemistry and Physics, 79 th Edition, CRC Press, Boca Raton, Fla., (1998-1999), p. 9-55 and p. 10-175.
13. A., Crocker, H. A. Gebbie, M. F. Kimmitt, L. E. S. Mathias, “Stimulated emission in the far infra-red”, Nature, Vol. 201, (1964), pp. 250-251.
14. W. J. Saijeant, Z. Kucerovsky, E. Brannen, “Excitation processes and relaxation rates in the pulsed water vapor laser”, Applied Optics, Vol. 11, No. 4, (1972), pp. 735-741.
15. A. K. Shuaibov, A. I. Dashchenko, I. V. Shevera, “Stationary radiator in the 130-190 nm range based on water vapour plasma”, Quantum Electronics, Vol. 31, No. 6, (2001), pp. 547-548.
16. R. L. Mills, P. Ray, E. Dayalan, B. Dhandapani, J. He, “Comparison of Excessive Balmer a Line Broadening of Inductively and Capacitively Coupled RF, Microwave, and Glow Discharge Hydrogen Plasmas with Certain Catalysts”, IEEE Transactions on Plasma Science, submitted.
17. R. L. Mills, P. Ray, “Substantial Changes in the Characteristics of a Microwave Plasma Due to Combining Argon and Hydrogen”, New Journal of Physics, www.njp.org, Vol. 4, (2002), pp. 22.1-22.17.
18. R. L. Mills, P. Ray, B. Dhandapani, J. He, “Comparison of Excessive Balmer cc Line Broadening of Glow Discharge and Microwave Hydrogen Plasmas with Certain Catalysts”, J. of Applied Physics, submitted.
19. F. C. Fehsenfeld, K. M. Evenson, H. P. Broida, “Microwave discharges operating at 2450 MHz”, Review of Scientific Instruments, Vol. 35, No. 3, (1965), pp. 294-298.
20. B. McCarroll, “An improved microwave discharge cavity for 2450 MHz”, Review of Scientific Instruments, Vol. 41, (1970), p. 279.
21. I. R. Videnovic, N. Konjevic, M. M. Kuraica, “Spectroscopic investigations of a cathode fall region of the Grimm-type glow discharge”, Spectrochimica Acta, Part B, Vol. 51, (1996), pp. 1707-1731.
22. J. Tadic, I. Juranic, G. K. Moortgat, “Pressure dependence of the photooxidation of selected carbonyl compounds in air: n-butanal and n-pentanal”, J. Photochemistry and Photobiology A: Chemistry, Vol. 143, (2000), 169-179.
23. NIST Atomic Spectra Database, www.physics.nist.gov/cgi-bin/AtData/display.ksh.
24. D. Barton, J. W. Bradley, D. A. Steele, and R. D. Short, “Investigating radio frequency plasmas used for the modification of polymer surfaces,” J. Phys. Chem. B, Vol. 103, (1999), pp. 4423-4430.
25. A. K. Shuaibov, L. L. Shimon, A. I. Dashchenko, I. V. Shevera, “Optical characteristics of a glow discharge in a HelH₂O mixture”, Plasma Physics Reports, Vol. 27, No. 10, (2001), pp. 897-900.
26. H. Okabe, Photochemistry of Small Molecules, John Wiley & Sons, New York, (1978).
27. J. G. Calvert, J. N. Pitts, Photochemistry, John Wiley & Sons, New York, (1966), pp. 200-202.
28. R. K. Vatsa, H. R. Volpp, “Absorption cross-section for atmospheric important molecules at the H atom Lyman α wavelength (121.567 nm)”, Chemical Physics Letters, Vol. 340, (2001), pp. 289-295.
29. S. Djurovic, J. R. Roberts, “Hydrogen Balmer alpha line shapes for hydrogen-argon mixtures in a low-pressure rf discharge”, J. Appl. Phys., Vol. 74, No. 11, (1993), pp. 6558-6565.
30. J. Seidel, “Theory of two-photon polarization spectroscopy of plasma-broadened hydrogen L_{α} line”, Phys. Rev. Letts., Vol. 57, No. 17, (1986), p. 2154.
31. A. Czemikowski, J. Chapelle, Acta Phys. Pol. A., Vol. 63, (1983), p. 67.
32. M. A. Gigosos, V. Cardenoso, “New plasma diagnosis tables of hydrogen Starlk broadening including ion dynamics”, J. Phys. B: At. Mol. Opt. Phys., Vol. 29, (1996), pp. 4795-4838.
33. A. Corney, Atomic and Laser Spectroscopy, Clarendon Press, Oxford, (1977).
34. M. Kuraica, N. Konjevic, “Line shapes of atomic hydrogen in a plane-cathode abnormal glow discharge”, Physical Review A, Volume 46, No. 7, October (1992), pp. 4429-4432.
35. S. B. Radovanov, K. Dzierzega, J. R. Roberts, J. K. Olthoff, “Time-resolved Balmer-alpha emission from fast hydrogen atoms in low pressure, radio-frequency discharges in hydrogen”, Appl. Phys. Letts., Vol. 66, No. 20, (1995), pp. 2637-2639.
36. T. Fujimoto, J. Phys. Soc. Jpn., Vol. 47, (1979). p. 265.
37. S. R. Forrest, “Solid-state lasers: Lasing from a molecular sieve”, Nature Vol. 397, (1999), pp. 294-295.
38. T. Someya, R. Werner, A. Forchel, M. Catalano, R. Cingolani, Y. Arakawa, “Room temperature lasing at blue wavelengths in gallium nitride microcavities”, Science, Vol. 285, (1999), pp. 1905-1906.
39. P. Ball, “Let there be light”, Nature, Vol. 409, (2001), pp. 974-976.
40. http://www.airbornelaser.com; http://home.achilles.net/˜jtalbot/history/starwars.html; http://www.peacevision.org.uk/papers/webb.html.
41. R. L. McCrory, et al., “OMEGA ICF experiments and preparation for direct drive ignition on NIF”, Nuclear Fusion, Vol. 41, No. 10, (2001), pp. 1414-1422.
42. Panasonic specifications sheet on model #2M167B-M10G, Two Panasonic Way, 7E-2, Secaucus, N.J. 07094, Feb. 25, 2000.
43. R. M. Dickinson, Chairman NASA SSP Wireless Power Transmission Working Group, presentation at http://ssp.jpl.nasa.gov/ssp_wireless_pres/wireless.ppt.
44. V. L. Granastein, R. K. Parker, C. M. Armstrong, “Scanning the technology vacuum electronics at the dawn of the twenty-first century”, Proceedings of the IEEE, May, (1999), Vol. 87, No. 5, http://www.spectrum.ieee.org/pubs/trans/9905/87proc05-granatstein.html, (accessed January 2001).
45. L. C. Olsen, D. A. Huber, G. Dunham, F. W. Addis, “High efficiency monochromatic GaAs solar cells”, in Conf. Rec. 22nd IEEE Photovoltaic Specialists Conf., Las Vegas, Nev., Vol. I, October (1991), pp. 419-424.
46. R. A. Lowe, G. A. Landis, P. Jenkins, “Response of photovoltaic cells to pulsed laser illumination”, IEEE Transactions on Electron Devices, Vol. 42, No. 4, (1995), pp. 744-751.
47. R. K. Jain, G. A. Landis, “Transient response of gallium arsenide and silicon solar cells under laser pulse”, Solid-State Electronics, Vol. 4, No. 11, (1998), pp. 1981-1983.
48. P. A. Iles, “Non-solar photovoltaic cells”, in Conf. Rec. 21st IEEE Photovoltaic Specialists Conf., Kissinimee, Fla., Vol. I, May, (1990), pp. 420-423.
49. http://www.nrel.gov/docs/fy01osti/28928.pdf.
50. R. Hartmann, K.-H. Stephan, L. Struder, “The quantum efficiency of pn-detectors from the near infrared to the soft X-ray region”, Nuclear Instruments and Methods in Physics Research A, Vol. 439, (2000), pp. 216-220.
51. R. L. Mills, X. Chen, P. Ray, J. He, B. Dhandapani, “Plasma Power Source Based on a Catalytic Reaction of Atomic Hydrogen Measured by Water Bath Calorimetry”, Thermochimica Acta, submitted.

In the lasers described herein above, the inverted hydrogen population can easily be formed in situ, which means that the inverted hydrogen population can be formed within a chemically generated plasma contained in a cell, without requiring rapid expansion of a plasma in a vacuum.

1.-297. (canceled)

298. A hydrogen reactor for forming an inverted hydrogen population, the reactor comprising:
a catalyst for catalyzing a reaction of hydrogen atoms to lower-energy hydrogen atoms;
atomic hydrogen; and
a plasma cell constructed and arranged to contain a plasma and catalyze atomic hydrogen under conditions that produce lower-energy hydrogen and a continuous inverted hydrogen population.

299. The reactor according to claim 298, further comprising a photon-to-electric power converter.

300. The reactor according to claim 298, further comprising a microwave cell, wherein the microwave cell is an open mesh cavity that transmits photons emitted from the plasma to a photon-to-electric power converter.

301. The reactor according to claim 299, wherein the photon-to-electric power converter comprises a photovoltaic cell.

302. The reactor according to claim 299, wherein the photon-to-electric power converter lines the plasma cell, and wherein the plasma cell comprises a vacuum chamber.

303. The reactor according to claim 299, wherein the photon-to-electric power converter is radiation-hardened and converts ultraviolet and extreme ultraviolet radiation to electricity.

304. The reactor according to claim 298, further comprising a laser cavity.

305. The reactor according to claim 304, wherein the laser cavity contains hydrogen atoms and lower energy hydrogen atoms, which undergo transitions to lower-energy states with energy levels of about
$$\frac{13.6 eV}{{( \frac{1}{p} )}^{2}} ,$$
where p is an integer, and which constitute the inverted population which lases in the laser cavity.

306. The reactor according to claim 304, wherein the laser cavity further comprises a high reflectivity mirror.

307. The reactor according to claim 306, wherein the mirror reflects about 95% to about 100% of a laser light and comprises a reflective spherical cavity mirror.

308. The reactor according to claim 306, further comprising an output coupler having a transmission output in the range of about 0.1% to about 50%.

309. A reactor according to claim 306, further comprising an output coupler having transmission output in the range of about 1% to about 10%.

310. The reactor according to claim 304, further comprising windows configured to direct a laser beam, and an optical rail configured to adjust a length of the laser cavity.

311. The reactor according to claim 304, wherein fast hydrogen atoms are formed by the catalysis of atomic hydrogen (H) to lower-energy states with energy levels of about
$$\frac{13.6 eV}{{( \frac{1}{p} )}^{2}} ,$$
where p is an integer, excited state atomic hydrogen (H) is formed from fast hydrogen atoms, where H(n=1), by collisions with a background gas such as H₂, and inversion is achieved by collisions with a heavier gas or gases which provide a resonant excitation by collision with fast hydrogen atoms such as at least one molecule from the list of O₂, H₂O, CO₂, N₂, NO₂, NO, CO, and a halogen gas.

312. The reactor according to claim 305, wherein a lasing species is at least one of OH*, CO₂, and H₂O.

313. The reactor according to claim 304, further comprising a plasma of a noble gas and at least one halogen gas, wherein excimers are formed, and power is extracted by excimer laser emission.

314. The reactor according to claim 304, further comprising a plasma that is excited by at least one of a pumping mechanism and an energy transfer from an excited state species such as excited atomic hydrogen.

315. The reactor according to claim 298, further comprising a means to propagate radiation corresponding to the plasma, wherein at least one of extreme ultraviolet, ultraviolet, visible, infrared, microwave, and radio wave radiation is produced in the reactor and propagated using the means to propagate radiation.

316. The reactor according to claim 315, wherein the means to propagate radiation is selected based on the wavelength or wavelength range of the radiation.

317. The reactor according to claim 315, wherein the means to propagate radiation comprises at least a part of a plasma cell wall that is transparent to the wavelength or wavelength range of the radiation.

318. The reactor according to claim 315, wherein the means to propagate radiation is coated with a phosphor, which converts at least one of ultraviolet and extreme ultraviolet light to light to which the photon-to-electric power converter is responsive.

319. The reactor according to claim 315, wherein the catalyst comprises at least one catalyst selected from the group consisting of potassium, rubidium, cesium metal, strontium metal, nitrate, and carbonate.

320. The reactor according to claim 319, wherein the catalyst comprises a first catalyst and a second catalyst, and the first catalyst generates the second catalyst from a source material supplied by the second catalyst.

321. The reactor according to claim 320, wherein the second catalyst is formed by ionization of the source of the second catalyst by the plasma formed by the first catalyst.

322. The reactor according to claim 315, further comprising control means for a heater and a heater power controller.

323. The reactor according to claim 315, further comprising a source of microwave power to at least partially maintain the plasma.

324. The reactor according to claim 315, wherein a source of catalyst is selected from the group consisting of helium, neon, argon, water vapor, and ammonia.

325. The reactor according to claim 324, wherein a catalyst is selected from the group consisting of He⁺, Ne⁺, Ar⁺, O₂, and N₂.

326. The reactor according to claim 315, wherein a source of atomic hydrogen and a source of catalyst comprises a mixture of about 10% hydrogen with at least one member selected from the group consisting of helium, neon, and argon.

327. A reactor according to claim 298, wherein the catalyst comprises a chemical or physical process that provides a net enthalpy of m·27.2±0.5 eV where m is an integer or m/2·27.2±0.5 eV where m is an integer greater than one.

328. A reactor according to claim 327, wherein the catalyst comprises at least one molecule selected from the group of C₂, N₂, O₂, CO₂, NO₂, and NO₃ or at least one atom or ion selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, 2H, He⁺, Na⁺, Rb⁺, Sr⁺, Fe³⁺, Mo²⁺, Mo⁴⁺, In³⁺, Ar⁺, Xe⁺, Ar²⁺ and H⁺, and Ne⁺ and H⁺.
